(19) United States
(12) Patent Application Publication
(10) Pub. No.: US 2005/0097191 A1
(43) Pub. Date: May 5, 2005

(54) Control system for controlling medical equipment

(75) Inventors: Masahide Yamaki, Tokyo (JP); Kenji Noda, Tokyo (JP); Akinobu Uchikubo, Saitama (JP); Takashi Ozaki, Tokyo (JP); Hiroyuki Mino, Tokyo (JP); Shigeo Nagayama, Tokyo (JP); Daisuke Sano, Tokyo (JP); Masaya Fujita, Kanagawa (JP); Nobuyuki Furukawa, Tokyo (JP); Sumihito Kontshi, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, TOKYO (JP)

(21) Appl. No.: 10/964,995

(22) Filed: Oct. 14, 2004

Related U.S. Application Data
(63) Continuation-in-part of application No. 10/233,508, filed on Sep. 3, 2002.

(30) Foreign Application Priority Data
Sep. 5, 2001 (JP) 2001-269304
Oct. 18, 2001 (JP) 2001-321138
Nov. 30, 2001 (JP) 2001-367807
Nov. 30, 2001 (JP) 2001-367810
Jan. 30, 2002 (JP) 2002-022103
Feb. 22, 2002 (JP) 2002-046743
Feb. 27, 2002 (JP) 2002-051814
Mar. 15, 2002 (JP) 2002-072934
Mar. 20, 2002 (JP) 2002-079092
Jul. 10, 2002 (JP) 2002-201714

(51) Int. Cl. G06F 15/177; G06F 15/16

(52) U.S. Cl. 709/219; 709/220

(57) ABSTRACT

A medical equipment control system consists mainly of a plurality of centralized controllers each of which controls on a centralized basis a plurality of pieces of medical equipment installed in an operating room, and a mobile device capable of communicating with the plurality of centralized controllers. The mobile device is used to determine or record control data based on which the plurality of pieces of medical equipment is controlled. The recorded control data is transmitted to and recorded in the centralized controller in an operating room concerned. Thus, a medical equipment control system capable of controlling medical equipment at low cost on a centralized basis is realized.

### CROSS-REFERENCE TO RELATED APPLICATIONS

This application is a Continuation-In-Part of U.S. application Ser. No. 10/233,508 filed on Sep. 3, 2002 which claims the benefit of Japanese Application No. 2001-269304 filed in Japan on Sep. 5, 2001, Japanese Application No. 2001-321138 filed in Japan on Oct. 18, 2001, Japanese Application No. 2001-367807 filed in Japan on Nov. 30, 2001, Japanese Application No. 2001-367810 filed in Japan on Nov. 30, 2001, Japanese Application No. 2002-022103 filed in Japan on Jun. 30, 2002, Japanese Application No. 2002-046743 filed in Japan on Feb. 22, 2002, Japanese Application No. 2002-051814 filed in Japan on Feb. 27, 2002, Japanese Application No. 2002-072934 filed in Japan on Mar. 15, 2002, Japanese Application No. 2002-079092 filed in Japan on Mar. 20, 2002, Japanese Application No. 2002-201714 filed in Japan on Jul. 10, 2002, and Japanese Application No. 2003-62048 filed in Japan on Mar. 7, 2003, the contents of each of which are incorporated by reference.

### BACKGROUND OF THE INVENTION

1. Field of the Invention

The present invention relates to a control system for controlling a plurality of medical devices.

2. Description of the Related Art

One of systems comprising a plurality of medical devices is a medical endoscope system having an endoscope. Generally, an endoscope system comprises: an endoscope for observation; a camera head connected to the endoscope; a camera device for endoscope which processes an image signal picked-up by the camera head; a light source device which supplies illuminating light to the endoscope so as to illuminate a subject; and a monitor which displays an endoscope image through the signal processing by the camera device for endoscope.

In the endoscope system, the endoscope is inserted to an examined portion, the illuminating light from the light source device is irradiated to the subject, and thus an optical image of the subject is obtained by the endoscope. In the endoscope system, the camera device for endoscope performs the signal processing of the image signal of a subject image picked-up by the camera head, and the endoscope image is displayed on the monitor. The endoscope system enables the observation and examination of the body cavity and the like.

The surgery uses the endoscope. In the surgery with the endoscope, various treatments are performed by observing the treated portion under the endoscope with the above-mentioned devices and various treatment devices such as an aeroperitoneum device used for expanding the abdominal cavity and a high-frequency cautery device for incising or coagulating the living body organ.

The surgery with the endoscope using the conventional medical endoscope system is executed as shown in FIG. 198. FIG. 198 is an explanatory diagram showing the flow of the operation starting up the preparation, through the execution of operation to the clearing of the conventional endoscope surgery.

Usually, a user conveys equipment to an operation room before the operation, and prepares for the operation by connecting cables and tubes. The connection ends, then, the user turns on the power supply, starts the medical endoscope system, and starts the endoscope operation.

Prior to the endoscope operation, the user previously initializes the various medical devices such as the aeroperitoneum device and the high-frequency cautery device. In this case, there are two types of the medical endoscope systems to be started, one for controlling the medical devices independently as shown in a flow A and the other for controlling the medical devices centrally as shown by a flow B.

The one medical endoscope system individually operates and controls the medical devices. Therefore, the operation is excessively complicated in the one medical endoscope system, e.g., the initialization is individually performed.

The other medical endoscope system is an intensive control system, so-called an integrated system. For example, Japanese Unexamined Patent Application Publication No. 9-31949 discloses the medical endoscope system, which comprises a medical device control apparatus, which intensively operates and controls the medical devices. In the medical device control apparatus disclosed in Japanese Unexamined Patent Application Publication No. 9-31949, the operation is excessively easy, e.g., the medical devices are automatically initialized at once.

The above-mentioned operation corresponds to the preparation before the operation. After ending the initialization of the medical devices, the user performs the operation. In this case, even during the surgery with the endoscope, the user sets again or changes the medical devices, for example, he/she changes the aeroperitoneum device or changes an output voltage of the high-frequency cautery device. After the operation, the user turns off the power, detaches the cables and the tubes of the medical endoscope system, and ends the operation.

In the medical device control apparatus disclosed in Japanese Unexamined Patent Application Publication No. 9-31949, the single system automatically sets the medical devices as shown in the flow B. In the surgery with the endoscope, the flow A or B has the excessively large number of steps of setting the medical devices, as compared with a flow C having the number of steps of individually operating the medical devices during the operation.

Generally, a plurality of operation rooms are set in a hospital or the like, and are scheduled for the use for the surgery with the endoscope or the general abdominal surgery. Recently, the number of such a surgery with the endoscope is increased, and the medical device control apparatus is widely used in every operation room.

Further, the computer is reduced in scale and, a small-sized mobile terminal, so-called palm-top computer as one of personal data assistants (hereinafter, referred to as a PDA) is developed. The mobile terminal forms electric data, controls the schedule, and has radio communication means using IrDA (infrared) or Bluetooth (electric waves). The mobile terminal enables not only the personal data management but also the easy data communication with another system by using the radio communication means.

Other endoscope systems are disclosed in Japanese Unexamined Patent Application Publication No. 2001-95818, Japanese Unexamined Patent Application Publication No. 11-299729, and Japanese Unexamined Patent Application Publication No. 2002-65618.

As disclosed in Japanese Unexamined Patent Application Publication No. 2001-95818, maintenance information of the medical device is recorded to a mobile recording medium, and the state of the medical device forming the system is easily checked.

Further, as disclosed in Japanese Unexamined Patent Application Publication No. 11-299729, the medical device is automatically set.

Furthermore, as disclosed in Japanese Unexamined Patent Application Publication No. 2002-65618, vital signs are communicated and displayed on a monitor that is monitored by a surgeon and, in the abnormal case, the treatment is displayed on the monitor.

The PDA is used for an input/output terminal of the endoscope operation systems.

In addition, Japanese Unexamined Patent Application Publication No. 6-114065 discloses an automatic setting function, in which set values of the medical devices are previously registered and stored, and the devices are set by one-button control before the operation.

The function for individually operating set values in the endoscope system includes the above-mentioned setting function, a customizing function for display operation of an operating panel or a display panel, and a voice recognizing function.

A hospital, a section, or a doctor can set or lay out the functions by personally using the operation set values.

As mentioned above, the general endoscope operation system comprises: the endoscope for observation; the camera head connected to the endoscope; a TV camera device for endoscope which processes the image signal picked-up by the camera head; the light source device which supplies illuminating light to the subject; the monitor which displays the subject image; the aeroperitoneum device which expands the abdominal cavity; and the high-frequency cautery device, as a medical device for manual operation, which incises or coagulates the living body tissue (hereinafter, referred to as an electric knife).

Then, the endoscope is inserted in the examined portion, the illuminating light from the light source device is irradiated, an optical image of the subject is obtained with the endoscope, the image signal of the subject image picked-up by the camera head is subjected to the signal processing by the endoscope camera device, and various treatments are performed by observing the treated portion which is displayed on the monitor.

Japanese Unexamined Patent Application Publication No. 7-303654 discloses an endoscope operation system comprising a plurality of controlled devices. In order to easily operate and control the plurality of devices and improve the system operability, the endoscope operation system uses a system control device comprising a system controller, which intensively operates the controlled devices on the hand side, a display device, and an operating device.

Further, Japanese Unexamined Patent Application Publication No. 9-319409 discloses an endoscope operation system comprising an automatic setting function, which automatically sets the devices by previously inputting/registering set values of the devices in a lump by a user and by calling the registered data upon starting so as to facilitate the setting of the controlled devices upon starting.

Furthermore, Japanese Unexamined Patent Application Publication No. 2001-32745 discloses an endoscope operation system comprising a system device having a recording function for recording the user operating history, comment, and system information on default information of controlled devices. In addition, Japanese Unexamined Patent Application Publication No. 2001-250507 discloses an endoscope operation system in which maintenance information of medical devices is easily picked-up to the outside.

As an endoscope operation system comprising a plurality of medical devices, a medical endoscope system having an endoscope is exemplified.

In the following endoscope system, a plurality of peripheral devices include an aeroperitoneum device which communicates data with an intensive control device by wiring of RS-232C, a light source device, a curing device, and a patient monitor device which communicates data by LAN wiring. Further, a mobile device denotes a mobile information terminal, which communicates data with an intensive control device by radio Bluetooth, such as a PDA.

In the above-mentioned endoscope system, the setting of the aeroperitoneum device as the peripheral device is changed, thereby updating information of the intensive control device with the serial transfer of RS-232C. After that, the data updated in the intensive controlled device as the information of one or a plurality of mobile devices is updated by a communication system of Bluetooth, which is different from the above-mentioned systems in communication speed.

In the endoscope operation system for intensively controlling the endoscope device and the operation devices, various tests are executed for the purpose of improving the operability. As one of the tests, a remote operating device such as a remote controller is developed to remotely operate the endoscope operation system.

Further, Japanese Unexamined Patent Application Publication No. 9-319409 proposes a method, by which a plurality of medical peripheral devices are managed by an intensive control device, set values of the peripheral device are stored in a memory, and parameters of the peripheral devices are set in a lump by reading the set values stored in the memory upon preparing the system before the operation.

Generally, the operation is executed for the patient by an operator in an operation room. When the operator in the operation room needs to perform the operation which is not familiar to him, a system is considered for supporting the proper operation on the patient in the operation room by performing the operation by the operator in the operation room under the remote support such as an instruction for a portion to be incised by a remotely supporting operator during the operation by the communication to a remotely supporting operator having rich experience in the operation via a communication line.

As mentioned above, Japanese Unexamined Patent Application Publication No. 2000-245738 discloses, as a conventional technology, a remote operation supporting system for remotely supporting the operation in detail.

As disclosed in Japanese Unexamined Patent Application Publication No. 2000-245738, the remotely supporting system has the following structure.

That is, a first controller in the operation room is connected to a first signal-transmitting device. The first signal-transmitting device is connected to a second signal-transmitting device in a remotely supporting device room via a communication line. The second signal-transmitting device is connected to a second controller and a display.

Information on the operation in the operation room is obtained on a display or the line, which is installed in the remotely supporting device room via the communication line and the signal transmitting devices in the operation room and the remotely supporting device room.

### SUMMARY OF THE INVENTION

A control system for controlling medical equipment in accordance with the present invention consists mainly of a mobile device and a controller. The mobile device includes: an operator panel having an operating section that is used to instruct setup of a plurality of pieces of medical equipment; a first information processing circuit that produces data representing the settings of medical equipment on the basis of an instruction entered at the operator panel; and a first communication interface that transmits the setting data produced by the information processing circuit. The controller includes: a second communication interface circuit connected to the plurality of pieces of medical equipment; a third communication interface that receives the setting data sent via the first communication interface and enables bi-directional communication; and a second information processing circuit that transfers the setting data, which is terminated by the third communication interface, to the second communication interface.

Other features of the present invention and advantages thereof will be fully apparent from the description below.

### BRIEF DESCRIPTION OF THE DRAWINGS

FIG. 1 to FIG. 5 are concerned with a first embodiment of the present invention;

FIG. 1 is a circuit block diagram showing the overall configuration of a medical equipment control system in accordance with the first embodiment of the present invention;

FIG. 2 is a front view showing the appearance of a mobile device shown in FIG. 1;

FIG. 3 to FIG. 5 are explanatory diagrams presenting concrete examples of the way of handling the mobile device;

FIG. 3 is an explanatory diagram concerning a case where a set value registration/modification mode image is displayed on a liquid crystal display;

FIG. 4 is an explanatory diagram concerning a case where a set value readout mode image is displayed on the liquid crystal display;

FIG. 5 is an explanatory diagram concerning a case where control data representing the settings of each piece of medical equipment and being sent from a centralized controller is registered as new data;

FIG. 6 to FIG. 11 are concerned with a second embodiment of the present invention;

FIG. 6 shows the appearance of a medical equipment control system in accordance with the second embodiment of the present invention;

FIG. 7 is an explanatory diagram showing a register name entry image displayed on a terminal monitor shown in FIG. 6;

FIG. 8 is an explanatory diagram showing an equipment selection image displayed on the terminal monitor shown in FIG. 6;

FIG. 9 is an explanatory diagram showing a setting entry image displayed on the terminal monitor shown in FIG. 6;

FIG. 10 is an explanatory diagram showing a register verification image displayed on the terminal monitor shown in FIG. 6;

FIG. 11 is a flowchart describing a processing flow of controlling addition of data to a programming terminal;

FIG. 12 to FIG. 18 are concerned with a third embodiment of the present invention;

FIG. 12 is an explanatory diagram showing an endoscopic surgery system installed in an operating room;

FIG. 13 is a block diagram showing a patient monitor system;

FIG. 14 is a plan view showing a screen image displayed on an operator panel when an electrocautery unit is designated;

FIG. 15 is a plan view showing a screen image displayed on the operator panel when download is designated;

FIG. 16 is a plan view showing a display operating section of a PDA on which a main menu is displayed;

FIG. 17 is a plan view showing the display operating section of the PDA on which a download menu is displayed;

FIG. 18 is a flowchart describing a procedure started with the display of the main menu ended with download;

FIG. 19 is a plan view showing a screen image displayed on an operator panel according to a variant of the third embodiment shown in FIG. 12 to FIG. 17;

FIG. 20 is a sectional view showing in enlargement a major portion of an encased device in accordance with a fifth embodiment of the present invention;

FIG. 21 is a sectional view showing in enlargement a major portion of an encased device in accordance with a sixth embodiment of the present invention;

FIG. 22 is a sectional view showing in enlargement a major portion of an encased device in accordance with a seventh embodiment of the present invention;

FIG. 23 is a sectional view showing in enlargement a major portion of an encased device in accordance with an eighth embodiment of the present invention;

FIG. 24 is a sectional view showing in enlargement a major portion of an encased device in accordance with a ninth embodiment of the present invention;

FIG. 25 is a sectional view showing in enlargement a major portion of an encased device in accordance with a tenth embodiment of the present invention;

FIG. 26 and FIG. 27 are concerned with an eleventh embodiment of the present invention;

FIG. 26 is an explanatory diagram showing an endoscopic surgery system installed in an operating room;

FIG. 27 is a perspective view showing a setting display panel and its surroundings;

FIG. 28 to FIG. 30 are concerned with a twelfth embodiment of the present invention;

FIG. 28 is a side view showing an endoscopic surgery trolley;

FIG. 29 is a front view showing the endoscopic surgery trolley seen from a clean zone;

FIG. 30 is a front view showing an LCD monitor installed in an unclean zone;

FIG. 31 and FIG. 32 are concerned with a thirteenth embodiment of the present invention;

FIG. 31 is a perspective view showing an endoscopic surgery trolley with an LCD monitor and a setting display panel left open;

FIG. 32 is a perspective view showing the endoscopic surgery trolley with the LCD monitor and setting display panel met each other;

FIG. 33 to FIG. 44 are concerned with a fourteenth embodiment of the present invention;

FIG. 33 shows the overall configuration of an endoscopic surgery system including the fourteenth embodiment;

FIG. 34 shows the internal configuration of a system controller;

FIG. 35 shows the configuration of a control module;

FIG. 36 is a screen image transition chart;

FIG. 37 shows a main screen image;

FIG. 38 shows an electrocautery screen image;

FIG. 39 shows an automatic setup screen image;

FIG. 40 shows an electrocautery unit setting screen image;

FIG. 41 describes automatic setup;

FIG. 42 shows the structure of internal data of a PC card;

FIG. 43 shows state transitions caused by a home editing program;

FIG. 44 shows an automatic setup screen image for personal computers;

FIG. 45 to FIG. 49 are concerned with a fifteenth embodiment of the present invention;

FIG. 45 is a block diagram showing the internal configuration of a system controller included in the fifteenth embodiment of the present invention;

FIG. 46 shows a directory tree structure formed in a memory included in a portable terminal;

FIG. 47 is a flowchart describing setting data designation to be performed using a portable terminal;

FIG. 48 shows a verification screen image through which it is verified whichever of a plurality of automatic setting data items is adopted;

FIG. 49 is a verification screen image to be displayed when a plurality of setting data items is available for setup of an electrocautery unit;

FIG. 50 to FIG. 55 are concerned with a sixteenth embodiment of the present invention;

FIG. 50 shows the overall configuration of an endoscope system including the sixteenth embodiment;

FIG. 51 schematically shows the internal configuration of a system controller;

FIG. 52 shows a main screen image to be displayed on a PDA;

FIG. 53A shows the contents of a first processing flow of registering or identifying information concerning the PDA;

FIG. 53B shows the contents of a second processing flow of registering or identifying information concerning the PDA;

FIG. 54 shows an input screen image through which a password used to access the PDA is entered;

FIG. 55 is an identification information input screen image through which identification information of the PDA is entered;

FIG. 56 and FIG. 57 are concerned with a seventeenth embodiment of the present invention;

FIG. 56 is a flowchart describing system information transmission;

FIG. 57 shows a screen image to be displayed when it is found during system information transmission that the storage capacity required by system information is larger than the available storage capacity of a PDA;

FIG. 58 to FIG. 71 are concerned with an eighteenth embodiment of the present invention;

FIG. 58 shows the configuration of an endoscopic surgery system;

FIG. 59 shows the configuration of a patient monitor system shown in FIG. 58;

FIG. 60 is a schematic block diagram showing the endoscopic surgery system shown in FIG. 58;

FIG. 61 is a schematic block diagram showing a variant of the endoscopic surgery system shown in FIG. 58;

FIG. 62 is a first diagram showing a screen image displayed on a mobile device shown in FIG. 58;

FIG. 63 is a second diagram showing a screen image displayed on the mobile device shown in FIG. 58;

FIG. 64 is a block diagram showing the configuration of a centralized controller shown in FIG. 60;

FIG. 65 is a block diagram showing the configuration of a mobile device shown in FIG. 60;

FIG. 66 is a block diagram showing the configuration of a communication interface included in the centralized controller shown in FIG. 64;

FIG. 67 is a block diagram showing the configuration of a communicating state distinguishing module shown in FIG. 65;

FIG. 68 is a first flowchart describing the operation of the endoscopic surgery system shown in FIG. 58;

FIG. 69 is a second flowchart describing the operation of the endoscopic surgery system shown in FIG. 58;

FIG. 70 is a third flowchart describing the operation of the endoscopic surgery system shown in FIG. 58;

FIG. 71 is a fourth flowchart describing the operation of the endoscopic surgery system shown in FIG. 58;

FIG. 72 to FIG. 76 are concerned with a nineteenth embodiment of the present invention;

FIG. 72 shows the configuration of an endoscopic surgery system;

FIG. 73 shows the configuration of a variant of the endoscopic surgery system shown in FIG. 72:

FIG. 74 shows the connective relationships among the components of the centralized control system shown in FIG. 72 and those of a mobile device;

FIG. 75 is a flowchart describing the operation of the endoscopic surgery system shown in FIG. 72;

FIG. 76 is a flowchart describing the operation of the endoscopic surgery system shown in FIG. 73;

FIG. 77 to FIG. 79 are concerned with a twentieth embodiment of the present invention;

FIG. 77 shows the configuration of an endoscopic surgery system;

FIG. 78 is a first diagram for explaining the operation of a mobile device shown in FIG. 77;

FIG. 79 is a second diagram for explaining the operation of the mobile device shown in FIG. 77;

FIG. 80 to FIG. 89 are concerned with a twenty-first embodiment of the present invention;

FIG. 80 shows the overall configuration of an endoscopic surgery system including the twenty-first embodiment with the components thereof laid out in an example of a use state;

FIG. 81 shows the internal configuration of a major portion of the endoscopic surgery system;

FIG. 82 schematically shows the appearance of a portable terminal;

FIG. 83 schematically shows the appearance of an infrared communication adaptor;

FIG. 84 shows the structure of a joint joining the portable terminal and infrared communication adaptor;

FIG. 85 shows the internal configuration of the infrared communication adaptor;

FIG. 86 shows the contents of processing to be performed by the portable terminal;

FIG. 87 shows the contents of processing to be performed with designation of an insufflator unit which are included in the contents of processing described in FIG. 86;

FIG. 88 shows a main menu screen image relevant to the contents of processing described in FIG. 86;

FIG. 89 shows an example of a set value entry screen image that is displayed as a step included in the contents of processing described in FIG. 87;

FIG. 90 to FIG. 91 are concerned with a twenty-second embodiment of the present invention;

FIG. 90 schematically shows an infrared communication adaptor;

FIG. 91 is a block diagram showing the internal configuration of the infrared communication adaptor;

FIG. 92 to FIG. 95 are concerned with a twenty-third embodiment of the present invention;

FIG. 92 schematically shows an infrared communication adaptor;

FIG. 93A shows the outline configuration of an infrared communication port 5082 of the infrared communication adaptor;

FIG. 93B is a functional diagram showing the infrared communication port 5082 seen in the direction of arrow A in FIG. 93A;

FIG. 94 is a block diagram showing the configuration of a major portion of the infrared communication adaptor;

FIG. 95 is an explanatory diagram showing a scene where a manipulator is driven in order to place an infrared receiving element at an angle permitting high optical sensitivity;

FIG. 96 shows the configuration of an endoscopic surgery system including a twenty-fourth embodiment of the present invention;

FIG. 97 shows the configuration of an endoscopic surgery system including a twenty-fifth embodiment of the present invention;

FIG. 98 to FIG. 104 are concerned with a twenty-sixth embodiment of the present invention;

FIG. 98 is an explanatory diagram for explaining an endoscopic surgery system;

FIG. 99 is a block diagram showing the configuration of a patient monitor system;

FIG. 100 is a plan view showing a standard operating screen image for surgeons to be displayed on an operator panel;

FIG. 101 is a plan view showing a main menu for surgeons displayed on a PDA;

FIG. 102 is a plan view showing an operating screen image to be displayed on the PDA when an insufflator unit is designated;

FIG. 103 is a flowchart describing a processing flow of downloading a program and data;

FIG. 104 is an explanatory diagram concerning the contents of programs and data items to be downloaded based on a verified identification code;

FIG. 105 shows the configuration of an endoscopic surgery system including a twenty-seventh embodiment of the present invention;

FIG. 106 shows the configuration of an endoscopic surgery system including a twenty-eighth embodiment of the present invention;

FIG. 107 to FIG. 111 are concerned with a twenty-ninth embodiment of the present invention;

FIG. 107 is a block diagram showing the overall configuration of a medical equipment control system;

FIG. 108 is a block diagram showing the configuration of an endoscopic surgery system;

FIG. 109 is an explanatory diagram concerning the abilities of a portable information terminal;

FIG. 110 is a block diagram showing the configuration of the portable information terminal and the configuration of a centralized controller;

FIG. 111 is a flowchart describing actions to be performed by the medical equipment control system;

FIG. 112 and FIG. 113 are concerned with a thirtieth embodiment of the present invention;

FIG. 112 is a block diagram showing the overall configuration of a medical equipment control system;

FIG. 113 is a flowchart describing actions to be performed by the medical equipment control system;

FIG. 114 and FIG. 115 are concerned with a thirty-first embodiment of the present invention;

FIG. 114 is a block diagram showing the overall configuration of a medical equipment control system;

FIG. 115 is a flowchart describing actions to be performed by the medical equipment control system;

FIG. 116 to FIG. 126 are concerned with a thirty-second embodiment of the present invention;

FIG. 116 shows the interior of an operating room in which an endoscopic surgery system is installed;

FIG. 117 is a block diagram showing the configuration of the endoscopic surgery system shown in FIG. 116;

FIG. 118 is a block diagram showing the circuitry of an infrared communication adaptor shown in FIG. 117;

FIG. 119 shows the appearance of a portable terminal shown in FIG. 117;

FIG. 120 shows the appearance of an infrared communication adaptor shown in FIG. 117;

FIG. 121 shows a joint joining the portable terminal and infrared communication adaptor shown in FIG. 119 and FIG. 120 respectively;

FIG. 122 is a flowchart describing a processing flow of controlling the portable terminal shown in FIG. 117 and a system controller;

FIG. 123 shows a main menu screen image displayed on a display section of the portable terminal during the processing described in FIG. 122;

FIG. 124 is a flowchart describing setup of an insufflator unit to be performed during the processing described in FIG. 122;

FIG. 125 shows an error message displayed on the display section of the portable terminal during the processing described in FIG. 124;

FIG. 126 shows a set value entry screen image displayed on the display section of the portable terminal during the processing described in FIG. 124;

FIG. 127 to FIG. 132 are concerned with a thirty-third embodiment of the present invention;

FIG. 127 is a flowchart describing a processing flow of controlling a portable terminal and a system controller;

FIG. 128 shows a file menu screen image displayed on a display section of the portable terminal during the processing described in FIG. 127;

FIG. 129 is a flowchart describing endoscopic image file reception described in FIG. 127;

FIG. 130 shows an endoscopic image displayed on the display section of the portable terminal during the processing described in FIG. 129;

FIG. 131 shows a first error message displayed on the display section of the portable terminal during the processing described in FIG. 129;

FIG. 132 shows a second error message displayed on the display section of the portable terminal during the processing described in FIG. 129;

FIG. 133 and FIG. 134 are concerned with a thirty-fourth embodiment of the present invention;

FIG. 133 shows the configuration of an endoscopic surgery system;

FIG. 134 is an explanatory diagram showing the operation of the endoscopic surgery system shown in FIG. 133;

FIG. 135 and FIG. 136 are concerned with a thirty-fifth embodiment of the present invention;

FIG. 135 shows the configuration of an endoscopic surgery system;

FIG. 136 is an explanatory diagram concerning the operation of the endoscopic surgery system shown in FIG. 135;

FIG. 137 to FIG. 139 are concerned with a thirty-sixth embodiment of the present invention;

FIG. 137 shows the configuration of an endoscopic surgery system;

FIG. 138 is a first explanatory diagram concerning the operation of the endoscopic surgery system shown in FIG. 137;

FIG. 139 is a second explanatory diagram concerning the operation of the endoscopic surgery system shown in FIG. 137;

FIG. 140 to FIG. 169 are concerned with a thirty-seventh embodiment of the present invention;

FIG. 140 shows the configuration of an endoscopic surgery system;

FIG. 141 shows the configuration of a patient monitor system for monitoring a patient's condition shown in FIG. 140;

FIG. 142 shows a network laid down in the premises of a hospital in which the endoscopic surgery system shown in FIG. 140 is installed;

FIG. 143 shows an example of an Internet connection service to be provided in order to connect an intra-hospital server shown in FIG. 142;

FIG. 144 is a block diagram showing the configuration of a system controller shown in FIG. 140;

FIG. 145 is a block diagram showing the configuration of an infrared interface shown in FIG. 144;

FIG. 146 is a flowchart describing a processing flow of filtering a signal using a filter circuit shown in FIG. 145;

FIG. 147 is a front view showing the configuration of the system controller shown in FIG. 140;

FIG. 148 is a back view showing the configuration of the system controller shown in FIG. 140;

FIG. 149 is a block diagram showing the configuration of an infrared remote controller shown in FIG. 140;

FIG. 150 shows the appearance of the infrared remote controller shown in FIG. 149;

FIG. 151 is a flowchart describing a procedure to be followed in order to operate peripheral equipment using a unidirectional infrared remote controller shown in FIG. 140;

FIG. 152 is a block diagram showing the configuration of a PDA shown in FIG. 140;

FIG. 153 is a block diagram showing the configurations of a touch-sensitive panel and a wireless communication interface shown in FIG. 152;

FIG. 154 shows a first screen image displayed on a liquid crystal display unit shown in FIG. 152;

FIG. 155 shows the components of the PDA shown in FIG. 140 which are exposed on the back thereof;

FIG. 156 is an explanatory diagram concerning an extension card to be loaded in a card slot shown in FIG. 155;

FIG. 157 shows a second screen image displayed on the liquid crystal display unit shown in FIG. 152;

FIG. 158 shows a third screen image displayed on the liquid crystal display unit shown in FIG. 152;

FIG. 159 shows a fourth screen image displayed on the liquid crystal display unit shown in FIG. 13;

FIG. 160 shows a fifth screen image displayed on the liquid crystal display unit shown in FIG. 152;

FIG. 161 shows a sixth screen image displayed on the liquid crystal display unit shown in FIG. 152;

FIG. 162 shows a seventh screen image displayed on the liquid crystal display unit shown in FIG. 152;

FIG. 163 shows an eighth screen image displayed on the liquid crystal display unit shown in FIG. 152;

FIG. 164 shows a ninth screen image displayed on the liquid crystal display unit shown in FIG. 152;

FIG. 165 shows a tenth screen image displayed on the liquid crystal display unit shown in FIG. 152;

FIG. 166 shows an eleventh screen image displayed on the liquid crystal display unit shown in FIG. 152;

FIG. 167 shows a twelfth screen image displayed on the liquid crystal display unit shown in FIG. 152;

FIG. 168 is a first flowchart describing a procedure to be followed in order to operate peripheral equipment using the PDA shown in FIG. 140;

FIG. 169 is a second flowchart describing the procedure to be followed in order to operate peripheral equipment using the PDA shown in FIG. 140;

FIG. 170 is a block diagram showing a major portion of the configuration of a PDA included in a thirty-eighth embodiment of the present invention;

FIG. 171 is a flowchart describing a procedure to be followed in order to operate a PDA included in a thirty-ninth embodiment of the present invention;

FIGS. 172 to 188 relate to the fortieth embodiment of the present invention, FIG. 172 is a diagram showing the structure of an operation supporting system;

FIG. 173 is a diagram showing the structure of an endoscope system shown in FIG. 172;

FIG. 174 is a block diagram showing the connecting structure of the endoscope system shown in FIG. 173;

FIG. 175 is a block diagram showing the structure of a system controller shown in FIG. 174;

FIG. 176 is an appearance diagram showing the appearance structure of a mobile terminal shown in FIG. 172;

FIG. 177 is a block diagram showing the structure of the mobile terminal shown in FIG. 176;

FIG. 178 is a diagram showing a first operating screen which is displayed on an intensive operating panel shown in FIG. 173;

FIG. 179 is a diagram showing a second operating screen which is displayed on the intensive operating panel shown in FIG. 173;

FIG. 180 is a diagram showing a third operating screen which is displayed on the intensive operating panel shown in FIG. 173;

FIG. 181 is a diagram showing a fourth operating screen which is displayed on the intensive operating panel shown in FIG. 173;

FIG. 182 is a diagram showing a fifth operating screen which is displayed on the intensive operating panel shown in FIG. 173;

FIG. 183 is a diagram showing a sixth operating screen which is displayed on the intensive operating panel shown in FIG. 173;

FIG. 184 is a diagram showing a seventh operating screen which is displayed on the intensive operating panel shown in FIG. 173;

FIG. 185 is a diagram showing a first operating screen which is displayed on the mobile terminal shown in FIG. 172;

FIG. 186 is a diagram showing a second operating screen which is displayed on the mobile terminal shown in FIG. 172;

FIG. 187 is a diagram showing a third operating screen which is displayed on the mobile terminal shown in FIG. 172;

FIG. 188 is a flowchart showing a remotely supporting method using the mobile terminal shown in FIG. 172;

FIGS. 189 to 195 relate to the forty-first embodiment of the present invention, FIG. 189 is a diagram showing the structure of a switching device;

FIG. 190 is a diagram showing a communication screen which is displayed on an intensive operating panel upon using the switching device shown in FIG. 189;

FIG. 191 is a diagram showing a first operating screen which is displayed on a mobile terminal upon using the switching device shown in FIG. 189;

FIG. 192 is a diagram showing a second operating screen which is displayed on a mobile terminal upon using the switching device shown in FIG. 189;

FIG. 193 is a diagram showing a third operating screen which is displayed on a mobile terminal upon using the switching device shown in FIG. 189;

FIG. 194 is a first flowchart showing a method for remotely supporting a plurality of operation rooms using one mobile terminal upon using the switching device shown in FIG. 189;

FIG. 195 is a second flowchart showing the method for remotely supporting the plurality of operation rooms by using one mobile terminal upon using the switching device shown in FIG. 189;

FIG. 196 is a side view showing a conventional casing device, for the purpose of describing the advantages according to the fifth embodiment of the present invention with reference to FIG. 20;

FIG. 197 is a plan view showing the conventional casing device, for the purpose of describing the advantages according to the fifth embodiment of the present invention with reference to FIG. 20; and

FIG. 198 is an explanatory diagram showing the flow of the operation and the clearing operation, starting up the preparing step of a conventional endoscope surgery operation.

### DETAILED DESCRIPTION OF THE PREFERRED EMBODIMENTS

### First Embodiment

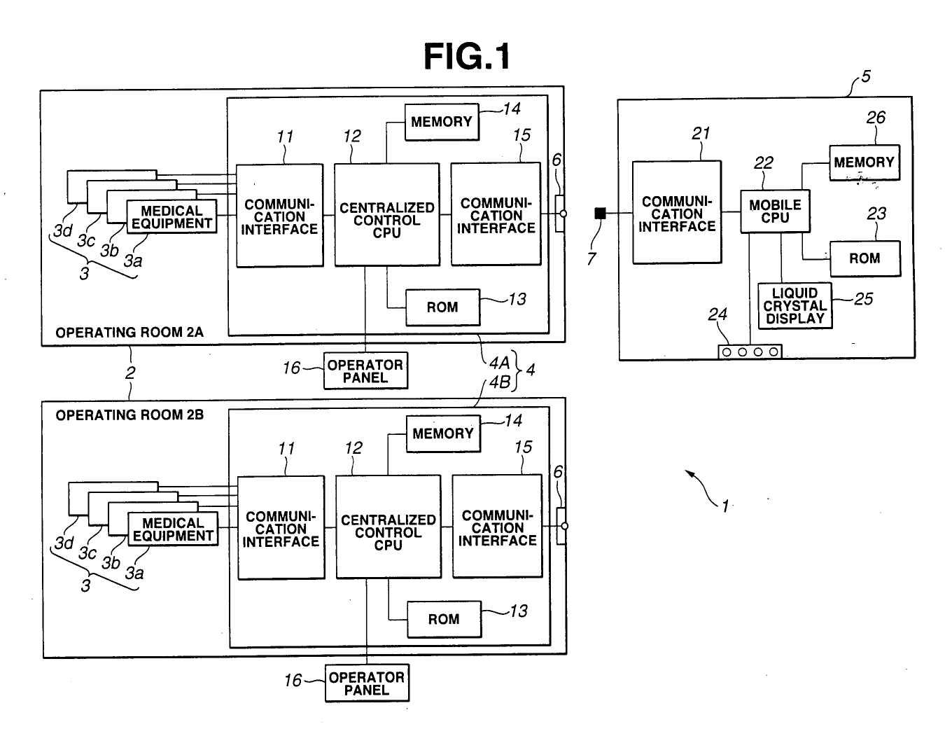

As shown in FIG. 1, a medical equipment control system 1 in accordance with a first embodiment of the present invention consists mainly of: a plurality of centralized controllers 4 that controls on a centralized basis a plurality of pieces of medical equipment 3 (3a to 3c) installed in operating rooms 2; and a mobile device 5 capable of communicating with the plurality of centralized controllers 4. Herein, when it says that a mobile device can communicate with a plurality of centralized controllers, it means that the mobile device communicates therewith over cables or by wireless. In the present embodiment, the mobile device 5 includes a connector 7 that is freely detachably attached to the connector receptacles 6 of the centralized controllers 4, and thus can communicate with the centralized controllers 4. Alternatively, the mobile device 5 and centralized controllers 4 may each include a transmitting/receiving means that transmits or receives electromagnetic waves including infrared light waves to that they can communicate with each other by wireless.

Referring to FIG. 1, there are two operating rooms 2 (2A and 2B). Accordingly, there are two centralized controllers 4 (4A and 4B). Alternatively, the number of operating rooms may be two or more, and the number of centralized controllers 4 may be two or more. The number of centralized controllers 4 may not be equal to the number of operating rooms 2.

The centralized controller 4 has a plurality of pieces of medical equipment 3 (3a to 3c) connected thereto. The plurality of pieces of medical equipment 3 (3a to 3c) includes, for example, an endoscope system and therapeutic units used to perform various kinds of treatments while observing a region to be treated using the endoscope system.

The endoscope system consists mainly of: an endoscope used for observation; a camera head connected to the endoscope; an endoscopic camera unit that processes an image signal produced by the camera head; a light source unit that supplies illumination light to the endoscope so that an object will be illuminated; and a monitor on which an endoscopic image represented by a signal processed by the endoscopic camera unit is displayed, though these components of the endoscope system are not shown. The therapeutic units include an insufflator unit that dilates an abdominal cavity, and surgical equipment such as a diathermic cautery unit that enables resection or coagulation of a living tissue, though they are not shown.

The centralized controller 4 consists mainly of: a communication interface 11 via which the centralized controller can freely be connected to or disconnected from the plurality of pieces of medical equipment 3 (3a to 3c); a centralized control CPU 12 that controls on a centralized basis the plurality of pieces of medical equipment 3 (3a to 3c) via the communication interface 11; a ROM 13 in which programs describing instructions based on which the centralized control CPU 12 acts are stored; a memory 14 in which control data based on which the plurality of pieces of medical equipment 3 (3a to 3c) is controlled is stored; and a communication interface 15 via which the centralized controller can communicate with the mobile device 5. Moreover, the centralized controller 4 has an operator panel 16 connected to the centralized control CPU 12 thereof. The operator panel 16 is realized with a simple operating input means such as a sheet switch pad. The operator panel 16 is therefore inexpensive.

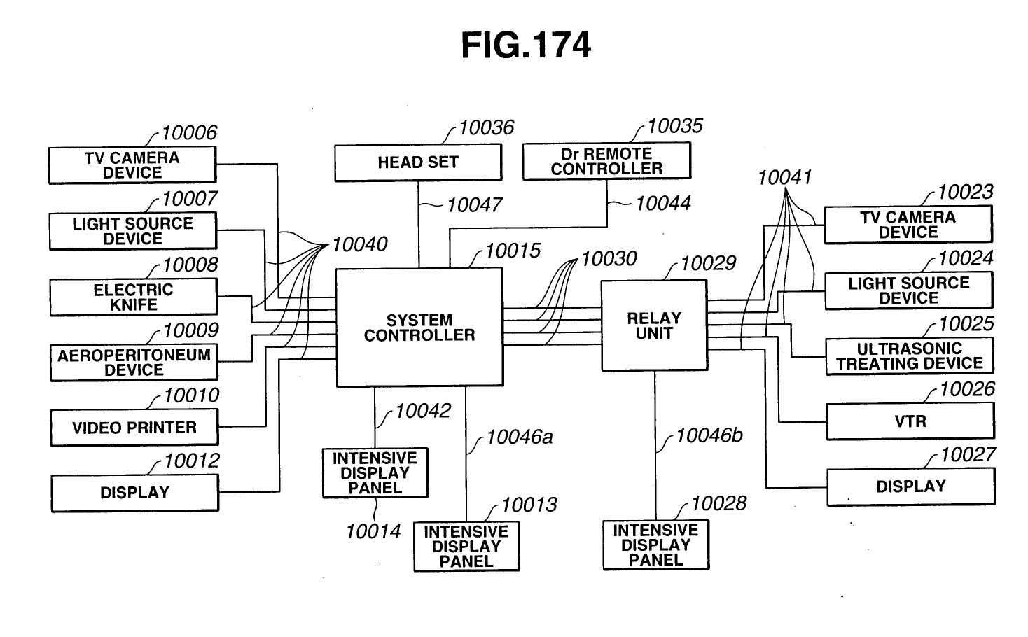

The centralized controller 4 serially communicates with the plurality of pieces of medical equipment 3 (3a to 3c) via the communication interface 15. The centralized control CPU 12 included in the centralized controller 4 controls medical equipment concerned on the basis of an operation command entered at the operator panel 16. The step of operating medical equipment during surgery corresponding to step C described in FIG. 174 is carried out using the operator panel 16. The number of settings of medical equipment a user modifies during surgery is quite limited. Although the operating input means such as the sheet switch pad has only a limited number of command buttons, medical equipment can be operated satisfactorily using the operator panel 16.

The mobile device 5 consists mainly of: a communication interface 21 via which the mobile device can communicate with the centralized controller 4; a mobile CPU 22 that acts on the centralized controller 4 via the communication interface 21; a ROM 23 on which programs describing instructions based on which the mobile CPU 22 acts are stored; a group of operation switches 24 serving as an inputting/operating means and being used to transmit control data; a liquid crystal display 25 on which menu images are displayed depending on whichever of the group of operation switches 24 is manipulated; and a memory 26 in which control data transmitted responsively to a manipulation performed on the group of operation switches 24 is stored.

The mobile device 5 has a centralized control program and an action program stored in the ROM 23. Based on the centralized control program, the centralized controller 4 controls the plurality of pieces of medical equipment 3 (3a to 3c). Based on the action program, the mobile CPU 22 displays the menu images on the liquid crystal display 25 and acts on the centralized controller 4 responsively to a manipulation performed on the group of operation switches 24.

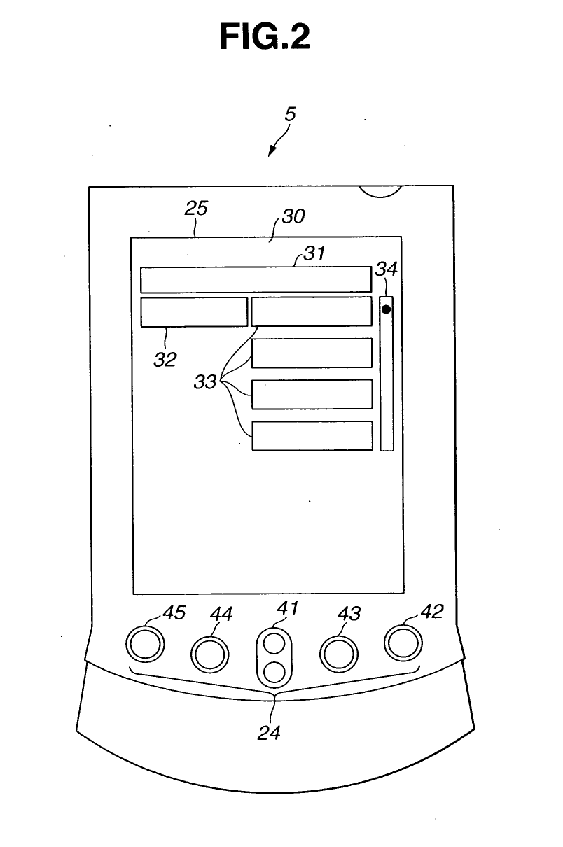

The mobile device 5 has, as shown in FIG. 2, a menu image 30, which prompts a user to control the plurality of pieces of medical equipment 3 (3a to 3c), displayed on the liquid crystal display 25.

The menu image 30 contains a mode display field 31, which presents a current mode, defined as the uppermost part thereof. An equipment name display field 32 that presents an equipment name that indicates an object of the current mode is located below the mode display field 31. Parameter entry fields 33 are located by the right-hand side of the equipment name display field 32. A list indicator field 34 used to indicate a parameter entry field 33 selected from among the parameter entry fields 33 is located by the side of the parameter entry fields 33.

The action program to be run by the mobile CPU 22 provides a set value registration/modification mode and a set value readout mode. In the set value registration/modification mode, control data which specifies initial set values or the like and based on which the centralized controller 4 controls the plurality of pieces of medical equipment 3 (3a to 3c) is determined and registered in the centralized controller 4. In the set value readout mode, the set values registered in the set value registration/modification mode are read out.

The mobile device 5 has the group of operation switches 24 located below the liquid crystal display 25.

The group of operation switches 24 includes: a Select button 41 used to select an equipment name presented in the menu image 30; a Finalize button 42 used to finalize determination or modification of parameter values concerning an equipment name selected using the Select button 41; a Send button 43 used to transmit control data representing set values finalized using the Finalize button 42 to the centralized controller 4; a Read Set Value button 44 used to switch the set value registration/modification mode into the set value readout mode; and a Copy button 45 used to read control data that specifies set values entered at the operator panel 16 and that is stored in the memory 14 included in the centralized controller 4. In the menu image 30, the Select button 41 is used to select a parameter associated with any of the parameter entry fields 33, and the Finalize button 42 is used to register or finalize a modified set value.

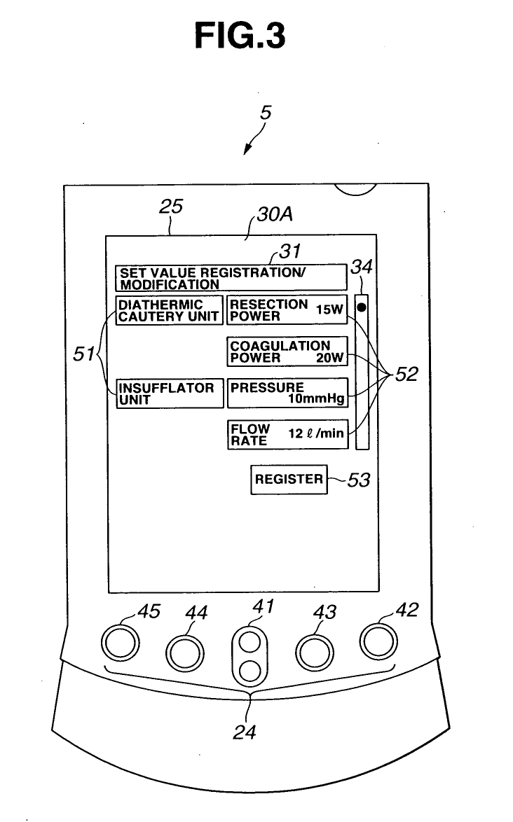

Next, a concrete example of a way of operating the mobile device 5 will be described in conjunction with FIG. 3 to FIG. 5. First, a description will be made of the set value registration/modification mode in which medical equipment is designated and parameter values are modified. FIG. 3 shows an example of an image relevant to the set value registration/modification mode in which parameter values for medical equipment are modified or registered. Referring to FIG. 3, the image relevant to the set value registration/modification mode in which parameter values for medical equipment, that is, a diathermic cautery unit and an insufflator unit are modified or registered is displayed on the liquid crystal display 25.

A menu image 30A shown in FIG. 3 relates to the set value registration/modification mode. Therefore, Set Value Registration/modification appears in the mode display field 31. When the power supply of the mobile device is turned on, the menu image 30A relevant to the set value registration/modification mode is displayed first.

Medical equipment name display fields 51 are contained as the equipment name display field 32. Set value entry fields 52 are contained as the parameter entry fields 33 and located by the right-hand side of the name display field 51 adopted as the equipment name display field 32. In the set value entry fields 52, set values are displayed together with treatment mode names or setting names. Moreover, a Register button 53 used to finalize or register the modified set values entered in the set value entry fields 52 is located below the set value entry fields 52.

When a user manipulates the Select button 41 to move a cursor to the name display field 51, a drop-down list box that is not shown appears. The user moves the cursor to a desired medical equipment name listed in the drop-down list box so as to thus select the medical equipment name. The Finalize button 42 is then pressed in order to finalize the selection of the medical equipment name. Consequently, the medical equipment name for which the user wants to modify set values appears in the name display field 51. Set values for the medical equipment that the user wants to modify are displayed in the set value entry fields 52 together with treatment mode names or setting names.

For example, when the user designates a diathermic cautery unit as desired medical equipment, Diathermic Cautery Unit appears in the name display field 51. “Resection power: 15 W” and “Coagulation power: 20 W” are displayed as treatment mode names and set values in the set value entry fields 52. At this time, the previously designated treatment mode names or setting names and their set values are displayed in the set value entry fields 52.

Thereafter, the user manipulates the Select button 41 so as to move the cursor to any of the set value entry fields 52, and thus selects a set value entry field 52 whose contents the user wants to modify. A drop-down list box that is not shown then appears from the set value entry field 52. At this time, the list indicator field 34 indicates selection of the set value entry field 52. Referring to FIG. 3, the list indicator field 34 indicates selection of the field “Resection power: 15 W.”

The user then moves the cursor to a field in the drop-down list box which presents a desired treatment mode name or setting name and its set value, and presses the Finalize button 42 so as to finalize the selection of the treatment mode name or setting name and its set value. The treatment mode name or setting name and its set value are then displayed in the set value entry field 52.

The user then terminates set value modification and presses the Select button 41 so as to move the cursor to the Register button 53. The user presses the Finalize button 42 so as to finalize registration. The modified set values for medical equipment are stored in the form of control data in the memory 26 included in the mobile device 5 under the control of the mobile CPU 22. The mobile device 5 modifies and registers the set values for desired medical equipment, and transmits the resultant set values to the centralized controller 4 for recording.

Now, a description will be made of the set value readout mode in which registered set values are read out.

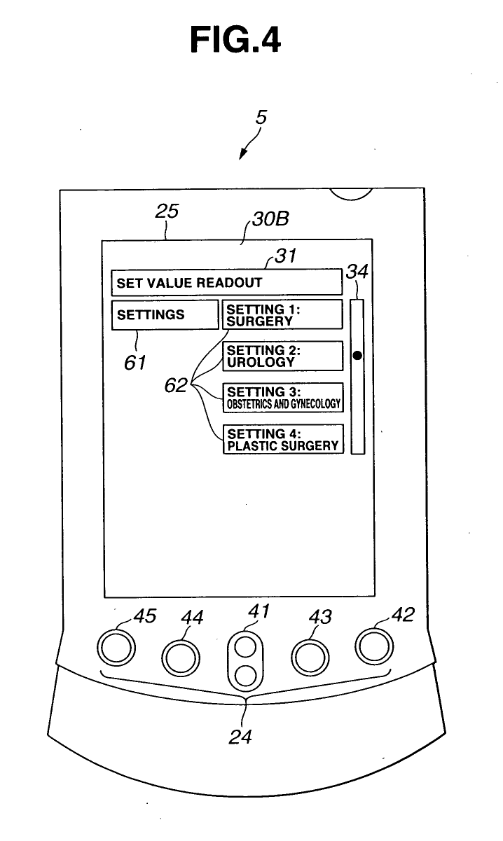

When a user presses the Read Set Value button 44, the image relevant to the set value readout mode is, as shown in FIG. 4, displayed on the liquid crystal display 25. FIG. 4 shows an example of the image relevant to the set value readout mode. A menu image 30B shown in FIG. 4 relates to the set value readout mode. Therefore, Set Value Readout appears in the mode display field 31.

A setting field 61 is contained as the equipment name display field 32. Setting display fields 62 are contained as the parameter entry fields 33 by the right-hand side of the setting field 61 contained as the equipment name display field 32. Setting numbers assigned to the operating rooms 2 and registered setting names associated with the setting numbers are displayed in the setting display fields 62. More particularly, for example, when general surgical equipment is used to conduct surgery, a setting display field 62 presenting “general surgery” is selected in order to have access to the settings of the general surgical equipment.

The user presses the Select button 41 so as to move the cursor to a setting display field 62 presenting a desired register name, and presses the Finalize button 42 so as to finalize the selection. At this time, the list indicator field 34 indicates selection of the setting display field 62. Referring to FIG. 4, the list indicator field 34 indicates selection of the field presenting “urology.”

The user then presses the Send button 43. This causes the mobile CPU 22 to read control data from the memory 26 according to the register name displayed in the selected setting display field 62. The read control data is then transmitted to the centralized controller 4, for example, the centralized controller 4A installed in the operating room 2A via the communication interface circuit 10, and then recorded therein.

The centralized controller 4 receives the control data from the mobile device 5 via the communication interface 11 under the control of he centralized control CPU 12, and stores the control data in the memory 14. The centralized controller 4 controls the plurality of pieces of medical equipment 3 (3a to 3c) on the basis of the control data stored in the memory 14 under the control of the centralized control CPU 12.

As mentioned above, the mobile device 5 can communicate with the centralized controller 4. The mobile device 5 can similarly communicate with the centralized controller 4B installed in the other operating room 22B by way of the centralized controller 4A in the operating room 2A, whereby the medical equipment 3 (3a to 3c) connected to the centralized controller 4B can be controlled using the mobile device 5.

Thereafter, the user operates the centralized controller 4A so as to start surgery in the operating room 2A using the medical equipment 3 (3a to 3c).

During surgery, the user handles the operator panel 16 connected to the centralized controller 4A so as to control the medical equipment 3 (3a to 3c). At this time, the control data representing the settings of the medical equipment 3 (3a to 3c) designated using the operator panel 16 is transferred to the centralized control CPU 12 via the communication interface circuit 12, and stored in the memory 14.

After the surgery is completed, the control data representing the settings of the medical equipment 3 (3a to 3c) and being stored in the memory 14 included in the centralized controller 4A is transmitted as new data to the mobile device 5.

The user re-connects the mobile device 5 to the centralized controller 4A for the purpose of communication. The user then presses the Copy button 45 included in the mobile device 5. Consequently, the mobile CPU 22 included in the mobile device 5 instructs the centralized control CPU 12 included in the centralized controller 4A to read the control data, which specifies the settings of the medical equipment 3 (3a to 3c), from the memory 14, and to transmit the read control data via the communication interface 15.

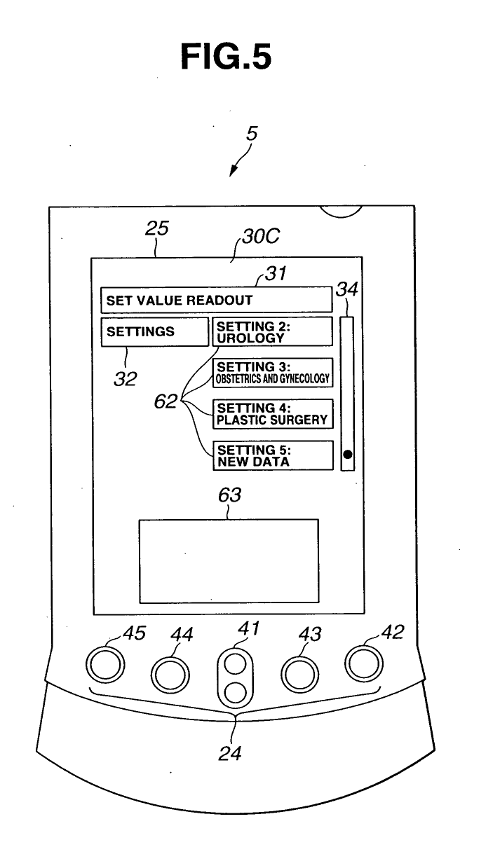

The mobile CPU 22 included in the mobile device 5 extends control to register the control data that represents the settings of the medical equipment 3 (3a to 3c) and that is sent from the centralized controller 4. At this time, as shown in FIG. 5, the menu image 30C presents “new data,” whereby the control data is registered as new data. The menu image 30C also presents Set Value Readout. For example, “Settings 5: new data” is displayed in the lowermost one of the setting display fields 62. The control data has a register name entered in a character entry field 63 located below the setting display fields 62, and is then stored in the memory 26.

Consequently, the mobile device 5 can copy the settings preserved in the centralized controller 4A in the operating room 2A. Therefore, when the mobile device 5 communicates with the centralized controller 4B in the other room, for example, the operating room 2B, the same settings as the settings preserved in the centralized control system installed in the operating room 2A can be transmitted to the centralized controller 4B.

Consequently, according to the present embodiment, the medical equipment control system 1 capable of controlling the medical equipment 3 (3a to 3c) on a centralized basis can be realized at low cost.

According to the present embodiment, the mobile device 5 has the memory 26, in which the control data is stored, on a fixed basis. The present invention is not limited to this mode. Alternatively, a memory in which control data is stored in advance may be made freely mountable or dismountable on or from the mobile device 5. When the memory is mounted, the data stored in the memory is transmitted to the centralized controller 4 and preserved therein. In this case, a personal computer or any other machine may be used to store control data in the memory. In this case, the mobile device 5 need not include the inputting/operating means that is used to input control data.

### Second Embodiment

According to a second embodiment, the medical equipment control system 1 is constructed using a programming terminal capable of communicating with the mobile device 5 as an inputting/operating means used to enter data that is transmitted to the mobile device 5. The other components are identical to those of the first embodiment. The description of the identical components will be omitted, and the same reference numerals will be assigned to the identical components.

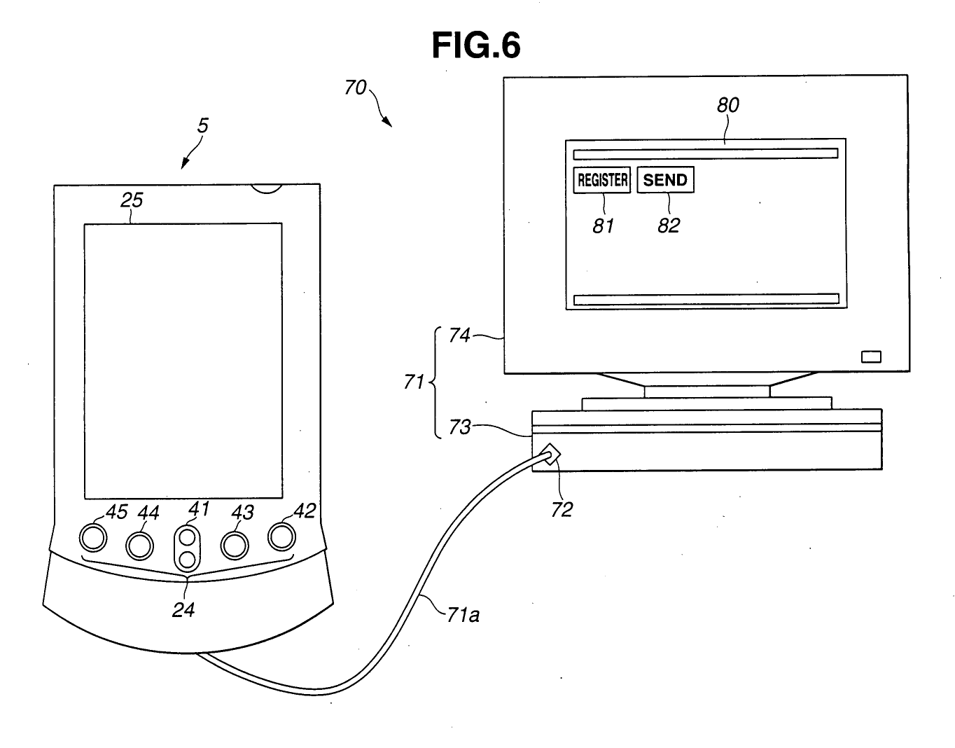

As shown in FIG. 6, a medical equipment control system 70 in accordance with the second embodiment includes a programming terminal 71 capable of communicating with the mobile device 5 as the inputting/operating means used to enter data that is transmitted to the mobile device 5. When it says that the programming terminal can communicate with the mobile device, it means that the programming terminal communicates therewith over a cable or by wireless. According to the present embodiment, the programming terminal 71 has a communication port 72, into which a connection cord 71a extending from the mobile device 5 is plugged in order to communicate with the mobile device 5, formed in a terminal body 73. Thus, the programming terminal 71 can communicate with the mobile device 5. Alternatively, the mobile device 5 and programming terminal 71 may include a transmitting/receiving means for transmitting or receiving electromagnetic waves including infrared light waves so that they can communicate with each other by wireless.

Moreover, the programming terminal 71 has the terminal body 73 connected to a terminal monitor 74 for use. The programming terminal 71 is realized with, for example, a personal computer. The terminal body 73 has an input device such as a keyboard or a mouse, which is not shown, connected thereto, and is thus operated.

The terminal body 73 has software, which is used to modify a program or control data stored in the memory 26 included in the mobile device 5, installed therein. Moreover, the terminal body 73 has control data, which represents the settings of medical equipment registered in the mobile device 5, stored in a hard disk thereof that is not shown.

In the medical equipment control system 70 having the foregoing components, the mobile device 5 is connected to the programming terminal 71.

Referring to FIG. 6, an activation image 80 is displayed on the terminal monitor 74 included in the programming terminal 71. When the power supply of the programming terminal is turned on, the activation image 80 is displayed first. The activation image 80 contains a Register button 81 that is used to register set values in the programming terminal 71, and a Send button 82 used to transmit the set values registered using the Register button 81 to the mobile device 5.

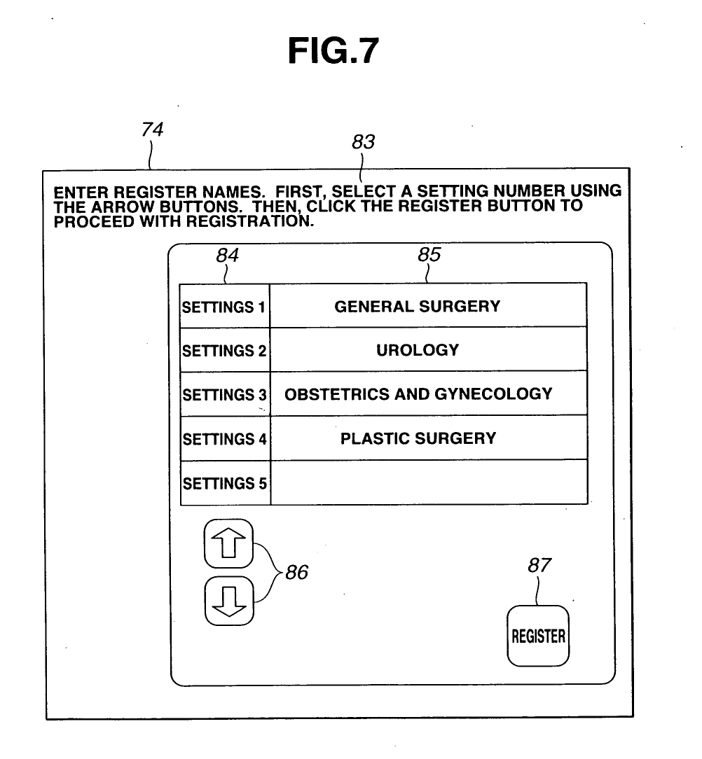

First, a description will be made of the actions to be performed by the programming terminal 71 when the Register button 81 is pressed in order to register set values. When a user clicks the Register button 81 by handling the keyboard or mouse, the image on the screen of the terminal monitor 74 is switched into a register name entry image 83 shown in FIG. 7.

The register name entry image 83 shown in FIG. 7 is an image prompting a user to enter a register name associated with a surgical procedure to be performed in each operating room 2 described in conjunction with FIG. 1. Register name entry fields 85 in which register names are entered are located by the right-hand side of setting number fields 84. Up and Down buttons 86 used to move the cursor over the register name entry fields 85 are located below the setting number fields 84. Furthermore, a Register button 87 is located at the right lower corner of the register name entry image 83.

The user uses the keyboard or mouse to enter register names that are recorded in the programming terminal 71. Referring to FIG. 7, the register name entry image 83 has register names entered in the register name entry fields 85 in association with Settings 1 to Settings 4. The cursor is positioned in the field of Settings 5, and a register name can be entered in the register name entry field 85 associated with the field of Settings 5. The register names to be entered in the register name entry fields 85 are, for example, “General surgery” for Settings 1, “Urology” for Settings 2, “Obstetrics and gynecology” for Settings 3, and “Plastic surgery” for Settings 4. In FIG. 7, the register name entry image 83 contains the fields of Settings 1 to Settings 5. In order to retrieve the other setting numbers, the displayed fields are scrolled up with the movement of the cursor.

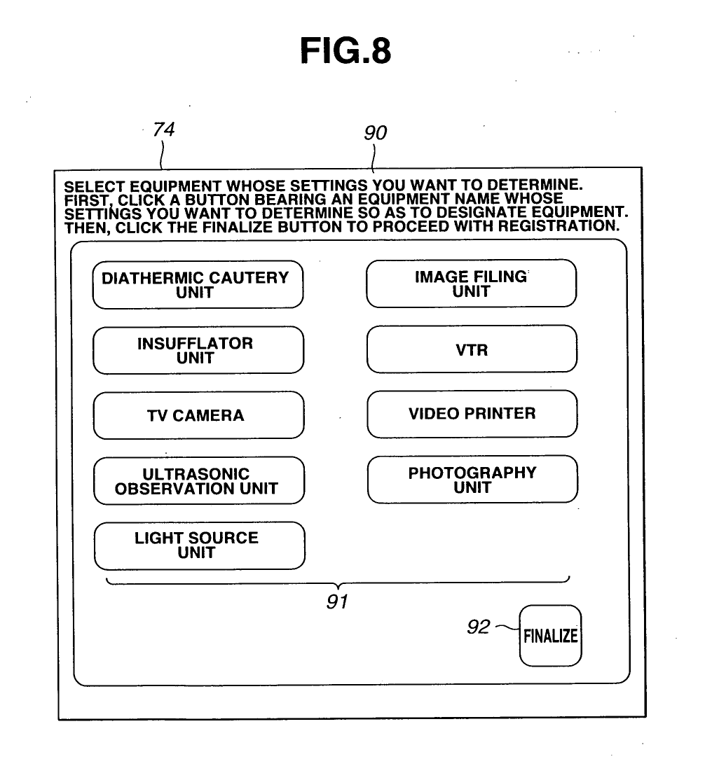

After entering register names, the user handles the keyboard or mouse to click the Register button 87. The register names are then registered. The register names are preserved (stored) in the programming terminal 71. Consequently, the programming terminal 71 can select a proper register name in association with a kind of surgery. Therefore, once the user selects any of the registered register names, the medical equipment 3 (3a to 3c) installed in an operating room is set up in a desired manner. When the Register button 87 is clicked, the screen image on the terminal monitor 74 is switched to an equipment selection image 90 shown in FIG. 8.

The equipment selection image 90 shown in FIG. 8 is an image prompting a user to select medical equipment 3 whose settings the user wants to register. The equipment selection image 90 contains a medical equipment name display field 91 in which the names of a diathermic cautery unit and others are displayed as the names of pieces of medical equipment. A Finalize button 92 is located at the right lower corner of the equipment selection image.

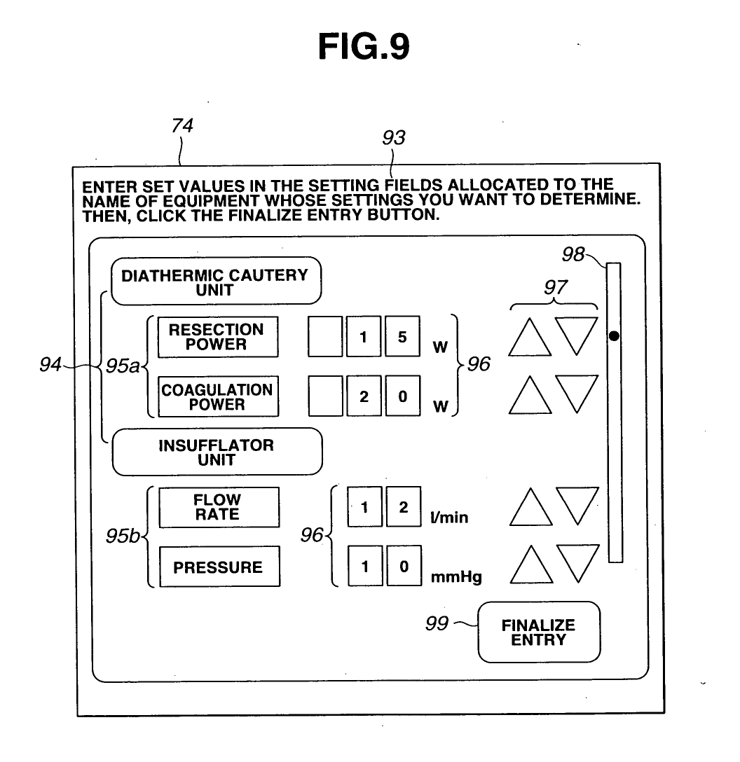

Now, the user handles the keyboard or mouse to select the name of medical equipment whose settings he/she wants to register, and clicks the Finalize button 92. Consequently, registration of the selected medical equipment name is finalized. In the present embodiment, assume that the names of a diathermic cautery unit and an insufflator unit are selected as medical equipment. When the Finalize button 92 is clicked, the screen image on the terminal monitor 74 is switched to a setting entry image 93 shown in FIG. 9.

The setting entry image 93 shown in FIG. 9 is an image prompting a user to determine settings of medical equipment selected through the equipment selection image described in conjunction with FIG. 8. The setting entry image 93 prompts a user to enter desired set values for medical equipment the user has selected through the image shown in FIG. 8. The setting entry image 93 contains treatment mode name fields 95a or setting name fields 95b that are located below medical equipment name display fields 94. Set value entry fields 96 are located by the right-hand side of the treatment mode name fields 95a or setting name fields 95b.

By the right-hand side of the set value entry fields 96, there are Up and Down buttons 97 to be used to increase or decrease a set value entered in each of the set value entry fields 96.

By the right-hand side of the Up and Down buttons 97, a list indicator field 98 is positioned in order to indicate selection of any of the set value entry field 96. Moreover, a Finalize Entry button 99 to be used to finalize an entry made in each of the set value entry fields 96 is located below the Up and Down buttons 97.

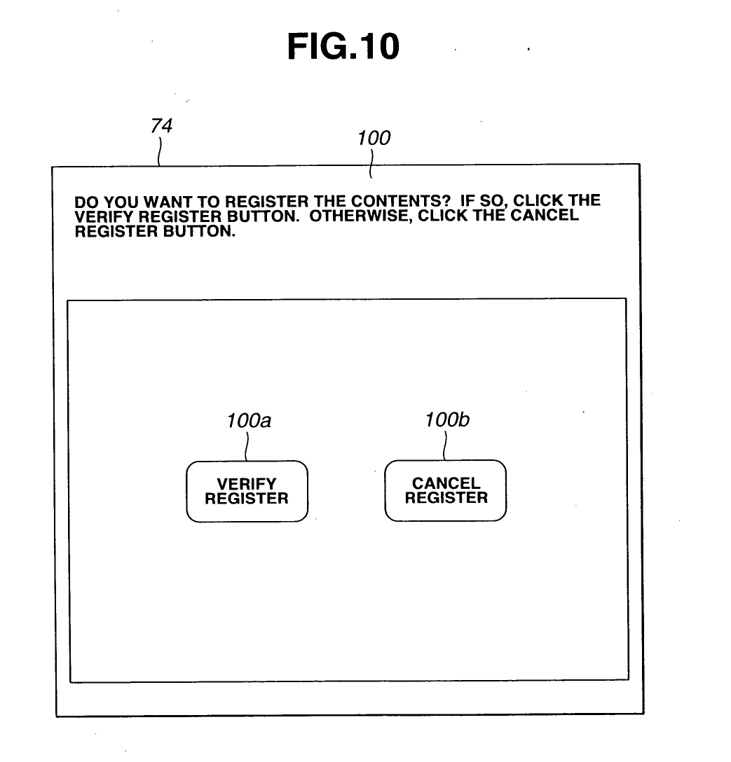

Herein, a user uses the keyboard or mouse to enter a desired set value in each of the set value entry fields 96 associated with the selected name of medical equipment. When entry is completed, the Finalize Entry button 99 is clicked in order to finalize the entry. When the Finalize Entry button 99 is clicked, the screen image on the terminal monitor 74 is switched to a register verification image 100 shown in FIG. 10.

The register verification image shown in FIG. 10 is an image prompting a user to verify the contents of register entered through the images ending with the setting entry image 93 described in conjunction with FIG. 9. The register verification image 100 contains a Verify Register button 100a to be used to verify the contents of register, and a Cancel Register button 100b to be used to cancel the contents of register. The Verify Register button 100a and Cancel Register button 100b are juxtaposed in the center of the screen.

If a user is satisfied with the contents of register, the user uses the keyboard or mouse to click the Verify Register button 100a. Registration is thus completed. If the Verify Register button 100a is clicked, the screen image on the terminal monitor 74 is switched to the activation image 80 described in conjunction with FIG. 5.

If the user is dissatisfied with the contents of registration, the user uses the keyboard or mouse to click the Cancel Register button 100b. The user then repeats registration until he/she is satisfied with the contents of register. If the Cancel Register button 100b is clicked, the screen image on the terminal monitor 74 is switched to the register name entry image 83 described in conjunction with FIG. 7.

Thereafter, the user terminates setting registration in which set values are registered in the programming terminal 71. Thereafter, the registered set values are transmitted to the mobile device 5, whereby data transmission is performed.

By following the steps for setting registration described in conjunction with FIG. 6 to FIG. 10, a group of control data items based on which the medical equipment 3 (3a to 3c) in the operating room 2A is set up automatically is stored in the programming terminal 71.

As described in conjunction with FIG. 6, with the mobile device 5 connected to the programming terminal 71 through the communication port 72, the user uses the keyboard or mouse to click the Send button 82 contained in the activation image 80. This causes the programming terminal 71 to transmit all control data stored therein to the mobile device 5. This enables the mobile device 5 to fetch the control data sent from the programming terminal 71 as if to fetch the control data sent from the centralized controller 4 as described in relation to the first embodiment.

When the control data is received from the programming terminal 71, for example, “Settings 5: new data” is, as described in conjunction with FIG. 5, displayed in the setting display field 62 on the mobile device 5. For the control data, similarly to the one described in conjunction with FIG. 5, a register name is entered in the character entry field 63. The control data is thus stored in the memory 26, whereby the settings represented by the control data are registered. Incidentally, the entered register name may be modified using the programming terminal 71.

After the user modifies and registers the set values for desired medical equipment using the mobile device 5 in the same manner as that described in relation to the first embodiment, the user transmits the set values to the centralized controller 4. The centralized controller 4 realizes automatic setup of desired medical equipment.

Moreover, after surgery is completed, a user re-connects the mobile device 5 to the centralized controller 4A as described in relation to the first embodiment, and presses the Copy button 45. Consequently, control data representing the settings of each medical equipment and being stored in the memory 14 included in the centralized controller 4 during surgery is read as new data into the mobile device 5 for the purpose of registration of the settings.

At this time, when the mobile device 5 is plugged into the communication port 72 of the programming terminal 71, the control data stored in the memory 26 is transmitted to the programming terminal 71. The programming terminal 71 compares control data sent from the mobile device 5 with the control data stored in the hard disk thereof.

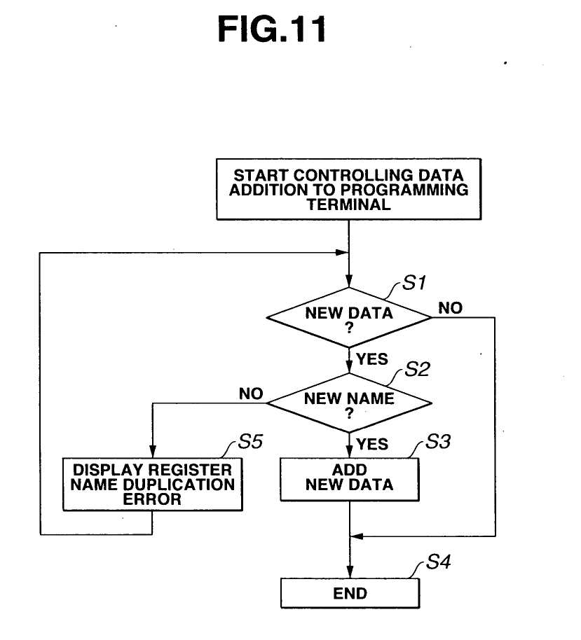

Next, a processing flow of controlling addition of data to the programming terminal 71 will be described in conjunction with the flowchart of FIG. 11.

As described in FIG. 11, the programming terminal 71 compares control data sent from the mobile device 5 with control data stored in the hard disk thereof (step S1 and step S2). If the control data is new data bearing a new register name, the data is additionally stored in the hard disk and the settings represented by the data are recognized to be newly registered (step S3). The processing is then terminated (step S4).

If it is found at step S1 that the control data is not different from existing control data, the programming terminal 71 performs nothing. The processing is terminated (step S4). In contrast, if the data is new data bearing an existing register name, the programming terminal 71 displays on the terminal screen an alarm message saying that the register name is a duplicate (step S5).

Consequently, every time new control data is stored in the mobile device 5, new settings are automatically registered in the programming terminal 71. According to the present embodiment, when a plurality of mobile devices 5 is employed, the control data items entered using the other mobile devices 5 are gathered in the programming terminal 71. Consequently, all the mobile devices 5 automatically share the same new control data items.

According to the second embodiment, the programming terminal 71 has the ability to register settings represented by control data. Alternatively, the mobile device 5 may have the ability to register settings represented by control data.

### Third Embodiment

(Features)

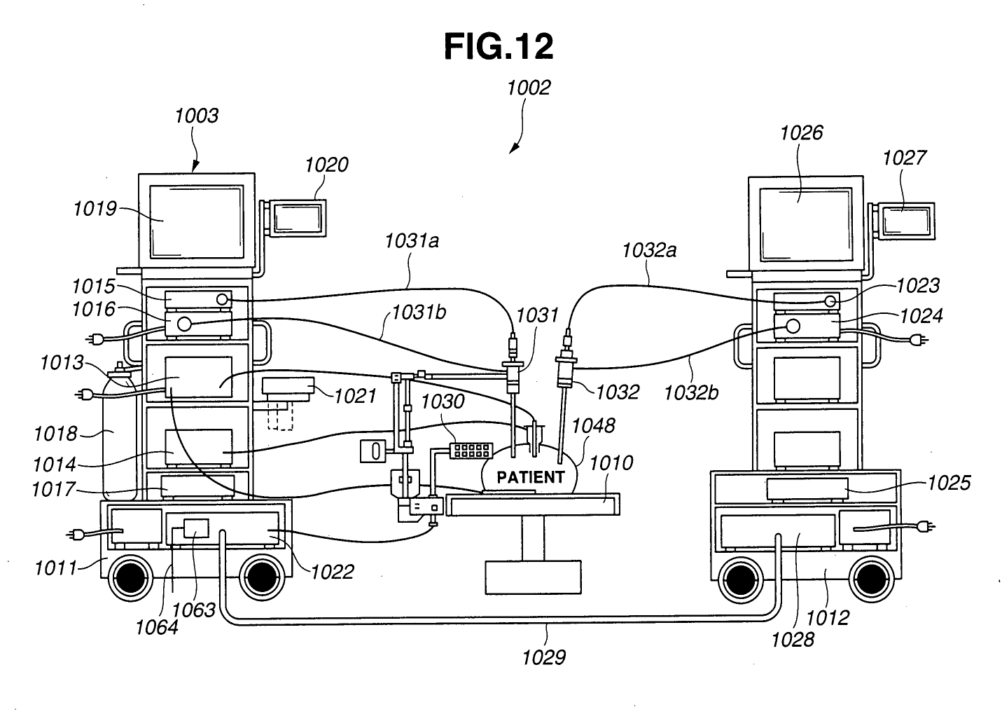

FIG. 12 shows the overall configuration of an endoscopic surgery system 1003 installed in an operating room 1002.

As shown in FIG. 12, a patient couch 1010 on which a patient 1048 lies down and the endoscopic surgery system 1003 are installed in the operating room 1002. The endoscopic surgery system 1003 includes a first cart 1011 and a second cart 1012.

Medical equipment, for example, an electrocautery unit 1013, an insufflator unit 1014, an endoscopic camera unit 1015, a light source unit 1016, a VTR 1017, and a chemical cylinder 1018 filled with carbon dioxide are integrated into the first cart 1011. The endoscopic camera unit 1015 is connected to a first endoscope 1031 over a camera cable 1031a. The light source unit 1016 is connected to the first endoscope 1031 over a light guide cable 1031b.

Moreover, a display device 1019, a centralized display panel 1020, and an operator panel 1021 are mounted on the first cart 1011.

The display device 1019 is, for example, a TV monitor on which an endoscopic image or the like is displayed.

The centralized display panel 1020 is a display means on which every information acquired during surgery can be selectively displayed. The operator panel 1021 is composed of a display, for example, a liquid crystal display and touch sensors integrated with the display. The operator panel 1021 serves as a centralized operating unit to be handled by a nurse or the like in a non-sterilized zone.

Furthermore, the first cart 1011 has a system controller 1022 mounted therein. The electrocautery unit 1013, insufflator unit 1014, endoscopic camera unit 1015, light source unit 1016, and VTR 1017 are connected to the system controller 1022 over transmission lines that are not shown. A communication control module 1063 is incorporated in the system controller 1022, and connected to the communication circuit 9 shown in FIG. 2 over a communication cable 1064.

On the other hand, an endoscopic camera unit 1023, a light source unit 1024, an image processing unit 1025, a display device 1026, and a second centralized display panel 1027 are integrated into the second cart 1012.

The endoscopic camera unit 1023 is connected to a second endoscope 1032 over a camera cable 1032a. The light source unit 1024 is connected to the second endoscope 1032 over a light guide cable 1032b.

An endoscopic image formed by the endoscopic camera unit 1023 is displayed on the display device 1026. Every information acquired during surgery can be selectively displayed on the second centralized display panel 1027.

The endoscopic camera unit 1023, light source unit 1024, and image processing unit 1025 are connected to a relay unit 1028 mounted in the second cart 1012 over transmission lines that are not shown. The relay unit 1028 is connected to the system controller 1022 mounted in the first cart 1011 over a relay cable 1029.

The system controller 1022 controls on a centralized basis the camera unit 1023, light source unit 1024, and image processing unit 1025 that are integrated into the second cart 1012 as well as the electrocautery unit 1013, insufflator unit 1014, camera unit 1015, light source unit 1016, and VTR 1017 that are integrated into the first cart 1011. When communication links are established between the system controller 1022 and these pieces of equipment, the system controller 1022 displays a setting screen image, which presents the settings of each piece of connected equipment and operation switches, on the liquid crystal display of the operator panel 1021. Moreover, a set value can be modified or entered by pressing a desired operation switch that is defined as a predetermined area on the liquid crystal display so as to actuate a touch sensor associated with the predetermined area.

A remote controller 1030 serves as a second centralized operating unit to be handled by an operator in a sterilized zone. Using the remote controller 1030, any other equipment with which a communication link is established can be operated via the system controller 1022. The system controller 1022 analyzes biomedical information acquired by a patient monitor system 1004 that will be described later, and displays the results of analysis on a given display device.

Moreover the system controller 1022 has an infrared communication port that is not shown. The infrared communication port is located at a position from which infrared light waves can be readily emitted, such as, a position near the display device 1019. The infrared communication port is connected to the system controller 1022 over a cable.

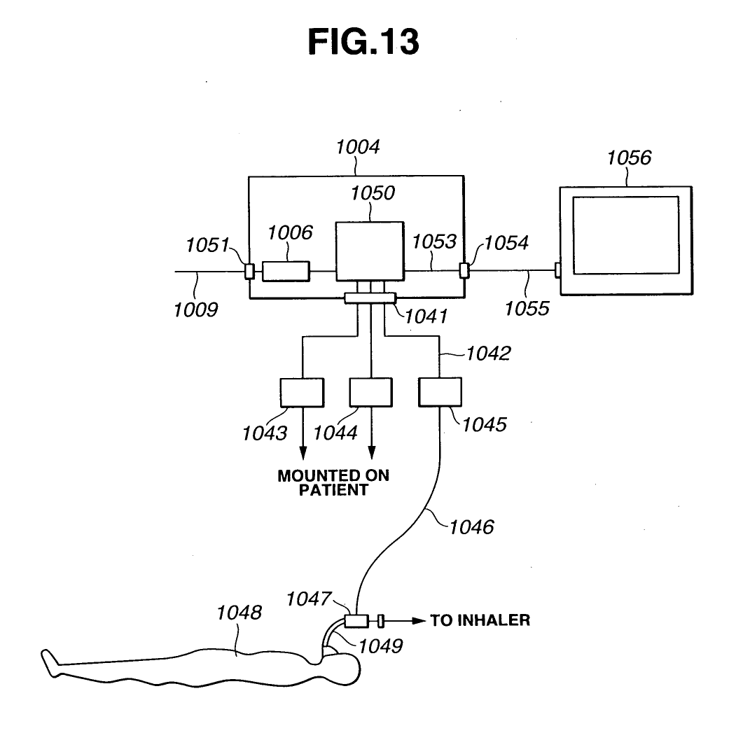

Next, the patient monitor system 1004 will be described in conjunction with FIG. 13.

As shown in FIG. 13, the patient monitor system 1004 employed in combination with the present embodiment includes a signal connector 1041. An electrocardiograph 1043, a pulse oximeter 1044, a capnograph 1045, and other vital sign measuring instruments are connected to the signal connector 1041 via cables 1042.

The capnograph 1045 is connected to a breath sensor 1047 over a cable 1046. The breath sensor 1047 is attached to a hose 1049 extending from an inhaler mounted on the patient 1048. Consequently, an electrocardiogram, a blood oxygen saturation, a breath carbonic dioxide concentration, and other biomedical information concerning the patient 1048 can be measured.

The signal connector 1041 is electrically connected to a control module 1050 incorporated in the patient monitor system 1004. The control module 1050 is connected to a display device 1056 by way of a video signal line 53, a video connector 1054, and a cable 1055. Moreover, the control unit 1050 is electrically connected to a communication control module 1006. The communication control module 1006 is connected to a communication circuit 1009 through a communication connector 1051.

The communication circuit 1009 is connected to a communication controller that is included in the endoscope system 1003 and that is not shown.

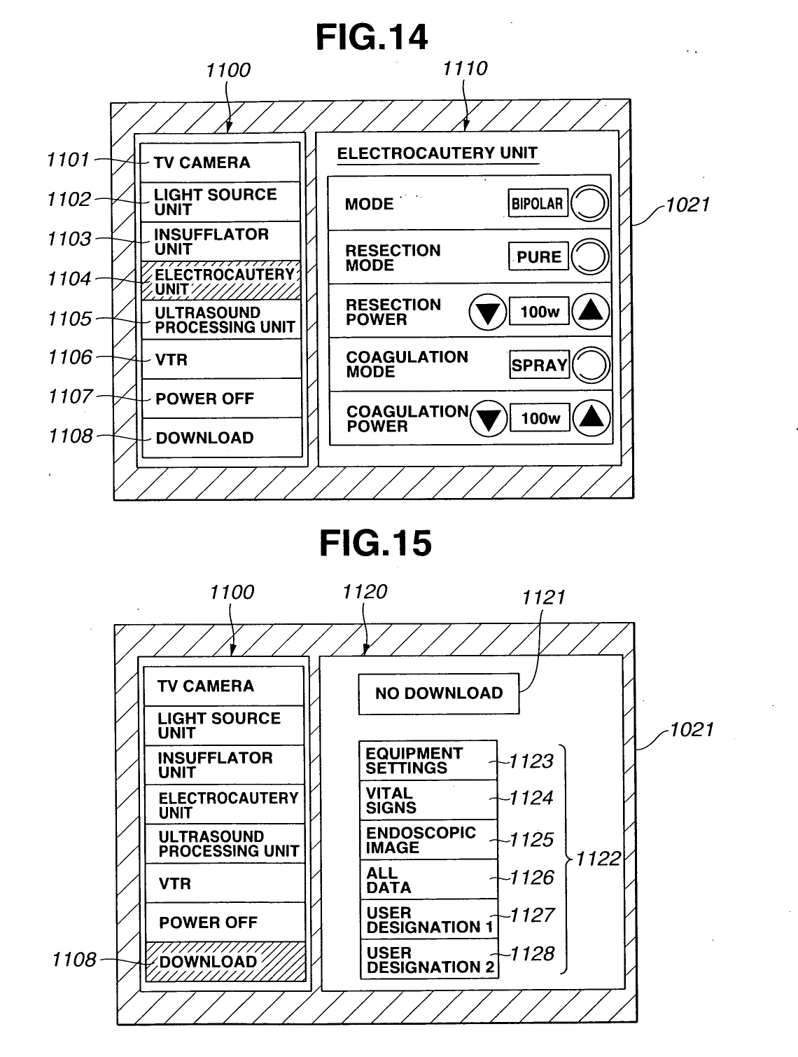

Next, what are displayed on the screen of the operator panel 1021 when the electrocautery unit is designated will be described in conjunction with FIG. 14.

As shown in FIG. 14, a main menu 1100 is displayed on the left part of the operator panel 1021. The main menu 1100 contains fields 1101 to 1108 in which TV camera, Light Source Unit, Insufflator unit, Electrocautery unit, Ultrasound Processing Unit that is not shown in FIG. 1, VTR, Power Off, and Download are specified. In the state shown in FIG. 14, the selected Electrocautery Unit field 1104 is highlighted in yellow. A setting screen image 1110 to be used to determine the settings of the selected electrocautery unit is displayed on the right part of the operator panel 1021.

Next, what are displayed when the Download field 1108 contained in the main menu 1100 is selected will be described in conjunction with FIG. 15.

As shown in FIG. 15, a detail menu 1120 concerning download is displayed on the right part of the operator panel 1021. The detail menu 1120 contains a selection field 1121 that is used to designate whether download is needed, and a menu 1122 having items concerning download. The menu 1122 contains an Equipment Settings field 1123, a Vital Signs field 1124, an Endoscopic Image field 1125, an All Data field 1126, a User Designation 1 field 1127, and a User Designation 2 field 1128. The User Designation 1 and User Designation 2 are included in order to permit an operator to download desired download items by performing one manipulation. For example, once the set values for equipment and vital signs are registered in association with User Designation 1, both the set values and vital signs can be downloaded by performing one manipulation.

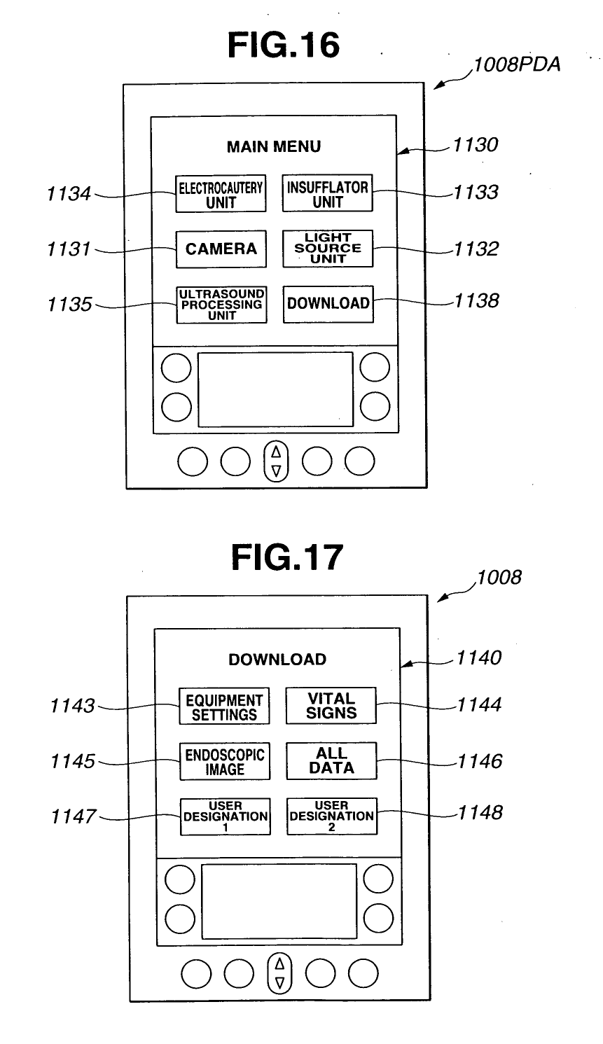

Next, a case where the main menu is displayed on a display operating section of a PDA 1008 will be described in conjunction with FIG. 16.

As shown in FIG. 16, a main menu 1130 is displayed on the display operating section of the PDA 1008. The main menu 1130 contains fields 1131 to 1135, and 1138 in which TV Camera, Light Source Unit, Insufflator unit, Electrocautery unit, Ultrasound Processing Unit, and Download are specified.

Next, a case where a download menu is displayed on the display operating section of the PDA 1008 will be described in conjunction with FIG. 17.

As shown in FIG. 17, a download menu 1140 is displayed on the display operating section of the PDA 1008 because download is designated through the main menu. The download menu 1140 contains an Equipment Settings field 1143, a Vital Signs field 1144, an Endoscopic Image field 1145, an All Data field 1146, a User Designation 1 field 1147, and a User Designation 2 field 1148.

As mentioned above, both the main menu 1130 and download menu 1140 are displayed on the display operating section of the PDA 1008 while having substantially the same contents as those displayed on the operator panel 1021. Moreover, the PDA 1008 has an infrared communication port that is not shown.

According to the present embodiment, the electrocautery unit 1013, insufflator unit 1014, endoscopic camera unit 1015, light source unit 1016, and VTR 1017 are adopted as medical equipment to be used for medical activities.

The system controller 1022, operator panel 1021, and PDA 1008 constitute a control system for controlling the medical equipment.

Moreover, the system controller 1022 includes: a receiving means that receives predetermined information from the medical equipment; a storage means in which the predetermined information received by the receiving means is temporarily stored; and a transmitting means that transmits the predetermined information read from the storage means to the PDA 1008 serving as a recording device which records information on a predetermined recording medium.

Moreover, the system controller 1022 and operator panel 1021 serve as a terminating means for terminating the action of the foregoing control system.

Furthermore, the system controller 1022 includes a judging means that judges whether the transmitting means has transmitted information, and a termination control means that controls the terminating means on the basis of the result of judgment made by the judging means.

(Operations)

Operations to be exerted by the third embodiment having the foregoing components will be described below.

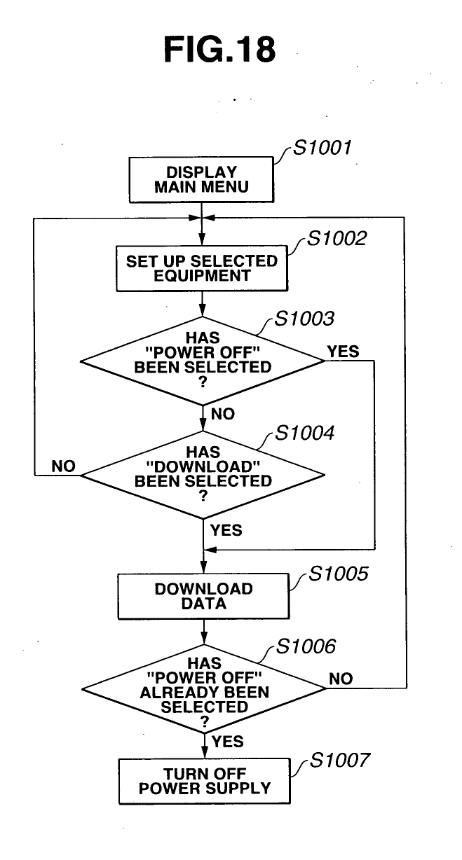

FIG. 18 is a flowchart describing a procedure started with the display of the main menu and ended with download.

At step S1001, the system controller 1022 displays the main menu 1100 shown in FIG. 14 on the operator panel 1021.

Thereafter, at step S1002, the system controller 1022 sets up the electrocautery unit 1013 and insufflator unit 1014 on the basis of an entry an operator made at the operator panel 21. During surgery, if no switch is pressed, that is, any part of the operator panel 1021 is not pressed, steps S1002, S1003, S1004, and S1002 are carried out in that order.

After surgery is completed, when the Power Off field 1107 contained in the main menu displayed on the operator panel 1021 is pressed, the judgment is made in the affirmative at step S1003. The system controller 1022 then passes control to download of step S1005.

Download will be described. At step S1005, the main menu on the operator panel 1021 is changed to the detail menu 1120 shown in FIG. 15. The Download field 1108 in the main menu 1100 is highlighted in yellow, whereby it is indicated that download is in progress. When an operator selects a desired download item at the operator panel 1021, the system controller 1022 and PDA 1008 communicate with each other through the infrared communication ports thereof according to the IrDA protocol so that data will be downloaded to the PDA 1008. Consequently, data received from the system controller 1022 is preserved in the storage means such as the hard disk of the PDA 1008.

When download is completed, the system controller 1022 passes control to step S1006. If the Power Off field 1107 has been selected, the power supply is turned off at step S1007. If the Power Off field 1107 is not pressed at step S1003 but the Download field 1108 is pressed at step S1004, the system controller 1022 performs download at step S1005 and passes control to step S1006. Since the Power Off field 1107 has not been selected, control is returned to step S1002. The procedure is repeated.

Incidentally, when the power supply of the PDA 1008 is turned off, the same procedure as the one described in the flowchart of FIG. 18 is carried out.

(Advantages)

As mentioned above, according to the present embodiment, when the Power Off field 1107 is pressed at the operator panel 1021, the system controller 1022 and PDA 1008 automatically communicate with each other so that data will be downloaded to the PDA 1008. Download will never be forgotten. This results in a user-friendly endoscopic surgery system.

In the third embodiment, the system controller 1022 and PDA 1008 communicate with each other according to the IrDA standard. Alternatively, radiocommunication that is achieved using radio waves according to the Bluetooth standard or the like will do. Moreover, a communication method that requires connection via RS-232C interfaces over a cable may be adopted.

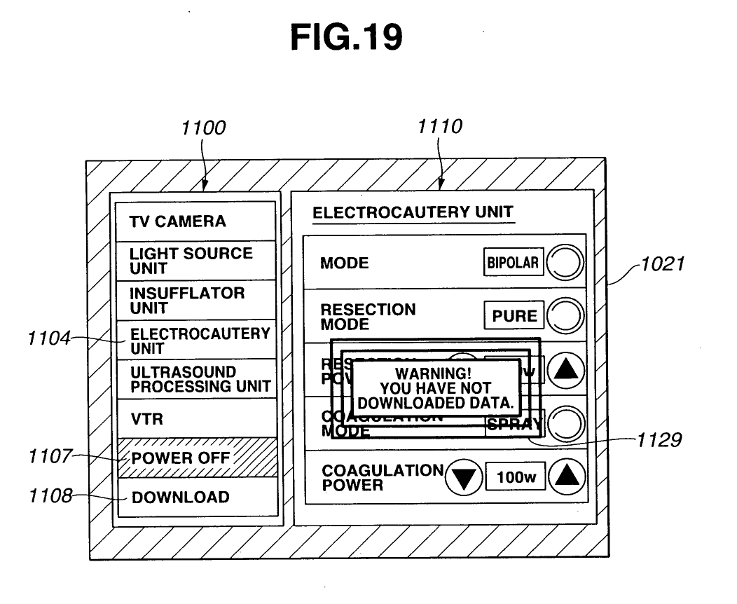

FIG. 19 is a plan view showing a screen image on the operator panel that is displayed according to a variant of the third embodiment shown in FIG. 12 to FIG. 17. The components other than the illustrated ones will be described in conjunction with FIG. 12 and FIG. 14.

According to the present variant, when the Power Off field 1107 contained in the main menu 1100 shown in FIG. 14 is pressed, if download has not been performed, an alarm message 1129 is, as shown in FIG. 19, displayed on a setting screen image 1110. The system controller then enters a standby state. Thus, an operator is notified of the fact that download has not been performed.

According to the present variant, the alarm message 1129 prevents a user from forgetting to download data.

### Fourth Embodiment

A fourth embodiment will be described with reference to FIG. 12 and FIG. 14.

As described in relation to the third embodiment by referring to FIG. 12 and FIG. 14, the PDA 1008 communicates with the system controller 1022 by means of infrared light waves. If there is an obstacle between the PDA 1008 and system controller 1022 or if the distance between them exceeds a standard value, communication is suspended.

According to the IrDA standard, bi-directional communication is achieved between the PDA 1008 and system controller 1022. In the fourth embodiment, the PDA 1008 and system controller 1022 check at intervals of, for example, one sec if they have successfully received signals sent from the others. If either of the signals is not detected, a built-in buzzer generates an alarm sound. Consequently, if the PDA 1008 goes out of a communication-enabled range within which the PDA 1008 can communicate with the system controller 1022, an operator immediately becomes aware of the fact. The operator can therefore achieve download. Moreover, the operator is prevented from going out of an operating room with the PDA 1008 put in his/her pocket or the like.

Moreover, the PDA 1008 may be fastened to a user's wrist using a wristband that is not shown. This allows the user to make his/her hands free. Moreover, the user is prevented from forgetting where he/she has put the PDA.

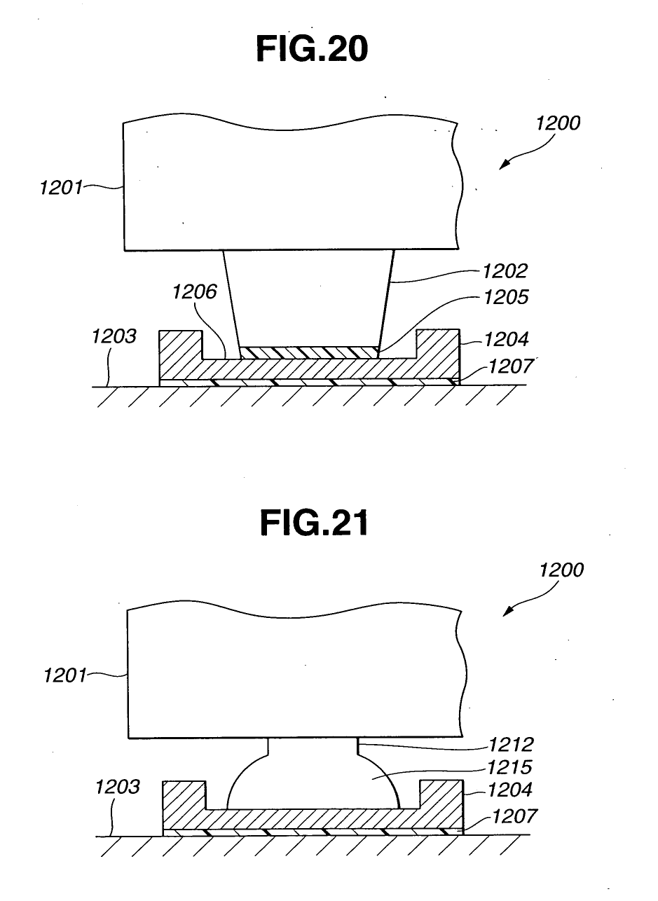

Incidentally, an operating unit like the system controller 1022 shown in FIG. 12 or equipment from which numerous cords are extended is likely to incur extraneous force. The force causes the equipment to float from the surface of a floor or any other installed surface on which the equipment is installed. Fifth to tenth embodiments that attempt to solve this problem will be described in conjunction with FIG. 20 to FIG. 25.

### Fifth Embodiment

(Features)

As shown in FIG. 20, an encased device 1200 is adapted to, for example, the system controller 1022 shown in FIG. 12.

The encased device 1200 in accordance with the fifth embodiment includes a casing 1201 that is compact and lightweight and has a plurality of connectors, a plurality of foot-holders 1204 having smoothing surfaces 1206, and a plurality of feet 1202 each having an adsorbent surface that is repeatedly usable.

The bottom of the casing 1201 has four feet 1202.

Four foot-holders 1204 are embedded in an installed surface 1203.

The foot 1202 has an adsorbent material 1205, which is repeatedly usable and washable, applied thereto.

The foot-holder 1204 has the smoothing surface 1206 on which the adsorbent material 1205 fixed to the foot 1202 is bonded. An adhesive seal 1207 is fixed to the bottom of the foot-holder 1204, whereby the foot-holder 1204 is bonded to the installed surface 1203.

(Operations)

Owing to the foregoing structure, the adsorbent material 1205 of the foot 1202 of the encased device 1200 is attracted to the smoothing surface 1206 of the foot-holder 1204.

(Advantages)

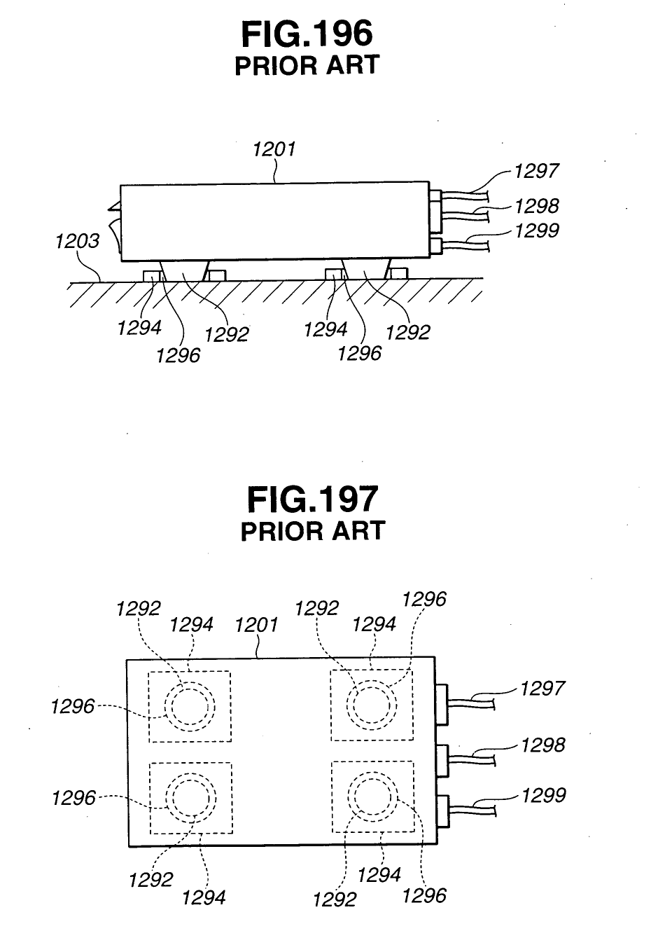

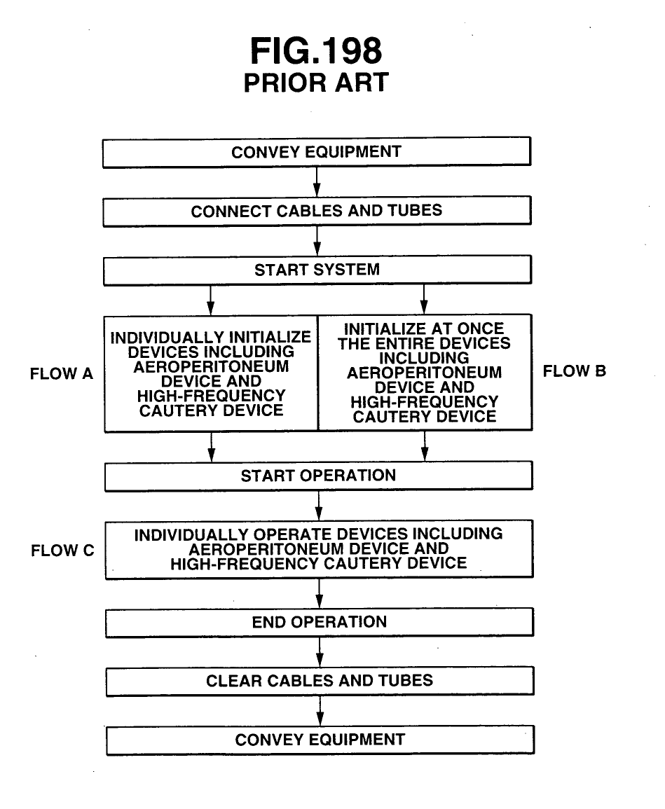

An advantage provided by the present embodiment will be described by comparing with FIG. 196 that is a side view of a conventional encased device and FIG. 197 that is a plan view thereof.

First, a conventional encased device 1290 shown in FIG. 196 and FIG. 197 has feet 1292 fixed to the bottom of a casing 1201 thereof. Through holes 1296 are bored in foot-holders 1294 placed on an installed surface 1203. The installed position of the encased device 1200 is determined with the feet 1292 and through holes 1296.

There is a gap between each foot 1292 and the through hole 1296 of each foot-holder 1294, and a structure for preventing the casing 1201 from floating is not included. Therefore, the casing 1201 of the conventional encased device 1290 may be displaced or may float due to extraneous force (force exerted in pressing a switch on the casing 1201 or tensile force exerted by cables 1297, 1298, and 1299 spliced to connectors).

In contrast, in the encased device 1200 in accordance with the fifth embodiment of the present invention shown in FIG. 20, since the adsorbent materials 1205 of the feet 1202 are attracted to the smoothing surfaces 1206 of the foot-holders 1204, the casing 1201 will neither be displaced nor float. Moreover, if the adsorbent material 1205 were smeared with humor or blood, the adsorbent material could be detached and cleaned with water. This is preferable in terms of sanitary.

### Sixth Embodiment

(Features)

As shown in FIG. 21, four sucker feet 1212 are fixed to the bottom of the casing 1201 of an encased device 1210. The sucker feet 1212 each have a sucker 1215 that is repeatedly usable. The foot-holders 1204 each have the smoothing surface 1206 to which the sucker 1215 of each sucker foot 1212 is attracted. The other members are identical to those of the fifth embodiment shown in FIG. 20. The same reference numerals will be assigned to the identical members, and the description of the members will be omitted.

(Operations)

Owing to the foregoing structure, the suckers 1215 of the sucker feet 1212 of the casing 1201 are attracted to the smoothing surfaces 1206 of the foot-holders 1204.

(Advantages)

According to the sixth embodiment, the suckers 1215 of the sucker feet 1212 are attracted to the smoothing surfaces 1206 of the foot-holders 1204. Force exerted in preventing floating of the casing 1201 works more effectively than it does in the fifth embodiment shown in FIG. 20.

### Seventh Embodiment

(Feature)

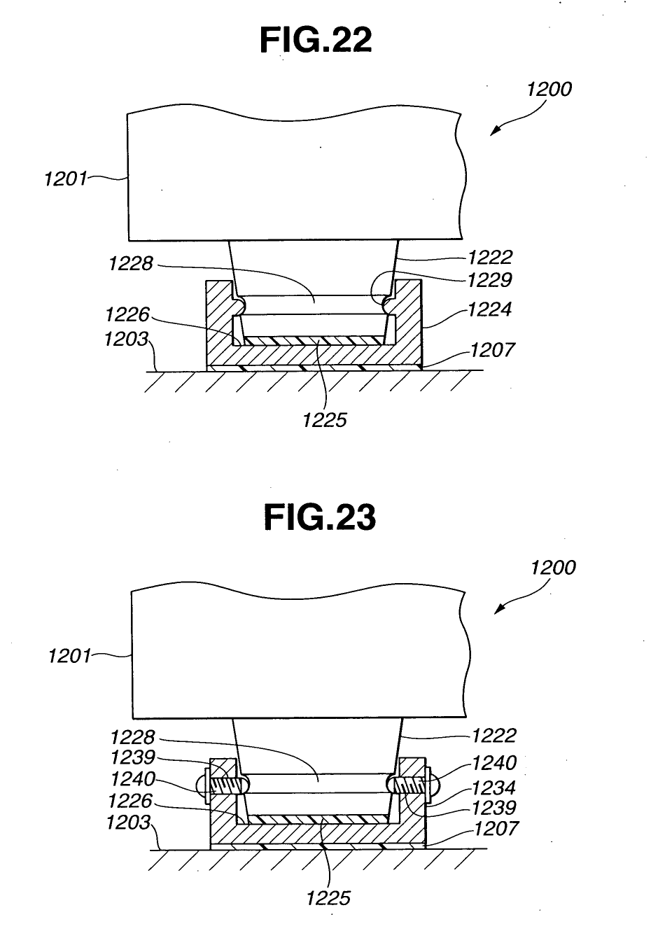

As shown in FIG. 22, four feet 1222 are fixed to the bottom of the casing 1201 of an encased device 1220.

Moreover, four foot-holders 1224 are placed on the installed surface 1203.

Each foot 1222 has a semicylindrical groove 1228 formed circumstantially. The distal portion of the foot 1222 is tapered from the semicylindrical groove 1228 towards the installed surface 1203.

Each foot-holder 1224 has a plurality of hemispheric projections 1229 formed on the internal surface thereof. The foot-holder 1224 has a smoothing surface 1226 to which an adsorbent material 1225 applied to the foot 1222 is attracted. The other members are identical to those of the fifth embodiment shown in FIG. 20. The same reference numerals will be assigned to the identical members, and the description of the members will be omitted.

(Operations)

Owing to the foregoing structure, the adsorbent materials 1225 of the feet 1222 of the casing 1201 are attracted to the smoothing surfaces 1226 of the foot-holders 1224. Furthermore, the hemispheric projections 1229 of each foot-holder 1224 are fitted in the semicylindrical groove 1228 of each foot 1222.

(Advantages)

According to the seventh embodiment, the hemispheric projections 1229 are fitted into the semicylindrical groove 1228 and locked therein. Force exerted in securing the casing 1201 works more successfully than it does in the fifth embodiment shown in FIG. 20.

### Eighth Embodiment

(Features)

As shown in FIG. 23, four feet 1224 are fixed to the bottom of the casing 1201 of an encased device 1230. Four hoot-holders 1234 are placed on the installed surface 1203. The foot-holders 1234 each have one or more screws threaded in the lateral surface thereof. Screws 1240 are meshed with the screws 1239, and have the tips thereof fitted in the semicylindrical groove 1228 formed in each foot 1222.

The other members are identical to those of the seventh embodiment. The same reference numerals will be assigned to the identical members, and the description of the members will be omitted.

(Operations)

Owing to the foregoing structure, the adsorbent materials 1225 of the feet 1222 of the casing 1201 are attracted to the smoothing surfaces 1226 of the foot-holders 1224. Moreover, the tips of the screws 1240 are fitted into the semicylindrical groove 1228 formed in each foot 1222, and the foot is thus immobilized.

(Advantages)

According to the eighth embodiment, the tips of the screws 1240 are fitted into the semicylindrical groove 1228 formed in each foot so that each foot will be immobilized. Force exerted in immobilizing the casing 1201 works more successfully than it does in the seventh embodiment shown in FIG. 22.

### Ninth Embodiment

(Feature)

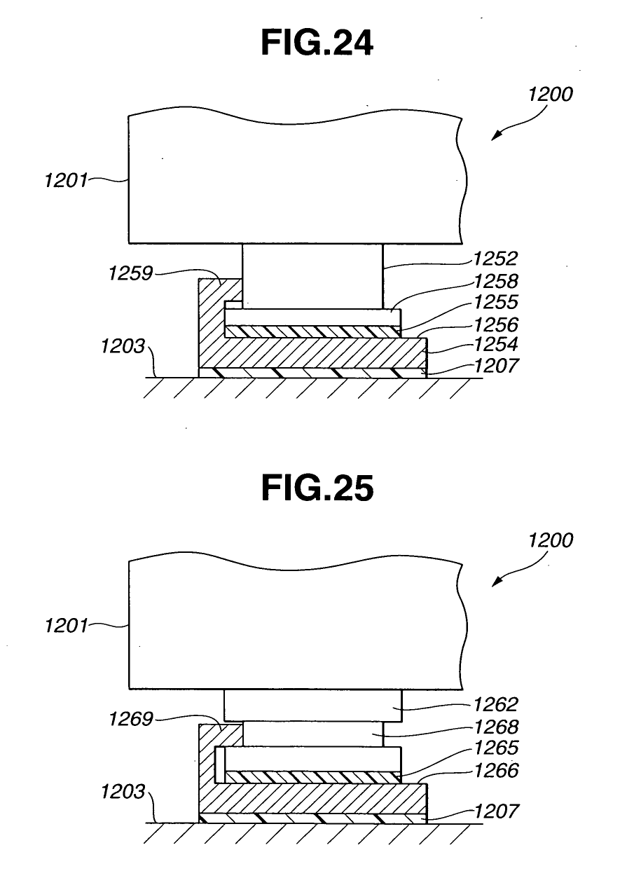

As shown in FIG. 24, four feet 1252 are fixed to the bottom of the casing 1201 of an encased device 1250. Moreover, four hoot-holders 1254 are placed on the installed surface 1203.

Each foot 1252 has a flange 1258 formed on the side thereof facing the installed surface 1203. The flange 1258 serves as a catch. Each foot-holder 1254 has a hooked portion 1259, and also has a smoothing surface 1256 to which an adsorbent material 1255 applied to each foot 1252 is attracted. The other members are identical to those of the fifth embodiment shown in FIG. 20. The same reference numerals will be assigned to the identical members, and the description of the members will be omitted.

(Operations)

Owing to the foregoing structure, the flange 1258 of each foot 1252 is engaged with the hooked portion 1259 of each foot-holder 1254, and the hooked portion 1259 catches the flange 1258 of the foot 1252. Furthermore, the adsorbent material 1255 of the foot 1252 of the casing 1201 is attracted to the smoothing surface 1256 of the foot-holder 1254.

(Advantages)

According to the ninth embodiment, the flange 1258 of each foot 1252 is engaged with the hooked portion 1259. Consequently, the ninth embodiment provides the same advantage as the seventh embodiment shown in FIG. 22. The encased device 1250 can be installed readily. This leads to improvement of working efficiency.

### Tenth Embodiment

(Feature)

As shown in FIG. 25, four feet 1262 are fixed to the bottom of the casing 1201 of an encased device 1260. Moreover, four foot-holders 1264 are placed on the installed surface 1203.

Each foot 1262 has a slit 1268 formed in the periphery thereof near the end thereof facing the installed surface 1203. Each foot-holder 1264 has a hooked portion 1269 and a smoothing surface 1266 to which an adsorbent material 1265 applied to each foot 1262 is attracted. The other members are identical to those of the ninth embodiment shown in FIG. 24. The same reference numerals will be assigned to the identical members, and the description of the members will be omitted.

(Operations)

Owing to the foregoing structure, the hooked portion 1269 of each foot-holder 1264 is fitted into the slit 1268 of each foot 1262, and thus locked in the slit 1268 thereof. Furthermore, the adsorbent material 1265 of each foot 1262 of the casing 1201 is attracted to the smoothing surface 1266 of each foot-holder 1264.

(Advantages)

According to the tenth embodiment, the hooked portion 1269 is locked in the slit 1268 of each foot 1262. Consequently, the tenth embodiment provides the same advantage as the ninth embodiment shown in FIG. 24.

By the way, the operator panel 1021 shown in FIG. 12 serves as a setting display panel to be used to determine set values for equipment that assists in endoscopic surgery. The operator panel 1021 is disposed on the side of the first cart 1011 serving as an endoscopic surgery trolley.

Moreover, conventional endoscopic surgery trolleys are classified into a type having a setting display panel disposed on the side of an endoscopic surgery trolley as described in Japanese Unexamined Patent Application Publications Nos. 7-303654 and 2001-128992, and a type having a setting display panel disposed separately from an endoscopic surgery trolley as described in Japanese Unexamined Patent Application Publication No. 7-132121.

The setting display panels included in the third embodiment shown in FIG. 12 and described in the Japanese Unexamined Patent Application Publications Nos. 7-303654 and 2001-128992 are each disposed on the side of an endoscopic surgery trolley. Therefore, it is impossible for a nurse to freely change the orientation of the setting display panel, and it is very hard to modify the settings of equipment within a crowded operating room. Moreover, the setting display panel described in the Japanese Unexamined Patent Application Publication No. 7-132121 is disposed separately from the endoscopic surgery trolley. It is possible for a nurse to freely change the orientation of the setting display panel. The maneuverability of the setting display panel is therefore satisfactory. However, the setting display panel itself may interfere with people working in a crowded operating room.

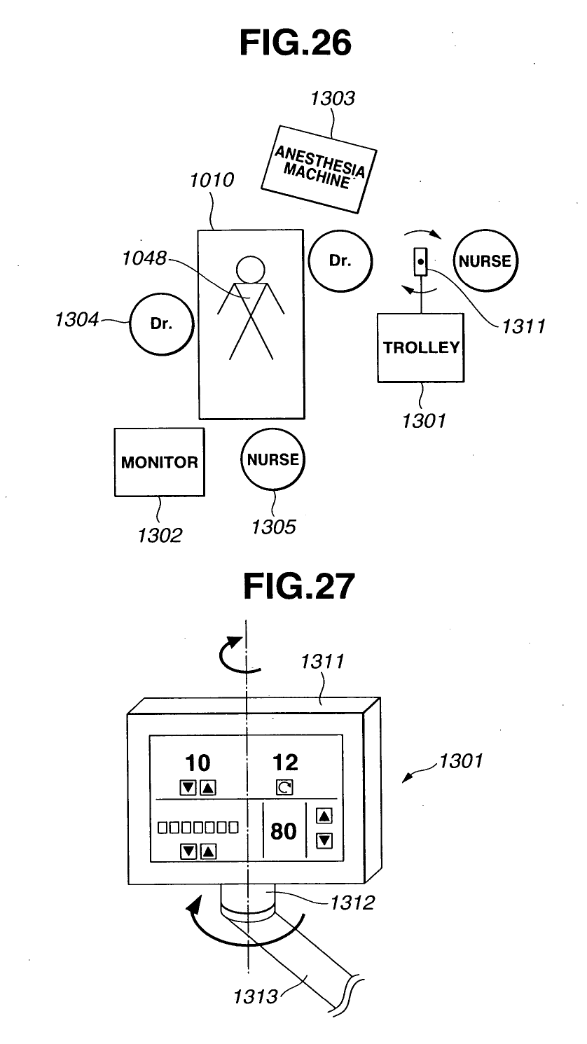

Eleventh to thirteenth embodiments that attempt to solve the foregoing problem will be described in conjunction with FIG. 26 to FIG. 32 below.

### Eleventh Embodiment

(Feature)

As shown in FIG. 26, a patient couch 1010 on which a patient 1048 lies down, an endoscopic surgery trolley 1301 serving as an endoscopic surgery system, a monitor 1302, and an anesthesia machine 1303 are installed in an operating room. Doctors 1304 and 1305 and nurses 1306 and 1307 are working in the operating room. The trolley 1301 has a setting display panel 1311 used to determine or display the set values for equipment that assists in endoscopic surgery.

As shown in FIG. 27, the endoscopic surgery trolley 1301 has the setting display panel 1311, a driver 1312 to be used to axially rotate the setting display panel, and an arm 1313. One end of the arm 1313 is fixed to the frame of a main body of the endoscopic surgery trolley 1301, and the other end thereof bears the setting display panel 1311 via the driver 1312.

Owing to the foregoing structure, a person who operates equipment can change the orientation of the screen of the setting display panel 1311 by 180° or more with respect to the main body of the endoscopic surgery trolley 1301.

(Operations)

When the driver 1312 of the endoscopic surgery trolley 1301 axially rotates, the setting display panel 1311 thereof rotates to change its orientation.

(Advantages)

According to the eleventh embodiment, the orientation of the setting display panel 1311 can be changed. This contributes to improvement of efficiency in proceeding with work such as setting modification or setting verification to be performed by a nurse or the like in an unclean zone during surgery. Eventually, a load the nurse incurs can be lightened.

### Twelfth Embodiment

(Feature)

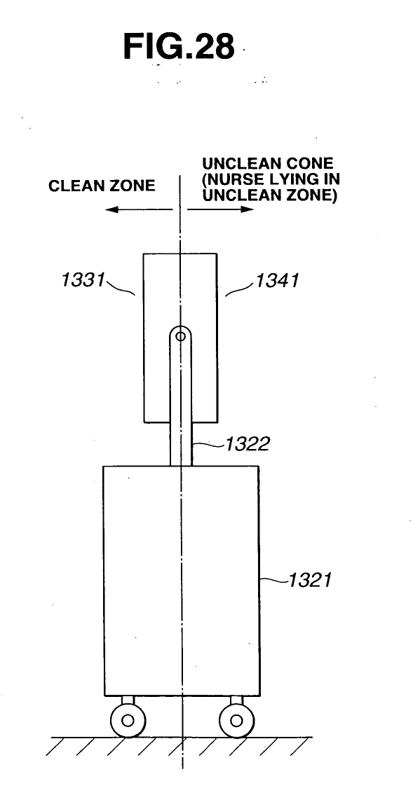

As shown in FIG. 28, an endoscopic surgery trolley 1321 has an LCD monitor 1331, which includes a touch-sensitive panel, and an LCD monitor 1341 integrated with each other. The LCD monitor 1331 and LCD monitor 1341 are mounted on the top of the endoscopic surgery trolley using arms 1322. The endoscopic surgery trolley 1321 has a footswitch that is not shown and that can be stepped on in a clean zone.

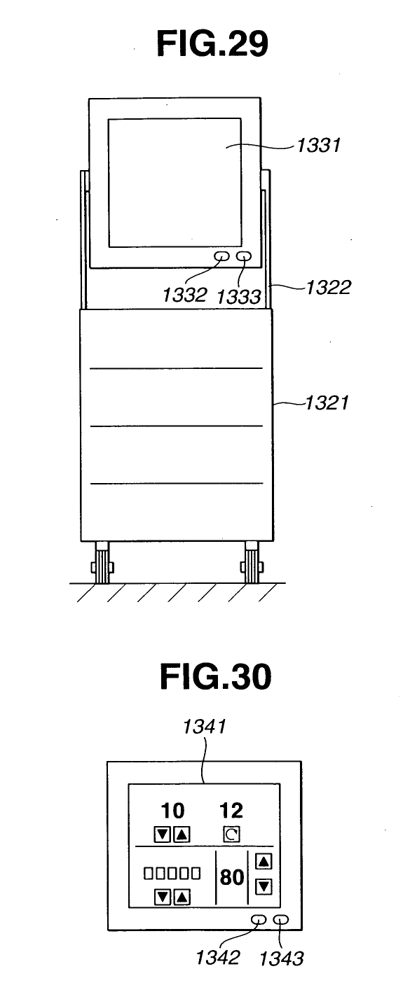

As shown in FIG. 29, the LCD monitor 1331 has a setting switch 1332 that is used to display an endoscopic image, and a setting switch 1333 that is used to display a screen image that is supposed to be displayed on a setting display panel.

As shown in FIG. 30, the LCD monitor 1341 has a setting switch 1342 that is used to display an endoscopic image, and a setting switch 1343 that is used to display a screen image that is supposed to be displayed on the setting display panel.

(Operations)

In the endoscopic surgery trolley 1321, depending on whichever of the setting switches of each of the LCD monitor 1331 and LCD monitor 1341 is pressed, one of the LCD monitor 1331 and LCD monitor 1341 displays an endoscopic image and the other displays a screen image.

(Advantages)

According to the twelfth embodiment, an LCD monitor on which an endoscopic image is displayed and a setting display panel are integrated with each other. This contributes to space saving.

### Thirteenth Embodiment

(Feature)

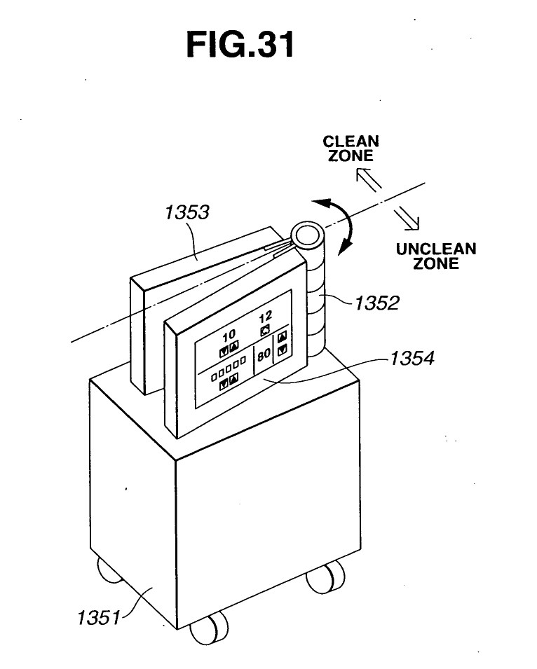

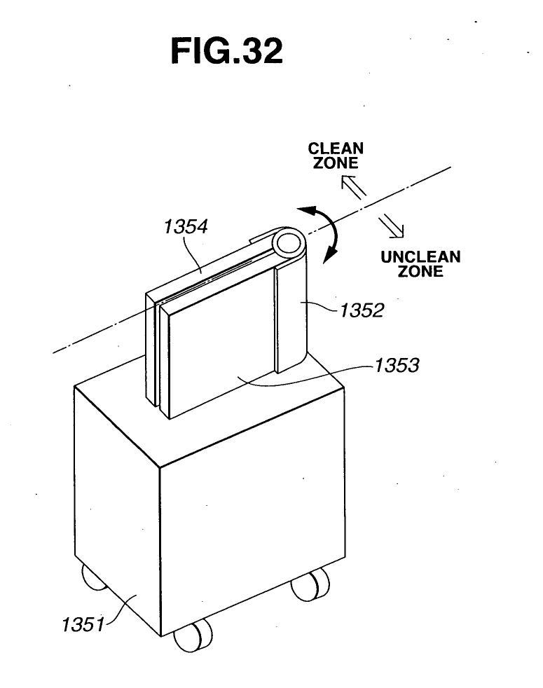

As shown in FIG. 31 and FIG. 32, an LCD monitor 1353 and a setting display panel 1354 that are integrated with each other using a hinge 1352 are placed on the top of an endoscopic surgery trolley 1351.

(Operations)

The endoscopic surgery trolley 1351 has the setting display panel 1354 that axially turns on the hinge 1352 so as to change the orientation thereof. As shown in FIG. 31, when the LCD monitor 1353 and setting display panel 1354 are left open, the screen of the LCD monitor 1353 lies in a clean zone and the screen of the setting display panel 1354 lies in an unclean zone.

(Advantages)

According to the thirteenth embodiment, unless the endoscopic surgery trolley is used, the screen of the setting display panel 1354 and the screen of the LCD monitor 1353 are, as shown in FIG. 32, met each other. Thus, the screen of the setting display panel 1354 and the screen of the LCD monitor 1353 can be protected.

### Fourteenth Embodiment

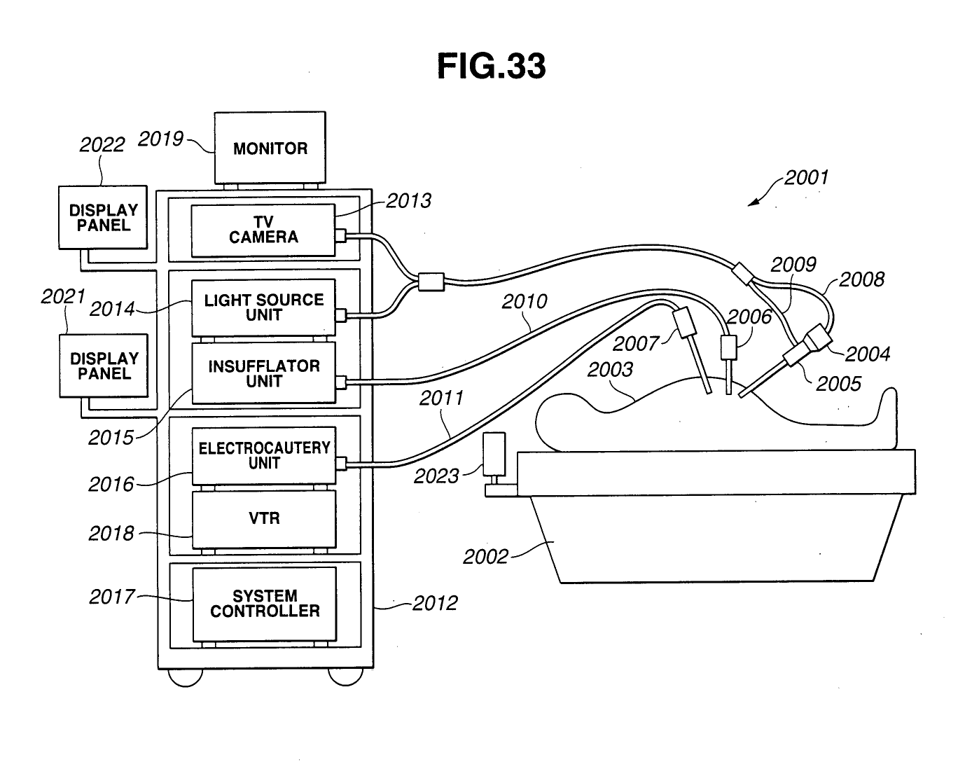

As shown in FIG. 33, an endoscopic surgery system 2001 is constructed in an operating room. Herein, a TV camera head 2004 having a built-in imaging device is mounted on an endoscope 2005 used to perform endoscopic examination. The endoscope 2005, an insufflator unit guide pipe 2006 used to dilate the abdominal cavity, and an electrocautery probe 2007 used to electrically cauterize a tissue are thrust into a patient 2003 lying down on an operating table 2002. A signal cable 2008 coupled to the TV camera head 2004, a light guide cable 2009 coupled to the endoscope 2005, an insufflator tube 2010 coupled to the insufflator guide pipe 2006, and a signal cable 2011 coupled to the electrocautery probe 2007 are led to a TV camera unit (hereinafter abbreviated to a TV camera for brevity's sake) 2013, a light source unit (hereinafter abbreviated to a light source) 2014, an insufflator unit 2015, and an electrocautery unit 2026 respectively which are integrated into a trolley 2012.

In addition to the TV camera 2013 that processes a signal picked up by the imaging device, the light source 2014 that supplies illumination light, the insufflator unit 2015 that supplies a gas to dilate the abdominal cavity, and the electrocautery unit 2016 that supplies high-frequency power for cauterization, a system controller 2017 that controls the entire system (serves as a medical system controller), a VTR 2018 that records a video signal produced by the TV camera 2013, and a monitor 2019 on which an image is displayed according to the video signal sent from the TV camera 2013 are integrated into the trolley 2012.

Moreover, an operator panel 2021 used to operate the endoscopic surgery system and a display panel 22 on which an image or the like is displayed are mounted on the trolley 2012. Furthermore, a remote controller 2023 used to remotely control or operate the endoscopic surgery system is detachably attached to the operating table 2 or the like.

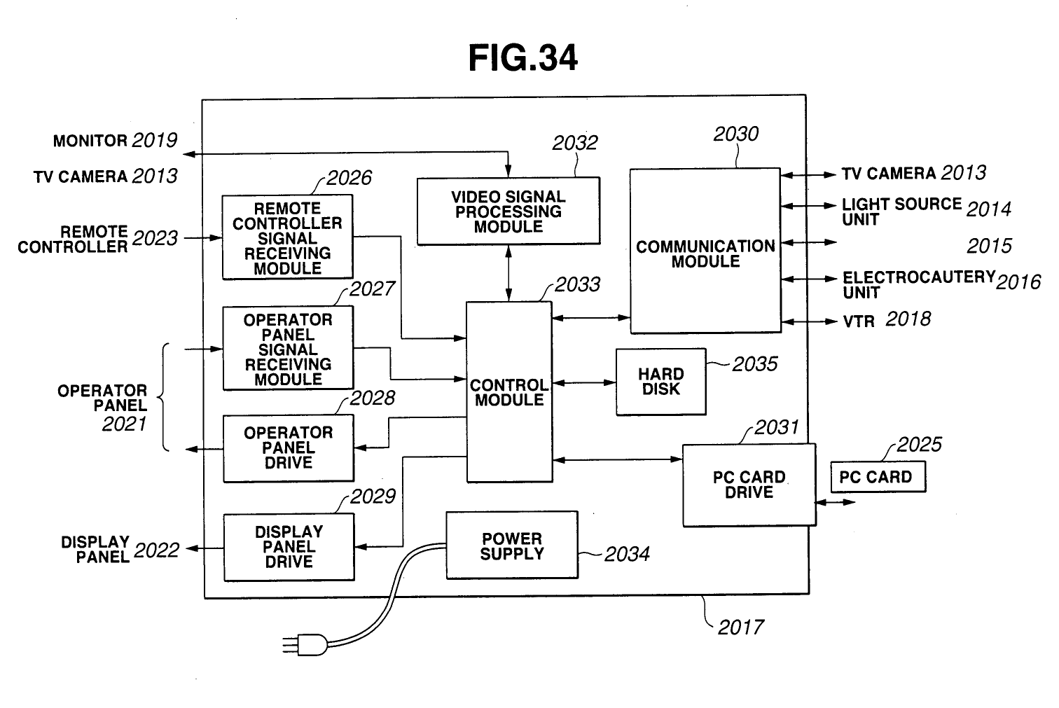

Medical equipment including the TV camera 2013 is connected to the system controller 2017 over communication cables that are not shown. According to the present embodiment, a PC card 2025 that will be described in conjunction with FIG. 34 can be loaded in the system controller 2017.

FIG. 34 shows the internal configuration of the system controller 2017.

The system controller 2017 can be operated using the touch-sensitive panel type operator panel 2021 or remote controller 2023. Displaying information or the like sent from the system controller 2017 is controlled using the operator panel 2021 or display panel 2022.

The system controller 2017 includes: a remote controller signal receiving module 2026 that receives a signal from the remote controller 2023; an operator panel signal receiving module 2027 that receives a signal from the operator panel 2021; an operator panel drive 2028 that transmits data needed to display information on the operator panel 2021; and a display panel drive 2029 that transmits data needed to display information on the display panel 2022.

Moreover, a communication module 2030 that communicates with medical equipment mounted in the trolley 2012 is connected to the TV camera 2013, light source 2014, insufflator unit 2015, electrocautery unit 2016, and VTR 2018 over communication cables. The communication module 2030 can communicate with the medical equipment bi-directionally.

Moreover, the system controller 2017 includes a PC card drive 2031 that receives or transmits data to or from the PC card 2025 when having the PC card 2025 loaded therein. This is intended to transfer data to or from a personal computer or any other external information processing unit via the PC card 2025 serving as a nonvolatile information recording device, for example, a flash memory.

Moreover, a video signal processing module 2032 included in the system controller 2017 digitizes a video signal sent from the TV camera 2013, and transfers the resultant signal to the control module 2033. Moreover, the video signal processing module 2032 converts video data produced by the control module 2033 into an analog signal, and transmits the analog signal to the monitor 2019.

The control module 2033 for controlling the foregoing components as well as a power unit 2034 that supplies power to the components and a hard disk 2035 in which automatic setup data is preserved are included in the system controller 2017. A program for producing the automatic setup data needed to automatically set up medical equipment in order to conduct surgery and a program for editing it are stored in the hard disk 2035.

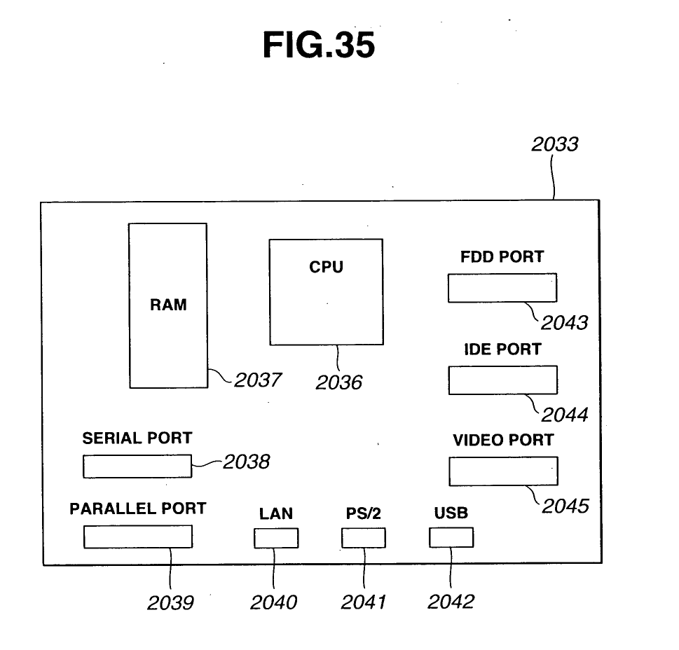

The control module 2033 is realized with a board personal computer. As shown in FIG. 35, the control module 2033 has, in addition to the CPU 2036, a RAM 2037 and various kinds of general interfaces which a typical personal computer has, such as, a serial port 2038, a parallel port 2039, a LAN port 2040, a PS/2 port 2041, a USB port 2042, an FDD port 2043 through which the control module is connected to a floppy® disk drive, and an IDE port 2044 through which the control module is connected to a hard disk drive 2035, and a video port 2045 through which a video signal is transmitted.

In general, it is necessary for surgery to determine an operation mode in which each piece of medical equipment operates and the set values for each piece of medical equipment. In this case, an automatic setup feature will prove useful. Specifically, the automatic setup feature preserves operational set values prior to surgery, and reads the set values at the start of surgery so as to set up each piece of medical equipment. According to the present embodiment, the automatic setup feature can be, as described later, implemented by loading the PC card 2025, which can be freely unloaded and serves as a recording means in which operational setting information (operational set values) is recorded, in the system controller 2017 included in the endoscopic surgery system 1.

An external personal computer (hereinafter abbreviated to a personal computer) or any other information processing unit is used to record operational setting information (or more particularly, automatic setup data) on the PC card 2025. The PC card 2025 is then loaded in the PC card drive 2031 included in the system controller 2017, whereby the operational setting information recorded in the PC card 2025 is read and effectively used to set up medical equipment.

In short, according to the present embodiment, an external information processing unit other than a conventional endoscopic surgery system can record or edit operational setting information. Moreover, the operational setting information can be utilized in efforts to realize a user-friendly medical system control system (and medical system).

As described later, a personal computer a doctor uses to edit data at his/her office with the PC card 2025 loaded therein has the same features as the control module 2033 shown in FIG. 35 (in FIG. 35, a hard disk and a display means are connected through the IDE port 2044 and video port 2045 respectively). Furthermore, the personal computer has a PC card drive in or from which the PC card 2025 can be loaded or unloaded.

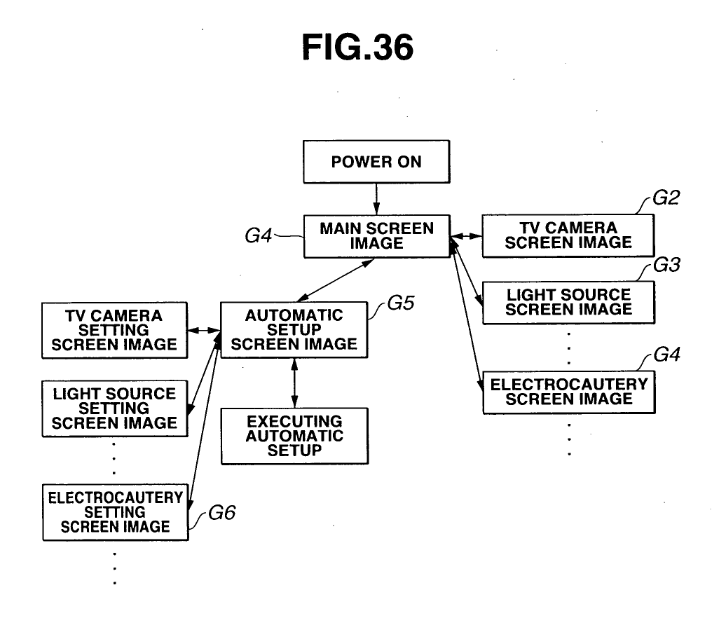

Next, operations to be exerted by the present embodiment will be described. First, referring to the screen image transition chart of FIG. 36, a description will be made of actions to be performed by the system controller 2017 included in the fourteenth embodiment.

When the power supply of the system controller 2017 is turned on, a main screen image G1 is displayed on the screen of the operator panel 2021. A transition can be made from the main screen image G1 to a TV camera image G2, a light source screen image G3, etc., or an electrocautery screen image G4. Moreover, a transition can be made from the main screen image G1 to an automatic setting screen image G5 by manipulating an Auto Setup button 55 that will be described later.

Automatic setting can be executed through the automatic setup screen image G5.

Moreover, the automatic setup screen image G5 can be changed to a TV camera setting screen image, a light source setting screen image, etc., or an electrocautery unit setting screen image G6.

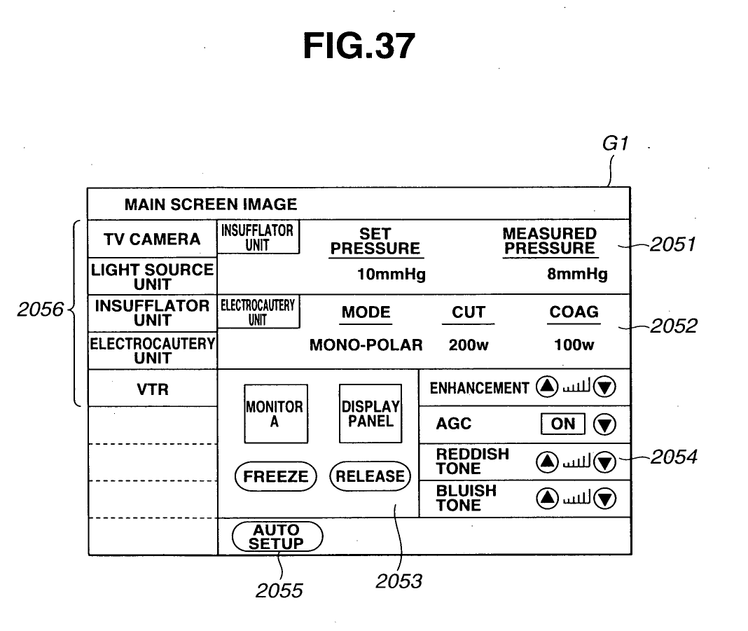

FIG. 37 shows a concrete example of the main screen image G1.

The main screen image G1 contains an insufflator unit information field 2051 as the right upper part thereof. A set value of an insufflation pressure and a measured value thereof are presented in the insufflator unit information field 2051.

An electrocautery unit information field 2052 is displayed as the middle part of the main screen image, wherein an output mode, a resection power value, and a coagulation power value are presented.

A monitor and display panel field 2053 is displayed as the left lower part of the main screen image. Whether a video signal received by the system controller 2017 is frozen or released (captured) can be specified in the field. Captured video data can be recorded in the PC card 2025 and seen at other personal computer.

A TV camera operation field 2054 is displayed as the right lower part of the main screen image, wherein the names of the features of the TV camera 2013 are presented. When part of the screen image defined as a button is pressed, any value can be set for each of the features. When the Auto Setup button 2055 is pressed, the main screen image is changed to the automatic setup screen image G5.

By the way, a list 2056 of pieces of medical equipment connected to the system controller 2017 is displayed as the left part of the main screen image.

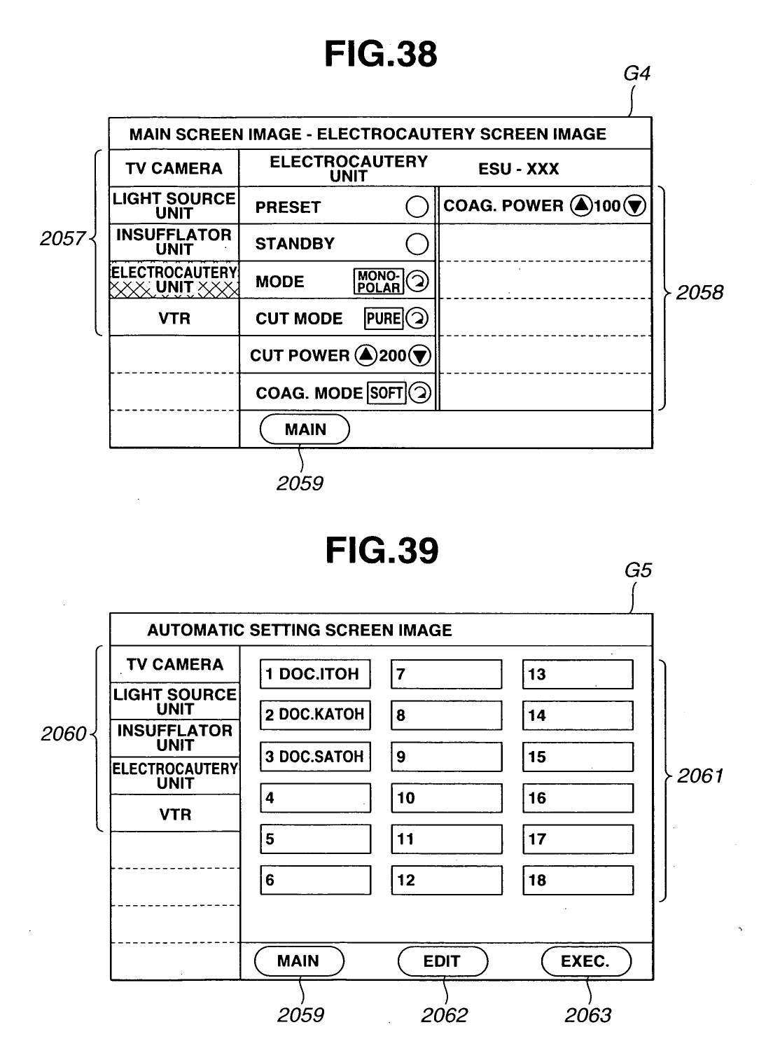

When, for example, an Electrocautery Unit field is pressed, the main screen image is changed to a screen prompting a user to operate the electrocautery unit 2016. The electrocautery screen image G4 is shown in FIG. 38.

Similarly to the main screen image G1, a list 2057 of pieces of medical equipment is displayed as the left part of the screen image. An Electrocautery Unit field is hatched because the electrocautery unit is currently designated.

A list 2058 of settings that must be determined in order to operate the electrocautery unit is displayed as the right part of the screen image. When a button in each setting is pressed, the setting can be determined or modified.

A Mode field presents an output mode that is selected from a mono-polar mode or a bipolar mode. A Cut mode field presents a resection mode that is selected from among Pure resection, Mixture 1, and Mixture 2. A Cut Power field presents a power value for resection. A Coag. Mode field presents a coagulation mode that is selected from Coagulation and Soft.

A Coag. Power field presents a power value for coagulation. A Preset field presents whether the settings determined for the previous use are adopted. A Standby field presents whether the electrocautery unit is put on standby but is not powered.

When a Main button 2059 in the lower most field is pressed, the electrocautery screen image is returned to the main screen image G1.

Now, automatic setup will be described.

The automatic setup feature is implemented during a time interval from the instant the endoscopic surgery system 2001 is carried into an operating room to the instant surgery is started. Medical equipment can operate in various modes on the basis of numerous set values. It is time-consuming to determine the set values at every start of surgery. The automatic setup feature is intended to preserve such set values in advance and set up all pieces of medical equipment with one touch of a button at the start of surgery.

In order to implement the automatic setup feature, the Auto Setup button 2055 is pressed through the main screen image G1. This causes the main screen image G1 to make a transition to the automatic setup screen image G5 shown in FIG. 39.

The left part of the automatic setup screen image G5 is displayed as a medical equipment list 2060, and the right part thereof is displayed as an automatic setup data list 2061.

In order to produce automatic setup data, first, any of the first to eighteenth fields is pressed in order to designate a storage area which is associated with the pressed field included in the automatic setup data list 2061 and in which data is stored. Thereafter, a text input means such as a keyboard (not shown) is used to enter a field name in the field.

Referring to FIG. 39, Doc. Itoh is entered as the name of the first field that is included in the list 2061 and that is associated with a storage area in which automatic setup data designated by Doc. Itho is stored. Doc. Katoh is entered as the name of the second field that is included therein and that is associated with a storage area in which automatic setup data designated by Doc. Katoh is stored. Doc. Satoh is entered as the name of the third field that is included therein and that is associated with a storage area in which automatic setup data designated by Doc. Satoh is stored.

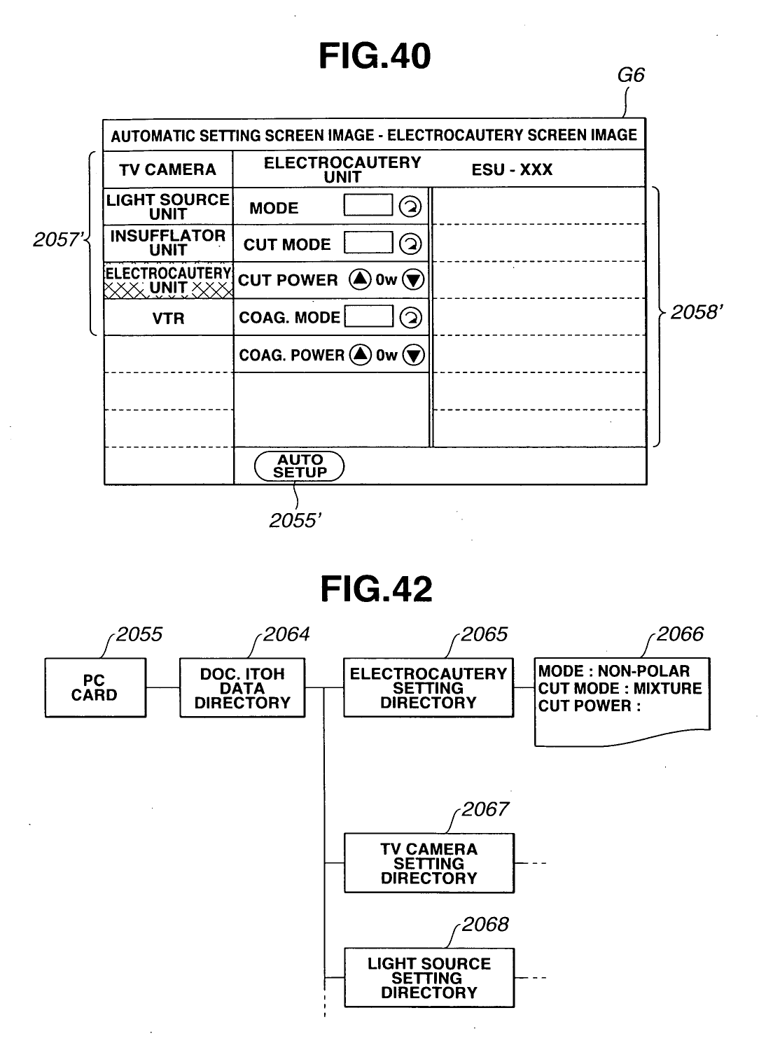

With any field included in the automatic setup data list 2061 held down, an Edit button 2062 in the lowermost field is pressed. Medical equipment whose settings must be edited is selected from the left-hand medical equipment list 2060, and the field that presents the selected medical equipment name is pressed. FIG. 40 shows an electrocautery unit setting screen image G6 that is displayed with the press of the Electrocautery Unit field.

In the electrocautery unit setting screen image G6 shown in FIG. 40, the features of the electrocautery unit are presented. The electrocautery unit setting screen image G6 is a little different from the electrocautery screen image G4 retrieved through the main screen image G1.

Similarly to the electrocautery screen image G4, the electrocautery screen image G6 contains a medical equipment list 2057′ as the left part thereof, and contains an electrocautery unit setting list 2058′ as the right part thereof. Unlike the electrocautery screen image G4 shown in FIG. 38, all the features of the electrocautery unit are not presented.

The Standby field and Preset field (shown in FIG. 38) are not contained in the screen image G6 because these settings cannot be automatically determined. Moreover, an Auto Setup button 2055′ is presented in the lower field of the electrocautery unit setting screen image G6.

After set values based on which all or required pieces of medical equipment are automatically set up are determined through the automatic setup screen image G5 shown in FIG. 39, the Edit button 2062 is pressed again in order to terminate editing.

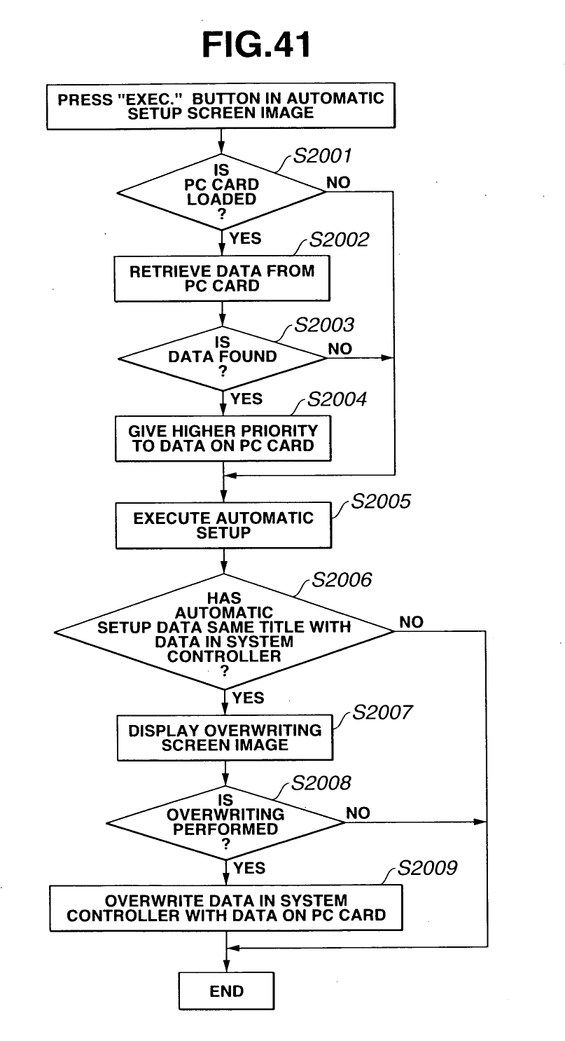

Moreover, when an Exec. button 2063 defined in the right lower field of the automatic setup screen image G5 is pressed, automatic setup is executed for equipment whose name is specified in a selected field included in the automatic setup data list. When the PC card 2025 is loaded in (the PC card drive 2031 included in) the system controller 2017, automatic setup is performed as described in the flowchart of FIG. 41.

When the Exec. button 2063 is pressed, it is judged at step S2001 whether the PC card 2025 is loaded. If the PC card 2025 is not loaded, control is jumped to step S2005. Automatic setup is performed based on designated automatic setup data.

If the PC card 2025 is loaded, the contents of the PC card are retrieved at step S2002.

It is then judged from the results of retrieval whether automatic setup data is present (step S2003). If the automatic setup data is present, the data is read. The data stored in the PC card 2025 is given higher priority over the currently selected automatic setup data (step S2004). Automatic setup is performed based on the data stored on the PC card 2025 at step S2005.

In other words, the control module 2033 in the system controller 2017 transmits automatic setup data concerning medical equipment to the medical equipment via the communication module 2030, and sets up the medical equipment according to a designated operation mode, a designated power value, and so one.

If data stored in the PC card 2025 is designated by, for example, Doc. Itoh as shown in FIG. 42, an electrocautery unit setting file 2066 contained in an electrocautery unit setting directory 2065 is transmitted to the electrocautery unit 2016, and the electrocautery unit 2016 is set up based on the received data. A file contained in a TV camera setting directory 2067 is transmitted to the TV camera 2013, and the TV camera is set up based on the received data. The same applies to the light source 2014 and others.

At step S2006, it is judged whether automatic setup data stored in the PC card 2025 has the same title as automatic setup data stored in the hard disk 2035 in the system controller 2017. If data having the same title is not found, the processing is terminated. If data having the same title is found, it is checked at step S2007 whether the automatic setup data stored in the hard disk 2035 in the system controller 2017 is overwritten with the automatic setup data stored in the PC card 2025. Specifically, an overwriting screen image is displayed at step S2007 in order to prompt a user to determine whether the overwriting is performed.

If the user designates that the overwriting is performed, the automatic setup data stored in the hard disk 2035 in the system controller 2017 is overwritten with the automatic setup data stored in the PC card 2025 (step S2009). The processing is then terminated. If the user does not designate that the overwriting is performed, the processing is terminated.

FIG. 42 shows a data structure adopted for the PC card 2025.

The PC card 2025 has an automatic setup directory (in this case, assigned to Doc. Itoh) created therein. The electrocautery unit setting directory 2065 is nested in the automatic setting directory. An electrocautery unit setting file 2066 is contained in the electrocautery unit setting directory 2065. A mode name and set values including a power value are recorded, for example, in a text mode.

Aside from the above directories, there are directories associated with respective pieces of medical equipment, such as, a TV camera setting directory 2067 and a light source setting directory.

When a doctor using the system 1 (or the system controller 2071) installs a home editor program (or personal computer editor program) in his/her personal computer that has an information processing feature, the doctor can edit data stored in the PC card 2025 in his/her office.

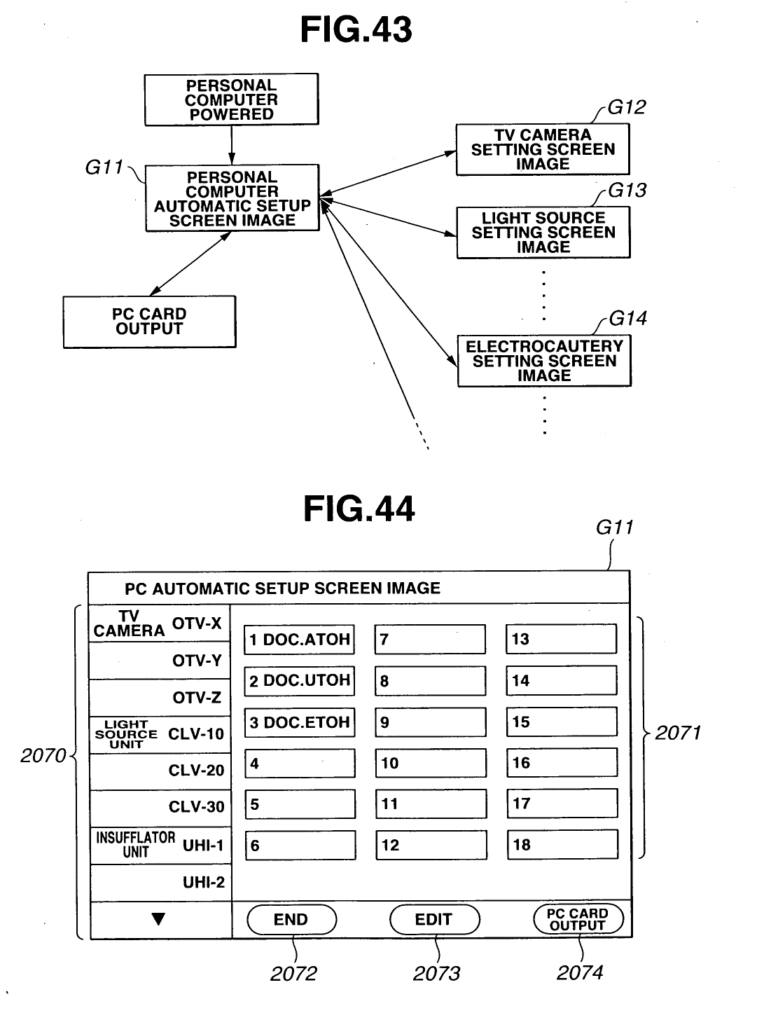

FIG. 43 is a state transition chart relevant to a personal computer having the home editor program installed therein.

After the power supply of a personal computer is turned on, when the home editor program is activated, a personal computer automatic setup screen image G11 appears. A transition can be made from the personal computer automatic setup screen image G11 to a TV camera setting screen image G12, a light source setting screen image G13, etc., or an electrocautery unit setting screen image G14.

Edited data can be transferred to the PC card 2025 that is loaded in the personal computer so that it can be unloaded freely. In order to install the home editor program in a personal computer, the home editor program may be first read from the PC card 2025 and then installed. The home editor program may be stored in the PC card shown in FIG. 42.

FIG. 44 shows the personal computer automatic setup screen image G11 displayed when the home editor program is activated.

The personal computer automatic setup screen image G11 contains a list 2070 of connectable pieces of medical equipment as the left-hand part thereof, and contains a setting data list 71 as the right-hand part thereof.

An End button 2072, an Edit button 2073, and a PC Card Output button 2074 are defined in the lower part of the personal computer automatic setup screen image.

A doctor first selects a field number associated with a storage area, in which data is stored, from the setting data list 2071. Thereafter, the doctor selects the name of medical equipment to be used from the right-hand medical equipment list 2070, and enters set values for the medical equipment. The setting screen image is the same as the image displayed when the system controller 2017 extends control in an operating room. For example, when a name of an electrocautery unit is selected, the screen image shown in FIG. 40 appears.

After entering the set values is completed, the PC Card Output button 2074 is pressed in order to record the entered setting data in the PC card 2025. When the End button 2072 is pressed, the editor program is terminated.

When setting data concerning medical equipment a doctor has edited in his/her office is preserved in the PC card 2025, the medical equipment can be automatically set up based on the setting data prior to surgery. At this time, automatic setup data recorded in the system controller 2017 installed in an operating room can also be modified (updated).

The present embodiment provides an advantage described below.

Automatic setup work need not be performed at a site of surgery. Data edited in a doctor's office can be used to automatically set up medical equipment. Consequently, the endoscopic surgery system 2001 is realized as a user-friendly system.

### Fifteenth Embodiment

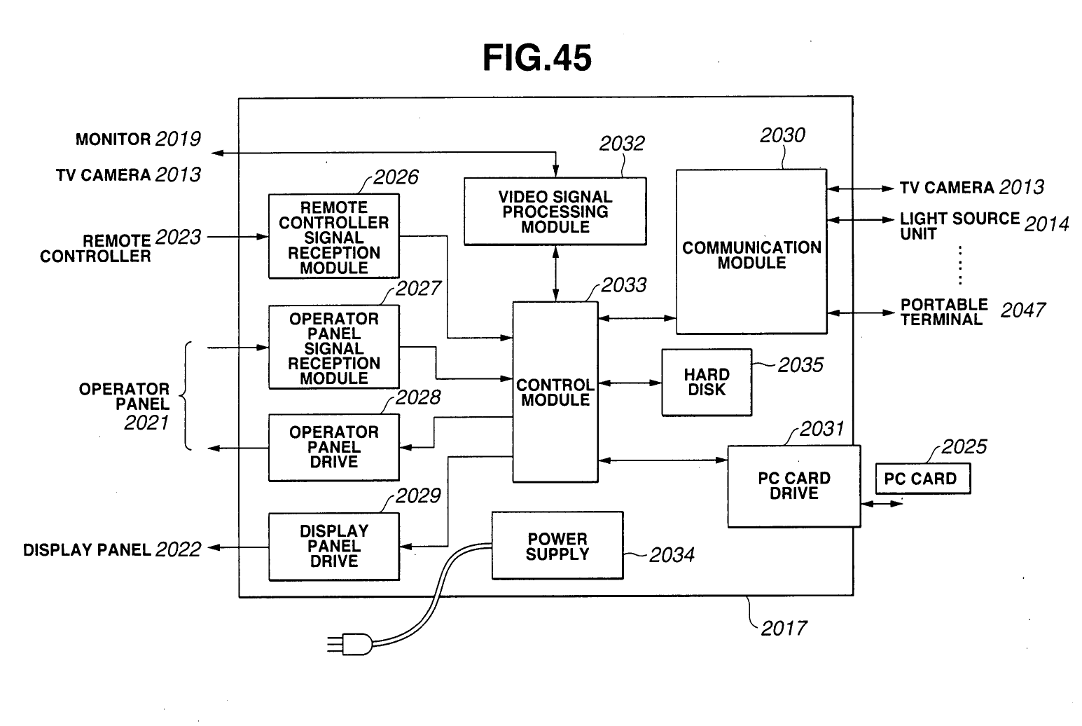

Next, a fifteenth embodiment will be described with reference to FIG. 45 to FIG. 49.

The configuration of an endoscopic surgery system to be constructed in an operating room that accommodates the present embodiment is nearly identical to the one shown in FIG. 33. Moreover, a portable terminal 2047 is usable. FIG. 45 shows the configuration of the system controller 2017 employed in this case.

The system controller 2017 can be controlled or operated using the touch-sensitive panel type operator panel 2021 or the remote controller 2023 as described in relation to the fourteenth embodiment. Moreover, information provided by the system controller 2017 is displayed on the operator panel 2021 or display panel 2022.

The remote controller signal receiving module 2026 receives a signal from the remote controller 2023. The operator panel signal receiving module 2027 receives a signal from the operator panel. The operator panel drive 2028 transmits data needed to display information on the operator panel. The display panel drive 2029 transmits data needed to display information on the display panel.

Moreover, the communication module 2030 that communicates with medical equipment integrated into the trolley 2012 communicates with the TV camera 2013, light source 2014, insufflator unit 2015, electrocautery unit 2016, and VTR 2018 respectively. Moreover, data can be transferred to or from the portable terminal 2047 via the communication module 2030.

Data is transferred to or from an external personal computer by way of the PC card 2025. Moreover, according to the present embodiment, setting data entered using the portable terminal 2047 can be used to set up medical equipment via (the communication module 2030 in) the system controller 2017.

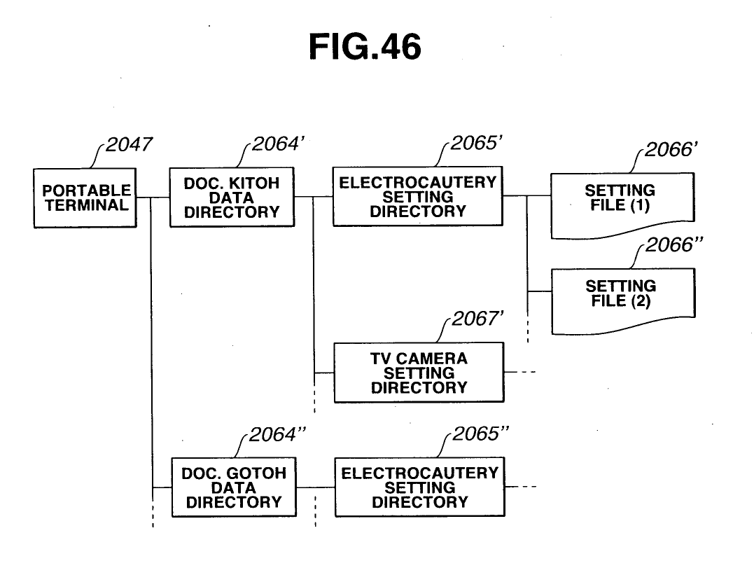

FIG. 46 shows a directory tree structure in a storage means (in practice, a memory) incorporated in the portable terminal 2047.

A Doc. Kitoh data directory 2064′ created in the memory incorporated in the portable terminal 2047 has a plurality of sub-directories such as an electrocautery setting directory 2065′, a TV camera setting directory 2067′, and other medical equipment setting directories. Moreover, the electrocautery setting directory 2065′ contains an electrocautery setting file (1) 2066′ and an electrocautery setting file (2) 2066″. Thus, setting data is preserved in the form of a plurality of files.

Moreover, a Doc. Gotoh directory 2064″ has a sub-directory of an electrocautery setting directory 2065″. Thus, setting data concerning a plurality of pieces of medical equipment is preserved within the Doc. Gotoh directory.

Next, the operations to be exerted by the present embodiment will be described below.

According to the fourteenth embodiment, only one setting data is available for setup of each piece of medical equipment. According to the present embodiment, a plurality of setting data items is available therefor. Any of the data items can be selected.

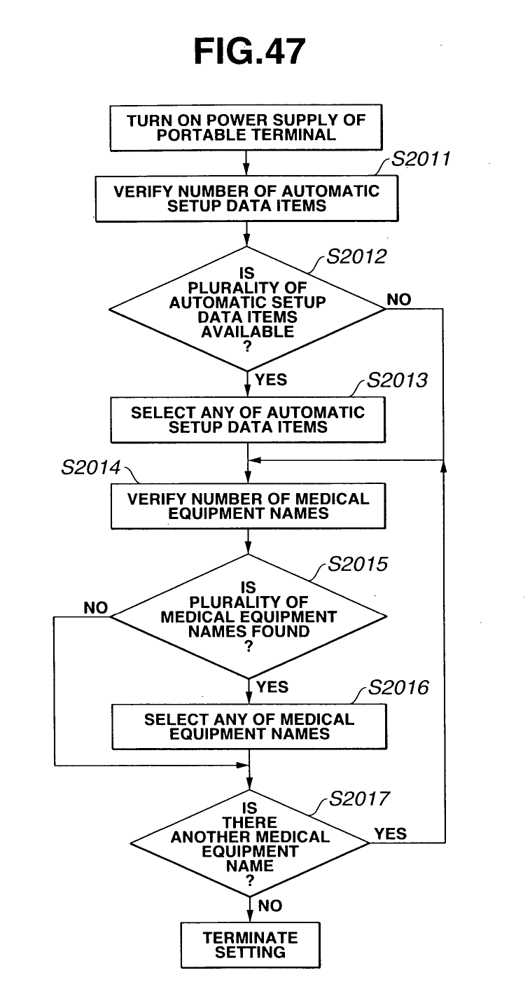

FIG. 47 is a flowchart describing a processing flow of setting data selection to be performed using the portable terminal 2047.

When the power supply of the portable terminal 2047 is turned on, the number of automatic setup data items preserved in the memory in the portable terminal is counted at step S2011. It is then checked if a plurality of automatic setup data items is available (step S2012).

If a plurality of automatic setup data items is available, a verification screen image is displayed in order to verify whichever of the data items is employed. Automatic setup data is designated through the verification screen image (step S2013). If a plurality of setting data items is unavailable, control is passed to step S2014.

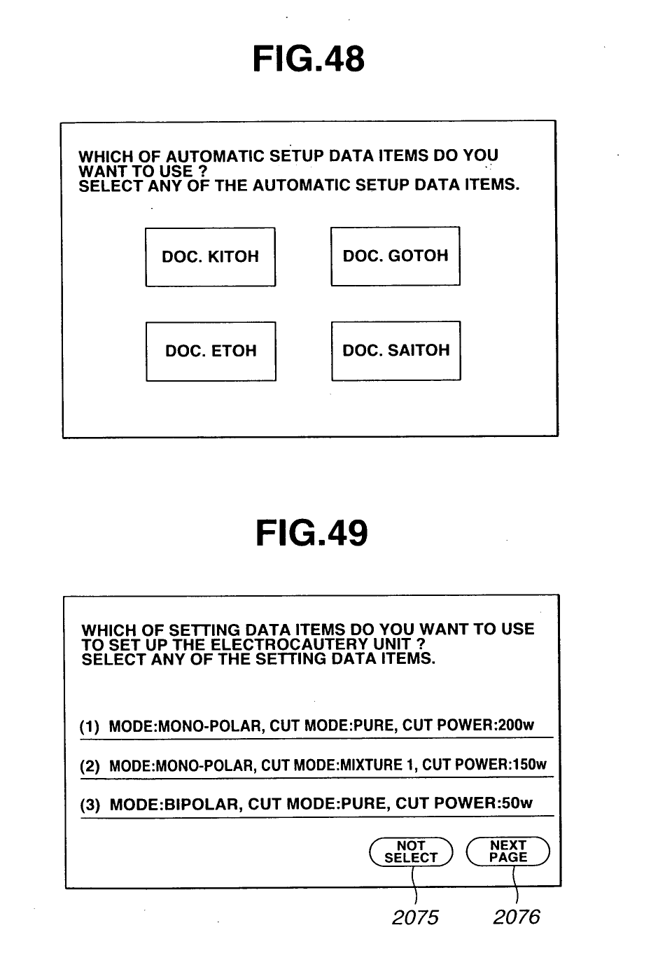

FIG. 48 shows a concrete example of the verification screen image to be displayed when a plurality of automatic setting data items is available. After one automatic setting data is selected through the screen image, the number of data items available for setup of each piece of medical equipment is verified at step S2014.

If a plurality of data items is available for setup of each piece of medical equipment, the verification screen image is displayed in order to verify whichever of the setting data items is employed. A user designates medical equipment data, which he/she wants to employ, through the verification screen image (step S2016). If a plurality of data items is unavailable for setup of medical equipment, the selection need not be performed. Control is then passed to a step of verifying which of data items is employed for the next medical equipment.

FIG. 49 shows a verification screen image to be displayed when a plurality of data items is available for setup of medical equipment that is an electrocautery unit.

Referring to FIG. 49, the number of data items is three. If the number of data items is larger, a Next Page button 2075 in the screen image is pressed in order to switch screen images. If the screen image is not especially needed, a Not Select button 2076 may be pressed.

After data for use in setting up medical equipment is selected at step S2016, it is verified at step S2017 whether another medical equipment name is found.

If another medical equipment name is found, control is returned to step S2014. The processing of step S2014 to step S2016 is repeated. When all medical equipment names have been selected, it is designated that no more medical equipment name is found. Setup to be performed using the portable terminal 2047 is terminated.

The portable terminal 2047 is connected to the system controller 2017 in the operating room, and automatic setup is executed. Consequently, the system controller 2017 reads setting data designated using the portable terminal 2047. The read data is given higher priority over the automatic setting data recorded in the system controller 2017.

The processing flow is nearly identical to the one described in FIG. 41, whereby “PC card” described in FIG. 41 should be read as “portable terminal.” If the same automatic setting data is preserved in the system controller 2017, it is checked whether the preserved data is overwritten with another. If so, the automatic setting data in the system controller 2017 is overwritten with the automatic setting data designated using the portable terminal 2047.

The present embodiment provides the advantage described below.

Any of a plurality of automatic setting data items can be selected, and medical equipment can be set up based on the selected data. A plurality of doctors can use the automatic setting data items while sharing the sole portable terminal 2047. The plurality of automatic setting data items can be used in common.

Moreover, set values can be modified if necessary or according to a technique adopted.

### Sixteenth Embodiment

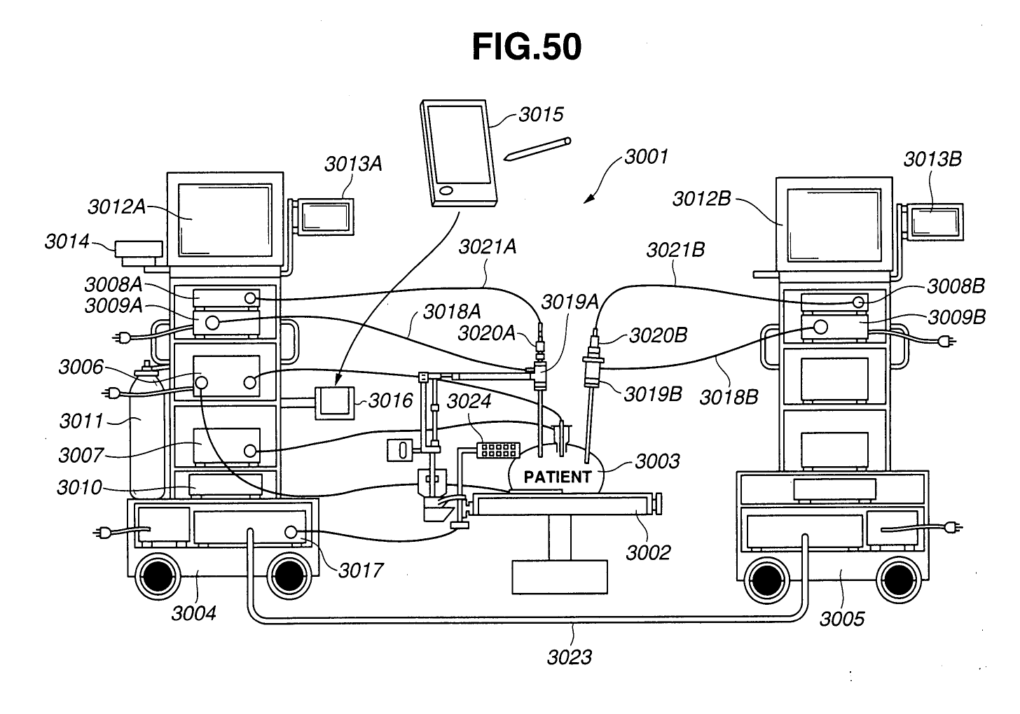

FIG. 50 shows an endoscope system 3001 including a sixteenth embodiment of a control system in which the present invention is implemented. The endoscope system 3001 is constructed by incorporating a group of pieces of medical equipment into a first cart 3004 and a second cart 3005 which are disposed with a patient couch 3002, on which a patient 3 lies down, between them.

Medical equipment, for example, an electrocautery unit 3006, an insufflator unit 3007, an endoscopic TV camera unit (hereinafter abbreviated to a TV camera) 3008A, a light source unit (hereinafter abbreviated to a light source) 3009A, a VTR 3010, and a chemical cylinder 3011 filled with carbon dioxide are integrated into the first cart 3004. Moreover, a TV monitor 3012A or the like on which an endoscopic image or the like is displayed, a centralized display panel 3013A on which every information acquired during surgery can be selectively displayed, and an operator panel 3014 that consists of a display such as a liquid crystal display and touch sensors integrated with the display, and that serves as a centralized operating means to be handled by a nurse or the like in an non-sterilized zone are mounted on the first cart 3004.

Moreover, the first cart 3004 has a PDA slot 3016 in which a general-purpose portable operating terminal, with which the endoscope system can be operated easily, or more particularly, a personal digital assistant (PDA) 3015 can be inserted.

The electrocautery unit 3006, insufflator unit 3007, TV camera 3008A, light source 3009A, and VTR 3010 are connected to a system controller 3017, which is a centralized control means for controlling the entire system provided on the cart 3004, over transmission lines that are not shown.

Moreover, the light source 3009A is connected to a first endoscope 3019A over a light guide cable 3018A over which illumination light is propagated. The illumination light emanating from the light source 3009A is supplied to (a light guide lying through) the first endoscope 3019A. Consequently, an abdominal lesion of the patient 3003 into which the insertion member of the first endoscope 3019A is thrust is illuminated.

A camera head 3020A having an imaging device incorporated therein is mounted on the eyepiece unit of the first endoscope 3019A. An optical image picked up by an observation optical system incorporated in the first endoscope 3019A is converged on the imaging device incorporated in the camera head 3020A, and propagated to the TV camera 3008A over a camera cable 3021A. The resultant signal is processed by a signal processing circuit incorporated in the TV camera 3008A, whereby a video signal is produced and transferred to a TV monitor 3012A. An endoscopic image of the lesion is then displayed on the TV monitor 3012A.

On the other hand, a TV camera 3008B, a light source 3009B, a TV monitor 3012B on which an endoscopic image produced by a TV camera 3000B is displayed, and a second centralized display panel 3013B on which any information acquired during surgery can be selectively displayed are integrated into the second cart 3005.

The light source 3009B is connected to a second endoscope 3019B over a light guide cable 3018B over which illumination light is propagated. The illumination light emanating from the light source 3009B is supplied to the (light guide lying through) second endoscope 3019B. Consequently, an abdominal-lesion of the patient 3003 into which the insertion member of the second endoscope 3019B is thrust is illuminated.

A camera head 3020B having an imaging device incorporated therein is mounted on the eyepiece unit of the second endoscope 3019B. An optical image of the lesion picked up by an observation optical system incorporated in the second endoscope 3019B is converged on the imaging device incorporated in the camera head 3020B, and propagated to the TV camera 3008B over a camera cable 3021B. The resultant signal is processed by a signal processing circuit incorporated in the TV camera 3008B, whereby a video signal is produced and transferred to a TV monitor 3012B. Consequently, an endoscopic image of the lesion is displayed on the TV monitor 3012B.

The TV camera 3008B and light source 3009B are connected to a relay unit 3022, which is mounted in the second cart 3005, over transmission lines that are not shown. The relay unit 3021 and system controller 3017 are connected to each other over a relay cable 3023.

Consequently, the pieces of medical equipment (group of controlled apparatuses) including the TV camera 3008B and light source 3009B mounted in the second cart 3005, the electrocautery unit 3006, insufflator unit 3007, TV camera 3008A, light source 3009A, and VTR 3010 mounted in the first cart 3004 are controlled by the system controller 3017 on a centralized basis.

Moreover, a remote controller 3024 serving as a centralized operating means is disposed near the patient couch 3002, and connected to the system controller 3017 over a transmission line. The remote controller 3024 is used to control or operate various pieces of medical equipment.

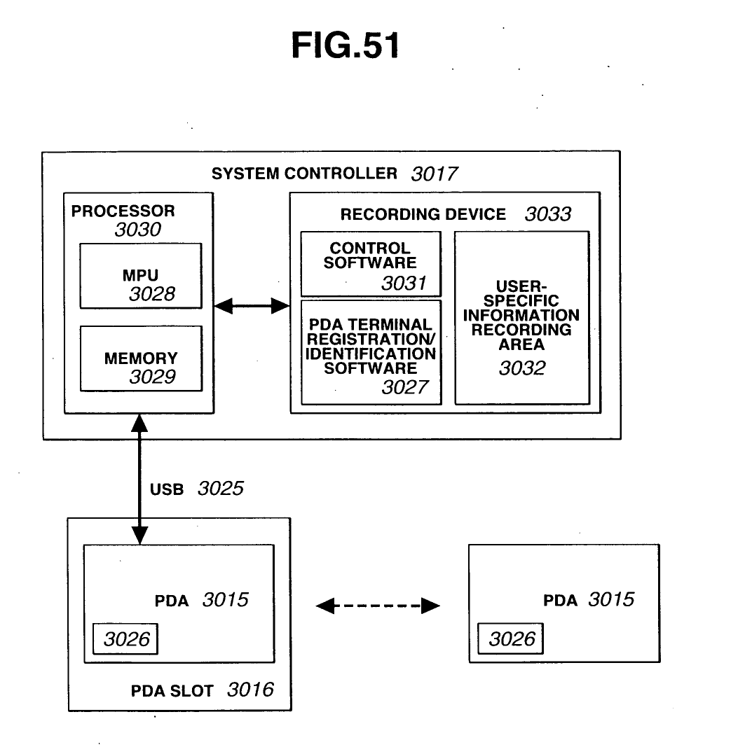

Moreover, the system controller 3017 and PDA slot 3016 are connected to each other over a universal serial bus (USB) 3025 (see FIG. 51). When the PDA 3015 is inserted into the PDA slot 3016, the fact is recognized by a plug-and-play (hereinafter PnP) feature.

When a communication link is established between the system controller 3017 and medical equipment, a setting screen image presenting the set states of pieces of connected medical equipment and operation switches is displayed on the liquid crystal display of the operator panel 3014. A set value can be modified or entered by pressing a predetermined area on the liquid crystal display that is defined as a desired operation switch so as to actuate a touch sensor associated with the area.

Graphical user interface (GUI) software 3026 (see FIG. 51) that helps a user control the endoscope system 3001 easily is installed in the PDA 3015.

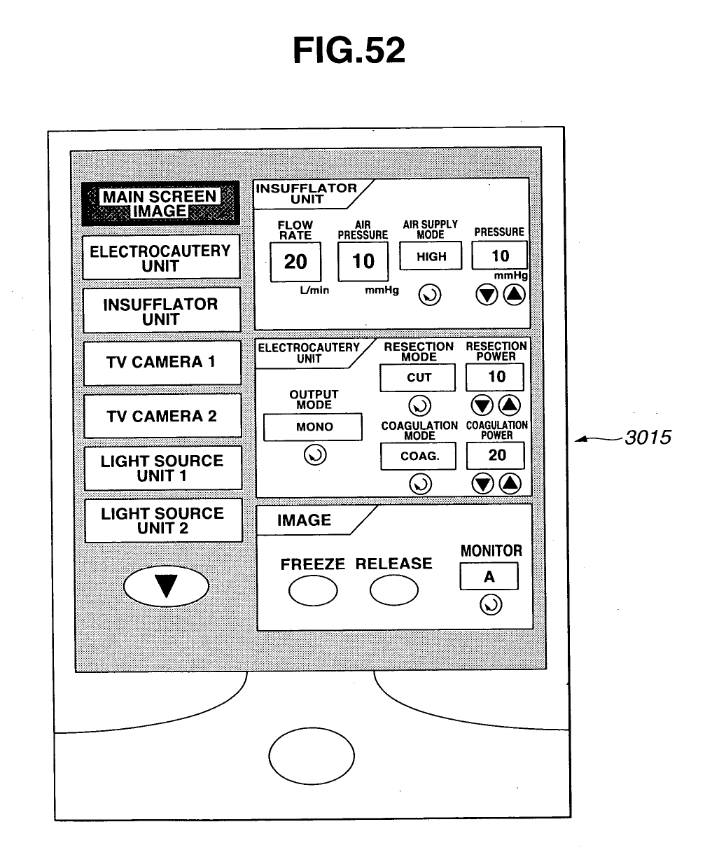

When the identified PDA 3015 has been registered by PDA terminal information registration/identification software 3027 (see FIG. 51) installed in the system controller 3017, if the user has been certified thereby, the pieces of medical equipment can be controlled using graphics displayed on the screen of the PDA 3015 by the GUI software 3026. FIG. 52 shows a main screen image displayed when the PDA 3015 having the GUI software 3026 installed therein is activated.

FIG. 51 schematically shows the internal configuration of the system controller 3017 that has the ability to distinguishes users or terminals. Consequently, identified users or terminals alone are permitted to use the PDA. In other words, a plurality of users can share the PDA.

A processor 3030 including an MPU 3028 that performs various kinds of processing and a memory 29, and a recording device 3033 in which control software 3031 that controls the pieces of medical equipment and software 3027 that registers or identifies terminal information concerning the PDA 3015 are stored are incorporated in the system controller 3017. in the storage device 3033. Moreover, a user-specific information recording area 3032 is defined in the storage device 3033.

According to the present embodiment, (a user is certified and the PDA 3015 is identified so that only a registered user can control the system controller 3017 using only the specified PDA 3015, which will be described later). Besides, the information recording area 3032 specific to each registered user is defined, and users use different information recording areas. Thus, any other user is prevented from modifying setting information or control information, and each user can use the user-designated setting information (or control information).

The system controller 3017 and PDA slot 3016 are connected to each other over a communicating means permitting both transmission and reception, that is, bi-directional communication, for example, over a universal serial bus (USB) 3025. When the PDA 3015 is inserted into the PDA slot 3016, the fact is recognized by the plug-and-play (PnP) feature of the system controller.

If the identified PDA 3015 has been registered by the software 3027 installed in the system controller 3017 (as long as the user has been certified), the pieces of medical equipment can be controlled using the graphics displayed on the screen of the PDA 3015 by the GUI software 3026.

According to the present embodiment, the endoscope system 3001 includes: one or more pieces of medical equipment (medical apparatuses) including the electrocautery unit 3006; the system controller 3017 that controls the medical equipment; a general-purpose portable terminal, for example, the PDA 3015; a communicating means such as the USB 3025 permitting the system controller 3017 and PDA 3015 to communicate with each other; an identifying means (identification software) that identifies the PDA 3015 and user that are permitted to communicate with the system controller 3017; the PDA software 3026 needed to control the system controller 3017; and the processor 3030 including the MPU 3028 that serves as a recording area control means so as to control a storage area in the recording device 3033. Consequently, only when a specific user having been registered uses the registered specific PDA 3015, the user can operate the medical equipment. Moreover, a storage area is allocated to each user so that a user can record setting information in his/her allocated storage area. Thus, the setting information is protected from being updated by any other user.

Moreover, the general-purpose PDA 3015 is used to control the system controller 3017. A user can select a display format most suitable for information to be transferred to the PDA.

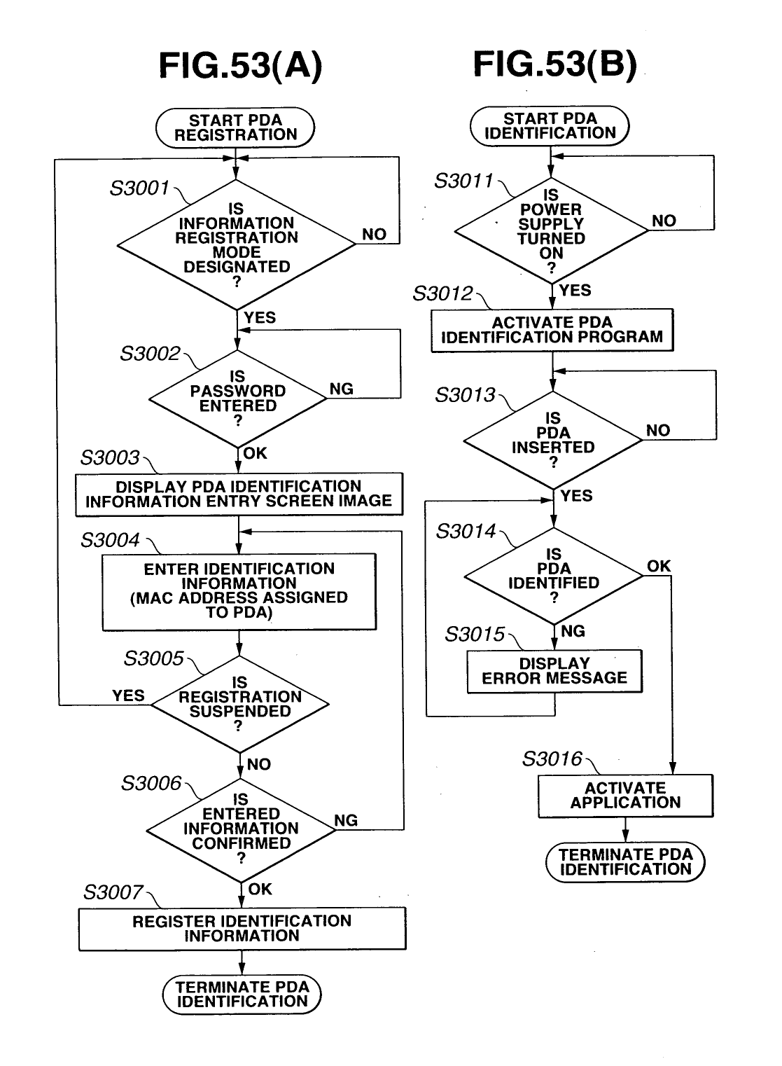

FIG. 53A and FIG. 53B are flowcharts describing registration and identification to be performed by the software 3027 for registering or identifying information preserved in the PDA 15. First, the method of registering information in the PDA 3015 will be described with reference to FIG. 53A.

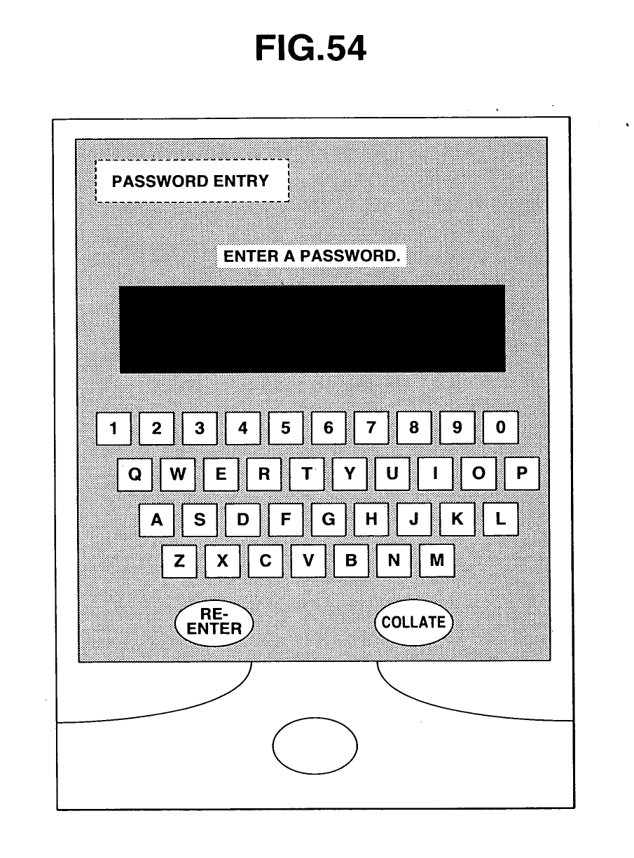

The PDA 3015 having been registered in the system controller 3017 is prepared and inserted into the PDA slot 3016. The GUI software 3026 is used to select an information registration mode (step S3001), whereby a password entry screen image shown in FIG. 54 appears.

The password entry screen image presents a prompt for prompting a user to enter a password. A user-specific password is then entered along with the prompt (step S3002).

A keyboard displayed below the prompt is used to enter the user-specific password. When a Collate button is pressed, the entered password is collated with a stored one. If a user fails to remember the password, the user cannot newly register information using the PDA 3015.

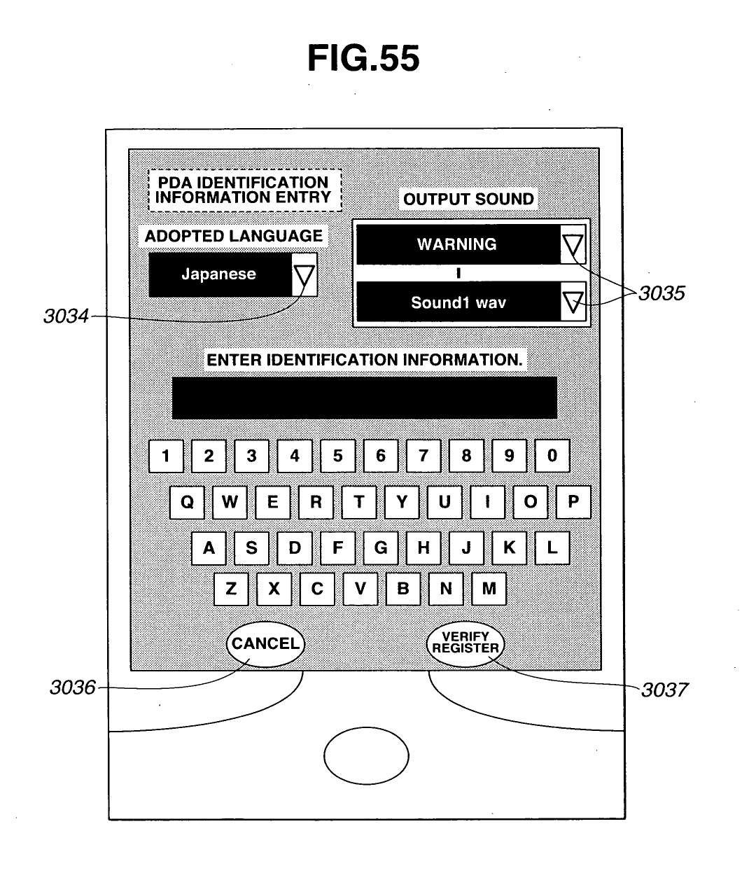

If the entered password is collated with the stored one, the collation is completed. An identification information entry screen image prompting the user to enter identification information concerning the PDA 3015 that is a portable terminal is displayed as shown in FIG. 55 (step S3003). A prompt prompting the user to enter the identification information concerning the PDA 3015 that is actually used appears. The user then enters the identification information (step S3004). Herein, for example, a MAC address specific to each PDA 3015 is entered as the identification information.

At the same time, a language in which a message is written when the PDA 3015 to be registered is inserted is registered in an adopted language selection field 3034. A sound to be generated when the registered PDA 3015 is inserted is registered in an output sound field 3035. Thus, information display and sound generation are achieved as a user likes irrespective of the hardware performance of the system controller 3017.

After or before an entry is made, a Cancel button 3036 is pressed in order to cancel registration. When the Cancel button 3036 is pressed, control is returned to step S3001 (step S3005). After identification information is entered and an adopted language is selected, if a Verify Register button 3037 is pressed, a registration verification screen image appears (step S3006). If a user is satisfied with the contents of the screen image, identification information registration is completed (step S3007). If the user is dissatisfied with the contents of the screen image, control is returned to step S3004. Identification information is re-entered. Thus, identification information of the PDA 3015 can be registered.

Incidentally, after the PDA 3015 is identified, the user may be certified.

Next, PDA identification will be described in conjunction with FIG. 53B.

When the power supply of the system controller 3017 is turned on (step S3011), a PDA terminal identification program that is part of the PDA terminal registration/identification software 3027 is activated at step S3012. It is judged at step S3013 whether the PDA 3015 has been inserted in the PDA slot 3016. If not, the system controller waits until the PDA is inserted into the PDA slot.

When the PDA 3015 is inserted into the PDA slot 3016, identifying the PDA 3015 is carried out (step S3014). A user enters a password and PDA identification information. If they are incorrect, an error message is displayed (step S3015) and control is returned to step S3014. A correct password and correct PDA identification information are entered again.

After a correct password and correct PDA identification information are entered, an application installed in the PDA 3015 is activated at step S3016. Consequently, setting information (or control information) can be transmitted or received to or from the system controller 3017, and the pieces of medical equipment can be controlled or operated. The PDA identification is then completed.

FIG. 52 shows a screen image displayed with an application activated. The names of pieces of medical equipment connected to the system controller 3017, such as, the names of the electrocautery unit 3006 and TV camera 3008A (TV camera 3001 in FIG. 52) are displayed so that the pieces of medical equipment can be controlled.

For example, when the name of the electrocautery unit 3006 is selected, the set state of the electrocautery unit 3006 and other information can be received from the system controller 3017. Moreover, the set state of the electrocautery unit 3006 can be presented through the screen image displayed on the PDA 3015. An instruction indicating that setting information should be modified may be issued from the PDA 3015 and transmitted to the system controller 3017. Thus, the state of the electrocautery unit 3006 or the like can be changed or the operation thereof can be controlled.

The contents of display can be made independent of the system controller 3017, or in other words, can be made user-specific. A user can determine the contents of display as he/she likes.

Moreover, various pieces of medical equipment can be set up, and the setting information or control information can be recorded. In this case, the information is recorded in a storage area specific to each other (more particularly, in the user-specific information recording area 3032 shown in FIG. 51) in the recording device 3033 included in the system controller 3017. Consequently, setting information or control information can be reliably protected from being modified by any other user.

Specifically, each user can repeatedly use information which the user has determined and recorded. Thus, a user-friendly environment can be provided.

The present embodiment provides the advantages described below.

As mentioned above, according to the present invention, only a user whose name has been registered (certified) can transfer setting information (or control information) to or from the system controller 3017 using a portable terminal whose name has been registered. This results in a user-friendly system. Moreover, a recording area in which setting information (or control information) concerning the system 1 is recorded is allocated to each certified user. Consequently, the setting information (or control information) determined by each user can be reliably protected from being modified by any other user.

Moreover, using software installed in a portable terminal, with no restrictions imposed by software installed in the system 1, a user can modify or select visual information to be displayed on the portable terminal or audio (sounds) information according to his/her likes. Thus, a user-friendly system is realized.

According to the present embodiment, the PDA slot 3016 and system controller 3017 are connected to each other over the USB bus 3025. Alternatively, a LAN, an IEEE1394 bus, or any other communicating means will do.

Moreover, a MAC address is adopted as identification information of the PDA 3015. Alternatively, a serial number will do.

According to the present embodiment, a recording area in which setting information is recorded is different from user to user. Alternatively, certified users may be allowed to freely use predetermined reference setting information.

Specifically, a certified user can use, in addition to his/her designated information, reference setting information to set up medical equipment. In this case, users can enjoy freedom in selection. Alternatively, medical equipment may be reset to operate based on the reference setting information.

### Seventeenth Embodiment

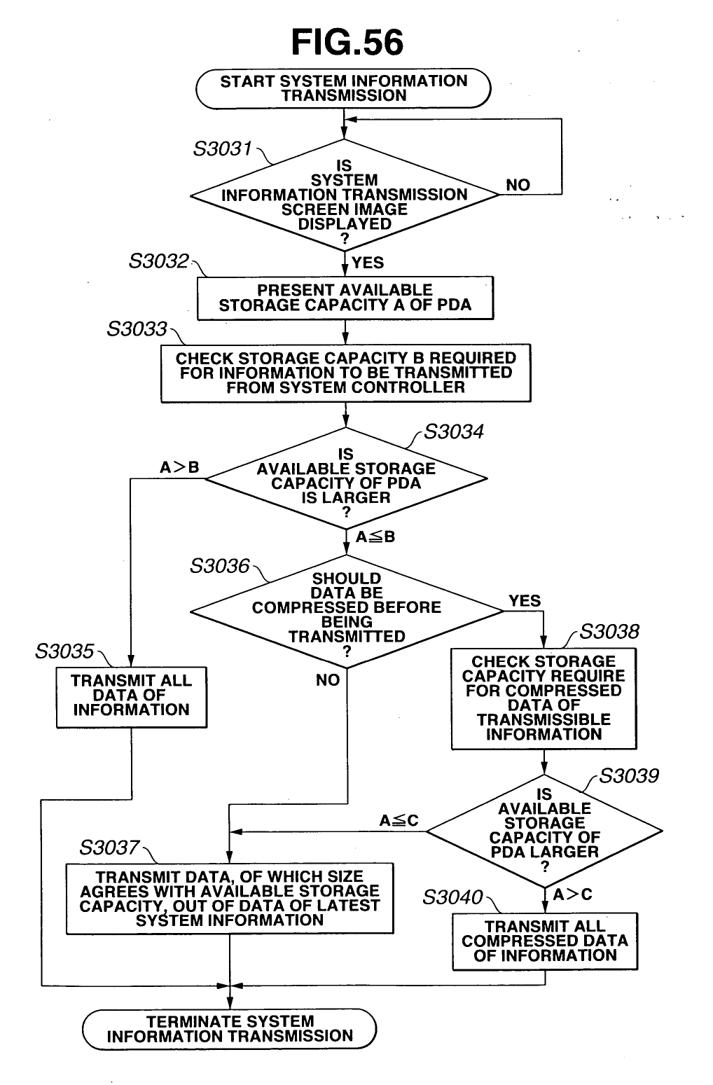

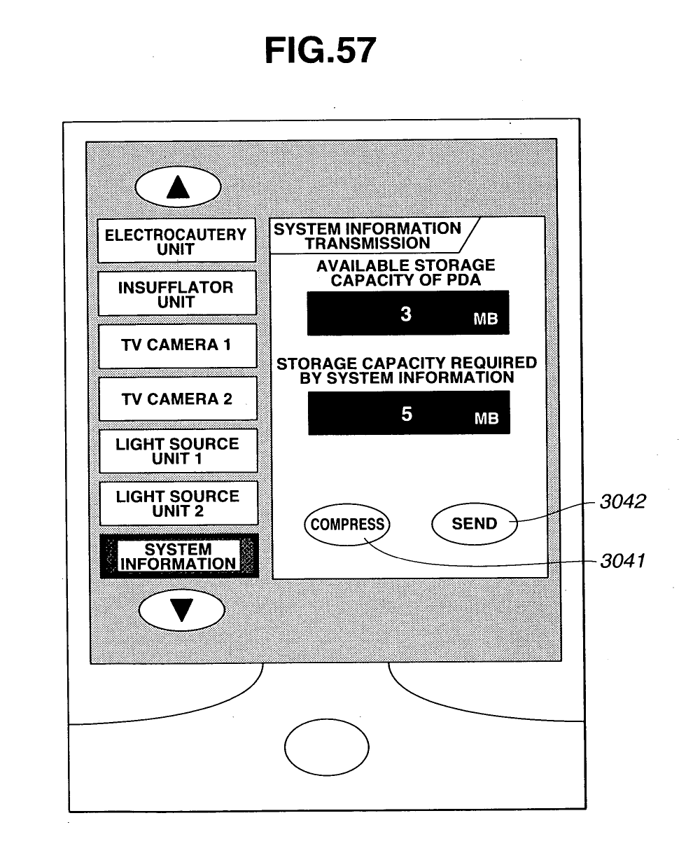

Next, a seventeenth embodiment of the present invention will be described with reference to FIG. 56 and FIG. 57. An endoscope system including the present embodiment has the same configuration as the one shown in FIG. 50. The same reference numerals will be assigned to components identical to those described in relation to the sixteenth embodiment.

According to the present invention, when the PDA 3015 is used to operate medical equipment, system information can be readily transmitted from the system controller 3017 to the PDA 3015 according to an available storage capacity offered by the PDA 3015.

What is referred to as system information refers to a user's history concerning operation of the endoscope system 3001, hardware failure information of each controlled apparatus, error information stemming from communication with the system controller 3017 or interlocking between controlled apparatuses, or a TV camera image to be displayed with occurrence of an error.

Next, system information transmission will be described with reference to the flowchart of FIG. 56.

To begin with, when system information must be transmitted from the system controller 3017 to the PDA 3015, the GUI software 3027 is used to select a system information transmission screen image (FIG. 57) (step S3031).

When the screen image is selected, the PDA 3015 analyzes the available storage capacity A of the recording device included in the PDA 3015, and presents the storage capacity through the system information transmission screen image (FIG. 57) (step S3032). At the same time, the system controller 3017 analyzes the storage capacity B occupied by system information in the own recording device 3033, and presents the storage capacity through the system information transmission screen image for verification (FIG. 57) (step S3033).

It is then judged whether the available storage capacity A of the recording device 3033 included in the PDA 3015 is larger than the storage capacity B required by system information (step S3034). In the example shown in FIG. 57, the storage capacity B required by system information is larger than the available storage capacity A of the recording device 3033 included in the PDA 3015.

If the available storage capacity A of the PDA 3015 is larger than the storage capacity B required by system information (namely, A>B), a Compress Info. button 3041 is not presented through the system information transmission screen image shown in FIG. 57 but only a Send Info. button 3042 is presented. When the Send Info. button 3042 is pressed, information is entirely transmitted (step S3035).

If the available storage capacity A of the PDA 3015 is equal to or smaller than the storage capacity B required by system information (namely, A≦B), the Compress Info. button 3041 is presented. In this state, the system controller 1307 judges whether compression and transmission is instructed (step S3036).

When the Compress Info. button 3041 is not pressed but the Send Info. button 3042 is pressed, the system controller 3017 transmits data, of which size agrees with the available storage capacity of the PDA 3015, out of data representing the latest system information (step S3037).

On the other hand, if the Compress Info. button 3041 is pressed, the system controller 3017 compresses the data representing system information, analyzes a storage capacity C required by the compressed data, updates the contents of the system information transmission screen image (FIG. 57), and compares the storage capacity C with the storage capacity A (step S3038).

It is then judged whether the available storage capacity A of the recording device 3033 included in the PDA 3015 is larger than the storage capacity C required by compressed data of system information (step S3039).

If the available storage capacity A of the PDA 3015 is larger than the storage capacity C required by the compressed data of system information (namely, A>C), all the compressed data of system information is transmitted (step S3040).

On the other hand, if the available storage capacity A of the PDA 3015 is equal to or smaller than the storage capacity C required by the compressed data of system information (namely, A≦C), a message saying that even compressed data cannot be entirely preserved in the PDA 3015 is displayed through the system information transmission screen image (FIG. 57). The system controller 3017 transmits data, of which size agrees with the available storage capacity of the PDA 3015, out of the data representing the latest system information.

Thereafter, medical equipment can be controlled or operated using the PDA 3015.

According to the present embodiment, whether data is compressed depends on a user. Alternatively, software may be installed so that the system controller 3017 autonomously makes a judgment.

Specifically, the endoscope system consists mainly of: at least one equipment; the system controller 3017 that controls the equipment; a general-purpose portable terminal; a communicating means that permits communication between the system controller 3017 and the portable terminal; the portable terminal software 3026 needed to control the system controller 3017; a system information recording means in which system information is recorded and that is included in the system controller 3017; an information verifying means that verifies what the storage capacity of the portable terminal is and that is included in the system controller 3017; and a transmitting means that autonomously selects and transmits output information according to the storage capacity information verified by the information verifying means. Consequently, even if the storage capacity of the portable terminal is smaller than the storage capacity required by system information, the time-consuming work of selecting data to be transmitted to the portable terminal need not be carried out. The system information can be readily transmitted to the portable terminal.

Incidentally, system information may be automatically or manually transmitted based on a user-designated mode.

The present embodiment provides the advantages described below.

The present embodiment can provide the same advantages as the advantages provided by the sixteenth embodiment. In addition, when system information has to be transmitted to a terminal, it can be transmitted through simple handling. Moreover, whether data is compressed may not depend on a user's choice. If the system controller 3017 is designed to autonomously judge whether data should be compressed, the system information can be transmitted more readily.

### Eighteenth Embodiment

(Features)

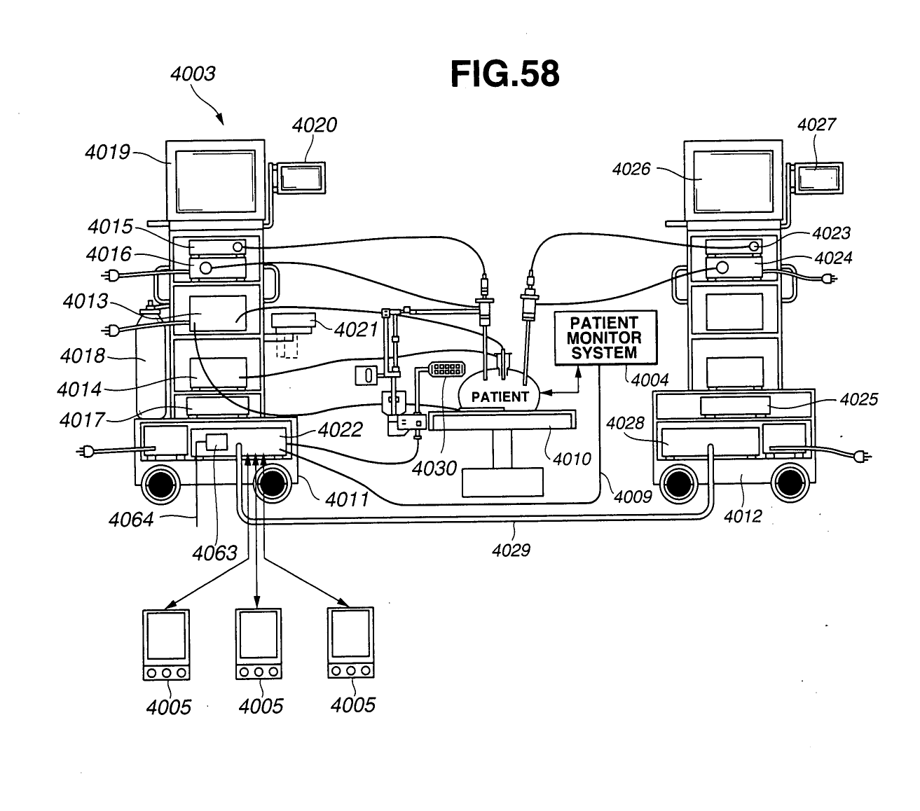

As shown in FIG. 58, a patient couch 4010 on which a patient lies down and an endoscopic surgery system 4003 are placed in an operating room 4002. The endoscopic surgery system 4003 includes a first cart 4011 and a second cart 4012. Peripheral equipment that is medical equipment, such as, an electrocautery unit 4013, an insufflator unit 4014, an endoscopic camera unit 4015, a light source unit 4016, a VTR 4017, and a chemical cylinder 4018 filled with carbon dioxide are integrated into the first cart 4011. These equipment pieces may be represented by peripheral equipment 4006, as described later.

Furthermore, a display device 4019 on which an endoscopic image is displayed, for example, a TV monitor, a centralized display panel 4020 on which every information acquired during surgery can be selectively displayed, and an operator panel 4021 that is composed of a display, for example, a liquid crystal display, and touch sensors integrated with the display and that is handled by a nurse or the like in a non-sterilized zone are mounted on the first cart 4012.

Furthermore, a centralized controller 4022 that is a centralized control means for controlling the entire system is mounted in the first cart 4011. The electrocautery unit 4013, insufflator unit 4014, endoscopic camera unit 15, light source unit 4016, and VTR 4017 are connected to the centralized controller 4022 over transmission lines that are not shown. A communication control module (hereinafter an interface 4063) is incorporated in the centralized controller 4022, and connected to interfaces 4063 of the pieces of peripheral equipment over communication cables 4064.

On the other hand, an endoscopic camera unit 4023, a light source unit 4024, and an image processing unit 4025, a display device 4026 on which an endoscopic image picked up by the endoscopic camera unit 4023 is displayed, and a second centralized display panel 4027 on which every information acquired during surgery can be selectively presented are integrated into the second cart 4012.

The endoscopic camera unit 4023, light source unit 4024, and image processor 4025 are connected to a relay unit 4028, which is mounted in the second cart 4012, over transmission lines that are not shown. The centralized controller 4022 is connected to the relay unit 4028 over a relay cable 4029.

The centralized controller 4022 controls on a centralized basis the camera unit 4023, light source unit 4024, and image processing unit 4025 which are integrated into the second cart 4012, the electrocautery unit 4013, insufflator unit 4014, camera unit 4015, light source unit 4016, and VTR 4017 which are integrated into the first cart 4011.

When communication links are established between the centralized controller 4022 and the above pieces of equipment, a setting screen image presenting the set state of each piece of connected equipment and operation switches is displayed on the liquid crystal display of the operator panel 4021. A set value can be modified or entered by touching a predetermined area on the liquid crystal display that is defined as a desired operation switch so as to actuate a touch sensor associated with the predetermined area.

A remote controller 4030 is a second centralized controller which an operator in a sterilized zone handles. When the communication links are established, the remote controller 4030 is used to operate the other pieces of equipment via the centralized controller 4022. Moreover, a plurality of mobile devices 4005 can be connected to the centralized controller 4022. The mobile device 4005 has the capabilities of both the operator panel 4021 and display panel 4020. Furthermore, a patient monitor system 4004 that measures biomedical information concerning a patient is included.

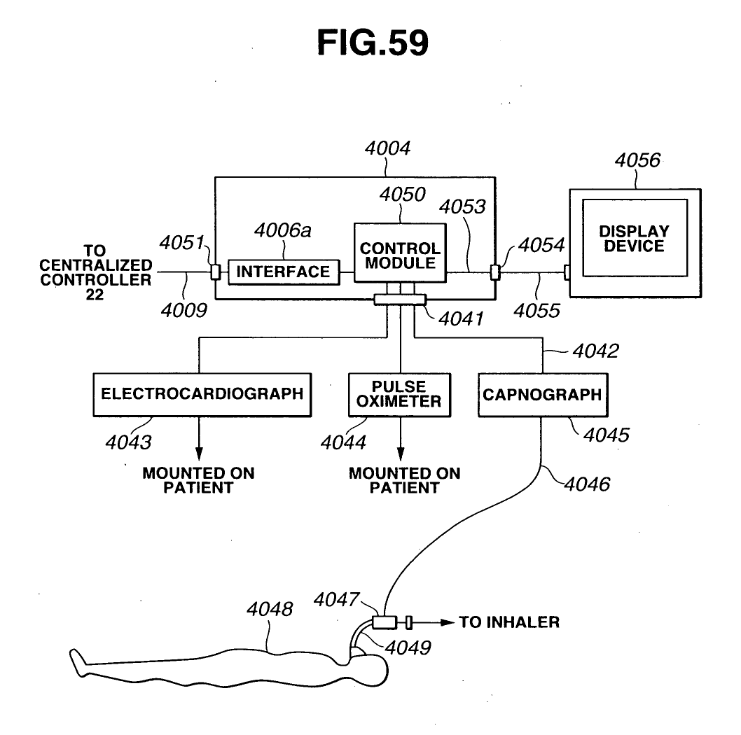

As shown in FIG. 59, the patient monitor system 4004 to be used in combination with the present embodiment has a signal connector 4041. The patient monitor system 4004 is connected to vital sign measuring instruments such as an electrocardiograph 4043, a pulse oximeter 4044, and a capnograph 4045 over cables 4042.

The capnograph 4045 is connected to a breath sensor 4047 over a cable 4046. The breath sensor 4047 is coupled to a hose 4049 extending from an inhaler mounted on a patient 4048. Consequently, an electrocardiogram, a blood oxygen saturation, a breath carbonic dioxide concentration, and other biomedical information concerning the patient 4048 can be measured.

The signal connector 4041 is electrically connected to a control module 4050 incorporated in the patient monitor system 4004. Moreover, the control module 4050 is connected to the display device 4056 by way of a video signal line 4053, a connector 4054, and a cable 4055. Furthermore, the control module 4050 is electrically connected to a communication control module (hereinafter, interface) 4006a. The interface 4006a is connected to a communication control module (hereinafter interface) 4008 (not shown) incorporated in the centralized controller 4022 through a communication connector 4051 according to a communication technique using a LAN.

The LAN on which the interface 4008 is connected may be a network on which equipment is interconnected through RS-232C interfaces or over a USB bus or a wireless network conformable to the IrDA or Bluetooth standard.

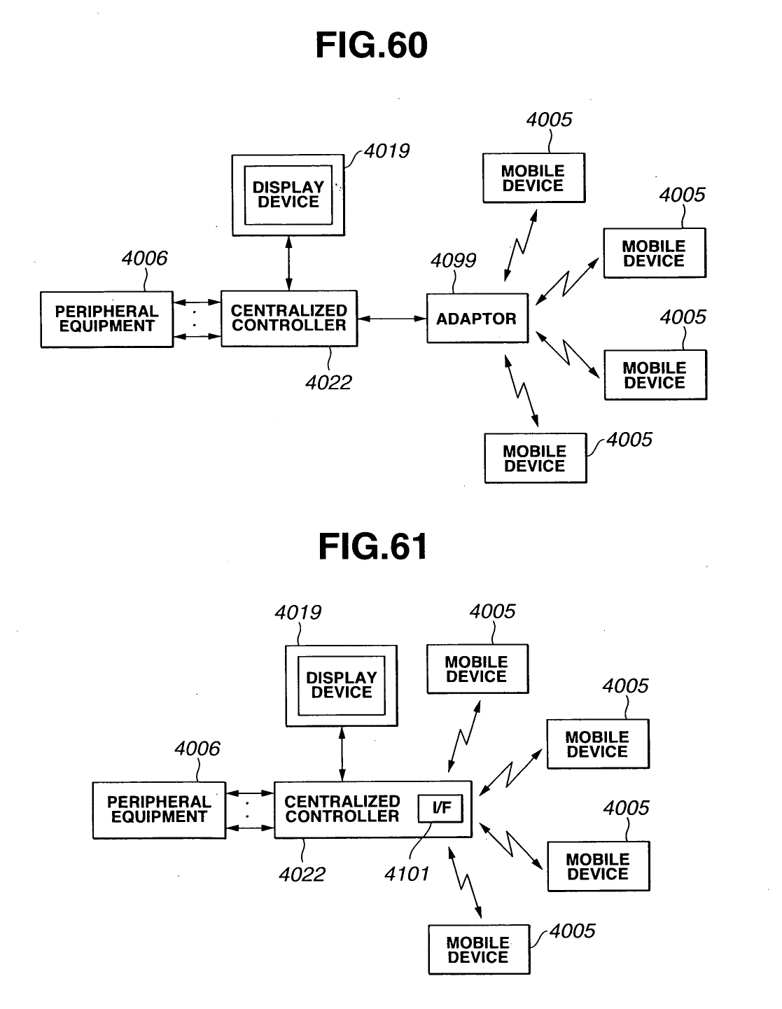

FIG. 60 is a simplified block diagram showing the endoscopic surgery system 3. An adaptor 4099 serially communicates with the centralized controller 4022. The centralized controller 4022 communicates with the plurality of mobile devices 4005(1), 4005(2), 4005(3), and 4005(4) via the adaptor 4099 according to the Bluetooth standard.

As shown in FIG. 61, a Bluetooth communication interface 4101 may be incorporated in the centralized controller 4022 so that the centralized controller 4022 can manage all controlled apparatuses. Even when the configuration shown in FIG. 61 is adopted, the same advantages as the advantages of the present embodiment can be made available. Moreover, the endoscope surgery system can be designed more compactly.

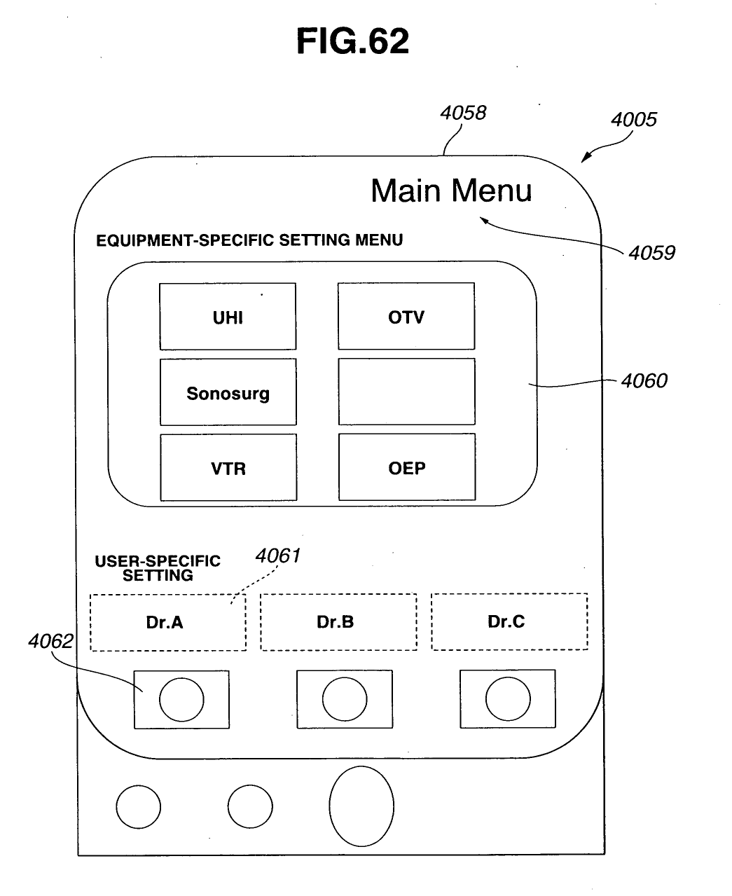

FIG. 62 shows a screen image displayed on the mobile device 4005 described in conjunction with FIG. 58. The mobile device 4005 has an operator panel 4058 on which a peripheral equipment-specific setting menu 4060 is displayed as part of a main menu screen image 4059. The peripheral equipment-specific setting menu 4060 permits a user to select a menu item bearing a peripheral equipment name so that a command screen image through which the user can remotely control the peripheral equipment can be displayed. Peripheral equipment setting information stored in a memory, which is included in the mobile device 4005 and is not shown, can be all transmitted to the centralized controller 4022. At this time, the information is serially transmitted in reality, or more particularly, the information is transmitted in succession in response to one command. Moreover, the main menu screen image 4059 contains user-specific setting fields 4061 and command buttons 4062 each of which is pressed in order to change the main menu screen image to an image permitting a user to verify the contents of storage.

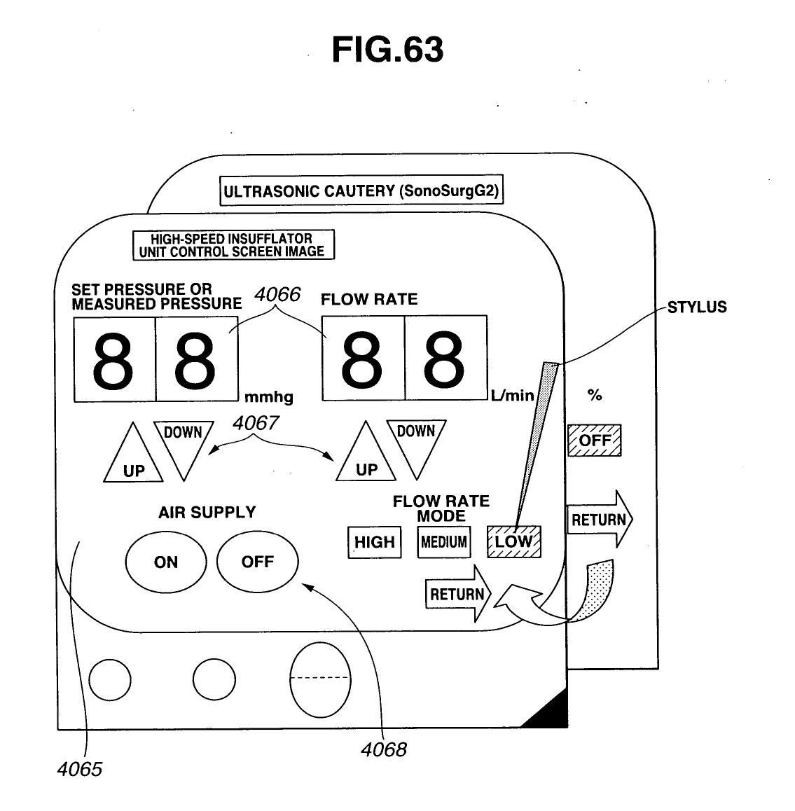

FIG. 63 shows a monitor screen image 4065 displayed when the insufflator unit 4014 is designated through the peripheral equipment-specific setting menu 4060. The insufflator unit is indicated as UHI in FIG. 62. At this time, the monitor screen image 4065 contains, as shown in FIG. 63, Up and Down command buttons 4067 to be used to determine a set value of a pressure in the abdominal cavity and a set value of a flow rate, a flow rate set value indicator 4066, and On and Off command buttons 4068 to be used to enable or disable air supply.

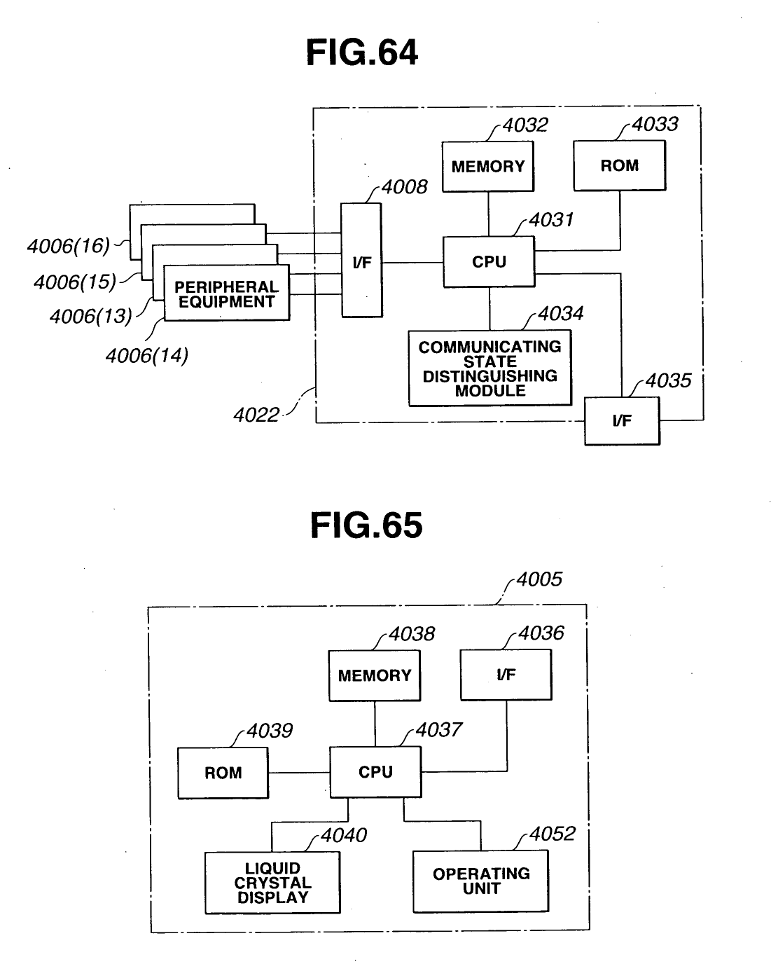

As shown in FIG. 64, the centralized controller 4022 consists mainly of: a serial communication interface 4008 via which the centralized controller 4022 communicates with the peripheral equipment 4006 such as the insufflator unit 4014 and light source unit 4016 according to the RS-232C standard in the present embodiment; a CPU 4031 that is a control module and controls on a centralized basis communications with the pieces of peripheral equipment; a data storage memory 4032 in which control data to be transmitted to the pieces of peripheral equipment is stored; a ROM 4033 in which operating programs describing instructions based on which the CPU 4031 operates are stored; a communication interface 4035 via which the centralized controller 4022 communicates with the mobile devices 4005; and a communicating state distinguishing module 4034 that monitors the communicating states of controlled apparatuses communicating with the centralized controller 4022.

The foregoing communications of the centralized controller 4022 with the pieces of equipment may be wire communications including serial communication conformable to the RS-232C standard, parallel communication, and communication over a LAN, or wireless communication conformable to the Bluetooth standard or IrDA standard, or over a wireless LAN.

As shown in FIG. 65, the mobile device 4005 consists mainly of: a communication interface (hereinafter I/F 4036) through which the mobile device 4005 communicates with the centralized controller 4022 by wireless; a CPU 4037 that is a control module and controls communications on a centralized basis; a memory 4038 in which data is stored; a ROM 4038 in which operating programs describing instructions based on which the CPU 4037 operates are stored; a liquid crystal display unit 4040 having a panel thereof touched in order to issue a command; and an operating unit 52 used to enter a command or the like. The operating unit 4052 is composed of, in practice, for example, the peripheral equipment-specific setting menu 4060, user-specific setting fields 4061, and command buttons 4062 contained in the main menu screen image 4059 shown in FIG. 62.

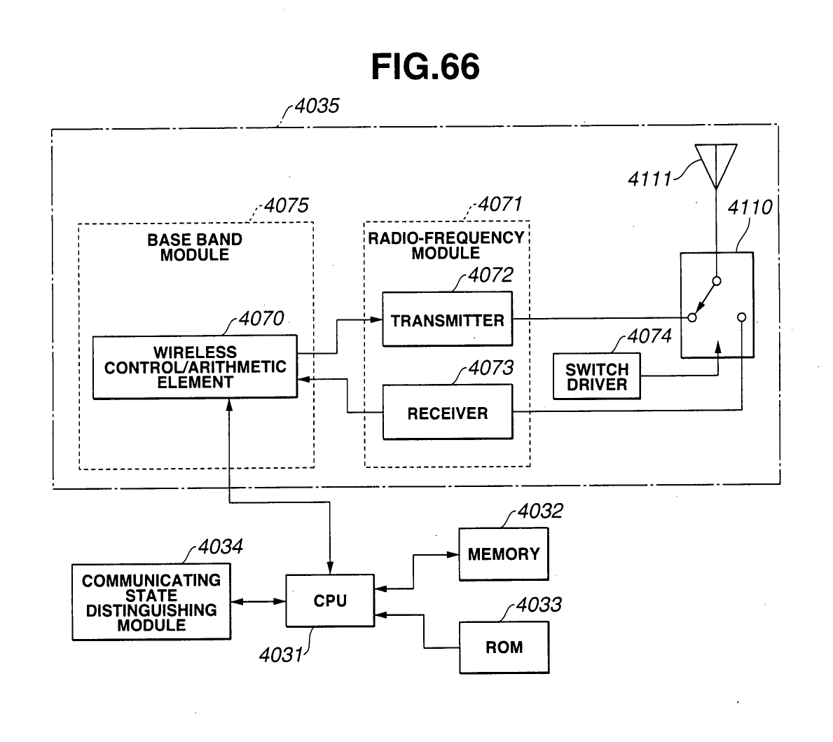

Referring to FIG. 66, the interface 4035 of the centralized controller 4022 consists mainly of: radio-frequency module that transmits or receives feeble signals whose frequencies fall within a broad band; a base band module 4075 that is a narrow-band module for controlling the radio-frequency module 4071 or managing data; a switch driver 4074 that switches transmission and reception; a switch 4110; and an antenna 4111.

The base band module 4075 includes a wireless control/arithmetic element 4070 formed with a control/arithmetic processor that processes a signal digitized by the radio-frequency module 4071. The base band module 4075 can transfer a signal to or from the centralized control CPU 4031 included in the centralized controller 4022.

A transmitter 4072 included in the radio-frequency module 4071 is composed of a D/A converter, a frequency modulator, a low-pass filter, and a power amplifier which are not shown. The transmitter 4072 has the ability to perform frequency hopping on digital information sent from the base band module 4075 or to control transmission power. Incidentally, the frequency hopping is a form of modulation in which modulated frequencies are quickly hopped or switched in order to skip data. A receiver 4073 included in the radio-frequency module 4071 is composed of a frequency modulator, a frequency-hopping control element, and a filter. The receiver 4073 correlates a frequency-hopping signal with a signal sent from the mobile device 4005 or demodulates a signal.

If communication data is lost, retransmission or the like is carried out. The switch driver 4074 switches transmission and reception, and a radio signal is originated or terminated from or at the antenna. The wireless control/arithmetic element 4070 performs arithmetic operations on a signal to be transmitted by the transmitter 4072 or a signal received by the receiver 4073. Moreover, since wireless communication is carried out. Therefore, a processing time varies depending on a level of communication sensitivity and an amount of data.

The interface 4036 included in the mobile device 4005 has the base band module 4075, radio-frequency module 4071, and transmitting/receiving antenna 4111, though these components are not shown.

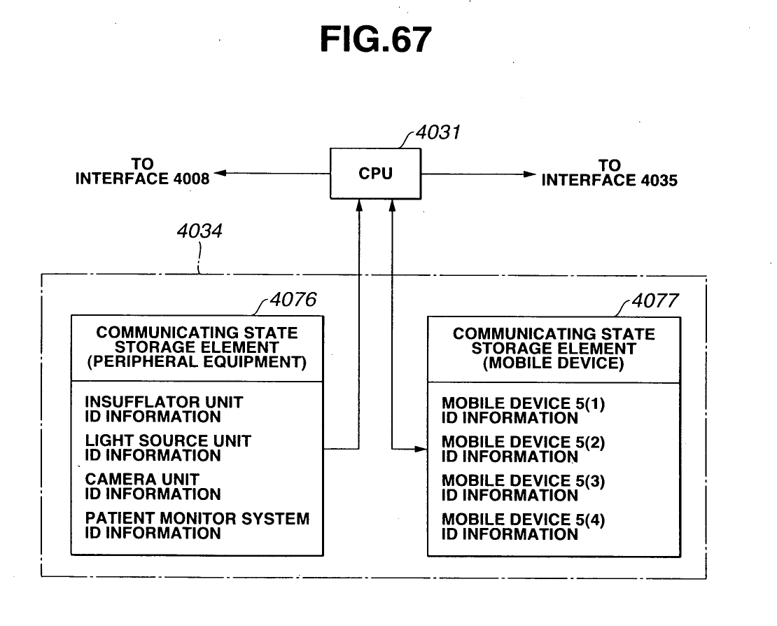

Referring to FIG. 67, the communicating state distinguishing module 4034 includes a communicating state storage element 4076 in which equipment distinguishing identifiers (IDs) assigned to the plurality of pieces of peripheral equipment, and the communicating states of the peripheral equipment, that is, communication information are stored and monitored all the time, and a communicating state storage element 4077 in which equipment distinguishing IDs assigned to the plurality of mobile devices 4005 and the communicating states of the mobile devices, that is, communication information are stored and monitored. The communicating state distinguishing module 4034 controls monitoring, regular data updating, communication control, and a communication data flow.

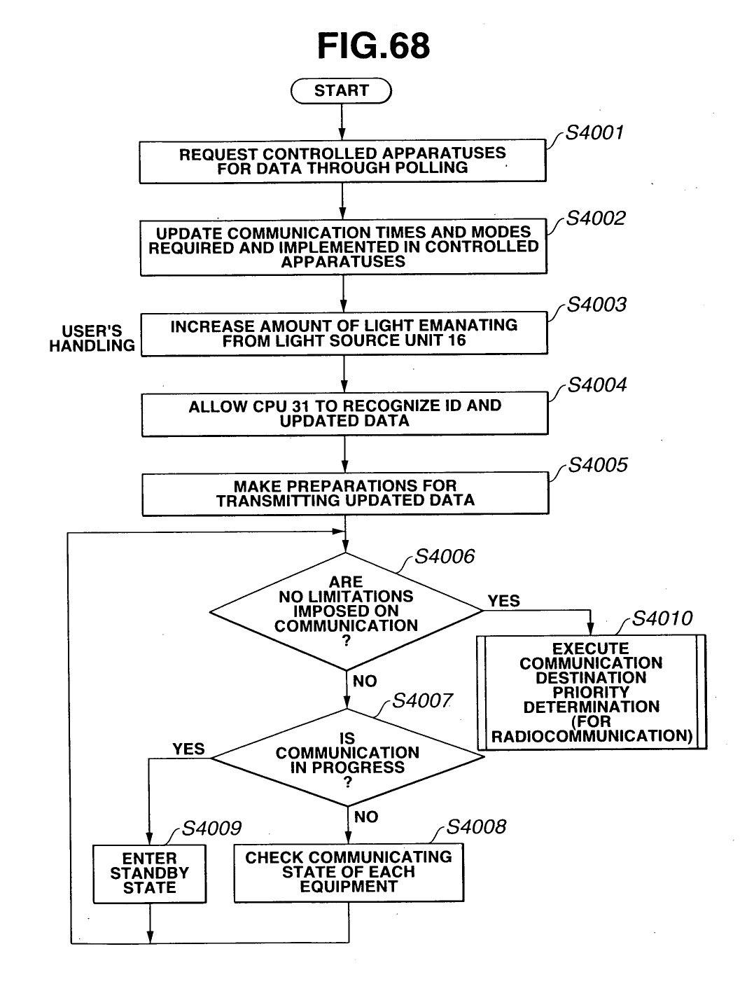

According to the present embodiment, the actions of the CPU 4031 are all directed by software. For example, when a touch-sensitive panel or the like is controlled in order to manipulate image data as described in the flowcharts of FIG. 68 to FIG. 71, if the frequency band the CPU 4031 can treat is defined as a megahertz band in the specifications for the CPU, the CPU 4031 has to incur a heavy load. Unless a CPU produced based on sophisticated specifications is adopted, it is hard for one CPU to monitor data stored in the communication storage elements while communicating with the plurality of controlled apparatuses.

Preferably, a device developed in efforts to process in real time data that is transferred at a high transfer rate by a digital signal processor (DSP) or the like is adopted in order to perform high-speed processing as another routine. The processing the DSP can perform is simpler than the one the CPU 4031 can. However, since the present invention requires a high speed, the adoption of the DSP may be preferable.

More preferably, communication limitations are imposed by hardware but not by the CPU 4031. During data transfer, the DSP detects the fact that data transfer is in progress, and produces a timing signal, which determines the timing of a communication control module realized with hardware, synchronously with a triggering signal that triggers the action of the DSP.

Moreover, a timing generator is preferably included for better control of the endoscopic surgery system. The timing generator includes a system clock that is not shown and that produces clock pulses as reference timing pulses, and synchronizes processing steps with the clock pulses. How communication limitations are imposed and how data transfer is carried out need not be mentioned and will therefore not be described in conjunction with drawings.

In the present embodiment, the CPU 4031 extends control to synchronize measured information or setting information and internal data in real time. For this purpose, the same data must be preserved among the peripheral equipment, centralized controller 4022, and mobile devices 5. Otherwise, the centralized controller 4022 must poll the peripheral equipment and mobile devices 5.

What it says that a communicating state is monitored in the present embodiment, it means that whether a communication failure has occurred, whether communication is enabled, or whichever of Bluetooth modes is designated. What is referred to as communication information is information based on which data preserved in the insufflator unit 4014, that is equipment whose data should be updated rather frequently, is updated as a top priority, or information based on which the priority given to the light source unit 16 in which no measured data is preserved is lowered.

According to the Bluetooth standard, communication that takes a little time is recognized as an excellent communicating state on the basis of the communication information. Moreover, the time required to establish a communication link for wireless communication or the communication time needed to request data through polling is regarded as the communication information.

Moreover, when data preserved in each piece of medical equipment is updated through polling that is normally performed at intervals of 2 sec, if the reading of a pressure on the insufflator unit must be finely monitored during surgery, the polling interval can be changed to 1 sec.

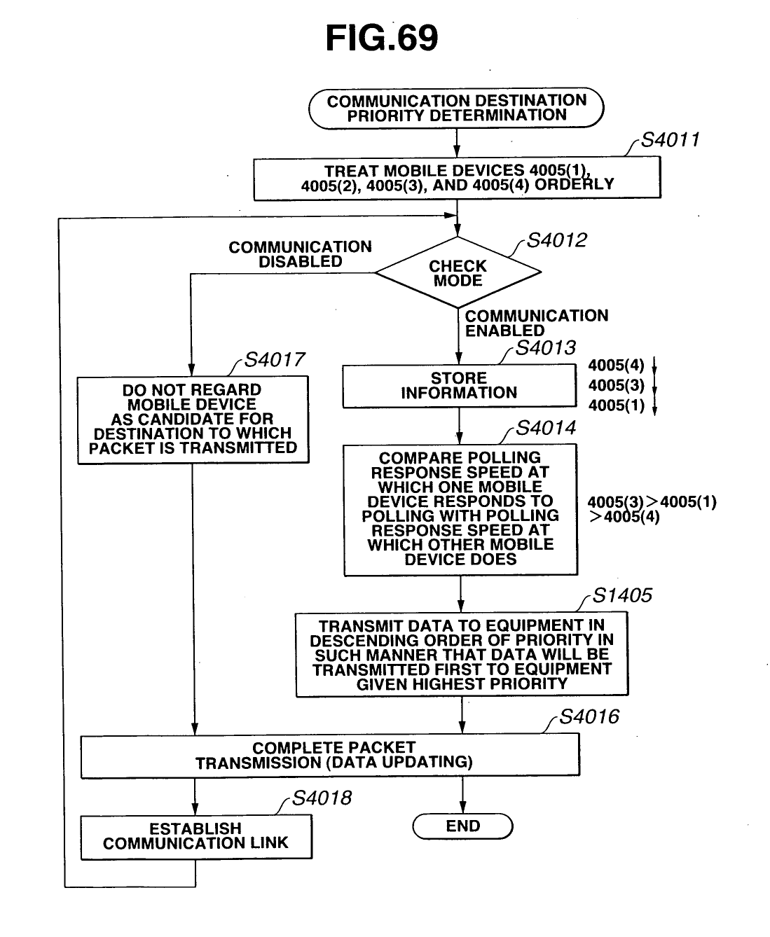

FIG. 68 and FIG. 69 are flowcharts describing a processing flow according to which the centralized controller 4022 and each mobile device communicate with each other to update data responsively to a press of a control command button relevant to the light source unit 4016 that is peripheral equipment. Transmission destination priority recognition described in FIG. 68 is related to communication destination priority recognition described in FIG. 69. If the state of equipment is recognized as a communication-disabled state through mode verification, the equipment is not regarded as a candidate for a destination to which a synchronizing (hereinafter sync) packet is transmitted. After data produced relative to the other equipment is synchronized with stored data, communication is verified.

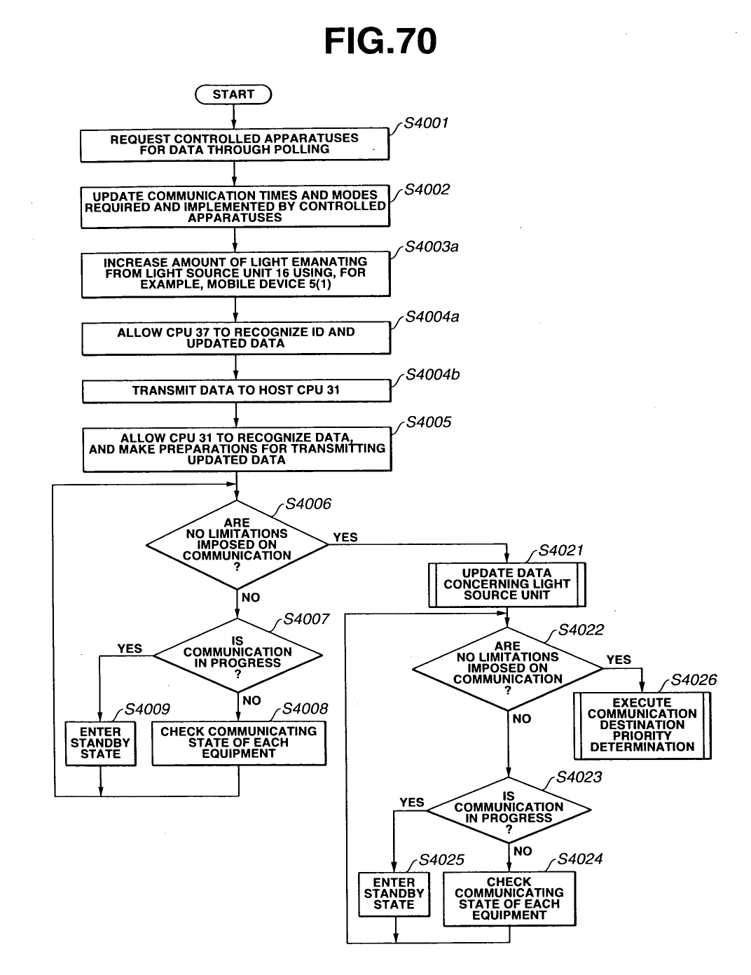

FIG. 70 is a flowchart describing a processing flow of extending control when the mobile device 4005 is used to increase an amount of light supposed to emanate from the light source unit 4016. A difference from the processing flow described in FIG. 68 and FIG. 69 lies in that the centralized controller 4022 identifies a command issued from the mobile device 4005, updates data concerning the light source unit 4016, and instructs the plurality of mobile devices 4005 to update displayed information. In contrast, according to FIG. 68 and FIG. 69, the centralized controller 4022 identifies a command issued from the light source unit 4016 and instructs the mobile devices 4005 to update displayed information. Priority recognition described in FIG. 70 is related to the flow described in FIG. 69 by means of a wireless communication version.

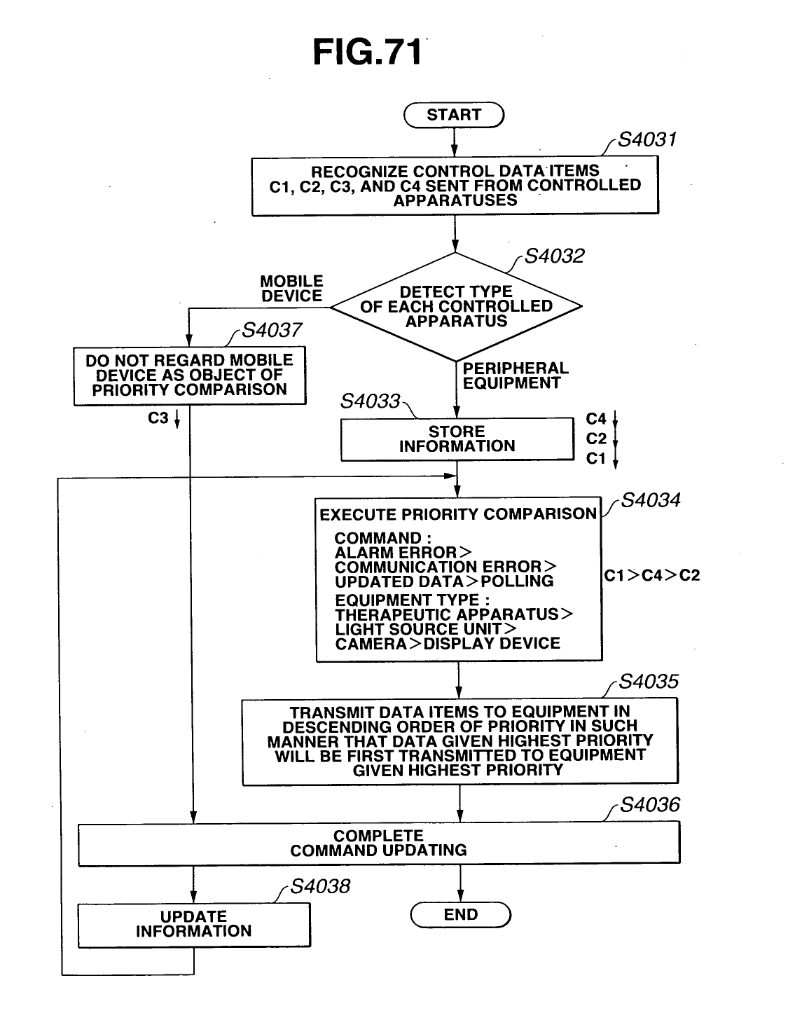

FIG. 71 is a flowchart describing a processing flow of recognizing the priorities given to a plurality of pieces of peripheral equipment when wire communication is adopted. The processing flow is followed when data items sent from the plurality of pieces of peripheral equipment are detected simultaneously with the peripheral equipment managed by the centralized controller 4022.

(Operations)

An operation to be exerted by the first embodiment having the foregoing features will be described. First, the endoscopic surgery system 4003 is set up as described in FIG. 68. The insufflator unit 4014 is used to supply carbon dioxide fed from a chemical cylinder in order to dilate a patient's body cavity. Thus, a field of view an endoscope can offer is ensured. Light emanating from the light source unit 4024 is propagated to the patient's body cavity. The illuminated body cavity is imaged using the camera unit 4015, and monitored using the display device 4019. The electrocautery unit 4013 is used to treat a lesion.

At this time, the centralized controller 4022 manages the peripheral equipment 4006, displays the set values for the peripheral equipment 4006 or the measured values provided thereby on the centralized display panel 4020. The centralized controller 4022 identifies a command issued responsively to a press of the operator panel 4019 and reflects the command on the peripheral equipment 4006 concerned.

Moreover, the centralized controller 4022 manages measured values provided by the patient monitoring system 4004 that monitors biomedical information of a patient such as a patient's pulse rate, temperature, and electrocardiogram. The centralized controller 4022 superposes characters, which represent the measured values, on an endoscopic image produced by the camera unit 4015, so that the measured values can be monitored through the display device 4019. Furthermore, if communication between the centralized controller 4022 and the patient monitor system 4004 is limited to communication over a LAN, a plurality of patient monitor systems can be managed on a single network.

Furthermore, assuming that tools supported by the mobile device 4005 capable of displaying information are used to select a menu item UHI shown in FIG. 62, the setting/display screen image 4065 permitting a user to remotely determine settings in detail as shown in FIG. 63 is displayed. When the flow rate Up button 4067 is pressed, the designated flow rate is transmitted from the mobile device 4005 to the centralized controller 4022 by wireless.

To be more specific, a user selects a menu item through the screen image displayed on the liquid crystal display shown in FIG. 62. The operating unit receives a command issued responsively to the selection of a menu item, and transmits it to the centralized controller 4022 via the interface 4036 of the mobile device 4005. The centralized controller 4022 receives the transmitted command via the interface 4035 thereof.

For reception, the switch driver 4072 included in the interface 4035 selects the contact of the switch 4110 connected to the receiver. The receiver 4073 receives the command via the transmitting/receiving antenna 4111 shown in FIG. 66. The receiver 4007 detects the correlation between signal components received by hopping frequencies, filters the signal, and transfers the resultant signal to the base band module 4070. The wireless control/arithmetic element 4070 processes the received signal.

When the centralized controller 4022 communicates with the mobile device 4005, the communicating state distinguishing module 4034 acts as described below.

When the centralized controller 4022 plays the role of a host, the centralized controller distinguishes pieces of communication-enabled peripheral equipment, recognizes the IDs of the pieces of peripheral equipment, and assigns an address, at which the communicating state and communication information are held, to each of the pieces of peripheral equipment. Thereafter, for example, the mobile device 4005 executes a command. The centralized controller 4022 receives information through wireless communication, recognizes an ID contained in the information, and stores the received information data storage memory 4032.

The Bluetooth standard stipulates, as described in the present embodiment, four modes described below.

An active mode refers to a state in which communication is in progress.

A sniff mode refers to a state in which when a host communicates with a plurality of controlled sides, the frequency of monitoring of controlled equipment is reduced and data is transmitted to specified equipment alone.

A hold mode refers to a state which when a host communicates with a plurality of controlled sides, a controlled side can enter to perform any work other than connection while being connected on a current network.

A park mode refers to a state in which designated information and stored information are kept synchronized and it is unnecessary to participate in data transfer over a network.

Information to be stored as a communicating state includes whichever of the four modes is under way and whether communication is enabled or disabled. If the Bluetooth standard is adopted, priorities are given to the above four modes.

As mentioned above, the centralized controller 4022 monitors the states of the mobile devices 4005. Furthermore, since the centralized controller 4022 has the capability of display equipment, the centralized controller 4022 always requests the peripheral equipment 4006 for measured information through polling, and instructs the mobile devices 4005 to update their data. At this time, the time required to complete transmission, data updating, and reception is stored as a level of receiver sensitivity, and updated all the time. Thus, the latest receiver sensitivity is held in the communicating state storage element in the centralized controller. Furthermore, priorities to be given to equipment errors, therapeutic instruments, or patient measured values are determined in advance and held as peripheral equipment information.

Based on the above settings, actions will be described in conjunction with the flowcharts of FIG. 68 and thereafter.

Referring to FIG. 68, at step S4001, the centralized controller 4022 requests controlled apparatuses for measured values and settings through polling. At step S4002, the CPU 4031 updates the contents of the communicating state storage elements 4076 and 4077 included in the communicating state distinguishing module 4034 with the information received through polling and the time required for communication.

In order to recognize the first communication link, the CPU 4031 monitors the port included in the interface 4008 all the time. When controlled apparatuses each have established a communication link and returns a reply, the IDs of the controlled apparatuses are received and stored at allocated addresses in the communicating state storage element 4076 or 4077 in order to identify what equipment has established a communication link. The information received through polling is then stored at the allocated addresses.

At step S4003, a user increases an amount of light emanating from the light source unit 4016. At step S4004, the CPU 4031 recognizes the ID and varied information. At step S4005, a transfer destination to which updated data is transferred is prepared.

Thereafter, the state of the transfer destination is checked. If it is found at step S4006 that limitations are imposed on communication, control is passed to step S4007. It is then judged whether the transfer destination is communicating with any equipment. If communication is in progress, the user is asked to stand by until the communication is completed at step S4009. If communication is not in progress, each equipment is investigated for a failure or any other factor at step S4008. If it is found at step S4006 that the limitations are lifted, transmission destination priority determination of step S4010 is performed.

FIG. 69 describes transmission destination priority determination for wireless devices that is needed to update the data preserved in the plurality of mobile devices 4005 with varied data sent from peripheral equipment 4006.

Referring to FIG. 69, at step S4011, the identified pieces of equipment interconnected on a Bluetooth network are checked sequentially. The modes in which the mobile devices are placed are distinguished at step S4012. If a mobile device is disabled from communicating with others, the mobile device is not regarded as a transfer destination at step S4017. Communication-enabled mobile devices alone are regarded as transfer destinations at step S4013. Latest communication times the communication-enabled mobile devices require are compared with one another at step S4014.

Instead of the latest communication times, the times required to connect the mobile devices onto the network may be compared with one another.

For example, assume that the mobile device 4005(3) requires 300 ms, the mobile device 4005(1) requires 500 ms, and the mobile device 4005(4) requires 1000 ms because of a large number of times of retransmission deriving from a poor receiving state, a large number of data losses, and a high error rate. In this case, the result of comparison performed at step S4014 is that the communication time required by the mobile device 4005(3) is larger than that required by the mobile device 4005(1) and the communication time required by the mobile device 4005(1) is larger than that required by the mobile device 4005(4). In other words, the response speed of the mobile device 4005(3) is higher than that of the mobile device 4005(1) and the response speed of the mobile device 4005(1) is higher than that of the mobile device 4005(4). At step S4015, data is transmitted to the mobile devices in descending order of response speed. When data transmission is completed, the communicating state of the disregarded mobile device 4005(2) is checked and a communication link with the mobile device is established. If the communicating state has improved, data updating is carried out.

In the foregoing processing, even if broadcasting that is a technique of transmitting data to all destinations over a general LAN is adopted, serial data is transmitted. The data is first transmitted to equipment whose communicating state is the best. Thus, the time required to update data preserved in all pieces of equipment is shortened. Synchronization is then completed. If data is transmitted at random or with priorities undetermined, it takes much time to treat equipment that is disabled from communicating data or whose communicating state is poor. Transmitting data to equipment whose state is good is delayed. Consequently, it takes too much time to complete synchronization.

Next, referring to FIG. 70, a description will be made of a processing flow according to which when the mobile device 4005 is used to remotely modify the set values for the peripheral equipment 4006, data preserved in the operated peripheral equipment 4006 is updated and data preserved in all the mobile devices 4005 is then updated.

As described in FIG. 70, steps S4001 and S4002 are identical to those described in FIG. 68. At step S4003a, an amount of light emanating from the light source unit 4016 is increased using, for example, the mobile device 4005(1). At step S4004a, the CPU 4037 included in the mobile device 4005(1) recognizes the change in the amount of light. At step S4004b, the CPU 4037 transmits the fact that the amount of light has been changed to the CPU 4031 included in the centralized controller 4022. At S4005, the CPU 4031 recognizes the change and transmits the modified data, which represents the changed amount of light, to the peripheral equipment having a detected ID. If it is judged at step S4007 that communication limitations are imposed, the aforesaid processing is carried out. If no communication limitations are imposed, the modified data is transmitted to the light source unit 4016 so that the data preserved in the light source unit will be updated at step S4021.

When the CPU 4031 recognizes that the data in the light source unit 4016 has been updated, the CPU 4031 checks at step S4022 if communication limitations are imposed. Communication destination priority determination is then carried out at step S4026. Data transmission to the mobile device 4005 (steps S4024 to S4025) is identical to the processing of steps S4007 to S4009 described in FIG. 68.

FIG. 71 is a flowchart describing a processing flow for efficiently updating data. Namely, when controlled apparatuses, that is, the plurality of pieces of peripheral equipment 4006 and mobile devices 4005 which are managed by the centralized controller 4022 issue data updating requests, if the requests are recognized during communication, the requests are coped with in descending order of priority given to each controlled apparatus.

Referring to FIG. 71, whichever of an overpressure error (control data C1) occurring in the insufflator, a user-designated increase in an amount of light (control data C2), the start of air supply from the insufflator unit instructed using the mobile device (control data C3), or an error in communication with the light source unit (control data C4) is recognized is judged at step S4031. At step S4032, it is judged from which of the controlled apparatuses, that is, from which of the peripheral equipment 4006 that is essential for surgery, the remote controller, and the display mobile device 4005 the control data is transmitted. Low priority is given to the mobile device 4005 at step S4037.

At step S4033, the control data is stored in the peripheral equipment 4006. At step S4034, peripheral equipment priority comparison is carried out.

According to the present embodiment, the highest priority is given to an alarm among all control data items. A communication error, updated information, and information received through polling are given the next highest priorities in that order. Thereafter, priorities are given to pieces of equipment. Higher priorities are given to the insufflator unit, electrocautery unit, and other therapeutic instruments.

Consequently, the control data C1, control data C4, and control data C2 are given the highest priorities in that order. At step S4035, data stricken with an overpressure error is updated. After updating data preserved in all pieces of equipment is completed, data preserved in the other places is updated sequentially. Herein, an alarm may be given the highest priority and the other control data items may be discarded. Thereafter, data preserved in the equipment disregarded at step S4037 is processed.

Moreover, a plurality of received control data items may be sorted equipment by equipment. The control data concerning communication-enabled equipment or equipment given higher priority may be transmitted in units of a block. This leads to a reduction in processing time.

When it says that data is transmitted in units of a block, it means that a plurality of received control data items is sorted by equipment and held at new addresses, and data items concerning the same equipment are transmitted in units of a block. This is because when data items are written or read at or from consecutive addresses all together, it takes only a short time. Consequently, the processing time is shortened.

Moreover, according to the present embodiment, a portable information terminal such as a PDA is adopted as the mobile devices 5. Alternatively, a display device such as a liquid crystal display or a plasma display, or a plurality of liquid crystal touch-sensitive panels may be adopted as the mobile devices 5. Even in this case, a wireless device is incorporated in each piece of equipment, and the wireless devices and equipment are managed using the centralized controller 4022. Thus, the same operations as the aforesaid ones can be exerted. When one host manages a plurality of pieces of controlled equipment through wireless communication, the pieces of equipment are given priorities for the purpose of efficient processing.

(Advantages)

Owing to the aforesaid features and operations, in the control system, data preserved in a plurality of pieces of peripheral equipment controlled by one centralized controller, for example, by adopting the same communication technique must be regularly synchronized with data preserved in a plurality of mobile devices controlled based on a different communication technique. Herein, the communicating states of the pieces of equipment controlled based on either of the communication techniques are monitored, the pieces of equipment are given priorities at the time of data transfer, and data is then transferred. Consequently, data can be transferred efficiently. This contributes to a reduction in the time required to synchronize data items, which are preserved within the control system, with each other. Since display data that is preserved in equipment and must be updated is updated earlier, users will neither be inconvenienced nor hindered from endoscopic surgery.

### Nineteenth Embodiment

A nineteenth embodiment is nearly identical to the eighteenth embodiment. Only differences will be described below. The same reference numerals will be assigned to identical components, and the description of the components will be omitted.

(Features)

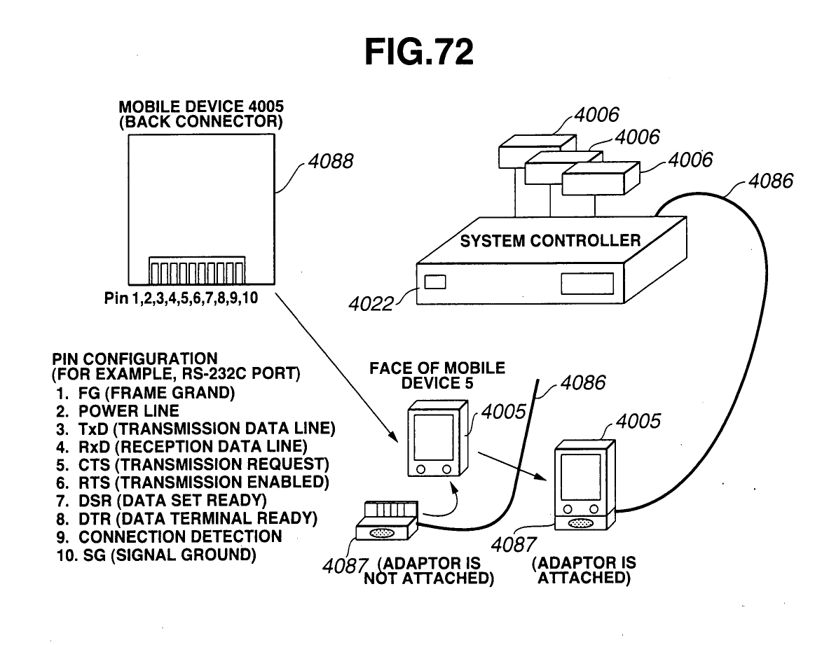

As shown in FIG. 72, according to the present embodiment, the mobile device 4005 is a portable information terminal, for example, a PDA. Herein, the mobile device 4005 includes an electrically connectable adaptor 4087. A typical PDA has a cable that is called a “cradle” and over which data is transmitted synchronously with data transmitted from a personal computer. A connector fixed to the cradle is electrically coupled to a connector located on the back of the PDA. Synchronization is achieved through communication conformable to the RS-232C or USB standard.

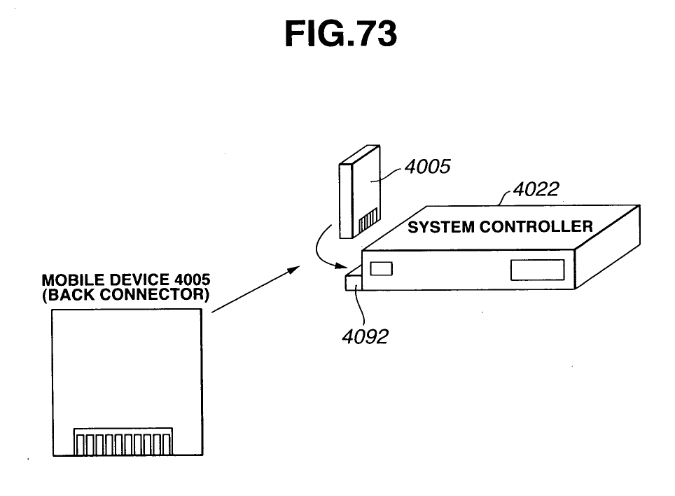

According to the present embodiment, the adaptor 4087 is coupled to a back connector 4088 of the mobile device 4005, and a cradle 4086 is extended from the adaptor 4087. Thus, FIG. 72 presents an example in which the mobile device 4005 includes the general adaptor that enables serial communication. In contrast, FIG. 73 presents an example in which the centralized controller 4022 has a folder 4092 to which the back connector 4088 of the mobile device 4005 can be coupled. In relation to these examples, a method of detecting a communication link will be described below.

The back connector 4088 shown in FIG. 72 is a connector that enables communication conformable to the RS-232C standard. The pins of the connector are assigned to general signal lines conformable to the RS-232C standard. Specifically, the pins are assigned to a power line, grounds FG and SG, a transmission data line TxD, a reception data line RxD, a signal line for a transmission request CTS, and signal lines for messages RTS, DSR, and DTR. Moreover, a pin through which connection is detected and which plays a key role of the present embodiment is also included. Herein, the cradle 4086 of the mobile device 4005 can be coupled to a driver 4089 formed in the adaptor 4087.

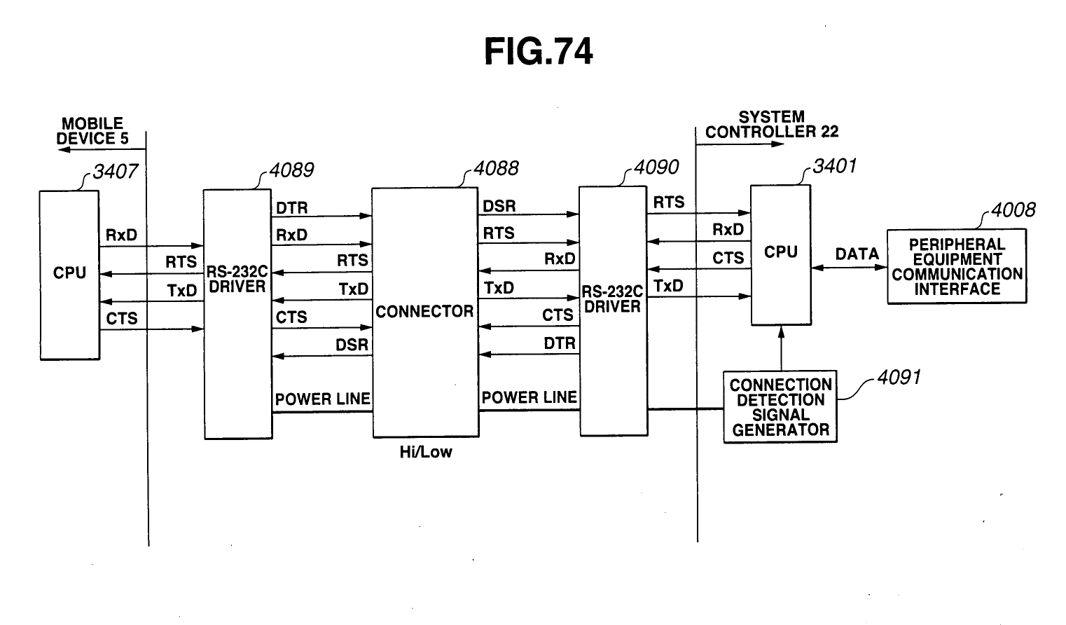

As shown in FIG. 74, the mobile device 4005 consists mainly of the CPU 4037 and the RS-232C driver 4089. The centralized controller 4022 consists mainly of an RS-232C driver 4090, the CPU 4031, a connection detection signal generator 4091, and the peripheral equipment communication interface 4008. The centralized controller 4022 is connected to the adaptor 4087 (folder 4092 in FIG. 73) through the back connector 4088 of the mobile device.

(Operations)

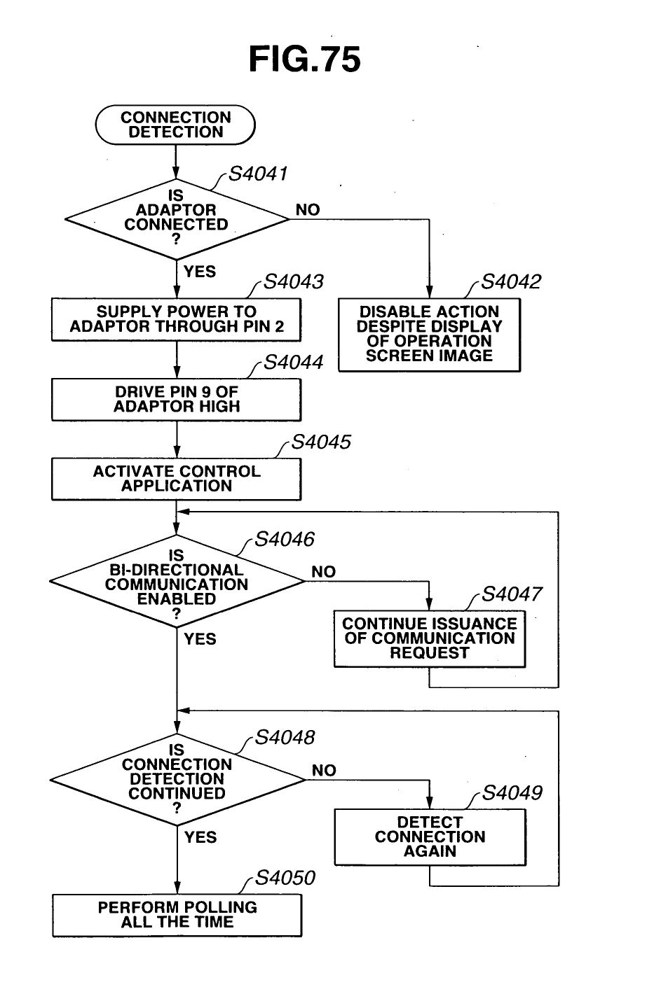

To begin with, a method for controlling connection detection will be described in relation to the configuration shown in FIG. 72 using the flowchart of FIG. 75.

Referring to FIG. 75, when the adaptor 4087 is attached to the mobile device 4005, the connection detection signal generator 4091 judges at step S4041 whether the adaptor 4087 is attached to the mobile device 4005. If the adaptor 4087 is not attached to the mobile device 4005, although the mobile device 4005 is used to display an operation screen image, the endoscopic surgery system will not operate. If the adaptor 4087 is attached to the mobile device 4005, control is passed to step S4043. At step S4043, power is supplied to the adaptor 4087 over the power line or a signal line allocated to pin 2.

Thereafter, at steps S4044 to S4050, a connection detection signal is received through the adaptor 4087 and used to produce a triggering signal for connection detection. The triggering signal is then transmitted to the CPU 4031 in the centralized controller 4022.

The CPU 4031 receives the triggering signal produced from the connection detection signal, whereby the centralized controller 4022 and mobile device 4005 are automatically connected to each other for the purpose of communication. When the communicational connection is completed, a peripheral equipment remote-control application is activated. The centralized controller 4022 requests peripheral equipment for measured values through polling, and transmits the measured values to the mobile device 4005. When the connection detection signal is detected, displayed information is updated in real time.

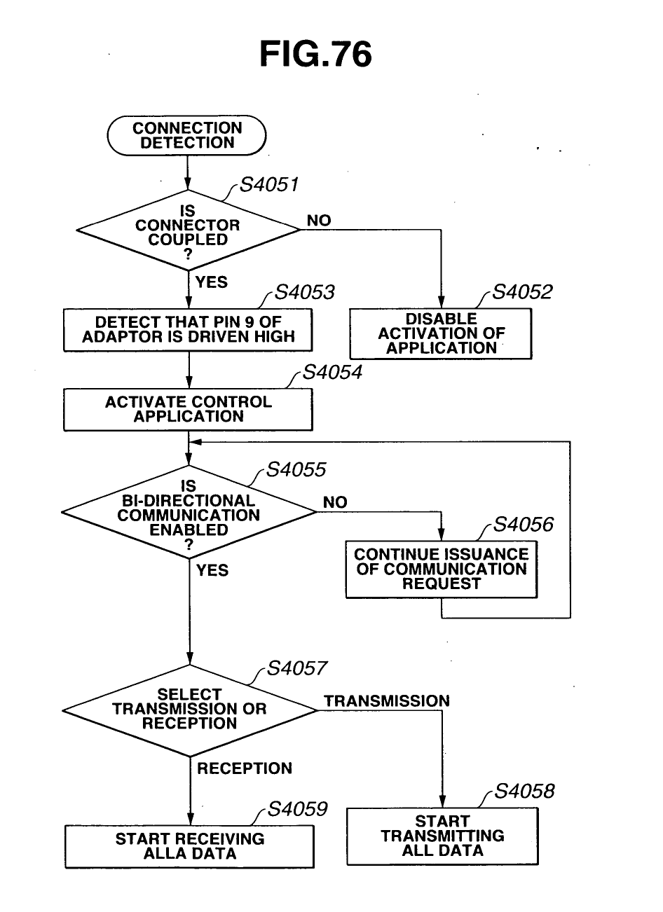

According to the configuration shown in FIG. 73, at steps S4051 to S4059 described in FIG. 76, when the mobile device 4005 is coupled to the folder 4092 that has an electrically connectable connector and that is included in the centralized controller 4022, the connection is detected. The centralized controller 4022 activates a control application installed in the mobile device 4005, whereby a communication link is automatically established. When communication is enabled, a Send button and a Receive button are displayed on the monitor of the mobile device 4005 so that either of transmission and reception can be selected. If a user selects transmission, the data representing the settings of the peripheral equipment (see FIG. 62) preserved in the mobile device 4005 is all transmitted at a time. The centralized controller 4022 having received the data updates the preserved data representing the settings of the peripheral equipment. Moreover, if the user selects reception, the data representing the settings of the equipment can be read.

(Advantages)

Owing to the foregoing features and operation, the settings of each pieces of peripheral equipment determined prior to surgery (data concerning each surgical procedure or each patient) can be all updated at a time. Otherwise, the settings of peripheral equipment can be all read and preserved at a time after surgery. Thus, preparations can be efficiently made for surgery.

### Twentieth Embodiment

A twentieth embodiment is nearly identical to the eighteenth embodiment. Differences alone will be described. The same reference numerals will be assigned to identical components, and the description of the components will be omitted.

(Features)

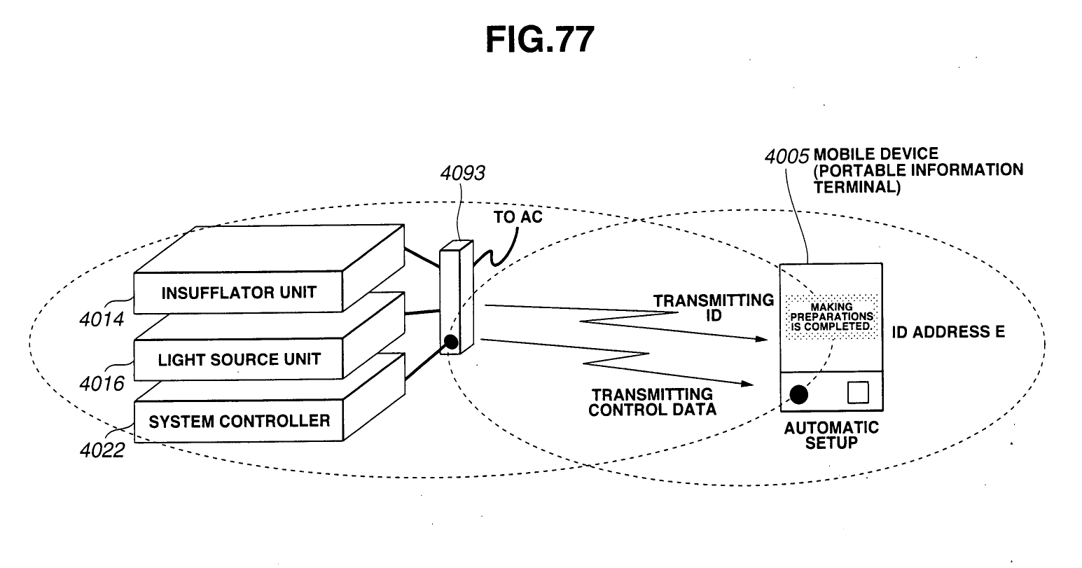

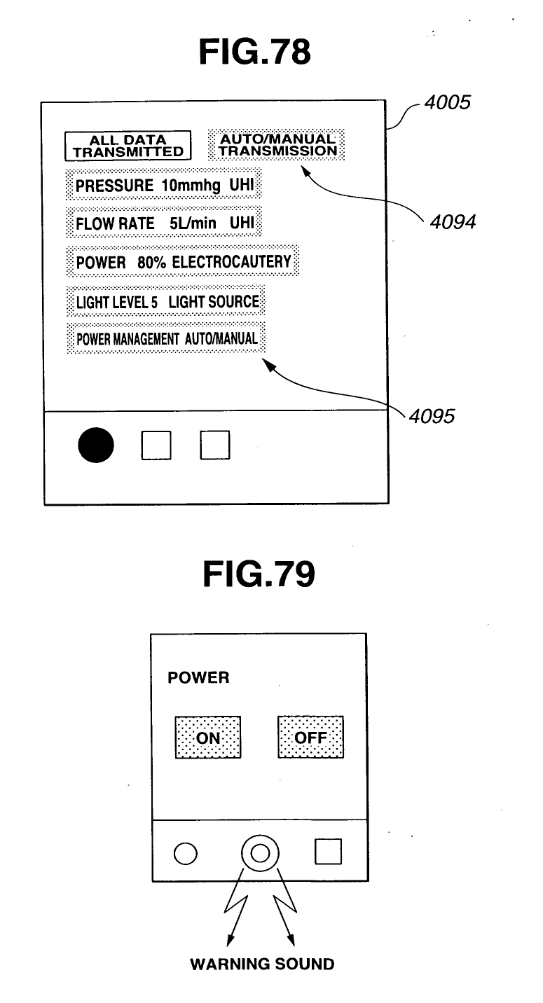

Referring to FIG. 77, a user who is a doctor or nurse and who carries a specific mobile device 4005 lies at a wireless communication-enabled distance at which the mobile device can communicates with the centralized controller 4022 or a peripheral equipment power manager 4093, the mobile device and the centralized controller or peripheral equipment power manager transmit their IDs to each other. Then, the mobile device and the centralized controller or peripheral equipment power manager are connected to each other for communication and initial settings are transmitted to each other. In the present embodiment, when it says that the mobile device lies at the wireless communication-enabled distance, it means that the mobile device is separated from the centralized controller or peripheral equipment power manager by 10 m. Specifically, the Bluetooth standard stipulates that if only power to be transmitted from a transmitting or receiving module is regulated, the distance from the centralized controller or peripheral equipment power manager may be selectively either 10 m or less or 100 m or less. Since the centralized controller or peripheral equipment power manager is installed in an operating room, the distance of 10 m is adopted.

According to the present invention, when the power supplies of the centralized controller 4022 and other pieces of peripheral equipment are turned off or on, if the mobile device 4005 enters or gets out of an operating room, the power supplies of the centralized controller 4022 and other pieces of peripheral equipment are automatically turned on or off. Moreover, the settings of the other pieces of peripheral equipment are automatically transmitted or received. This is intended to simplify preparations for surgery or clearing away to be performed after surgery.

The centralized controller 4022, peripheral equipment 4006, and Bluetooth interfaces are identical to those described in relation to the eighteenth and nineteenth embodiments. The present embodiment includes the peripheral equipment power manager 4093 having a Bluetooth interface. Moreover, when any of the user-specific setting buttons 4062 bearing doctors' names as shown in FIG. 62 is selected through the peripheral equipment data setting screen image displayed on the mobile device 4005, a Power Auto/Manual button 4095 for use in selecting an automatic or manual mode for power management or an Auto/Manual transmission button 4094 for use in selecting an automatic or manual mode for transmission or reception of all set values are presented through a detail screen image.

(Operations)

In relation to the foregoing features, a description will be made of how the power supplies of the centralized controller 4022 and pieces of peripheral equipment 4006 are all turned on and how the settings of the pieces of peripheral equipment are all transmitted.

Initially, the power supplies of the centralized controller 4022 and pieces of peripheral equipment 4006 are turned off. The peripheral equipment power manager 4093 is plugged into an ac mains outlet. The pieces of equipment are plugged into the receptacles formed in the peripheral equipment power manager, whereby the power supplies of the pieces of equipment are managed on a centralized basis. Moreover, a Bluetooth module incorporated in the peripheral equipment power manager is always in operation and on standby so as to wait until communication enabled equipment responds.

For example, when a nurse carrying the mobile device 4005 enters an operating room, the fact is detected. Once numerical values are determined through an all data transmission screen image in advance, after a communication link is established, the set values for the pieces of peripheral equipment are transmitted automatically. Moreover, once an automatic power management mode is designated, the power supply of the mobile device 4005 is turned on before a user enters the operating room and the remote-control application is activated. Alternatively, if the power supply of the mobile device 4005 alone is turned on, when a user enters the operating room, the application is automatically activated.

Herein, when a user comes to lie at the communication-enabled distance, the mobile device 4005 and the peripheral equipment power manager 4093 transmit the IDs thereof to each other and establish a communication link between them. When establishing a communication link is completed, since the automatic power management mode is designated, control data Power On is transmitted. In response to the control data, the peripheral equipment power manager 4093 supplies power, which is distributed through the mains outlet, to the pieces of equipment via relays or the like.

The power supplies of the centralized controller 4022 and the pieces of peripheral equipment 4006 are then turned on. Thereafter, the mobile device 4005 transmits the ID thereof to the centralized controller 4022, and the centralized controller 4022 checks the communicating state of the mobile device. Consequently, a communication link is established between them. Thereafter, the centralized controller 4022 requests the mobile device 4005 to transmit all the settings designated using the mobile device, and the mobile device 4005 transmits the setting data.

The centralized controller 4022 having received the setting data autonomously sets up the pieces of peripheral equipment 4006 as described in relation to the eighteenth and nineteenth embodiments. Preparations for surgery have thus been made. Moreover, if a user wants to manually turn on the power supplies, all the actions ending with establishment of a communication link are carried out automatically. A Power On button is, as shown in FIG. 79, then displayed (with an alarm sound) in order to prompt the user to confirm that the user wants to turn on the power supplies.

After surgery is completed, as described in the nineteenth embodiment, the mobile device 4005 is connected to the centralized controller 4022 and the set values for the pieces of peripheral equipment are read into the mobile device 4005. Once a user gets out of an operating room, the communication link between the peripheral equipment power manager 4093 and mobile device 4005 is disconnected. The peripheral equipment power manager 4093 turns off all the power supplies. At this time, the mobile device 4005 and peripheral equipment power manager 4093 checks at regular intervals of 5 sec to 10 sec whether a communication link is established. Alternatively, a Power Off button presented through a screen image displayed on the mobile device 4005 may be pressed so that control data Power Off will be manually transmitted in order to turn off all the power supplies.

(Advantages)

Owing to the aforesaid features and operation of the twentieth embodiment, when the fact that a doctor or nurse carrying a mobile device whose ID is managed has entered or got out of an operating room is recognized by detecting the ID, the power supplies of peripheral equipment and the power supply of the system controller are automatically turned on (shut down). Furthermore, preparations for surgery can be made automatically. Consequently, preparations for surgery can be made shortly through simple handling. This leads to a reduction in a load to be incurred by a doctor or nurse.

### Twenty-first Embodiment

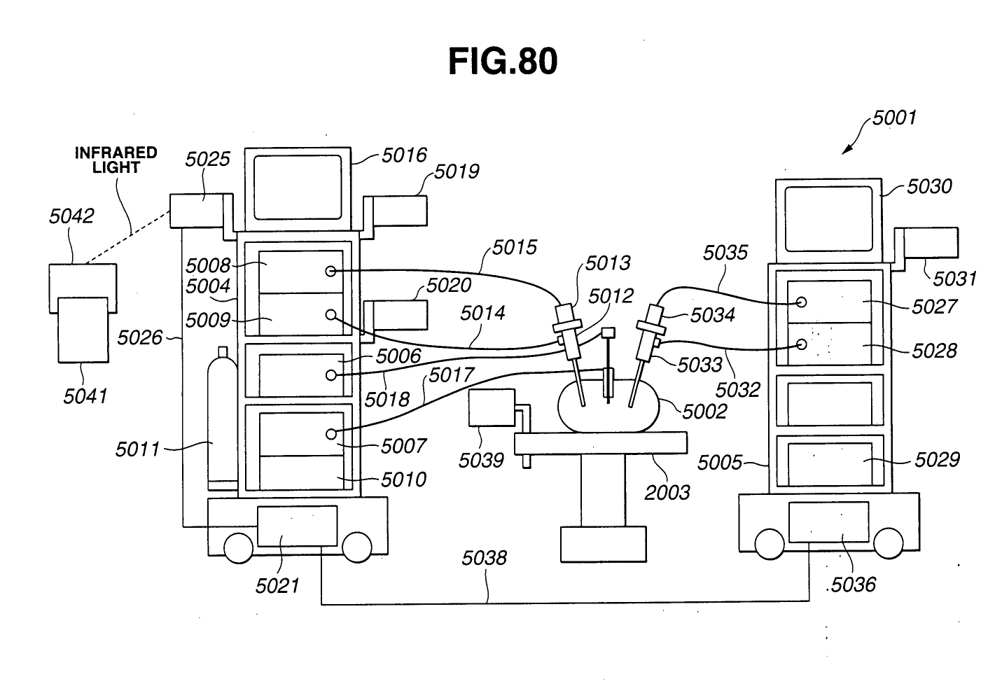

As shown in FIG. 80, an endoscopic surgery system 5001 is installed near a patient couch 5003, on which a patient 5002 lies down, in an operating room. The endoscopic surgery system 5001 includes a first cart 5004 and a second cart 5005.

Medical equipment, for example, an electrocautery unit 5006, an insufflator unit 5007, an endoscopic camera unit (camera control unit) 5008, a light source unit 5009, a VTR 5010, and other electric apparatuses, and a chemical cylinder 5011 filled with carbon dioxide are integrated into the first cart 5004.

An insertion member of a first endoscope 5012 designed for endoscopic observation is inserted into a body cavity of the patient 5002. A camera head (imaging unit) 5013 having a built-in imaging device is mounted on the eyepiece member of the first endoscope 5012. The first endoscope 5012 is connected to the light source unit 5009 over a light guide cable 5014, so that illumination light will be supplied to the first endoscope 5012.

Moreover, the camera head 5013 is connected to the endoscopic camera unit 5008 over a camera cable 5015. An image signal picked up by the imaging device is processed, converted into a video signal, and transferred to a first display device 5016. Consequently, an endoscopic image converged on the imaging device is displayed on the display surface of the display device 5016 realized with a TV monitor.

Moreover, a trocar inserted into the patient 5002 is connected to the insufflator unit 5007 by way of an insufflation tube 5017. Carbon dioxide for insufflation is supplied to the abdominal cavity of the patient 5002 via the insufflator unit 5007, whereby the abdominal cavity is dilated.

A treatment electrode connected to the electrocautery unit 5006 over a cable 5018 is embedded in the trocar, so that high-frequency current supplied from the electrocautery unit can be conducted to a region to be treated within the abdominal cavity. Thus, resection or any other treatment can be carried out.

In addition to the display device 5016 mounted on the top of the first cart 5004, for example, a centralized display panel 5019 and an operator panel 5020 are mounted on the first card 5004. The centralized display panel 5019 is a display means on which every information acquired during surgery can be selectively displayed. The operator panel 5020 is composed of a display, for example, a liquid crystal display and touch sensors integrated with the display. The operator panel 5020 is a first centralized operating unit to be handled by a nurse or the like in a non-sterilized zone.

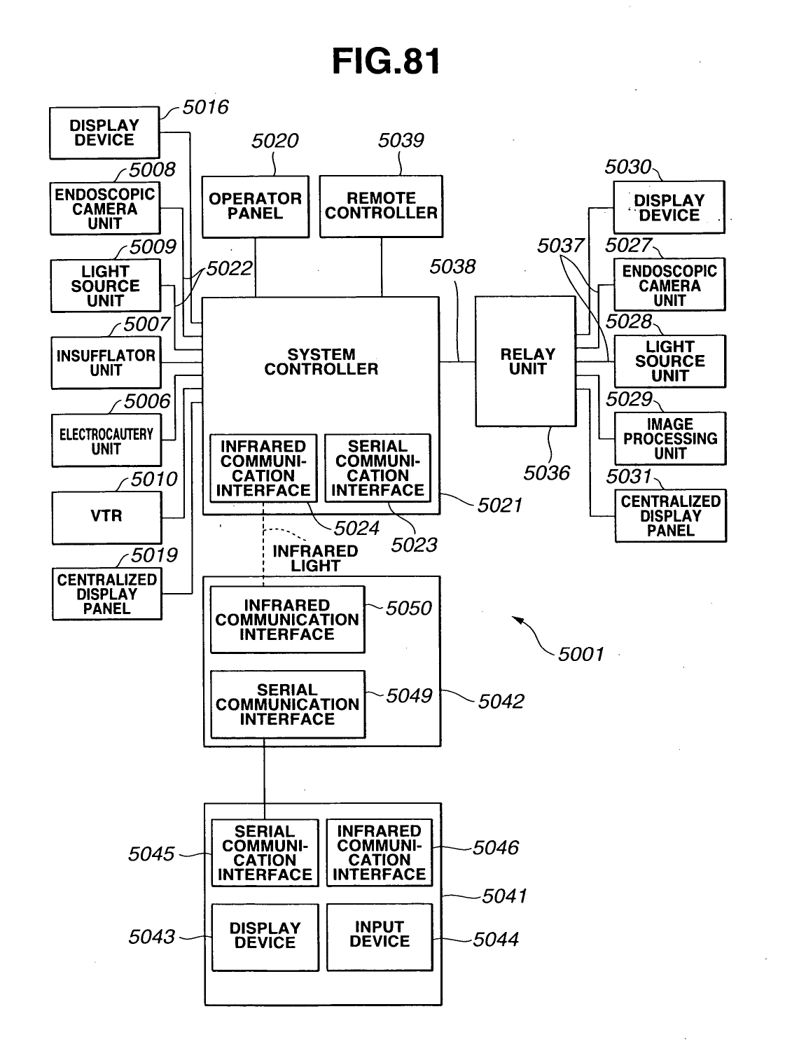

Furthermore, a system controller 5021 having the ability to control the electrocautery unit 5006, insufflator unit 5007, and other medical equipment (controlled apparatuses) that constitute the endoscopic surgery system 5001 is mounted in the first cart 5004. The electrocautery unit 5006, insufflator unit 5007, endoscopic camera unit 5008, light source unit 5009, and VTR 5010 are connected to the system controller 5021 over transmission lines 5022 shown in FIG. 81.

Referring to FIG. 81, the system controller 5021 has a serial communication interface 5023 and an infrared communication interface 5024 incorporated therein. As shown in FIG. 80, an infrared communication port 5025 through which infrared light waves are irradiated for infrared communication via the infrared communication interface 5024 is disposed outside the system controller 5021. The infrared communication port 5025 is connected to the system controller 5021 over a cable 5026.

On the other hand, an endoscopic camera unit 5027, a light source unit 5028, an image processing unit 5029, a display device 5030, and a second centralized display panel 5031 are integrated into the second cart 5005.

The light source unit 5028 is connected to a second endoscope 5033 over a light guide cable 5032. The light source unit 5028 supplies illumination light.

Moreover, a camera head 5034 is mounted on the second endoscope 5033. The endoscopic camera unit 5027 is connected to the camera head 5034 over a camera cable 5035. The endoscopic camera unit 5027 processes a signal picked up by an imaging device incorporated in the camera head 5034 so as to produce a video signal.

The video signal produced by the endoscopic camera unit 5027 is transferred to the display device 5030, whereby an endoscopic image or the like is displayed. Every information acquired during surgery can be selectively displayed on the second centralized display panel 5031.

The endoscopic camera unit 5027, light source unit 5028, image processing unit 5029, display device 5030, and second centralized display panel 5031 are connected to a relay unit 5036 mounted in the second cart 5005 over transmission lines 5037 (see FIG. 81). The relay unit 5036 is connected to the system controller 5021 mounted in the first cart 5004 over a relay cable 5038.

Moreover, a remote controller 5039 serving as a second centralized operating unit to be handled by an operator is disposed near the couch 5003 in a sterilized zone. By handling the remote controller 5039, the operator can operate medical equipment such as the electrocautery unit 5006 and insufflator unit 5007, which are included in the endoscopic surgery system 5001, via the system controller 5021 included in a control system (serving as a main body of the control system).

Moreover, the present embodiment includes a portable terminal 5041 serving as a third centralized operating unit used to remotely control the medical equipment included in the endoscopic surgery system 5001. The portable terminal 5041 is realized with, for example, a PDA.

In the present embodiment, a communication adaptor 5042 is included as an apparatus for reinforcing wireless communication between the portable terminal 5041 and system controller 5021. The communication adaptor 5042 is attached to the portable terminal 5041 for use.

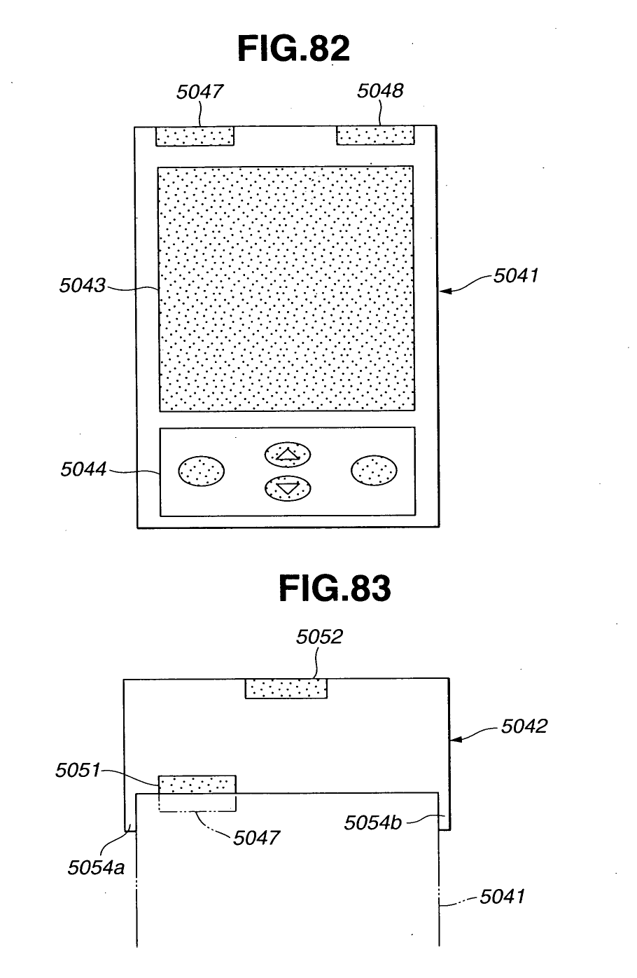

FIG. 82 shows the appearance of the portable terminal 5041. The portable terminal 5041 includes a display device 5043 on which an image or the like is displayed, and an input device 5044 used to enter information. The portable terminal 5041 includes, as shown in FIG. 81, a serial communication interface 5045 and an infrared communication interface 5046. A serial communication port 5047 and an infrared communication port 5048 that serve as the input/output sections of the portable terminal 5041 through which serial data is transmitted or infrared light waves are irradiated are formed on the upper edge of the portable terminal 5041. Serial communication and infrared communication are achieved through the serial communication port 5047 and infrared communication port 5048 respectively.

FIG. 83 shows the appearance of the infrared communication adaptor 5042. The infrared communication adaptor 5042 includes, as shown in FIG. 81, a serial communication interface 5049 and an infrared communication interface 5050. A serial communication port 5051 and an infrared communication port 5052 serving as the input/output sections of the infrared communication adaptor 5042 through which serial data is transmitted or infrared light waves are irradiated are formed on the bottom of the infrared communication adaptor 5042 and the upper edge thereof respectively. Serial communication and infrared communication are achieved through the serial communication port 5051 and infrared communication port 5052 respectively.

Moreover, the infrared communication adaptor 5042 is, as shown in FIG. 83, freely detachably attached to the upper edge of the portable terminal 5041. For this purpose, a freely detachable connecting mechanism is attached to the upper edge of the portable terminal 5041.

When the infrared communication adaptor 5042 is attached to the portable terminal 5041, the serial communication port 5051 of the infrared communication adaptor 5042 is, as described later, coupled to the serial communication port 5047 of the portable terminal 5041.

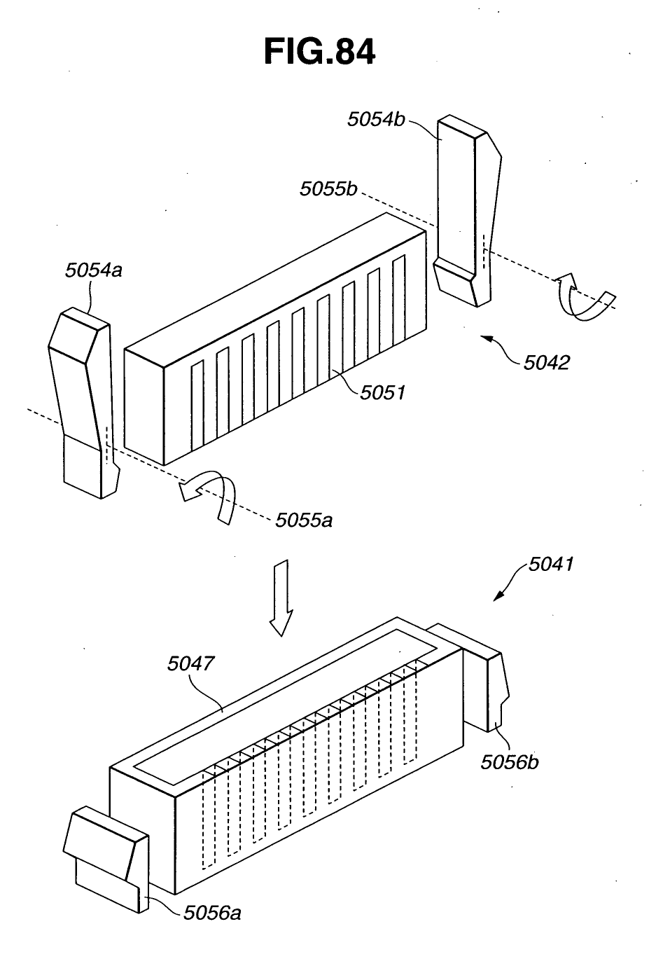

FIG. 84 shows connectors of the portable terminal 5041 and infrared communication adaptor 5042 respectively.

Hooks 5054a and 5054b are fixed to both sides of the serial communication port 5051 formed on the lower edge of the infrared communication adaptor 5042, and constrained to turn in directions of arrows with axes 5055a and 5055b as axes of rotation owing to spring force.

On the other hand, hooks 5056a and 5056b are fixed to both sides of the serial communication port 5047 formed on the upper edge of the portable terminal 5041 so that they will be engaged with the hooks 5054a and 5054b. The infrared communication adaptor 5042 is met with the portable terminal 5041 from above the portable terminal 5041 so that the serial communication port 5047 will be fitted into the serial communication port 5051. Thus, the hooks 5056a and 5056b are engaged with the hooks 5054a and 5054b. Consequently, the infrared communication adaptor 5042 is fixed to the portable terminal 5041. At this time, the serial communication port 5051 of the infrared communication adaptor 5042 is electrically coupled to the serial communication port 5047 of the portable terminal 5041. Serial communication is thus enabled.

As seen from FIG. 81, the system controller 5021 can control on a centralized basis the electrocautery unit 5006, insufflator unit 5007, camera unit 5008, light source unit 5009, and VTR 5010 which are integrated into the first cart 5004, and the camera unit 5021, light source unit 5027, image processing unit 5023, and others which are integrated into the second cart 5005.

When communication links are established between the system controller and the above pieces of equipment, the system controller 5021 can display a setting screen image, which presents the settings of each medical equipment and operation switches, on the centralized display panel 5019 or 5031. At the same time, the operator panel 5020 or remote controller 5039 is used to modify or enter set values.

On the other hand, the portable terminal 5041 can communicate with the system controller 5021 by infrared light waves. At this time, the infrared communication port 5048 serving as an input/output section of the infrared communication interface 5046 through which infrared light waves are irradiated must be located at a short distance from the infrared communication port 5025 connected to the infrared communication interface 5024 included in the system controller 5021. Moreover, infrared light waves must be able to be transferred between the infrared communication port 5048 and infrared communication port 5025. Consequently, the pieces of medical equipment can be remotely controlled by handling the portable terminal 5041.

However, as described in “Problems to be Solved by the Invention,” significant restrictions are imposed. Namely, the distance from the portable terminal 5041 to the infrared communication port 5025 connected to the system controller 5021 must be about 1 m. According to the present embodiment, therefore, the infrared communication adaptor 5042 is attached to the portable terminal 5041 so that the communication-enabled distance can be extended largely.

Specifically, the portable terminal 5041 can communicate with the infrared communication adaptor 5042 through the serial communication interface 5045, while the infrared communication adaptor 5042 can communicate with the system controller 5021 through the infrared communication interface 5050. Consequently, the portable terminal 5041 can communicate with the system controller 5021 by infrared light waves via the infrared communication adaptor 5042.

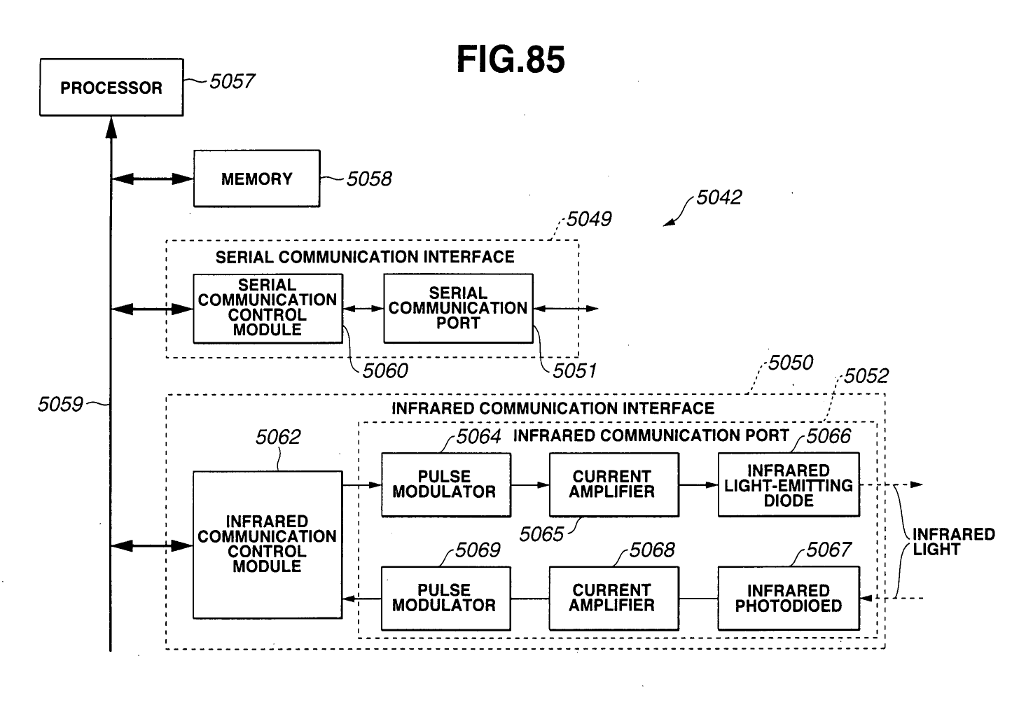

FIG. 85 is a block diagram showing the internal configuration of the infrared communication adaptor 5042. A memory 5048 in which operating programs and data are stored and which provides a work area, a serial communication interface 5049, and an infrared communication interface 5050 are electrically connected to a processor 5057, which controls the infrared communication adaptor 5042, over a data bus 5059.

The serial communication interface 5049 includes a serial communication control module 5060 that controls serial communication, and a serial communication port 5051 connected to the control module 5060. The serial communication interface 5049 enables serial communication with an external terminal electrically connected through the serial communication port 5051.

The infrared communication interface 5050 includes an infrared communication control module 5062 that controls infrared communication, and an infrared communication port 5052 connected to the control module 5062. The infrared communication interface 5050 enables infrared communication with an external terminal by means of transfer of infrared light waves.

The infrared communication port 5052 consists mainly of a transmitting module and a receiving module. The transmitting module includes: a pulse modulator 5064 that modulates a signal to be transmitted using a pulse train; a current amplifier 5065 that delivers a greater output current than an output signal of the pulse modulator 5064; and an infrared light-emitting diode 5066 that emits infrared light waves when forward biased with a signal having been subjected to current amplification (pulse modulation) by the current amplifier 65. The receiving module includes: a infrared photodiode 5067 that receives infrared light waves; a current amplifier 5068 that delivers a greater output current than a signal photoelectrically converted by the infrared photodiode 5067; and a pulse demodulator 5069 that demodulates a signal, which has been subjected to current amplification, using a pulse train.

When the serial communication port 5051 is coupled to the serial communication port 5047 of the portable terminal 5041, the processor 5057 is interlocked with a processor that is incorporated in the portable terminal 5041 and that is not shown.

To be more specific, the portable terminal 5041 manipulates (converts) serial data, that is communicated through the serial communication port 5047 thereof, into data to be subjected to infrared communication by means of the infrared communication interface 5050.

In this case, the infrared communication interface 5050 enables long-distance infrared communication owing to improved infrared radiation intensity and improved receiver sensitivity.

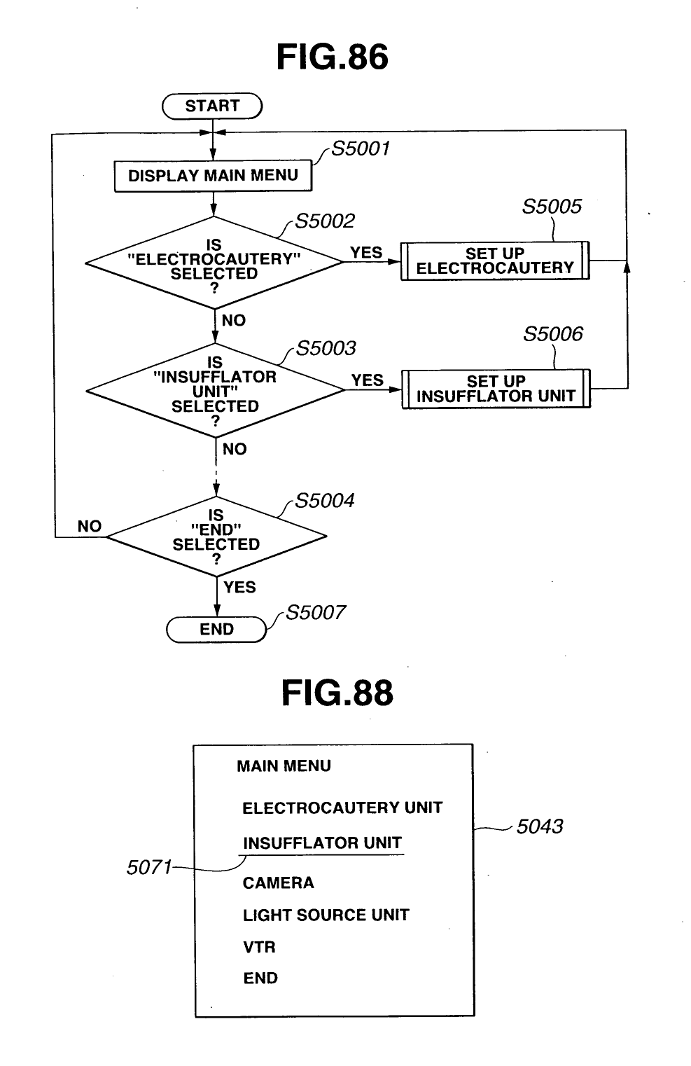

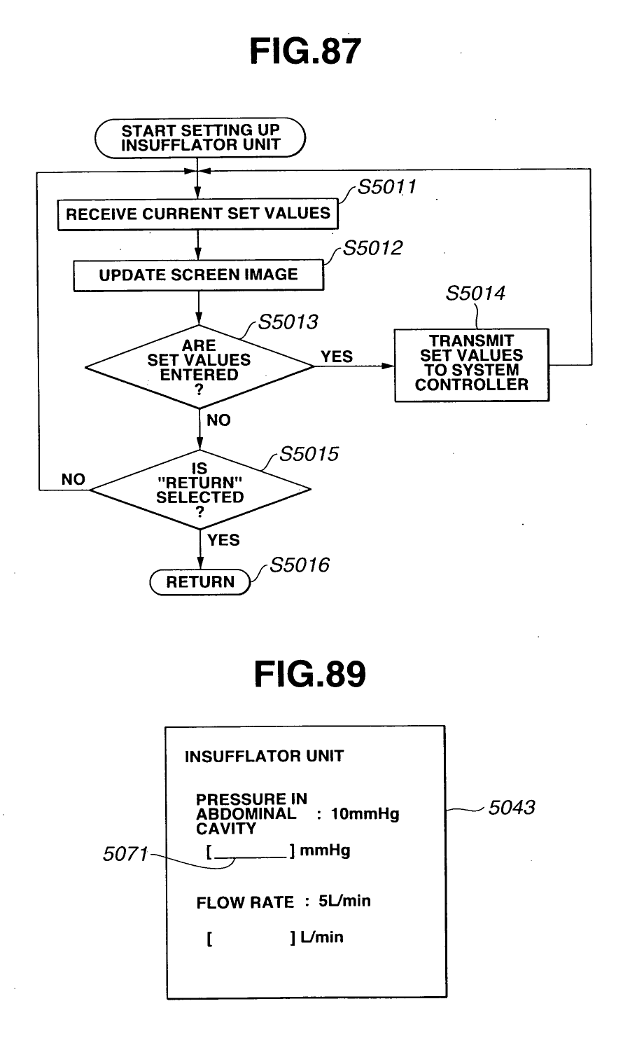

Next, the operation to be exerted by the present embodiment having the foregoing features will be described with reference to FIG. 86 to FIG. 89. FIG. 86 and FIG. 87 are flowcharts outlining a software procedure. FIG. 88 and FIG. 89 show user interfaces that provide graphics to be displayed on the display device 5043 of the portable terminal 5041.

As shown in FIG. 80 or FIG. 83, when the infrared communication adaptor 5042 is attached to the portable terminal 5041, the portable terminal 5041 has the serial communication port 5047 thereof coupled to the serial communication port 5051 of the infrared communication adaptor 5042. The infrared communication adaptor 5042 is thus functionally integrated with the portable terminal 5041.

When the power supply of the portable terminal 5041 is turned on, software installed in the portable terminal 5041 is activated. As described in FIG. 86, when the software procedure is started, a main menu is displayed at step S5001. Namely, a main menu is, as shown in FIG. 88, displayed on the display device 5043 of the portable terminal 5041. The main menu contains items bearing the names of pieces of medical equipment to be operated (herein, electrocautery unit, insufflator unit, etc., and VTR) and an item of End. A user (specifically, a doctor or a nurse) selects any menu item using a cursor 5071. Thereafter, a wait state is continued until the user enters data at the input device 5044.

As described in FIG. 86, it is judged at step S5002 whether the item of Electrocautery Unit is selected. It is judged at step S5003 whether the item of Insufflator Unit is selected (the item of VTR is selected). At step S5004, whether the item of End is selected is judged.

The user moves the cursor 5071 to designate medical equipment (surgical equipment) he/she wants to operate. Control is then passed to a processing flow of setting up the selected medical equipment.

Referring to FIG. 86, if the electrocautery unit 5006 is designated, control is passed to step S5005 at which the electrocautery unit is set up. Thereafter, control is returned to step S5001. If the insufflator unit 5007 is designated, control is passed to step S5006 at which the insufflator unit 5007 is set up. Thereafter, control is returned to step S5001.

Therefore, when the insufflator unit 5007 is, as shown in FIG. 88, selected with the cursor 5071, control is passed to step S5006 at which the insufflator unit 5007 is set up.

It is also judged whether the user has designated no surgical equipment. Specifically, if End is selected at step S5004, the software procedure is terminated at step S5007.

Referring to FIG. 87, setting up, for example, the insufflator unit 5007 will be described below. When the insufflator unit 5007 is designated as shown in FIG. 88, setting up the insufflator unit 5007 is started as described in FIG. 87. At the first step S5011, the portable terminal 5041 receives the current set values for the insufflator unit 5007 from the system controller 5021.

In this case, data containing a command “Transmit Set Values” is originated from the serial communication interface 5045 of the portable terminal 5041. The data is stored in a memory 5058 included in the infrared communication adaptor 5042 through the serial communication interface 5049.

Thereafter, the data is manipulated into data, which can be transmitted through infrared communication, by means of the processor 5057 and infrared communication control module 5062. The data that is a digital signal is converted into an analog signal by the pulse modulator 5064. Namely, the digital signal is converted according to a pulse modulation form such as pulse-position modulation (PPM) in order to produce an analog signal representing a fluctuating current. What is transferred to the current amplifier 5065 is the data that represents the fluctuating current having been subjected to pulse modulation. The current amplifier 5065 amplifies the current.

In general, when a current to be conducted into the infrared light-emitting diode is intensified, the radiation intensity to be offered by the infrared light-emitting diode increases. According to the present invention, a current amplification factor offered by the current amplifier 5065 is set to a large value. Therefore, when a fluctuating current produced by the current amplifier 5065 is transformed into variations in the infrared radiation intensity to be offered by the infrared light-emitting diode 5066, the fluctuating current is transformed into variations in a higher infrared radiation intensity. Consequently, infrared light waves can be transmitted by a longer distance (than they are transmitted using only the portable terminal 5041).

When the system controller 5021 receives data through the infrared communication port 5052 and can “transmit received set values,” the system controller 5021 originates the current set values for the insufflator unit 5007 through the infrared communication port 5025. The data representing the set values is received in the form of a variation in the infrared radiation intensity by the infrared photodiode 5067 included in the infrared communication adaptor 5042.

The data received by the infrared photodiode 5067 is amplified in current by the current amplifier 5068, and then transferred to the pulse demodulator 5069. The pulse demodulator 5069 provides data of a demodulated digital signal. Even in this case, since the data is amplified in current by the current amplifier 5068, even feeble infrared light waves can be received from a place at a longer distance (than it can be received using only the portable terminal 5041). In short, a reception-enabled distance can be extended (along with improvement of receiver sensitivity).

The data is stored in the memory 5058, and transmitted to the portable terminal 5041 via the serial communication interface 5049 in due course. Thereafter, at step S5012 described in FIG. 87, a screen image is updated. In other words, the main menu screen image shown in FIG. 88 is updated to a setting screen image, which permits a user to determine the settings of the insufflator unit, shown in FIG. 89.

At step S5013, it is judged whether a user has entered set values (using the portable terminal 5041). For example, the user positions, as shown in FIG. 89, the cursor 5071 in an intended entry field and then enters a value.

When entry is completed, the portable terminal 5041 transmits the data representing entered set values (or new set values) to the system controller 5021. Thus, preserved data is modified with the data.

In this case, data containing a command “Modify Sets Values” is transmitted to the system controller 5021 similarly as it is at step S5011. Then, the preserved set values are modified with the new set values. Control is then returned to step S5011.

If no set value is entered, it is judged at step S5015 whether “Return to the Menu” is designated. If so, control is passed to step S5016. The processing flow of setting up the insufflator unit 5007 is terminated. The main menu screen image is then displayed, that is, control is returned to step S5001 in FIG. 86. If a user neither enters a set value nor designates “Return to the Menu,” control is returned to step S5011 and the current values are received. The software procedure has been briefed so far.

According to the present embodiment, the infrared communication adaptor 5042 is attached to the portable terminal 5041. Consequently, the infrared radiation intensity increases, and the receiver sensitivity improves. This leads to an increase in a distance from the system controller at which infrared communication with the system controller is enabled. A doctor or nurse who carries the portable terminal 5041 to which the infrared communication adaptor 5042 is attached can use the portable terminal 5041 not only while keeping still but also while moving. At this time, the infrared communication port 5052 must be opposed to the infrared communication port 5019 of the system controller 5021.

The present embodiment has the advantages described below.

Since the infrared communication adaptor 5042 offers a higher infrared radiation intensity, a doctor or nurse who carries the portable terminal 5041 need not approach the infrared communication port 5025 so closely that infrared light waves can reach the infrared communication port 5025. This contributes to improved user-friendliness, a shortened surgery time, and improved surgical efficiency.

So far, a description has been made on the assumption that the infrared communication adaptor 5042 is attached to the portable terminal 5041. The inclusion of an infrared communication adaptor capable of being attached to the infrared communication port 5025 would be more advantageous.

### Twenty-Second Embodiment

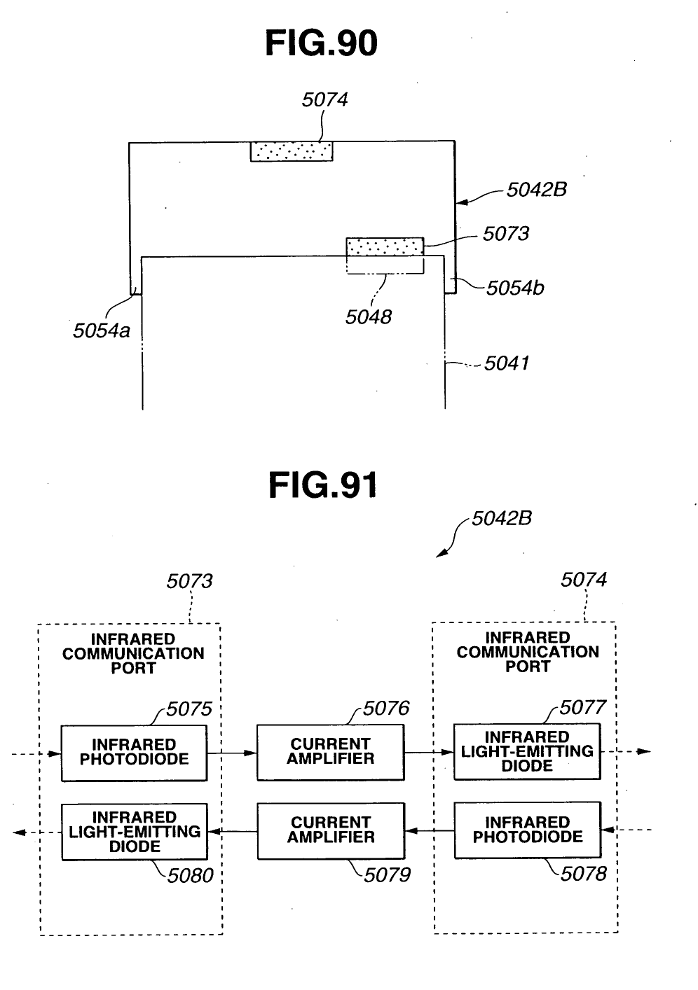

Referring to FIG. 90 and FIG. 91, a twenty-second embodiment of the present invention will be described below. FIG. 90 shows an infrared communication adaptor 5042B included in the twenty-second embodiment.

The infrared communication adaptor 5042B has a different configuration from the infrared communication adaptor 5042 included in the twenty-first embodiment.

The infrared communication adaptor 5042B shown in FIG. 90 is, similarly to the one included in the twenty-first embodiment, attached to the infrared communication port 5025 or portable terminal 5041. According to the present embodiment, the infrared communication adaptor 5042B includes two infrared communication ports 5073 and 5074. When the infrared communication adaptor 5042B is attached to the portable terminal 5041, the infrared communication port 5073 is opposed to the infrared communication port 5048 of the portable terminal 5041 as indicated with an alternate long and two short dashes line shown in FIG. 90.

FIG. 91 is a block diagram showing the internal configuration of the infrared communication adaptor 5042B included in the present embodiment. The infrared communication adaptor 5042B consists of a transmitting module composed of an infrared photodiode 5075, a current amplifier 5076, and an infrared light-emitting diode 5077, and a receiving module composed of an infrared photodiode 5078, a current amplifier 5079, and an infrared light-emitting diode 5080.

Next, an operation to be exerted by the present embodiment will be described below.

The transmitting module helps the portable terminal 5041 originate infrared light waves towards the system controller 5021. The infrared photodiode 5075 receives infrared light waves which are originated through the infrared communication port 5048 of the portable terminal 5041 and of which radiation intensity is low. The infrared signal is transformed into a fluctuating current. The current amplifier 5076 that offers a high current amplification factor amplifies an output current of the infrared photodiode 5075. The infrared light-emitting diode 5077 transforms the fluctuating current produced by the current amplifier 5076 into variations in the radiation intensity of infrared light waves, and originates the infrared light waves towards the infrared communication port 5025 connected to the system controller 5021.

The receiving module helps the system controller 5021 originate infrared light waves towards the portable terminal 5041. Specifically, the infrared photodiode 5078 receives infrared light waves irradiated through the infrared communication port 5025 connected to the system controller 5021. The infrared signal is transformed into a fluctuating current. The current amplifier 5079 that offers a high current amplification factor amplifies an output current of the infrared photodiode 5078. The infrared light-emitting diode 5080 transforms the fluctuating current produced by the current amplifier 5079 into variations in the radiation intensity of infrared light waves, and originates the infrared light waves towards the infrared communication port 5048 of the portable terminal 5041.

As mentioned above, even in the present embodiment, the radiation intensity of infrared light waves is increased in order to extend a transmissible distance. The received power of infrared light waves is thus intensified in order to extend a receivable distance. This leads to a longer distance from the system controller at which infrared communication with the system controller is enabled. A user would find the control system as user-friendly as the control system of the twenty-first embodiment.

If the infrared communication adaptor 5042B included in the present embodiment is attached to the system controller 5021, the receiving module may be excluded. However, the infrared communication adaptor 5042B must have such a shape that infrared light waves can fall on the infrared communication port 5048 of the portable terminal 5041 (for example, a portion (of the infrared communication adaptor 5042B) opposed to an infrared photodiode included in the infrared communication port 5048 of the portable terminal 5041 must be cut off (or made from a transparent member) so that infrared light waves can fall on the infrared communication port 5048).

Consequently, a doctor or nurse who carries the portable terminal 5041 having the infrared communication adaptor 5024B attached thereto can use the portable terminal 5041 not only while keeping still but also while moving. At this time, the infrared communication port 5074 must be opposed to the infrared communication port 5025 connected to the system controller 5021.

The present embodiment provides advantages described below.

Compared with the twenty-first embodiment, the infrared communication adaptor 5042B can be constructed at relatively low cost. The other advantages are identical to those of the twenty-first embodiment.

### Twenty-Third Embodiment

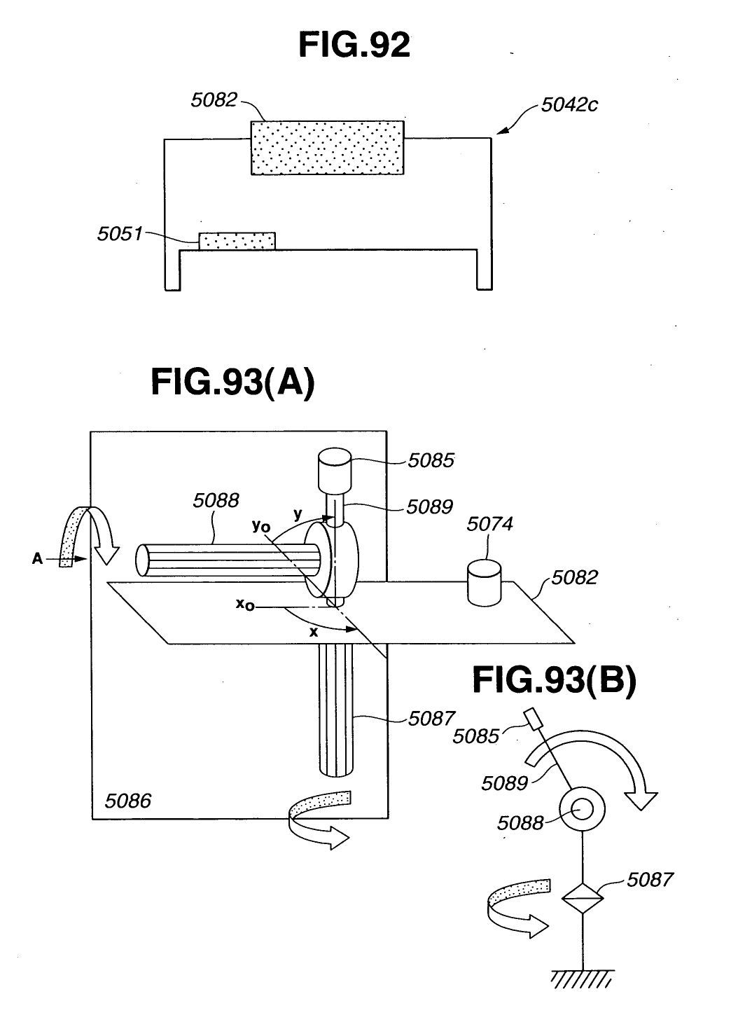

Next, a twenty-third embodiment of the present invention will be described with reference to FIG. 92 to FIG. 95.

FIG. 92 shows the appearance of an infrared communication adaptor 5042C included in the twenty-third embodiment. The infrared communication adaptor 5042C has a connector capable of being attached or detached to or from the portable terminal 5041, an infrared communication port 5082, and a serial communication port 5051. Similarly to the twenty-first embodiment, the infrared communication adaptor 5042C is attached to the portable terminal 5041 (or infrared communication port 5025).

FIG. 93A schematically shows the structure of the infrared communication port 5082 of the infrared communication adaptor 5042C included in the present embodiment. FIG. 93B is a functional block diagram of the infrared communication port seen in a direction of arrow A in FIG. 93A.

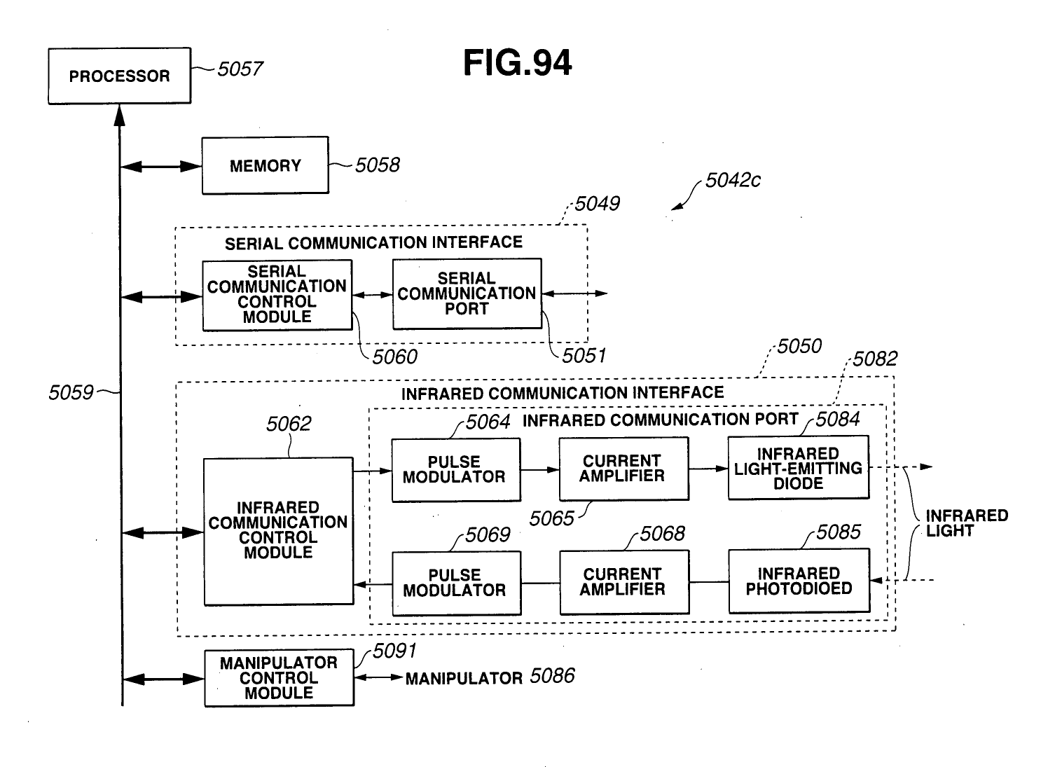

The infrared communication port 5082 of the infrared communication adaptor 5042C included in the present embodiment includes an infrared light-emitting diode 5084 and an infrared photodiode 5085. Moreover, a manipulator 5086 is included for varying the angle of the infrared communication port 5082 for better infrared communication. The manipulator 5086 includes a motor 5087 and a motor 5088 whose rotation shafts are perpendicular to each other. The manipulator 5086 is driven by a manipulator control module 5091 under the control of a processor 5057 shown in FIG. 94.

Referring to FIG. 93A, the infrared photodiode 5085 is fixed to the tip of a support shaft 5089 projecting upwards from the top of the infrared communication adaptor 5042C. As shown in FIG. 93B, when the motor 5087 rotates about the vertical shaft (orthogonal to the top), the infrared photodiode 5085 rotates together with the motor 5088 on the top of the infrared communication adaptor 5042C. With the rotation of the motor 5088 that extends in a direction orthogonal to the direction of the rotation shaft of the motor 5087 and that can rotate freely, the support shaft 5089 having the infrared photodiode 5085 fixed thereto can be tilted at any angle with respect to the top of the infrared communication adaptor 5042C.

FIG. 94 is a block diagram showing the internal configuration of the communication adaptor 5042C. The communication adaptor 5042C has, in addition to the same elements as those shown in FIG. 85, the manipulator control module 5091 that controls the manipulator 5086.

To be more specific, a memory 5058, a serial communication interface 5049, an infrared communication interface 5050, and the manipulator control module 5091 are electrically connected to a processor 5057, which controls the entire communication adaptor 5042C, over a data bus 5059.

The processor 5057 not only controls the same facilities as those described in relation to the twenty-first embodiment but also controls the manipulator 5086 via the manipulation control module 5091. Moreover, the processor 5057 controls the angle of the infrared communication port 5082 optimally for infrared communication (time-sequentially or all the time).

The serial communication interface 5049 includes a serial communication control module 5060 and a serial communication port 5051, and enables serial communication with an external terminal.

The infrared communication interface 5050 includes an infrared communication control module 5062 and an infrared communication port 5082, and enables infrared communication with an external terminal. The infrared communication port 5052 consists of a transmitting module including a pulse modulator 5064, a current amplifier 5065, and an infrared light-emitting diode 5084, and a receiving module including an infrared photodiode 5085, a current amplifier 5068, and a pulse demodulator 5069.

Next, an operation to be exerted by the present embodiment will be described below.

The manipulator control module 5091 drives the motors 5087 and 5088 so as to control the action of the manipulator 5086. In particular, the manipulator control module 5091 varies the orientation (three-dimensional angle) of the infrared photodiode 5085 projecting from the top of the communication adaptor 5042C (or the support shaft 5089 having the infrared photodiode 5085 fixed to the tip thereof).

Assume that the angle of the infrared photodiode 5085 (with respect to a reference direction x0) determined by the motor 5087 is x and the angle thereof (with respect to a reference direction y0) determined by the motor 5088 is y. The reason why the manipulator 5086 is driven is to search for the angles x and y, which permit the infrared photodiode 5085 to offer relatively high receiver sensitivity for infrared light waves, and to tilt the infrared photodiode 5085 at a state determined with the angles. This is intended to bring the infrared photodiode 5085 to a state ensuring excellent infrared communication.

The manipulator 5086 determines the orientation of the infrared photodiode 5085 at the start of infrared communication.

The angles x and y are varied to the greatest possible extent in order to search for the angles permitting the infrared photodiode 5085 to offer high receiver sensitivity for infrared light waves. The infrared photodiode 5085 has the orientation thereof varied so as to attain the angles.

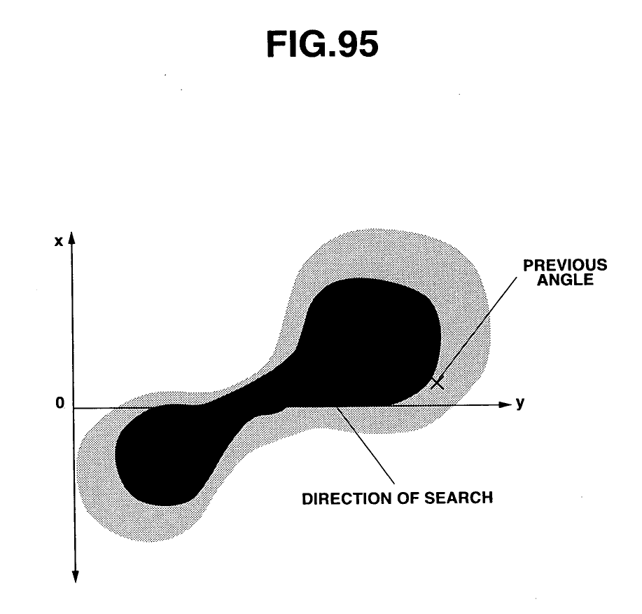

Furthermore, the manipulator 5086 varies the orientation of the infrared photodiode 5085 even during infrared communication. FIG. 95 shows how to search for the angles permitting the infrared photodiode 5085 to offer high receiver sensitivity for infrared light waves.

The manipulator 5086 perturbs the infrared photodiode 5085 to slightly change the angles x and y. If the infrared receiver sensitivity is lower than it is attained at the previous angles, the angles of the infrared photodiode 5085 are restored to the previous angles.

If the infrared receiver sensitivity is equal to or higher than it is attained at the previous angles, the angles of the infrared photodiode 5085 are not restored but angles permitting a higher sensitivity are searched for. In other words, the infrared photodiode 5085 is repeatedly moved to such an extent that infrared communication will not be hindered. Consequently, the infrared photodiode 5085 is oriented in a direction (at angles) permitting locally the highest receiver sensitivity for infrared light waves. The orientation causes the infrared photodiode 5085 of the infrared communication port 5082 to face the infrared communication port 5025 connected to the system controller 5021.

Referring to FIG. 95, the infrared photodiode 5085 is positioned at the angles permitting the higher infrared receiver sensitivity than the previous angles (indicated with an arrow). FIG. 95 shows a range of positions permitting a higher level of infrared receiver sensitivity with a darker hatch.

Except the fact the manipulator control module 5091 is included for controlling the manipulator, the actions of the infrared communication adaptor 5042C are identical to those of the infrared communication adaptor included in the twenty-first embodiment. Incidentally, the infrared light-emitting diode 5084 may be moved concurrently with the infrared photodiode 5085. Namely, the elements constituting the transmitting module may be controlled similarly to a receiving means (that is, the elements constituting the receiving module). Moreover, instead of controlling the receiving elements, the transmitting elements may be controlled.

A doctor or nurse carries the portable terminal 5041, to which the infrared communication adaptor 5042C is attached, so as to use it. The infrared communication port 5082 autonomously varies its orientation so as to face the infrared communication port 5025 connected to the system controller 5021. The doctor or nurse therefore need not move the infrared communication port 5082 so that the infrared communication port 5082 will face the infrared communication port 5025.

The present embodiment provides advantages described below.

Since the manipulator 5086 moves the infrared photodiode 5085, infrared light waves readily fall on the infrared communication port 5082. A doctor or nurse who carries the portable terminal 5041 is freed from the labor of walking about in an operating room until the infrared communication port 5082 faces the infrared communication port 5025. This leads to improved user-friendliness and a shortened surgical time.

A description has been made on the assumption that the angles of the infrared communication port 5082 included in the infrared communication adaptor 5042C attached to the portable terminal 5041 are set to appropriate values permitting excellent communication all the time. The same applies to the infrared communication port 5025 connected to the system controller 5021.

### Twenty-Fourth Embodiment

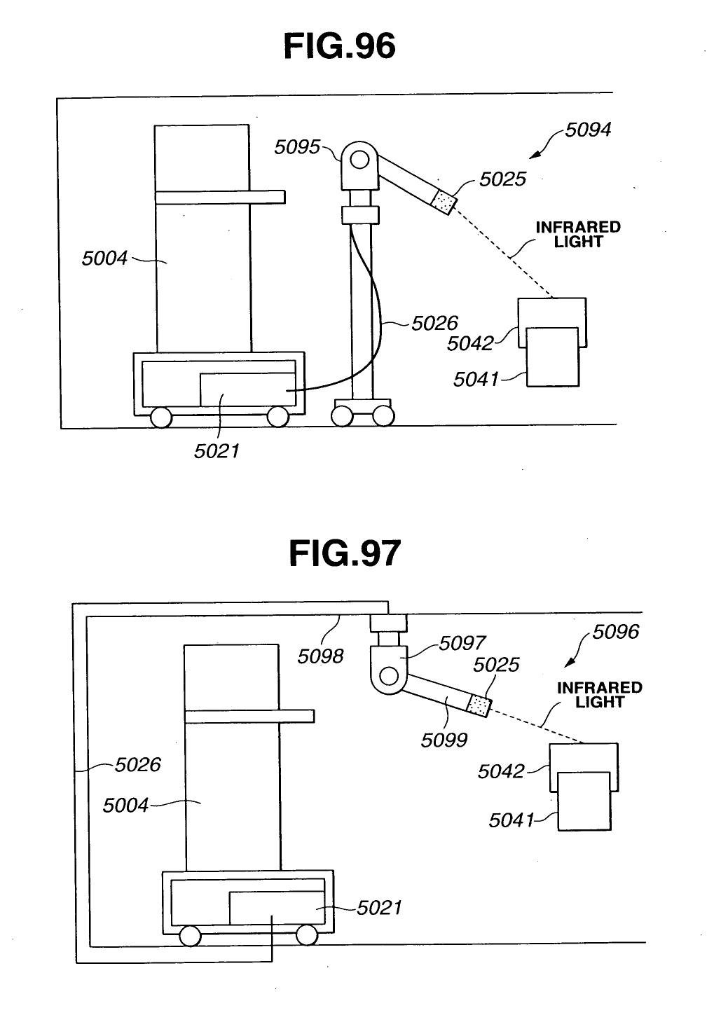

Next, a twenty-fourth embodiment of the present invention will be described with reference to FIG. 96. FIG. 96 shows an endoscopic surgery system 5094 including the twenty-fourth embodiment.

The endoscopic surgery system 5094 has, in addition to the same components as the endoscopic surgery system 5001 including the twenty-first embodiment, an infrared communication port support cart 5095. The infrared communication port 5025 (mounted on the first cart 5004 in the twenty-first embodiment) is mounted on the infrared communication port support cart 5095.

The infrared communication port support cart 5095 has casters fixed to the bottom thereof so that it can move freely. The infrared communication port support cart 5095 can be easily moved to any position.

Moreover, the infrared communication port 5025 is fixed to the distal end of, for example, a movable arm 5099 of the infrared communication port support cart 5095. The proximal end of the movable arm 5099 is borne so that it can pivot freely. The movable arm 5099 can therefore be freely positioned manually. A user can easily direct the infrared communication port 5025 fixed to the distal end of the movable arm 5099 so that the infrared communication port 5025 will face the infrared communication port 5052 of the infrared communication adaptor 5042 attached to the portable terminal 5041 the user carries. The other features are identical to those of the twenty-first embodiment.

An operation to be exerted by the present embodiment will be described below.

A doctor or nurse can easily move the infrared communication port support cart 5095 to a position permitting easy infrared communication, and then perform surgery.

The present embodiment provides advantages described below.

The infrared communication port 5019 can be easily moved to a position permitting easy infrared communication. This leads to improved efficiency in surgery. The other advantages are identical to those of the first embodiment.

### Twenty-Fifth Embodiment

Next, a twenty-fifth embodiment of the present invention will be described with reference to FIG. 97. FIG. 97 shows an endoscopic surgery system 5096 including the twenty-fifth embodiment.

The endoscopic surgery system 5096 has, in addition to the same components as the endoscopic surgery system 5001 including the twenty-first embodiment, an infrared communication port supporting arm stand 5097. The infrared communication port 5025 (mounted on the first cart 5004 in the twenty-first embodiment) is fixed to the infrared communication port supporting arm 5097.

The infrared communication port supporting arm stand 5097 is hung on the ceiling 5098 of an operating room. However, a cable 5026 is embedded in the wall of the operating room. A movable arm 5099 extending from the infrared communication port supporting arm stand 5097 allows a user to manually and freely change the orientation of the infrared communication port 5025. Moreover, the infrared communication port supporting arm stand 5097 hung on the ceiling 5098 can be rotated freely.

The other features are identical to those of the twenty-first embodiment.

Next, an operation to be exerted by the present embodiment will be described.

A doctor or nurse manually moves the proximal end of the infrared communication port supporting arm stand 5097 or the movable arm 5099 so as to orient the infrared communication port 5025 at an angle facilitating infrared communication. Thereafter, surgery is performed.

The present embodiment provides an advantage described below.

Compared with the twenty-fourth embodiment, a movable range of the infrared communication port 5025 is limited. However, since the infrared communication port supporting cart 5095 need not be placed around the cart 5004, the space in an operating room will not be narrowed. This leads to improved user-friendliness and improved efficiency in surgery.

The angle or orientation of the infrared communication port 5025 fixed to the distal end of the movable arm 5099 may be controlled as described in relation to the twenty-third embodiment. Thus, the infrared communication port 5025 may be retained at the angle facilitating infrared communication.

The infrared communication port 5052 may be fixed to an end of a cable extended from the infrared communication adaptor 5042 included in the twenty-first embodiment. The end of the cable may be designed to be able to be mounted on, for example, the head of a user such as a doctor. Thus, even when the user's orientation varies, infrared light waves will not be intercepted but infrared communication can be continued.

### Twenty-Sixth Embodiment

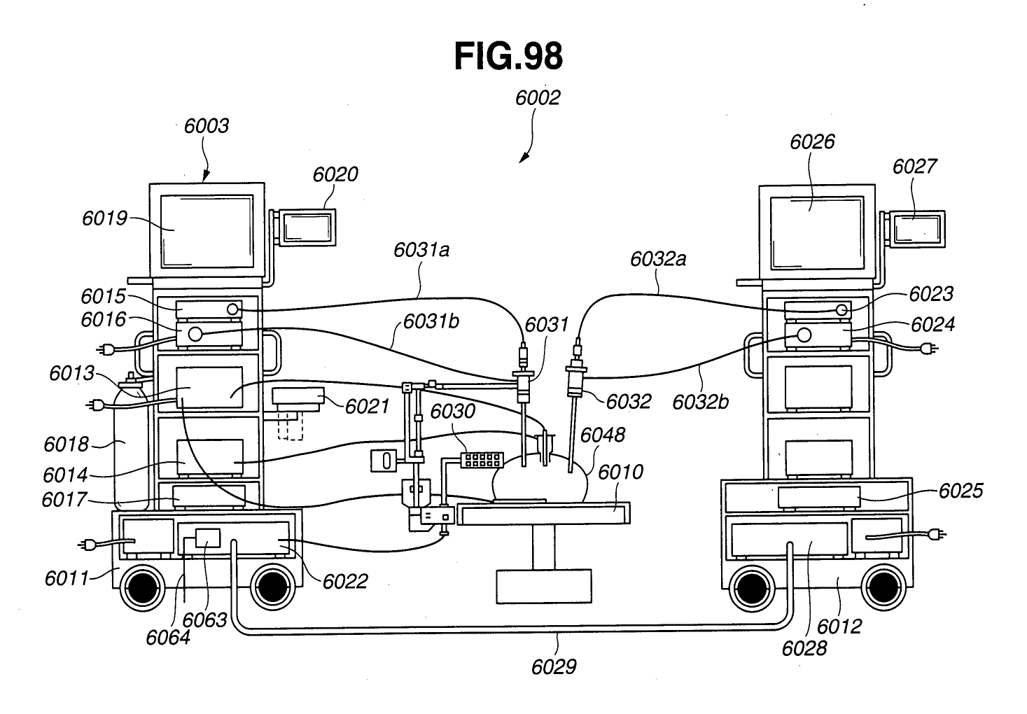

First, the overall configuration of an endoscopic surgery system 6003 installed in an operating room 6002 will be described in conjunction with FIG. 98.

Referring to FIG. 98, a patient couch 6010 on which a patient 6048 lies down and an endoscopic surgery system 6003 are installed in an operating room 6002. The endoscopic surgery system 6003 includes a first cart 6011 and a second cart 6012.

Medical equipment or controlled apparatuses, for example, an electrocautery unit 6013, an insufflator unit 6014, an endoscopic camera unit 6015, a light source unit 6016, a video tape recorder (VTR) 6017, and a chemical cylinder 6018 filled with carbon dioxide are integrated into the first cart 6011. The endoscopic camera unit 6015 is connected to a first endoscope 6031 over a camera cable 6031a. The light source unit 6016 is connected to the first endoscope 6031 over a light guide cable 6031b.

Moreover, a display device 6019, a first centralized display panel 6020, and an operator panel 6021 are mounted on the first cart 6011. The display device 6019 is, for example, a TV monitor on which an endoscopic image or the like is displayed.

The centralized display panel 6020 is a display means on which every information acquired during surgery can be selectively displayed. The operator panel 6021 is composed of a display, for example, a liquid crystal display and touch sensors integrated with the display. The operator panel 6021 serves as a centralized operating unit that is handled by a nurse or the like in a non-sterilized zone.

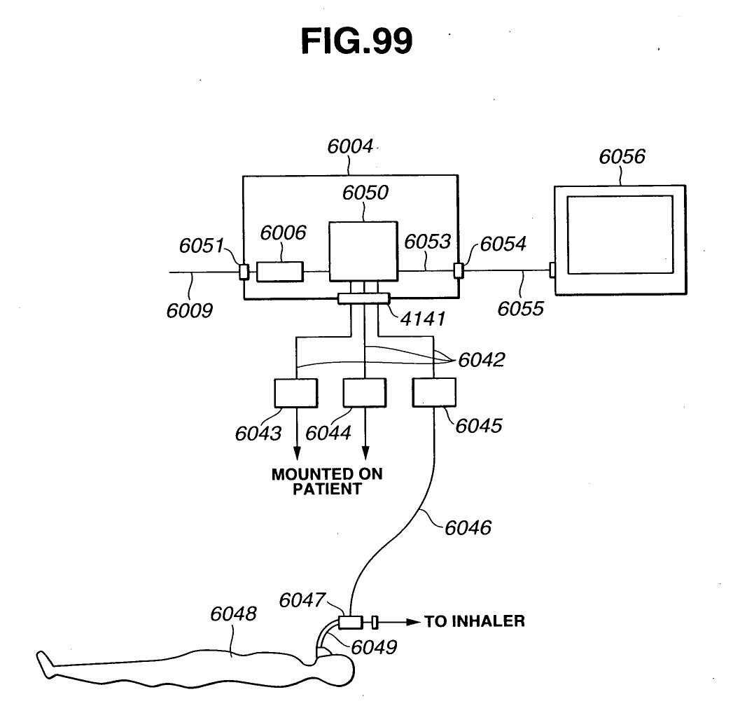

Furthermore, a system controller 6022 that is included in a control system is mounted in the first cart 6011. The electrocautery unit 6013, insufflator unit 6014, endoscopic camera unit 6015, light source unit 6016, and VTR 6017 are connected to the system controller 6022 over transmission lines that are not shown. A communication control module 6063 is incorporated in the system controller 6022. A communication cable 6064 extended from the communication control module 6063 is spliced to a transmission line 6009 shown in FIG. 99.

On the other hand, an endoscopic camera unit 6023, a light source unit 6024, an image processing unit 6025, a display device 6026, and a second centralized display panel 6027 that are controlled apparatuses are integrated into the second cart 6012.

The endoscopic camera unit 6023 is connected to a second endoscope 6032 over a camera cable 6032a. The light source unit 6024 is connected to the second endoscope 6032 over a light guide cable 6032b.

An endoscopic image or the like produced by the endoscopic camera unit 6023 is displayed on the display device 6026. Every information acquired during surgery is selectively displayed on the second centralized display panel 6027.

The endoscopic camera unit 6023, light source unit 6024, and image processing unit 6025 are connected to a relay unit 6028 mounted in the second cart 6012 over transmission lines that are not shown. The relay unit 6028 is connected to the system controller 6022 mounted in the first cart 6011 over a relay cable 6029.

The system controller 6022 controls on a centralized basis the camera unit 6023, light source unit 6024, and image processing unit 6025 which are mounted in the second cart 6012, and the electrocautery unit 6013, insufflator unit 6014, camera unit 6015, light source unit 6016, and VTR 6017 which are mounted in the first cart 6011. When communication links are established between the system controller 6022 and these pieces of equipment, the system controller 6022 can display a setting screen image, which presents the settings of each piece of equipment and operation switches, on the liquid crystal display of the operator panel 6021. Furthermore, when a desired one of the operation switches is touched in order to actuate a touch sensor occupying a predetermined area of the liquid crystal display, the system controller 6022 enables modification or entry of set values.

A remote controller 6030 is a second centralized operating unit that is handled by an operator or the like who lies in a sterilized zone. The remote controller 6030 allows the operator to operate any other equipment, with which a communication link is established, via the system controller 6022. The system controller 6022 analyzes biomedical information sent from a patient monitor system 6004 that will be described later, and displays the results of analysis on the predetermined display device.

Moreover, the system controller 6022 has an infrared communication port (not shown) serving as a communicating means. The infrared communication port is located at a position near the display device 6019 at which infrared light waves can be irradiated readily, and connected to the system controller 6022 over a cable.

Next, the patient monitor system 6004 will be described in conjunction with FIG. 99.

As shown in FIG. 99, the patient monitor system 6004 included in the present embodiment has a signal connector 6041. The signal connector 6041 is connected to vital sign measuring instruments such as an electrocardiograph 6043, a pulse oximeter 6044, and a capnograph 6045 over cables 6042.

The capnograph 6045 is connected to a breath sensor 6047 over a cable 6046. The breath sensor 6047 is fixed on a hose 6049 extending from an inhaler mounted on the patient 6048. Consequently, an electrocardiogram, a blood oxygen saturation, a breath carbon dioxide concentration, and other biomedical information concerning the patient 6048 can be measured.

The signal connector 6041 is electrically connected to a control module 6050 incorporated in the patient monitor system 6004. The control module 6050 is connected to the display device 6056 by way of a video signal line 6053, a video connector 6054, and a cable 6055. Furthermore, the control module 6050 is electrically connected to a communication control module 6006. The communication control module 6006 is coupled to the transmission line 6009 through a communication connector 6051.

The transmission line 6009 is led to a communication controller that is not shown and that is included in the endoscopic surgery system 6003.

Next, an example of a screen image displayed on the operator panel 6021 will be described below.

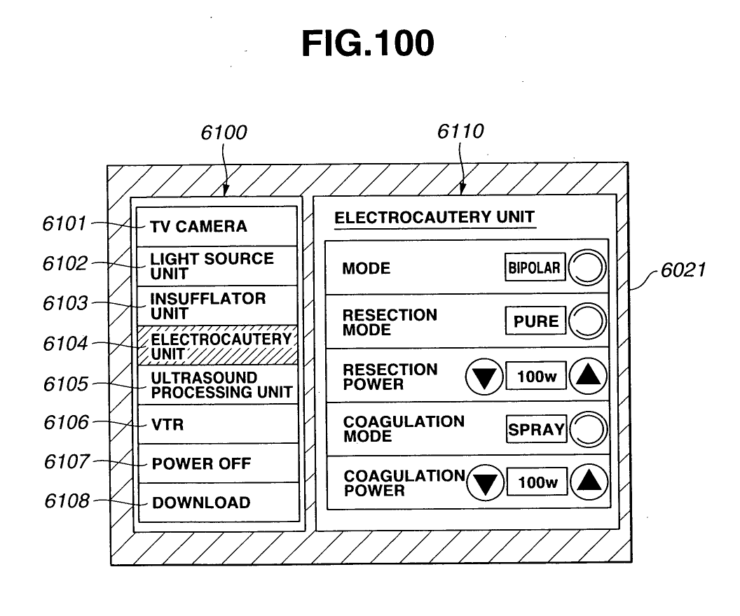

FIG. 100 shows an example of a screen image displayed on the operator panel 6021 when the electrocautery unit is designated. As shown in FIG. 100, the left-hand part of the display screen of the operator panel 6021 is defined as a main menu display area 6100. Fields 6101 to 6108 bearing TV Camera, Light Source Unit, Insufflator unit, Electrocautery unit, Ultrasonic Processing Unit (not shown in the FIG. 1), VTR, Power Off, and Download are displayed on the main menu display area 6100. Herein, the Ultrasonic Processing Unit field is not shown in FIG. 1. In the case shown in FIG. 100, the Electrocautery unit field 6104 is selected and highlighted in yellow (hatched in the drawing). The right-hand part of the display screen of the operator panel 6021 is defined as a setting screen image display area 6110 in which information concerning the selected electrocautery unit is displayed. In short, the right-hand part of the operator panel 6021 serves as a setting screen image display area in which information concerning selected equipment is displayed.

In the setting screen image display area 6110 shown in FIG. 100, the names of electrocautery unit-related items such as Mode, Resection Mode, Resection Power, Coagulation Mode, and Coagulation Power are displayed.

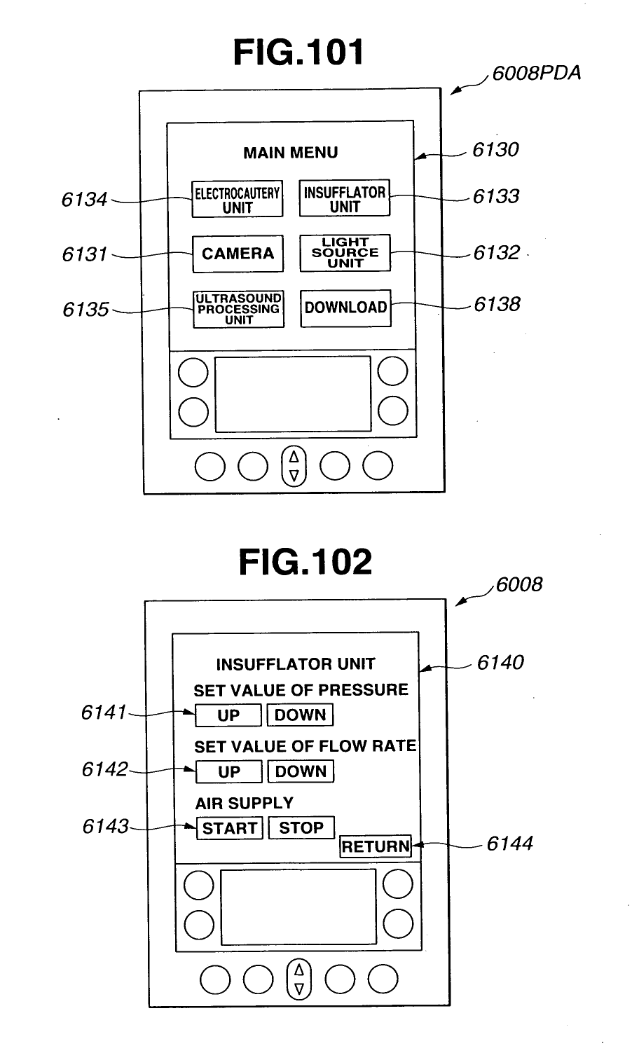

Next, an example of an image displayed on the display operating section of a PDA 6008 an operator carries will be described below. First, an example of a main menu will be described in conjunction with FIG. 101.

FIG. 101 shows a main menu display image 6130 displayed when a control program for surgeons is downloaded. The main menu display image 6130 is displayed on the display operating section of the PDA 6008, and contains fields 6131 to 6135 and 6138 bearing TV Camera, Light Source Unit, Insufflator unit, Electrocautery unit, Ultrasonic Processing Unit, and Download. An operator touches the Download field 6138, whereby an identification code transmission screen image (hereinafter an ID transmission screen image) is displayed. An identification code (hereinafter, an ID) that is an identifier of the operator is transmitted. The PDA 6008 has an infrared communication port (not shown) serving as a communicating means.

The display operating section of the PDA 6008 has the capability of a touch-sensitive panel. When the display screen is touched with a finger or the like, a function associated with each field of a display image is designated.

Referring to FIG. 102, an example of an image displayed on the display operating section of the PDA 6008 when one controlled apparatus is designated. FIG. 102 is an explanatory diagram concerning a case where a control menu for the insufflator unit is displayed on the display operating section of the PDA 6008. When the main menu 6130 shown in FIG. 101 is displayed, if the Insufflator unit field 6133 is touched with a finger or the like, the insufflator unit is designated. This results in a screen image shown in FIG. 102.

FIG. 102 shows an insufflator unit control menu display area 6140. Up and Down buttons 6141 are used to increase or decrease the set value of the pressure in the abdominal cavity. Up and Down buttons 6142 are used to increase or decrease the set value of an air flow rate. Start and Stop buttons 6143 are used to start or stop air supply. A Return button 6144 is used to return control to the main menu. An operator of the PDA 6008 touches the portion of the display area corresponding to the Up, Down, Start, or Stop button, whereby the operator can increase or decrease the set value of the pressure or flow rate or can start or stop air supply.

Herein, the system controller 6022, operator panel 6021, and PDA 6008 constitute a control system that controls medical equipment included in the endoscopic surgery system shown in FIG. 98 and the patient monitor system shown in FIG. 99.

Moreover, the system controller 6022 includes: a receiving means that receives predetermined information from each piece of medical equipment; a storage means in which predetermined information received by the receiving means is stored temporarily; and a transmitting means that transmits predetermined information stored in the storage means to the PDA 6008 that also serves as a recording device for recording predetermined information in a predetermined recording medium. Furthermore, the system controller 6022 includes a storage means in which operating programs which surgeons, anesthesiologists, nurses, and clinical engineers use to operate required medical equipment are stored, and a transmitting means that transmits any of the operating programs stored in the storage means to the PDA 6008.

The PDA 6008 includes a storage means in which IDs assigned to surgeons, anesthesiologists, nurses, and clinical engineers are stored.

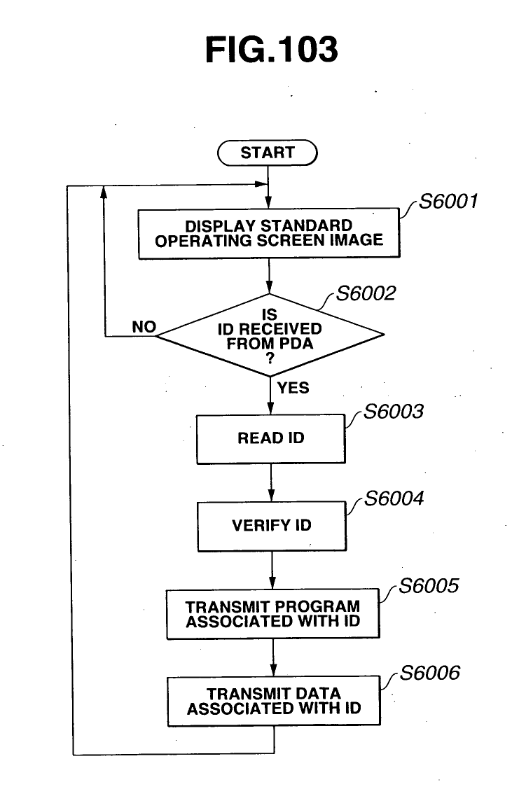

Next, referring to FIG. 103, a control procedure the system controller 6022 follows to enable an operator of the PDA 6008 to install a program or download data. FIG. 103 is a flowchart describing an example of a processing flow of downloading a program or data.

The processing described in FIG. 103 is executed when the power supply of the system controller 6022 is turned on. First, when the power supply of the system controller 6022 is turned on, the system controller 6022 displays a standard screen image on the operator panel 6021 (step S6001). According to the present embodiment, for example, an operating screen image for surgeons like the one shown in FIG. 100 is displayed on the display screen of the operator panel 6021.

Thereafter, it is judged whether an ID is received from the PDA 6008 (S6002). If no ID is received, the judgment is made in the negative at step S6002, and control is returned to step S6001. The standard operating screen image is then displayed, and a normal control procedure is executed. If an ID is received from the PDA 6008, the judgment is made in the affirmative at step S6002. The received ID is read (S6003). Thereafter, the received ID is checked to see to whichever of the surgeons, anesthesiologists, nurses, and clinical engineers the ID is assigned (S6004).

If an operator wants to download a program or data, the operator touches the Download field 6138 that serves as a Download button and that is displayed on the display operating section of the PDA 6008. When the field 6138 is touched with a finger or the like, an ID transmission screen image (not shown) appears on the display operating section. The operator then enters his/her own ID in a predetermined entry field in the displayed ID transmission screen image. The ID is transferred to the PDA 6008. Thereafter, if a Send button (not shown) is pressed, the PDA 6008 transmits the ID to the system controller 6022 through the infrared communication port (not shown). Incidentally, data representing the operator's ID may be stored in the storage means included in the PDA 6008 in advance. This obviates the necessity of entering an ID. Once the Send button is pressed, the ID is transmitted.

Thereafter, the system controller 6022 transmits a control program associated with the verified ID to the PDA 6008. The PDA 6008 downloads the control program (S6005). Thereafter, data associated with the verified ID is transmitted to the PDA 6008, and the PDA 6008 downloads the data (S6006). The program or data to be downloaded to the PDA 6008 varies depending on the verified ID. The downloaded program is installed in the PDA 6008 and now executable.

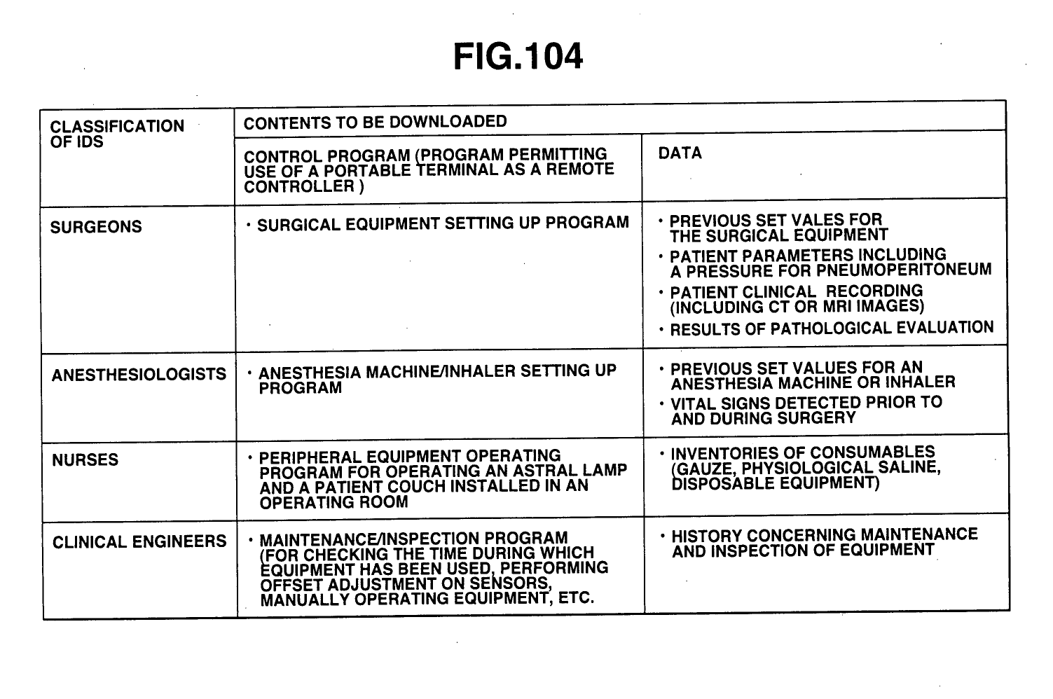

FIG. 104 is an explanatory diagram concerning the contents of programs and data to be downloaded depending on a verified ID. FIG. 104 lists control programs (programs required to use the PDA 6008 as a remote controller) and data items which are downloaded. If a verified ID is assigned to surgeons, a program to be downloaded is a program helping a surgeon to set up surgical equipment. Data to be downloaded is data representing the previous set values for the surgical equipment, patient parameters including a pressure for insufflation, a patient clinical recording (including CT or MRI images), and the results of pathological evaluation. If the verified ID is assigned to anesthesiologists, the program to be downloaded is a program helping an anesthesiologist to set up an anesthesia machine and an inhalator. The data to be downloaded is data representing the previous set values for the anesthesia machine and inhalator, and vital signs detected before and during surgery. If the verified ID is assigned to nurses, the program to be downloaded is a program helping a nurse operate peripheral equipment installed in an operating room, such as, an astral lamp and a patient couch. The data to be downloaded is data representing the inventories of gauze, physiological saline, disposable equipment, and other consumables. If the verified ID is assigned to clinical engineers, the program to be downloaded is a maintenance/inspection program helping a clinical engineer check the time during which equipment has been used, perform offset adjustment on sensors, or manually operate equipment. The data to be downloaded is data that represents a history concerning maintenance and inspection of equipment. When step S6006 is completed, control is returned to step S6001 and the standard operating screen image is displayed.

When the surgeon program is downloaded, the main menu 6130 provided by the surgeon program is, as shown in FIG. 103, displayed on the display operating section of the PDA 6008.

The standard operating screen image displayed on the operator panel 6021 may be an operating screen image associated with a control program selected depending on a verified ID.

The control program and data to be preserved in the system controller 6022 can be updated any time. Thus, the latest program and data are preserved owing to maintenance. Consequently, the latest program and data are downloaded to the PDA 6008.

Furthermore, an ID assigned to the PDA 6008 may be an IPv6 address used a protocol in the Internet. In this case, communication with other system or external facility can be simplified.

In particular, even when no program is installed in the PDA 6008, a setting data editor program may be automatically downloaded to the PDA 6008 at the start of operation or use of the PDA 6008. Thus, medical equipment can be operated easily using the PDA 6008. Any portable information terminal can be adopted as the PDA 6008.

Data representing the settings of peripheral equipment that is medical equipment is transmitted to the PDA 6008, and the setting data is preserved in the PDA 6008. An operator or the like can modify the setting data preserved in the PDA 6008 or add data to the setting data while being apart from an operating room. The PDA 6008 may be used to check preserved data or modify setting data prior to surgery, or to transmit data representing the settings of each piece of medical equipment so as to modify all the set values preserved in the medical equipment prior to surgery.

As mentioned above, an operator should merely transmit an ID using the PDA 6008 so as to download a required program and required data. Thus, the operator can make preparations for surgery readily and accurately. This leads to a shortened preparation time and improved efficiency in making preparations for surgery.

According to the present embodiment, IDs are classified into four kinds assigned to surgeons, anesthesiologists, nurses, and clinical engineers. Irrespective of the classification, each person may be allowed to designate required parameters and data and preserve them in the system controller 6022. In this case, a program and data associated with each person's ID is stored in the storage device of the system controller 6022. The system controller 6022 reads a program and data associated with each person on the basis of a verified ID, and transmits the program and data to the PDA 6008.

Moreover, data representing a department to which an operator belongs (department of surgery, obstetrics and gynecology, or the like) may be adopted as data concerning the operator. The department data may be transmitted from the PDA 6008 to the system controller 6022. The system controller 6022 may in turn determine data to be downloaded on the basis of the department data, and transmit it to the PDA 6008. Since the data representing a department is utilized and personal data concerning each operator need not be preserved, the system controller 6022 may offer a small storage capacity.

If each operator is provided with a predetermined PDA 6008, that is, if the owner of each PDA 6008 is determined, an ID may not be an operator's ID but may be an ID assigned to each PDA. In this case, once an operator touches the Download button, data representing the ID is transmitted from the PDA 6008 to the system controller 6022. The system controller 6022 transmits a required program and data on the basis of the received ID data. The operator can therefore easily download the program and data to the PDA 6008.

According to the present embodiment, a control program and data are downloaded from the system controller 6022. Alternatively, the control program and data may be downloaded from any other system or equipment installed in another hospital over a telephone network or any other transmission line. In this case, a required program and data can be acquired from equipment installed in another hospital or the like. This obviates the necessity of preserving data in a control system installed in each hospital. A more convenient control system ensues.

### Twenty-Seventh Embodiment

Next, a twenty-seventh embodiment will be described below.

According to the twenty-sixth embodiment, the adoption of the PDA 6008 realizes a simplified controller for controlling surgical equipment or the like. However, the PDA 6008 is so small in size that it may be left in an operating room or medical office after surgery and then lost. The present embodiment provides a system enabling a user, who has lost the PDA 6008, to immediately find it out.

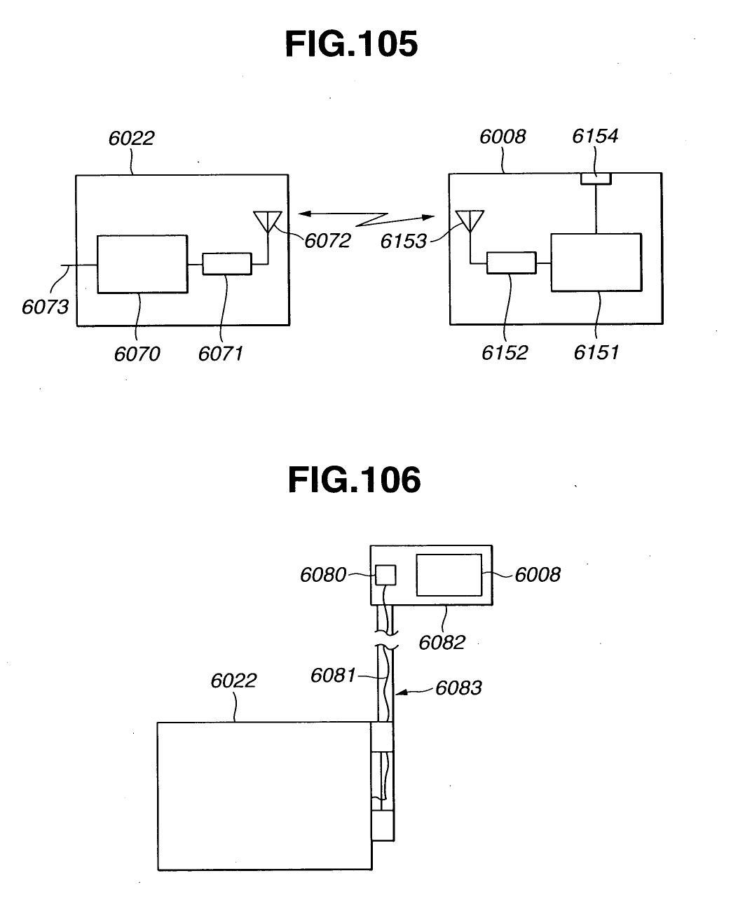

FIG. 105 shows the configuration of an endoscopic surgery system including the twenty-seventh embodiment of the present invention. Referring to FIG. 105, a system controller 6022 includes a control module 6070, a signal transmitting module 6071, and an antenna 6072. The signal transmitting module 6071 and antenna 6072 support communication techniques conformable to the Bluetooth standard or the like. The control module 6070 is connected to the operator panel 6021 over a cable 6073. On the other hand, the PDA 6008 includes a control module 6151, a signal receiving module 6152, an antenna 6153, and a buzzer 6154.

Owing to the above configuration, if the PDA 6008 is lost, an ID assigned to the PDA 6008 to be searched for is entered in a screen image, which is not shown, displayed on the operator panel 6021. Thereafter, when the Send button is pressed, a radio-wave signal inherent to the entered ID is distributed from the antenna 6072. The radio-wave signal is used to search for the PDA. Specifically, for example, a screen image presenting a PDA Search button is displayed on the operator panel 6021 and the PDA Search button is then touched. Consequently, an ID entry field appears. An ID is entered in the entry field, and the Send button is touched. Eventually, a radio-wave signal inherent to the ID is originated from the system controller 6022.

The originated radio-wave signal is terminated by the antenna 6153 of the PDA 6008, and processed by the signal receiving module 6152 and control module 6151. If the received ID agrees with the own ID, the buzzer 6154 is sounded. The buzzer 6154 serving as an alarming means sounds for a certain period of time.

Talking of data transmission using radio waves, for example, if the spread spectrum transmission technique is adopted, the system controller 6022 includes a transmitting means composed of a primary modulator and a diffusion modulator, and the PDA 6008 includes a receiving means composed of an inverse diffuser and an information demodulator. The receiving means receives data sent from the transmitting means.

As described above, even if the PDA 6008 is lost, as long as a user performs the aforesaid handling, the buzzer of the PDA 6008 sounds. This assists in finding out the position of the PDA 6008 or a place where the PDA 6008 lies, that is, obviates the necessity of searching for the lost PDA 6008.

Every time the Find button is touched, the radio-wave signal inherent to the ID is originated. The buzzer of the PDA 6008 sounds a plurality of times. A nurse or the like can easily find out the PDA 6008, and surgery will not be hindered.

The present embodiment presents a method of searching for the lost PDA 6008. The system controller 6022 and PDA 6008 may have connectors via which they can be electrically connected, so that unless they are connected to each other, the power supply of the system controller 6022 cannot be turned off. This prevents the PDA 6008 from being lost.

### Twenty-Eighth Embodiment

In relation to the twenty-sixth embodiment, a description has been made of the control procedure using the infrared communication port of a PDA. A typical infrared communication technique is based on the IrDA standard. Although the IrDA technique offers bi-directional transmission and reception, it has a drawback that a communication-enabled distance is limited to approximately 30 cm. In relation to the present embodiment, a description will be made of a method of preventing occurrence of such an incident that a PDA recedes by a distance longer than the communication-enabled distance, communication is suspended.

FIG. 106 shows the configuration of an endoscopic surgery system including the present embodiment.

Referring to FIG. 106, a system controller 6022 has a supporting rod 6083 fixed to one side of the casing thereof. An infrared communication port 6080 is connected to the system controller 6022 over a cable 6081. The infrared communication port of the PDA 6008 and the infrared communication port 6080 are fixed to a locking plate 6082 serving as a folder so that their infrared irradiating surfaces will be opposed to each other. The locking plate 6082 is fixed to the system controller 6022 with the supporting rod 6083 between them.

The PDA 6008 can be detachably attached to the locking plate 6082. The locking plate 6082 has a locking member in which the PDA 6008 is locked so that the distance between the infrared communication port of the PDA 6008 and the infrared communication port 6080 will remain constant and the positions of the infrared communication ports will remain unchanged.

Owing to the foregoing features, when the settings of surgical equipment are determined through a menu screen image displayed on the PDA 6008, infrared communication conformable to the IrDA standard or the like is achieved between the infrared communication port of the PDA 6008 and the infrared communication port 6080. The settings of the surgical equipment are modified via the system controller 6022. At this time, the distance between the infrared communication terminal 6080 of the PDA 6008 and the infrared communication port connected to the system controller 6022 is retained at a value equal to or smaller than the communication-enabled distance. Therefore, communication is achieved reliably.

According to the present embodiment, the PDA 6008 and infrared communication port 6080 are fixed to the same member. Alternatively, if the PDA 6008 is immobilized using a turnable member that can turn with the infrared communication port 6080 as a center, user-friendliness improves. In this case, even if an operator moves the PDA 6008 to any position at which the PDA can be operated easily and immobilizes the PDA 6008 thereat, the transmitting and receiving member incorporated in the PDA 6008 and a transmitting and receiving member incorporated in the locking plate 6082 will maintain a certain distance and angle between them.

As described above, according to the twenty-eighth embodiment, the IrDA-conformable transmitting and receiving member of a PDA and the transmitting and receiving member of a communication partner are immobilized with a certain distance between them. Infrared communication will not be suspended. This results in a more user-friendly control system.

### Twenty-Ninth Embodiment

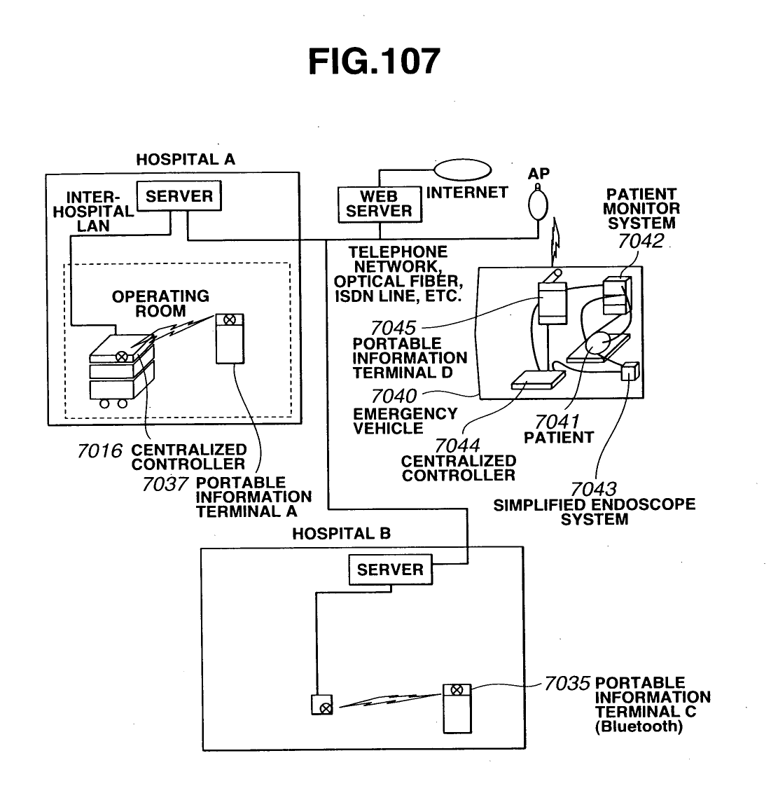

Referring to FIG. 107, the overall configuration of a medical equipment control system in accordance with the present invention will be described below. A server connected on the Internet via a Web server over a telephone line, an optical fiber, or ISDN line is installed in each of hospitals A and B.

The server in hospital A is connected to a centralized controller 7016 included in an endoscopic surgery system installed in an operating room over an intra-hospital LAN. The centralized controller 7016 is connected to a portable information terminal A 7037 by radio or through infrared communication.

The server in hospital B is connected to an access point (AP) that is connected to an endoscopic surgery system, which is analogous to the endoscopic surgery system in hospital A, though it is not shown, over an intra-hospital LAN. A portable information terminal C 7039 is included for communicating with the access point by radio or infrared light waves.

The telephone line, optical fiber, or ISDN line includes access points (AP) that are accessible by radio or infrared light waves. The access points (AP) are accessible to a portable information terminal D 7045 aboard an emergency vehicle 7040.

A patient monitor system 7042 capable of measuring an electrocardiogram, a pulse rate, a blood pressure, and other vital signs of a patient 7041, and a simplified endoscope system 7043 including a simplified endoscopic light source unit, a simplified endoscopic camera unit, and a simplified endoscope, and a centralized controller 7044 that drives and controls the patient monitor system 7042 and simplified endoscope system 7043 are loaded on the emergency vehicle 7040. The centralized controller 7045 is connected to the portable information terminal D 7045 via interfaces.

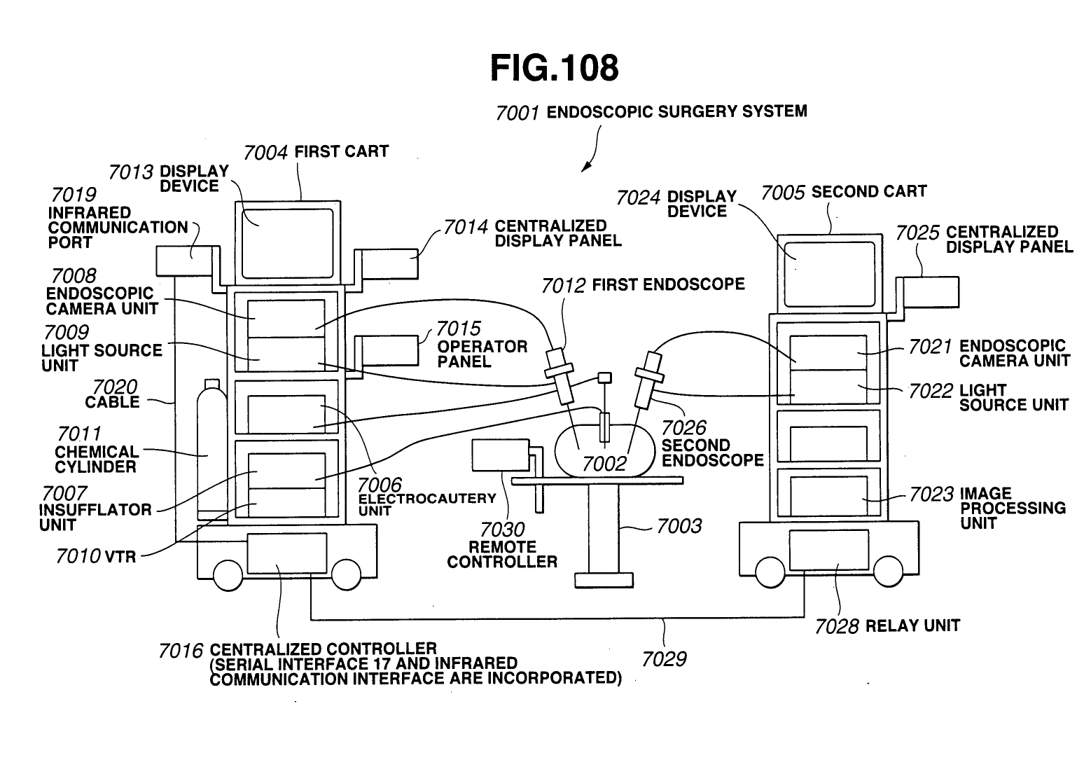

The endoscopic surgery system installed in the operating room in hospital A will be described in conjunction with FIG. 108. The endoscopic surgery system 7001 is divided into a first cart 7004 and a second cart 7005 with a patient couch 7003, on which a patient 7002 lies down, between them.

Medical equipment, for example, an electrocautery unit 7006, an insufflator unit 7007, an endoscopic camera unit 7008, a light source unit 7009, a VTR 7010, and a chemical cylinder 7011 filled with carbon dioxide are integrated into the first cart 7004. The electrocautery unit 7006 and insufflator unit 7007 are connected to an electrocautery and insufflator respectively over cables. The endoscopic camera unit 7008 is connected to a first endoscope 7012 over a camera cable.

Moreover, a display device 7013, a centralized display panel 7014, and an operator panel 7015 are mounted on the first cart 7004. The display device 7013 is, for example, a TV monitor on which an endoscopic image or the like picked up by the first endoscope 7012 is displayed. The centralized display panel 7014 is a display means on which every information acquired during surgery can be selectively displayed. The operator panel 7015 is composed of a display, for example, a liquid crystal display and touch sensors integrated with the display. The operator panel 7015 serves as a centralized operating unit to be handled by a nurse or the like in a non-sterilized zone.

Furthermore, a centralized controller 7016 is mounted in the first cart 7004. The centralized controller 7016 is connected to the electrocautery unit 7006, insufflator unit 7007, endoscopic camera unit 7008, light source unit 7009, and VTR 7017 over transmission lines that are not shown. A serial communication interface and an infrared communication interface are incorporated in the centralized controller 7016. The centralized controller 7016 is connected to an infrared communication port 7019, which is part of an infrared communication interface, over a cable 7020.

On the other hand, an endoscopic camera unit 7021, a light source unit 7022, an image processing unit 7023, a display device 7024, and a centralized display panel 7025 are integrated into the second cart 7005.

The endoscopic camera unit 7021 is connected to a second endoscope 7026 over a camera cable. An endoscopic image or the like produced by the endoscopic camera unit 7021 is displayed on the display device 7024. Every information acquired during surgery can be selectively displayed on the centralized display panel 7025.

The endoscopic camera unit 7021, light source unit 7022, and image processing unit 7023 are connected to a relay unit 7028, which is mounted in the second cart 7005, over transmission lines that are not shown. The relay unit 7028 is connected to the centralized controller 7016, which is mounted in the first cart 7004, over a relay cable 7029.

A remote controller 7030 located near the patient couch 7003 serves as a second centralized operating unit to be handled by an operator who lies in a sterilized zone. Using the remote controller 7030, the endoscopic surgery system 7001 can be operated via the centralized controller 7016.

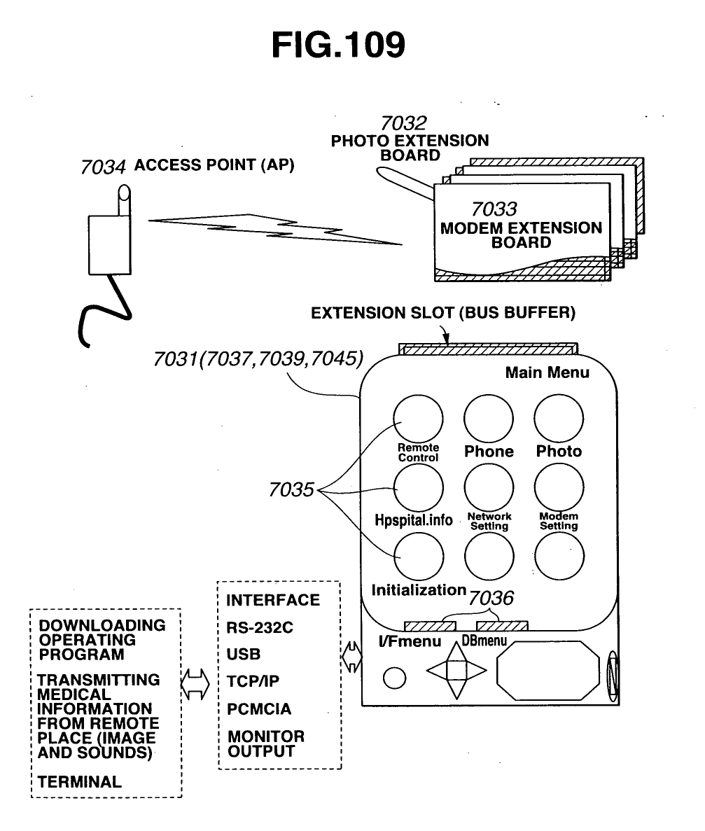

Next, the configurations of the portable information terminals A 7037, C 7039, and D 7045 will be described in conjunction with FIG. 109. Incidentally, the portable information terminals A 7037, C 7039, and D 7045 will be generically called a portable information terminal 7031. The portable information terminal 7031 serves as a centralized operating unit to be handled in order to remotely operate the endoscopic surgery system 7001, and is, for example, a PDA. An infrared communication adaptor is incorporated in the portable information terminal 7031 in order to reinforce wireless communication with the centralized controller 7016.

Furthermore, a modem extension board 7033 enabling transfer of information such as sounds over a telephone line, a photo extension board 7032 that provides a photographing facility, an image pickup facility, and an image processing facility can be inserted into an extension slot. For communications over a telephone line or ISDN line, the portable information terminal 7031 is connected using a cable that is not shown or connected on a wireless network via an access point 7034.

Application programs for realizing the capabilities of a remote controller, an image processor, a telephone, a hospital information processor, a network setup module, a modem setup module, and an initialization module are installed in the portable information terminal 7031, and specific program.

When an Interface Menu button 7036 or a Database Menu button 7036 is pressed, screen images are changed. A communication screen image or a database perusal screen image that is not shown is displayed.

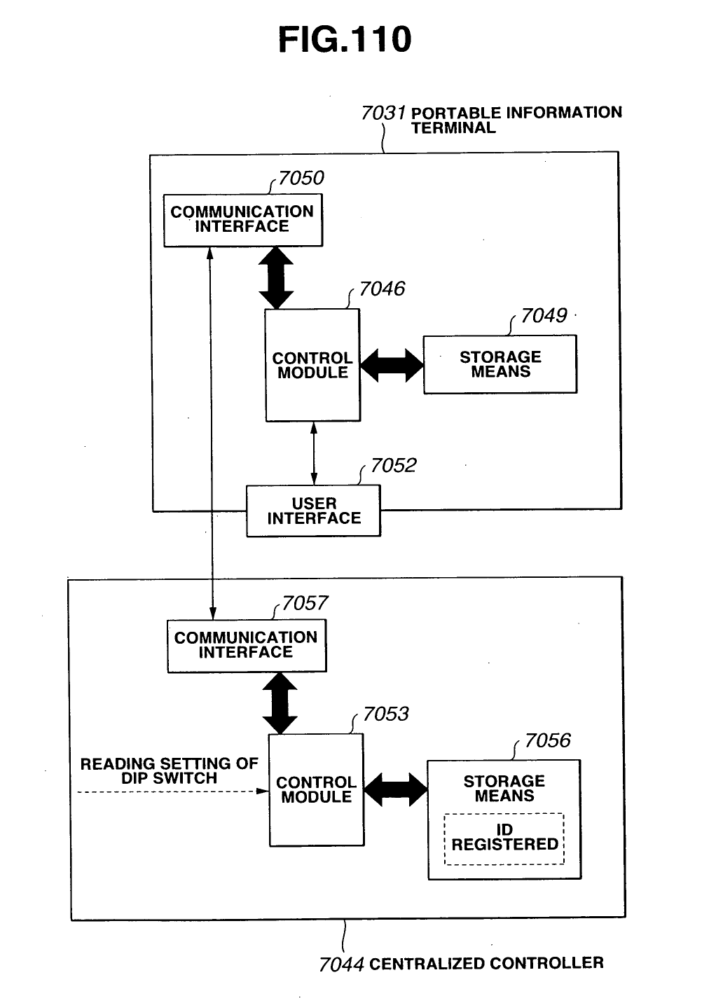

The internal configurations of the portable information terminal 7031 and centralized controller 7016 will be described in conjunction with FIG. 110. The portable information terminal 7031 includes a control module 7036, a rewritable storage means 7049 in which data can be stored, a communication interface 7050, and a user interface 7052.

The centralized controller 7016 includes a control means 7053, a storage means 7056 in which data can be stored, and a communication interface 7057. An application control program is stored in the storage means 7056. Moreover, usable equipment IDs may be sorted based on whether the equipment relates to remote control or communication, and stored in the storage means 7056 in the form of a database. The centralized controller 7044 loaded on the emergency vehicle 7040 has substantially the same configuration as the centralized controller 7016.

When the endoscopic surgery system having the foregoing components is used to perform endoscopic surgery, the endoscopic surgery system 7001 shown in FIG. 108 is first set up. The insufflator unit 7007 is actuated in order to supply carbon dioxide, which is contained in the chemical cylinder 7011, to the body cavity of the patient 7002 for the purpose of dilating the body cavity. A field of view offered by an endoscope is then visualized. During surgery, the centralized controller 7016 requests the insufflator unit 7007 for information through polling, and presents the operating state of the insufflator unit 7007 using the centralized display panel 7014. Based on information on air supply from the chemical cylinder 7011 and a measured pressure value, the centralized controller 7016 recognizes that endoscopic surgery is in progress.

Light emanating from the light source unit 7009 is irradiated to a patient's body cavity. The illuminated body cavity is imaged using the first endoscope 7012. An image produced by the endoscopic camera unit 7008 is displayed on the centralized display device 7013. At the same time, the electrocautery unit 7006 is used to treat a lesion.

The centralized controller 7016 drives and controls the pieces of medical equipment 7006 to 7015. The set values and/or measured values for the pieces of medical equipment 7006 to 7015 are presented using the centralized display panel 7014. A selected command field contained in a screen image displayed on the operator panel 7015 is identified and reflected on the pieces of medical equipment 7006 to 7015. Moreover, the centralized controller 7016 controls the pieces of peripheral equipment 7021 to 7025 integrated into the second cart via the relay unit 7028.

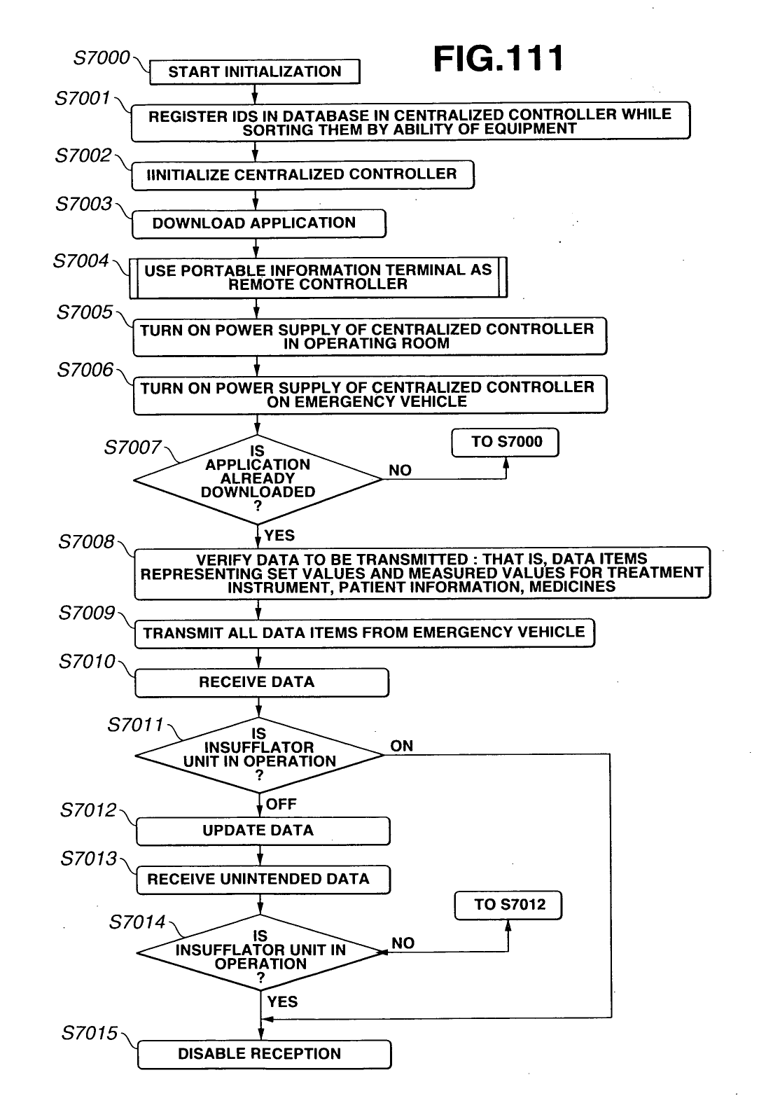

Initialization during which control software is downloaded to the centralized controllers 7016 and 7044 using the portable information terminal 7031, and communication limitations to be imposed in order to permit network communication before and after surgery will be described in conjunction with FIG. 111.

The power supply of the centralized controller 7016 is turned on in order to start initialization. At step S7001, IDs assigned to the pieces of medical equipment to be controlled by the centralized controller 7016 are registered in the storage means 7056. At step S7002, an initialization routine is called and started in order to initialize the centralized controller 7016. At step S7003, the communication interface of the portable information terminal 7031 is switched to an interface enabling communication with the centralized controller 7016 over, for example, a USB bus. A remote control application is downloaded into the portable information terminal 7031. An ID assigned to the portable information terminal 7031 is registered in the centralized controller 7016.

Thereafter, at step S7004, a password needed to activate the application is determined. Consequently, the portable information terminal 7031 now has the capability of a remote controller.

The steps S7001 to S7004 are not limited to the centralized controller 16 and portable information terminal 7031. Similar processing is performed on the centralized controller 7044 and portable information terminal 7045 loaded on the emergency vehicle 7040.

At step S7005, a module for transmitting or receiving various kinds of control data that is incorporated in the centralized controller 7016 in an operating room is activated. Moreover, a module for transmitting or receiving various kinds of control data that is incorporated in the centralized controller 7044 on the emergency vehicle 7040 is activated at step S7006.

At step S7007, it is judged whether initialization of the centralized controllers 7016 and 7044 that is performed at steps S7001 to S7006 is completed. Whether the centralized controllers 7016 and 7044 can access the access point is also judged. If the centralized controllers 7016 and 7044 fail to access the access point, initialization is restarted from step S7000.

If it is judged at step S7007 that initialization is completed, data to be transmitted is verified at step S7008.

The patient monitor system 7042 on the emergency vehicle 7040 monitors vital signs including a patient's pulse rate, temperature, and electrocardiogram. The monitored and measured vital signs are preserved in the form of data.

In a hospital, based on the vital sign data that is preserved in the emergency vehicle 7040, an advice is given to emergency staff, a medical procedure and medical equipment required for treatment of a patient to be admitted to the hospital are determined, or preparations are made for initialization of the medical equipment.

At step S7008, the centralized controller 7044 on the emergency vehicle 7040 creates a file containing the data that represents the vital signs measured by the patient monitor system 7042, patient information including a patient's name, age, and sex, and information concerning medicines the patient usually takes.

At step S7009, the data items contained in the file are all transmitted from the portable information terminal D 7045 on the emergency vehicle 7040 to the centralized controller 7016 in hospital A via the server in the hospital and the access point AP.

At step S7010, the centralized controller 7016 in the operating room receives the data sent from the emergency vehicle 7040 via the server in the hospital over the intra-hospital LAN. Otherwise, the centralized controller 7016 receives the data from the portable information terminal A 7037 located in the operating room.

The portable information terminal A 7037 includes communication interfaces that enable infrared communication or radiocommunication conformable to the Bluetooth® standard. The portable information terminal A 7037 communicates with the centralized controller 7016 through the infrared communication port 7019 connected to the centralized controller 7016 via the infrared communication interface thereof. The portable information terminal D 7045 on the emergency vehicle 7040 includes the same communication interfaces.

When the data representing the vital signs and others is received from the emergency vehicle 7040, it is judged at step S7011 whether the centralized controller 7016 in the operating room is being used to treat another patient. In order to judge whether the centralized controller 7016 is in use, since the insufflator unit 7007 is driven during treatment of a patient, it is judged whether the insufflator unit 7007 is driven in order to supply air. If it is judged that the insufflator unit 7007 is in operation, that is, surgery is in progress, reception of the data representing the vital signs and others from the emergency vehicle is rejected.

If it is judged that the insufflator unit 7007 is not driven in order to supply air, the data representing the vital signs and others is received from the emergency vehicle 7040 and stored in the storage means 7056 included in the centralized controller 7016.

The data representing vital signals and others and being preserved in the centralized controller 7016 is read under the control of the control module 7053, and transferred via a character generator or the like that is not shown. Consequently, biomedical information is displayed on the display device 7013 included in the endoscopic surgery system 7001. The pieces of medical equipment 7006 to 7010 and 7021 to 7023 included in the endoscopic surgery system 7001 are then initialized.

Based on the biomedical information displayed on the display device 7013, a doctor in charge gives instructions, which are concerned with treatment and measurement of biomedical information, to the staff aboard on the emergency vehicle 7040.

At step S7013, the patient is transported to the hospital. If unintended data is transmitted to the centralized controller 7016, the driven state of the insufflator unit 7007 is judged at step S7014. If the insufflator unit 7007 is not driven at all, the unintended data is update data with which the data representing vital signals and other is updated. Control is therefore returned to step S7012. If the insufflator unit 7007 is driven, reception of the unintended data is rejected.

As mentioned above, according to the twenty-ninth embodiment of the present invention, the centralized controller manages data items that represent vital signs, which are measured by the patient monitor system 7042 on the emergency vehicle, and patient information. The data is transmitted from the centralized controller on the emergency vehicle to the centralized controller, which controls the pieces of medical equipment installed in an operating room in a hospital, using the portable information terminal. The centralized controller in the operating room having received the data, which represents the vital signs and others and is sent from the emergency vehicle, displays biomedical information concerning a patient on the display device. Moreover, the centralized controller in the operating room transmits instructions and advises, which are given by a doctor in charge, to the emergency vehicle. Moreover, the pieces of medical equipment in the operating room are initialized based on the data representing the vital signs and others under the control of the centralized controller so that surgery can be immediately performed on the patient to be transported by the emergency vehicle.

Moreover, when the pieces of medical equipment in the operating room are currently used to perform surgery on other patient for treatment, the centralized controller judges whether the insufflator unit is driven. Based on the result of the judgment, it is determined whether reception of the data representing vital signs and others from the emergency vehicle is rejected or the patient is accepted.

Moreover, information concerning whether any hospital room is available or information concerning hospital facilities is preserved in the form of a database in the Web server. When a hospital information application is activated through a screen image displayed on the portable information terminal, the latest information on whichever of hospitals can accept an emergency patient can be acquired. If information concerning an emergency patient is transmitted, whether surgery is in progress is automatically judged, and medical equipment is prevented from being incorrectly set up. Higher safety is guaranteed.

### Thirtieth Embodiment

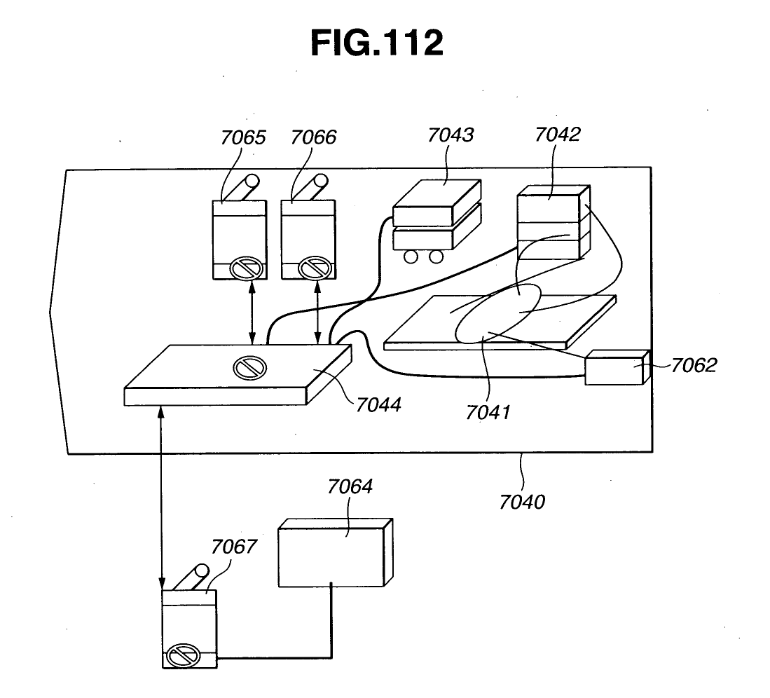

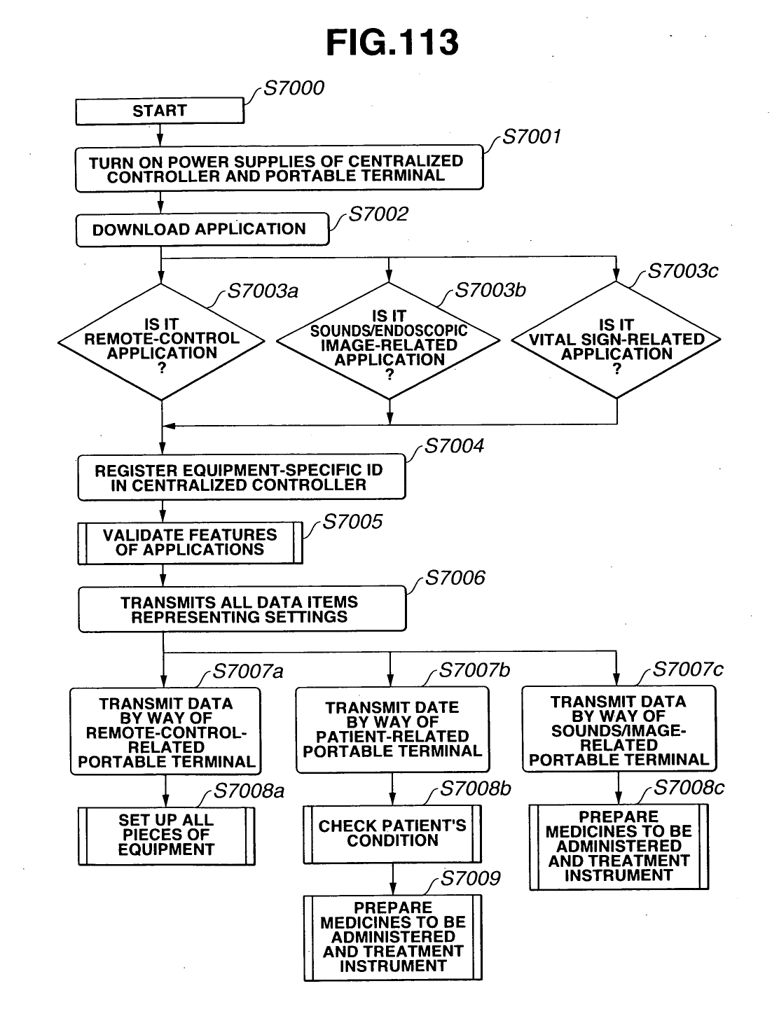

Next, a thirtieth embodiment of the present invention will be described in conjunction with FIG. 112 and FIG. 113. To begin with, the overall configuration of the thirtieth embodiment will be described in conjunction with FIG. 112.

As mentioned previously, a patient monitor system 7042, a simplified endoscope system 7043, a therapeutic unit 7060, and a centralized controller 7044 that controls driving of the patient monitor system 7042, simplified endoscope system 7043, and therapeutic unit 7060 are loaded on an emergency vehicle 7040.

A portable information terminal 7065 that transmits data, which represents vital signs of a patient 7041 measured by the patient monitor system 7042 and other information, while superposing the data on an endoscopic image signal produced by the simplified endoscope system 7043 is also loaded on the emergency vehicle 7040. Moreover, a remote control-related portable information terminal 7066 for use in remotely controlling the patient monitor system 7042, simplified endoscope system 7043, and therapeutic unit 7060 under the control of the centralized controller 7044 is loaded on the emergency vehicle 7040.

Furthermore, the centralized controller 7044 on the emergency vehicle 7040 controls a portable information terminal 7067 and a monitor 7064. The portable information terminal 7067 receives the data that represents the vital signs measured by the patient monitor system 7042 and other information and that is superposed on the endoscopic image signal produced by the simplified endoscope system. Moreover, the monitor 7064 is a liquid crystal display or the like on which the endoscopic image and the vital signs are displayed based on the data received by the portable information terminal 7067.

The actions of the centralized controller 7044 loaded on the emergency vehicle 7040 will be described in conjunction with FIG. 113.

At step S7001, the power supplies of the centralized controller 7044 and portable information terminals 7065, 7066, and 7067 are turned on. At step S7002, applications are downloaded to the portable information terminals 7065 to 7067 respectively. The applications are then installed in the portable information terminals 7065 to 7067 respectively at steps S7003a, S7003b, or S7003c so that the portable information terminals 7065 to 7067 can access an access point via which equipment is remotely controlled, an access point via which sounds and an endoscopic image are processed, or an access point via which data representing vital signs and others is received.

At step S7004, the portable information terminals 7065 to 7067 that access the access points are registered as dedicated portable information terminals in the centralized controller 7044. Namely, the IDs of the portable information terminals 7065 to 7067 are registered in the centralized controller 7044 so that they can run or control the applications.

When the registration of the portable information terminals 7065 to 7067 of step S7004 is completed, the features of the applications are implemented.

At step S7006, the centralized controller 7044 transmits all data items representing set values and measured values. At step S7007a, the data is transmitted by way of the remote control-related portable information terminal 7066. At step S7008a, all pieces of medical equipment are set up according to the set values. If the data is transmitted by way of the patient-related portable information terminal, a patient's condition is checked. If the data is transmitted by way of the sounds/image-related portable information terminal, a medicine to be administered to a patient and a treatment instrument are prepared. At step S7009, preparations are made depending on the feature of each portable information terminal. FIG. 113 presents an example of preparing a medicine to be administered and a treatment instrument at step S7009.

Assume that a simplified endoscope system is used to perform examination or surgery inside an emergency vehicle or an office. In this case, an endoscopic image or vital signs are displayed on the screen of the portable information terminal. Since the simplified endoscope system is designed compactly, examination or treatment can be performed even in a narrow space. Moreover, experts in different fields can transmit or receive expertise. Consequently, an efficient control system can be constructed.

### Thirty-First Embodiment

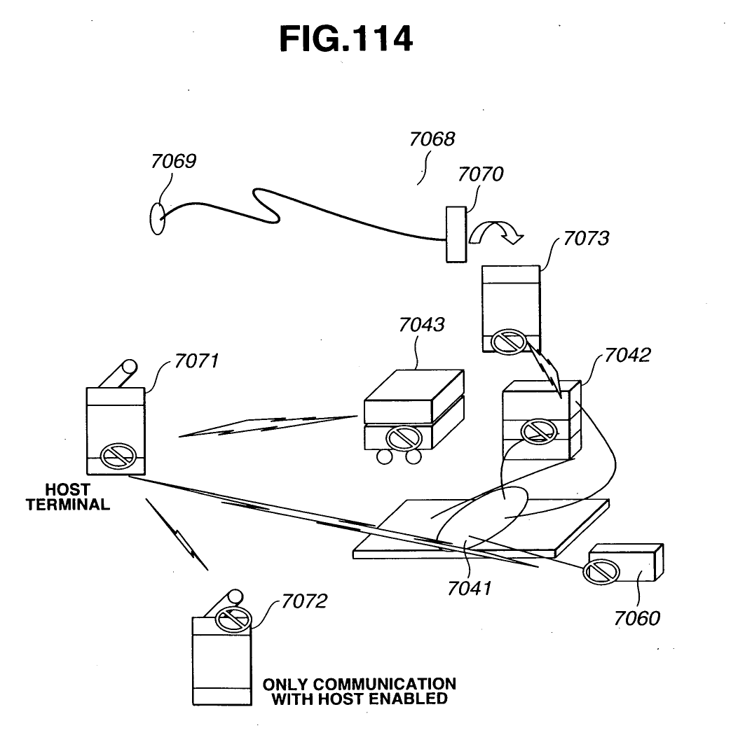

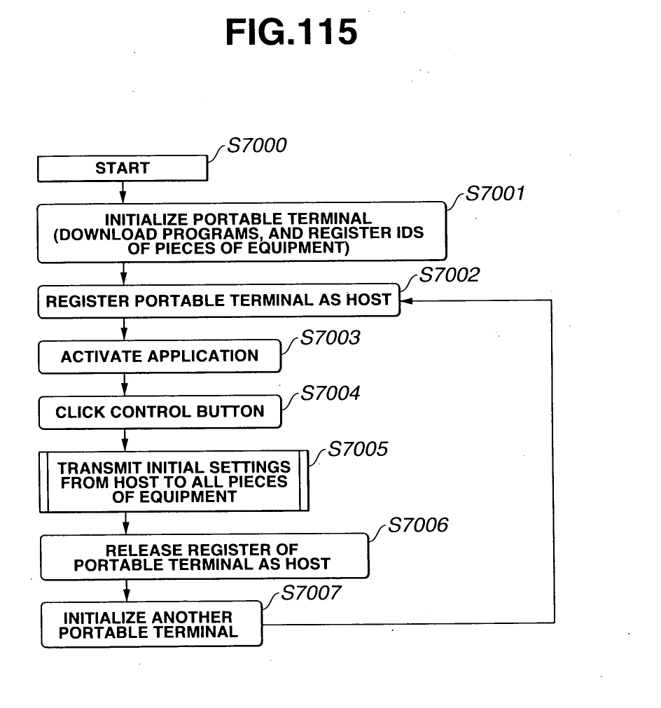

Next, a thirty-first embodiment of the present invention will be described in conjunction with FIG. 114 and FIG. 115. The thirty-first embodiment consists mainly of: a host portable information terminal 7071 that controls on a simplified and centralized basis a patient monitor system 7042 that monitors biomedical information of a patient 7041, a simplified endoscope system 7043, and a therapeutic unit 7060; a communication portable information terminal 7072 capable of communicating with the host portable information terminal 7071 alone; and a portable information terminal 7073 having a vital sign measurement extension module and communicating with the patient monitor system 7043.

An extension module 7068 for the portable information terminal 7073 is, for example, a temperature measurement module that includes a temperature sensor 7069 and an output signal converter 7070 that converts an output signal of the temperature sensor 7069. Data representing measured values can be transmitted by way of the patient monitor system 7043 and a communication interface such as an interface dedicated to a wireless LAN.

Communication interfaces included in the host portable information terminal 7071 and the portable information terminal 7072 that can communicate only with the host portable information terminal 7071 are conformable to the Bluetooth® standard.

The host portable information terminal 7071 can communicate with and control such pieces of controlled equipment as the patient monitor system 7042, simplified endoscope system 7043, therapeutic unit 7060, and portable information terminal 7072 capable of communicating only with the host.

When the simplified endoscope system 7043 is used to treat the patient 7041, the host portable information terminal 7071 initializes the pieces of controlled equipment as described in FIG. 115. At step S7001, identifiers assigned to the pieces of controlled equipment are registered in the memory in the post portable information terminal 7071 so that the post portable information terminal 7071 can control the pieces of controlled equipment. Moreover, simplified control programs helping control the controlled equipment are downloaded to the host portable information terminal 7071. At step S7002, the power supplies of the pieces of controlled equipment are turned on in order to register the host portable information terminal 7071 as a host.

At step S7003, an application residing in the host portable information terminal 7071 is activated. At step S7004, a Remote Control button presented through a screen image displayed on the host portable information terminal 7071 is clicked in order to establish bi-directional communication links between the host portable information terminal 7071 and the pieces of controlled equipment so that data can be transmitted.

At step S7005, the host portable information terminal 7071 initializes all the pieces of controlled equipment, or in other words, transmits data representing initial settings to the pieces of controlled equipment. At step S7006, the register of the host portable information terminal 7071 as a host is released. At this time, if the portable information terminal 7072 that is one of the pieces of controlled equipment and can communicate only with a host is registered as a host similarly to the host portable information terminal 7071, a centralized controller can be realized.

Specifically, a simplified remote-control application program is downloaded to the portable information terminal, and the identifiers of the pieces of controlled equipment are registered in the portable information terminal. Thus, the portable information terminal can fulfill the role of a centralized controller to control the pieces of controlled equipment. Data representing initial settings can be all transmitted in a secured manner. This contributes to provision of a user-friendly endoscope system.

### Thirty-Second Embodiment

(Features)

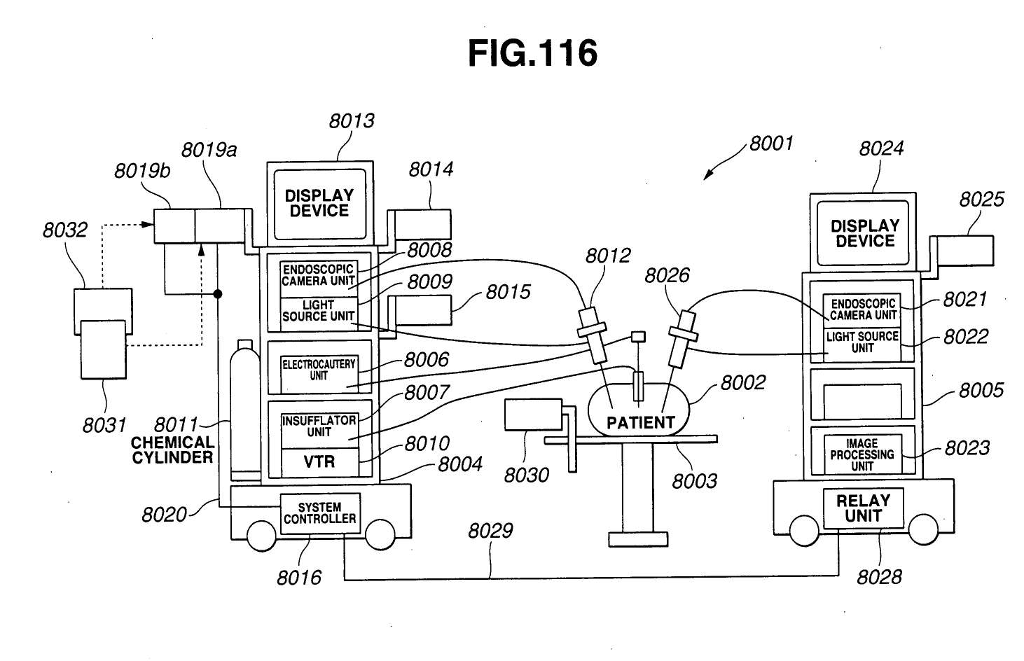

FIG. 116 shows the interior of an operating room in which an endoscopic surgery system 8001 is installed. As shown in FIG. 116, a patient couch 8003 on which a patient 8002 lies down and the endoscopic surgery system 8001 are placed in the operating room. The endoscopic surgery system 8001 includes a first cart 8004 and a second cart 8005.

Medical equipment, for example, an electrocautery unit 8006, an insufflator unit 8007, an endoscopic camera unit 8008, a light source unit 8009, a VTR 8010, and a chemical cylinder 8011 filled with carbon dioxide are integrated into the first cart 8004. The endoscopic camera unit 8008 is connected to a first endoscope 8012 over a camera cable. The light source unit 8009 is connected to the first endoscope 8012 over a light guide cable.

Moreover, a display device 8013, a centralized display panel 8014, and an operator panel 8015 are mounted on the first cart 8004. The display device 8013 is, for example, a TV monitor on which endoscopic images or the like are displayed. The centralized display panel 8014 is a display means on which any data acquired during surgery can be selectively displayed. The operator panel 8015 consists of a display, for example, a liquid crystal display and touch sensors integrated with the display, and serves as a first centralized operating unit to be handled by a nurse or the like in a non-sterilized zone.

Furthermore, a system controller 8016 is mounted in the first cart 8004. The electrocautery unit 8006, insufflator unit 8007, endoscopic camera unit 8008, light source unit 8009, and VTR 8010 are connected to the system controller 8016 over transmission lines that are not shown.

On the other hand, an endoscopic camera unit 8021, a light source unit 8022, an image processing unit 8023, a display device 8024, and a centralized display panel 8025 are integrated into the second cart 8005. The endoscopic camera unit 8021 is connected to a second endoscope 8026 over a camera cable, while the light source unit 8022 is connected to the second endoscope 8026 over a light guide cable. Endoscopic images or the like produced by the endoscopic camera unit 8021 are displayed on the display device 8024. Every information acquired during surgery can be selectively displayed on the centralized display panel 8025.

The endoscopic camera unit 8021, light source unit 8022, and image processing unit 8023 are connected to a relay unit 8028 mounted in the second card 8005 over transmission lines that are not shown. The relay unit 8028 is connected to the system controller 8016, which is mounted in the first cart 8004, over a relay cable 8029.

A remote controller 8030 disposed near the patient couch 8003 is a second centralized operating unit to be handled by an operator in a sterilized zone. The remote controller 8030 can control the endoscopic surgery system 8001 under the control of the system controller 8016.

A portable terminal 8031 is a third centralized operating unit including a first remote-control means that remotely controls the endoscopic surgery system 8001 through first infrared communication, and is, for example, a PDA. An infrared communication adaptor 8032 is a second remote control means enabling communication between the system controller 8016 and portable terminal 8031 to be performed through second infrared communication, and is attached to the portable terminal 8031.

Infrared communication devices 8019a and 8019b serve as infrared communication interfaces 8018a and 8018b that will be described later, and are connected to the system controller 8016 over a cable 8020. The first infrared communication between the portable terminal 8031 and system controller 8016 is achieved via the infrared communication device 8019a, while the second infrared communication enabled by the infrared communication adaptor 8032 is achieved via the infrared communication device 8019b.

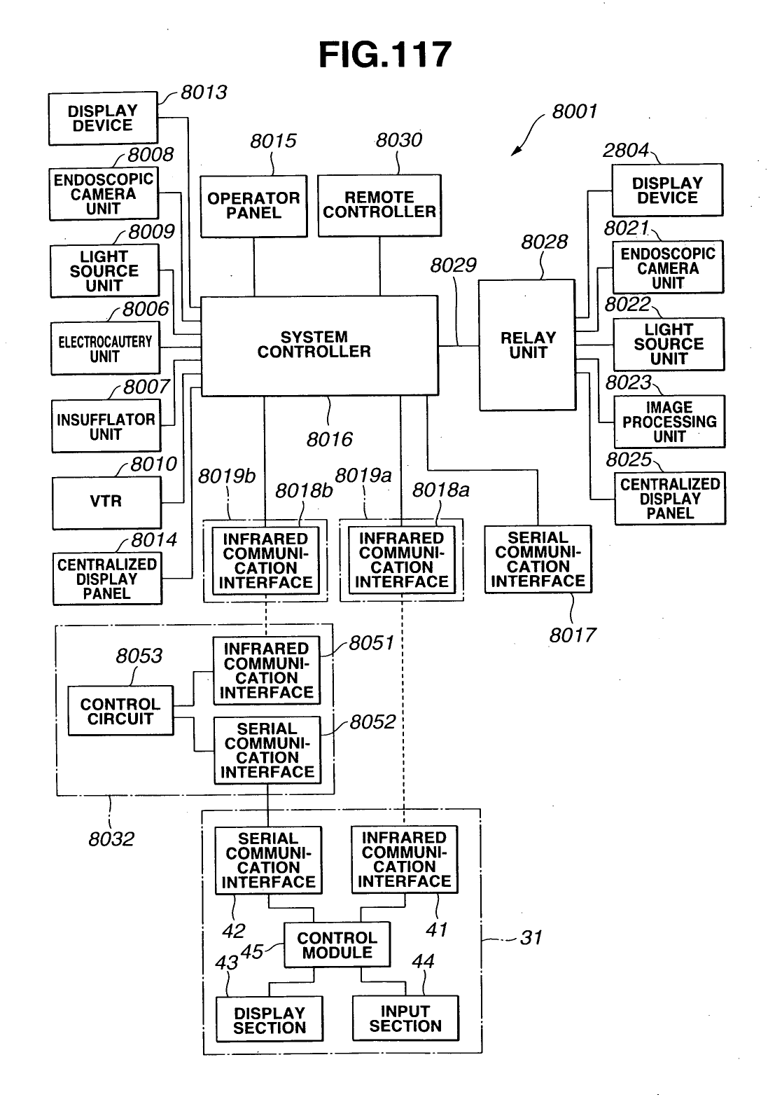

FIG. 117 is a block diagram showing the configuration of the endoscopic surgery system 8001. As seen from the drawing, the system controller 8016 controls on a centralized basis the electrocautery unit 8006, insufflator unit 8007, camera unit 8008, light source unit 8009, and VTR 8010 that are integrated into the first cart 8004, and the camera unit 8021, light source unit 8027, and image processing unit 8023 that are integrated into the second cart 8005.

When communication links are established between the system controller 8016 and the above pieces of equipment, the system controller 8016 can display a setting screen image, which presents the settings of each piece of equipment and operation switches, on the centralized display panel 8014 or 8025. At the same time, the system controller 8016 allows a user to modify or enter set values using the operator panel 8015 or remote controller 8030.

On the other hand, the portable terminal 8031 can communicate with the system controller 8016 bi-directionally via the infrared communication interface 8018a, which is provided as the infrared communication device 8019a, at a high transmission speed by wireless. This wireless communication is the first infrared communication over a relatively short distance. Furthermore, the portable terminal 8031 can communicate with the system controller 8016 bi-directionally via the infrared communication adaptor 8032 and the infrared communication interface 8018b, which is provided as the infrared communication device 8019b, at a relatively low transmission speed by wireless. This wireless communication is the second infrared communication over a long distance. The system controller 8016 includes a serial communication interface 8017 that enables serial communication with external equipment.

The portable terminal 8031 consists mainly of: an infrared communication interface 8041 enabling infrared communication via the infrared communication interface 8018a; a serial communication interface 8042 enabling serial communication with the infrared communication adaptor 8032; a display section 8043 on which data or the like is displayed; an input section 8044 used to enter data or the like; and a control module 8045 that controls these components.

Moreover, the infrared communication adaptor 8032 includes an infrared communication interface 8051 that enables infrared communication via the infrared communication interface 8018b, a serial communication interface 8052 that enables serial communication with the portable terminal 8031, and a control circuit 8053 that controls the components.

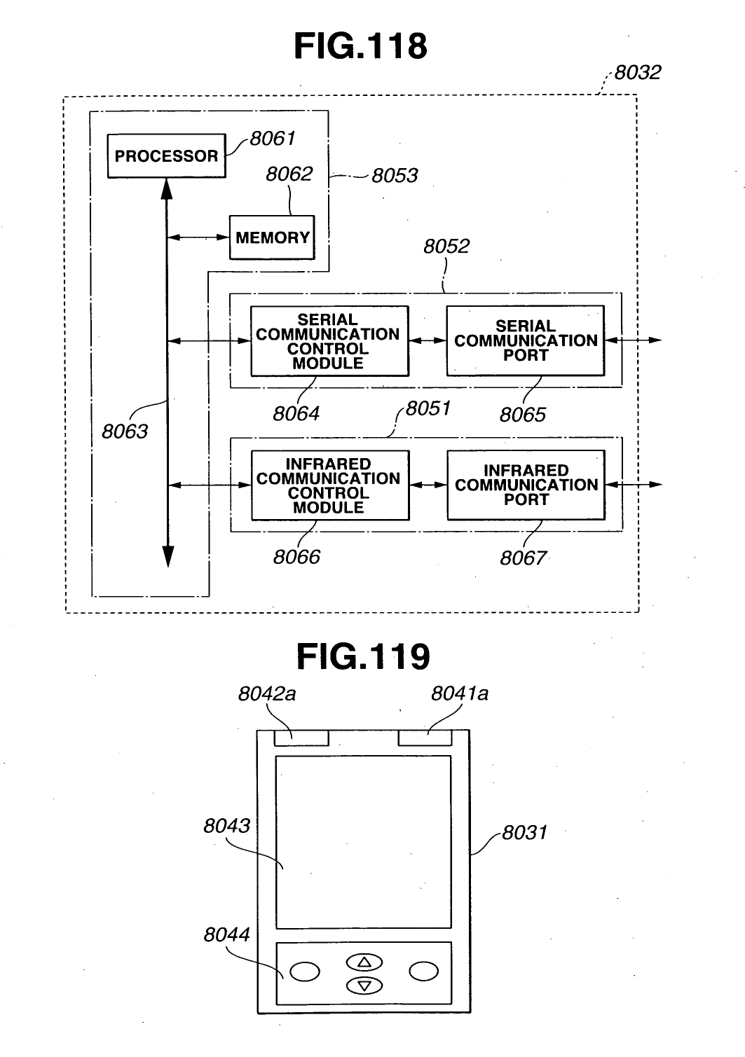

FIG. 118 is a block diagram showing the circuitry of the infrared communication adaptor 8032. The control circuit 8053 includes a processor 8061, a memory 8062, and a data bus 8063. The memory 8062, serial communication interface 8052, and infrared communication interface 8051 are electrically connected to the processor 8061, which controls the infrared communication adaptor 8032, over the data bus 8063.

The serial communication interface 8052 is composed of a serial communication control module 8064 and a serial communication port 8065, and enables serial communication with external terminals. The infrared communication interface 8051 is composed of an infrared communication controller 8066 and an infrared communication port 8067, and enables infrared communication with external terminals.

FIG. 119 shows the appearance of the portable terminal 8031. The portable terminal 8031 has the display section 8043 and input section 8044. The serial communication interface 8042 and infrared communication interface 8041 are, as described previously, incorporated in the portable terminal 8031. The serial communication port 8042a and infrared communication port 8041a are parts of the serial communication interface 8042 and infrared communication interface 8041 respectively.

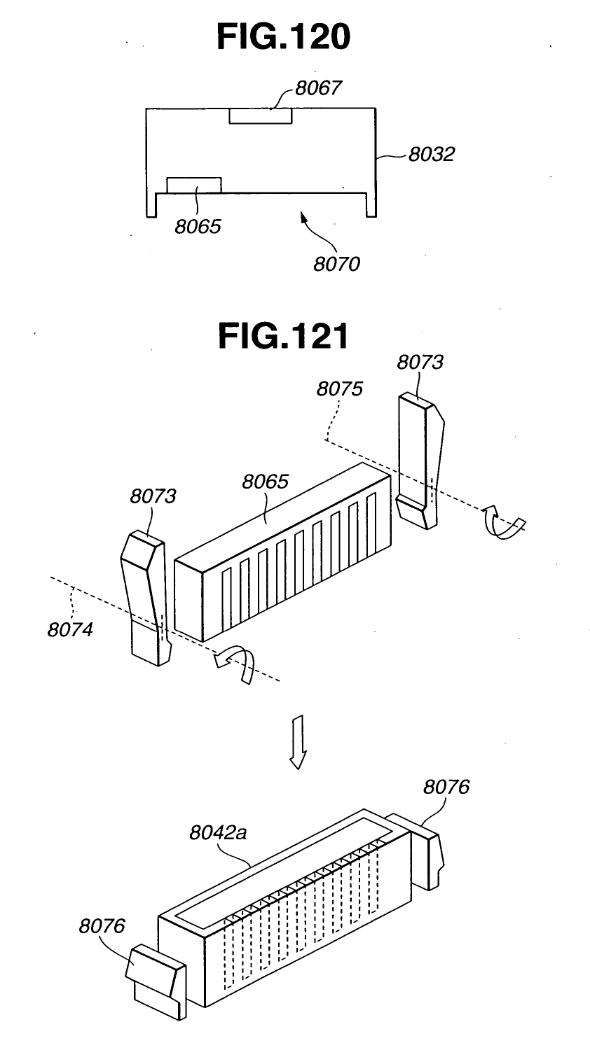

FIG. 120 shows the appearance of the infrared communication adaptor 8032. The serial communication interface 8052 and infrared communication interface 8051 are, as described previously, incorporated in the infrared communication adaptor 8032. The serial communication port 8065 and infrared communication port 8067 are parts of the serial communication interface 8052 and infrared communication interface 8051 respectively. Moreover, the infrared communication adaptor 8032 has a connector 8070 that is freely detachably attached to the portable terminal 8031.

FIG. 121 shows the connector 8070 of the infrared communication adaptor 8032 to be attached to the portable terminal 8031. Hooks 8073 are constrained to turn in directions of arrows with axes 8074 and 8075 as axes of rotation because of spring force. Hooks 8076 are formed to be engaged with the hooks 8073. The infrared communication adaptor 8032 is fixed to the portable terminal 8031 with the hooks 8073 engaged with the hooks 8076. At this time, the serial communication port 8042a of the portable terminal 8031 is electrically coupled to the serial communication port 8065 of the infrared communication adaptor 8032.

(Operations)

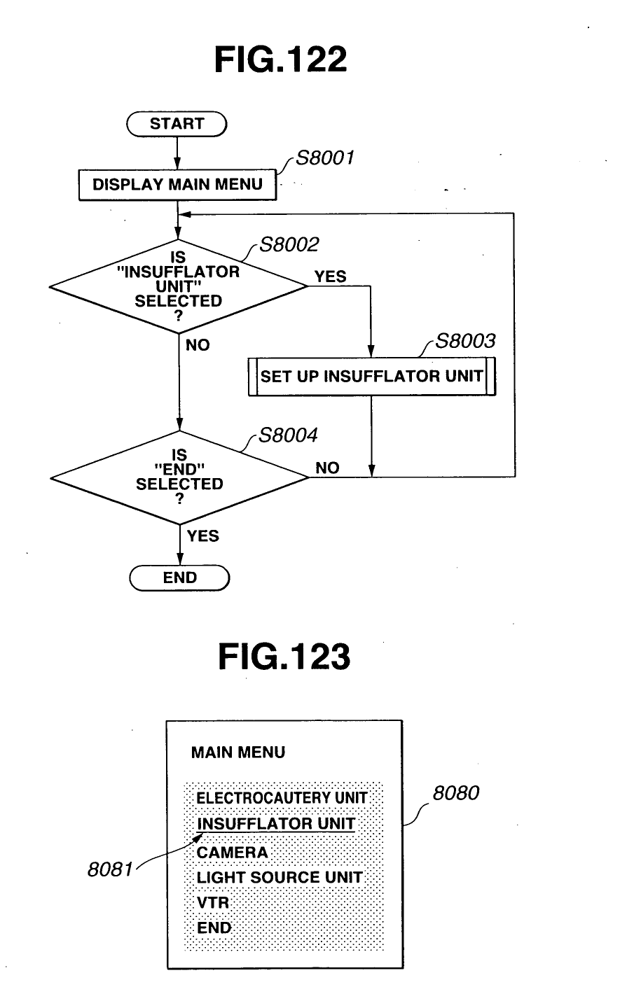

Referring to FIG. 122 to FIG. 126, software residing in the portable terminal 8031 so as to implement the capability of a remote controller for the purpose of remotely controlling the endoscopic surgery system 8001 will be described below.

When the software is activated at step S8001 described in FIG. 122, the control module 8045 of the portable terminal 8031 displays a main menu screen image 8080 shown in FIG. 123 on the display section 8043 at step S8001, and then waits for a user entry made at the input section 8044.

A user moves a cursor 8081 (see FIG. 123) on the display section 8043 so as to designate surgical equipment the user wants to operate. This causes the control module 8045 to pass control to setup of pieces of equipment. For brevity's sake, FIG. 122 describes an example in which the insufflator unit 8007 is designated. The other equipment can be set up in the same manner.

Specifically, the control module 8045 of the portable terminal 8031 judges at step S8002 whether Insufflator unit is selected as surgical equipment through the main menu screen image 8080. If it is judged that Insufflator unit is selected, the insufflator unit is set up at step S8003. Control is then returned to step S8002. If a user designates no surgical equipment, it is judged at step 8004 whether End is selected through the main menu screen image 8080. If End is selected, the control module 8045 of the portable terminal 8031 terminates the software.

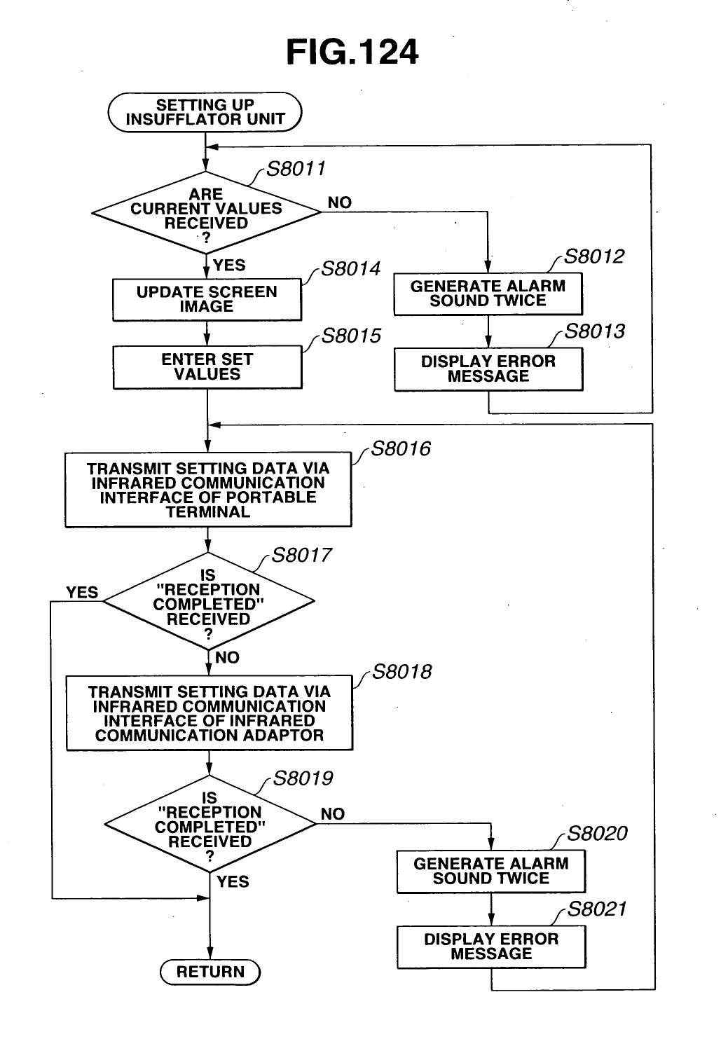

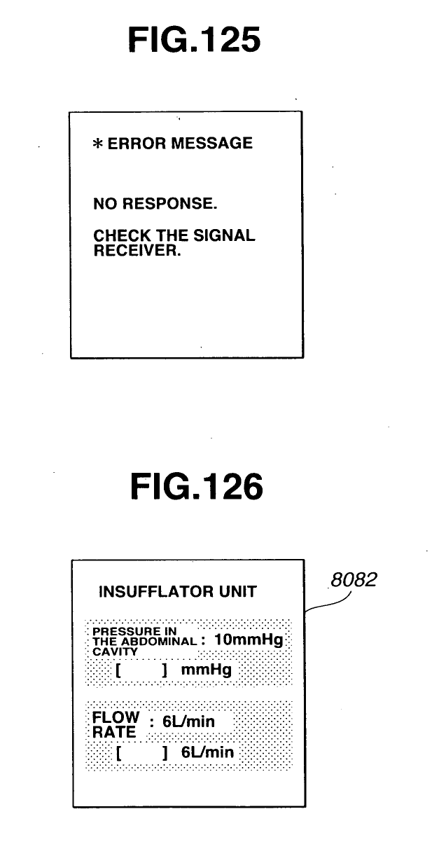

When the insufflator unit is set up at step S8003, the control module 8045 of the portable terminal 8031 judges, as described in FIG. 124, at step S8011 whether data representing the current settings of the insufflator unit 8007 has been received from the system controller 8016 via the infrared communication interface 8041 and infrared communication interface 8018a. If not, the control module 8045 generates an alarm sound twice at step S8012, and displays an error message like the one shown in FIG. 125 on the display section 8043 at step S8013.

After the current setting data is received, the control module 8045 of the portable terminal 8031 updates the main menu screen image 8080 displayed on the display section 8043 and displays a set value entry screen image 8082 like the one shown in FIG. 126. At step S8015, the control module 8045 of the portable terminal 8031 waits until the user enters the set values for the insufflator unit in the set value entry screen image 8082. When the set values are entered, the data representing the entered set values is transmitted at step S8016 from the portable terminal 8031 to the system controller 8016 via the infrared communication interface 8041 and infrared communication interface 8018a.

Thereafter, at step S8017, the control module 8045 of the portable terminal 8031 detects a Reception Completed signal sent from the system controller 8016 via the infrared communication interface 8041 and infrared communication interface 8018a. If the Reception Completed signal is not transmitted, data is transmitted to the system controller 8016 via the infrared communication interface 8051 of the infrared communication adaptor 8032 and the infrared communication interface 8018b. Moreover, if the control module 8045 detects the Reception Completed signal sent from the system controller 8016, the control module 8045 terminates processing and returns control to step S8002 in FIG. 122.

Thereafter, at step S8019, the control module 8045 of the portable terminal 8031 detects a Reception Completed signal sent from the system controller 8016 via the infrared communication interface 8051 of the infrared communication adaptor 8032 and the infrared communication interface 8018b. If the Reception Completed signal is not received from the system controller 8016, the control module 8045 generates an alarm sound twice at step S8020, and displays an error message shown in FIG. 125 on the display section 8043 at step S8021. Moreover, if the control module 8045 detects the Reception Completed signal sent from the system controller 8016, the control module 8035 terminates processing, and returns control to step S8002 in FIG. 122.

During surgery, a doctor or nurse carries the portable terminal 8031 to which the infrared communication adaptor 8032 is attached. At this time, the infrared communication interface 8051 included in the infrared communication adaptor 8032 is kept opposed to the infrared communication interface 8018b connected to the system controller 8016.

(Advantages)

Since the infrared communication adaptor 8032 enables wireless communication over a long distance via the infrared communication interface 8018b, a doctor or nurse carrying the portable terminal 8031 need not approach the infrared communication interface 8018a so that infrared light waves will reach the infrared communication interface 8018a. This leads to a reduced surgery time.

### Thirty-Third Embodiment

(Features)

The features of a thirty-third embodiment are identical to those of the thirty-second embodiment.

(Operations)

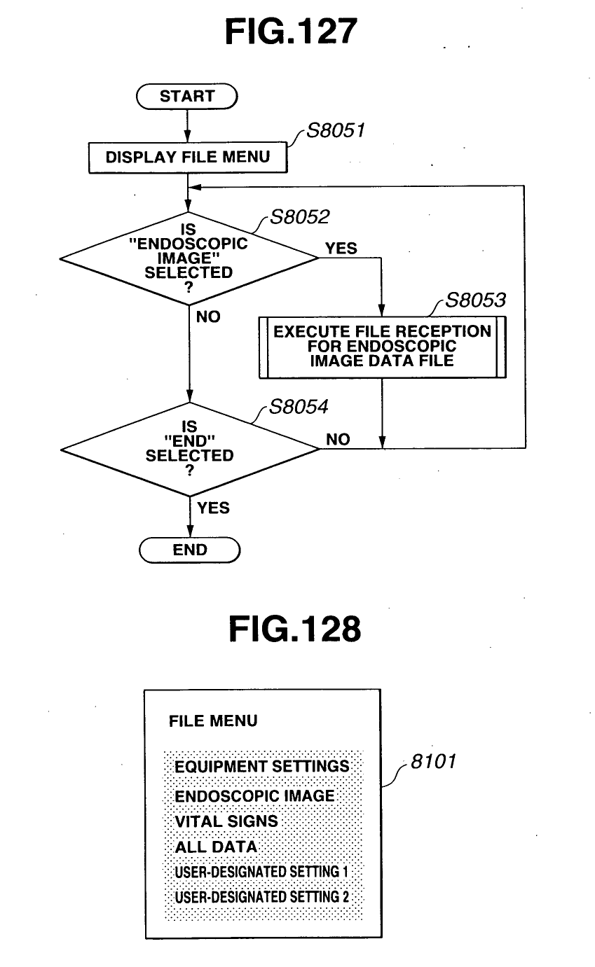

Referring to FIG. 127 to FIG. 132, software residing in the portable terminal 8031 so as to implement the capability of a remote controller for the purpose of remotely controlling the endoscopic surgery system 8001 according to the present embodiment will be described below.

As shown in FIG. 127, according to the present embodiment, when the software is activated at step S8051, the control module 8045 of the portable terminal 8031 displays a file menu screen image 8101 shown in FIG. 128 on the display section 8043 at step S8052. Thereafter, the control module 8045 waits for a user entry made at the input section 8044.

A user moves the cursor 8056 so as to designate a file, which the user wants to receive, through the file menu screen image 8101. The control module 8045 then passes control to data file reception that is performed on a data file concerning a designated menu item. For brevity's sake, FIG. 127 describes an example in which a menu item Endoscopic Image is selected.

Specifically, the control module 8045 of the portable terminal 8031 judges at step S8052 whether Endoscopic Image is selected through the file menu screen image 8101. If it is judged that Endoscopic Image is selected, file reception is executed for an endoscopic image data file at step S8053. Thereafter, control is returned to step S8052. If a user does not select Endoscopic Image, it is judged at step S8054 whether End is selected through the file menu screen image 8101. If End is selected, the control module 8045 of the portable terminal 8031 terminates the software.

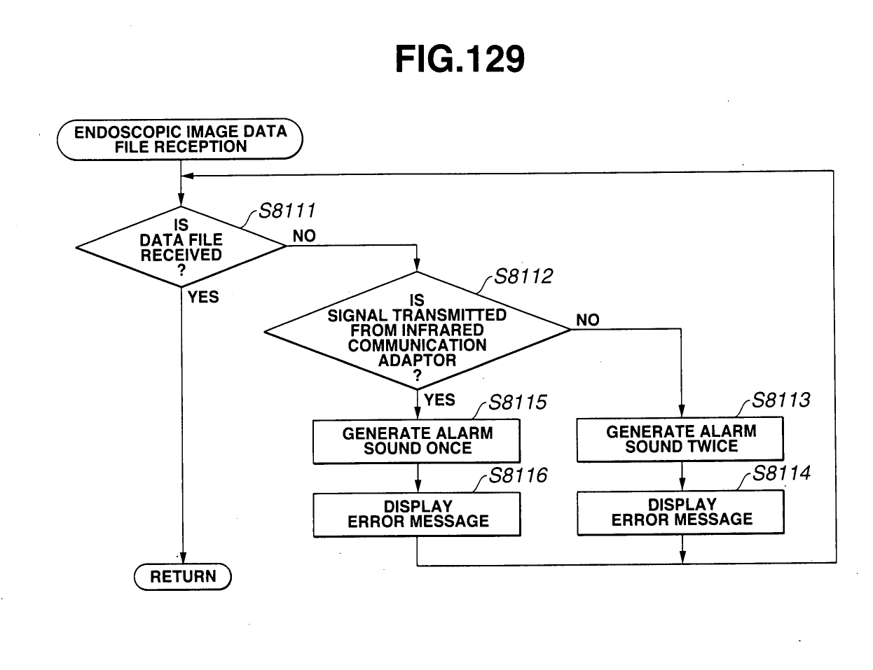

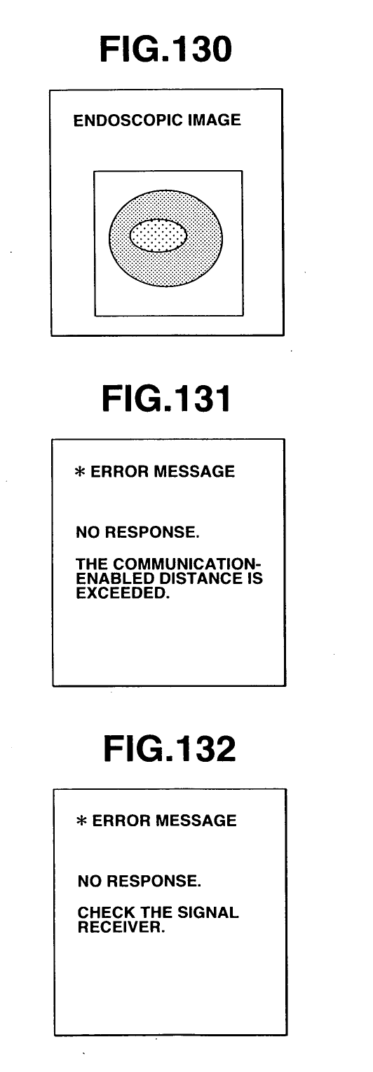

During file reception to be performed on an endoscopic image data file at step S8052, the control module 8045 of the portable terminal 8031 judges at step S8111 described in FIG. 129 whether the endoscopic image data file has been received from the system controller 8016 via the infrared communication interface 8041 and infrared communication interface 8018a. If the endoscopic image data file has been received, an endoscopic image like the one shown in FIG. 130 is displayed on the display section 8043. Processing is then terminated, and control is returned to step S8052 in FIG. 127. If the endoscopic image data file has not been received, a signal is transmitted from the infrared communication adaptor 8032 to the system controller 8016 via the infrared communication interface 8051 of the infrared communication adaptor 8032 and the infrared communication interface 8018b.

Thereafter, at step S8112, the control module 8045 of the portable terminal 8031 detects a Reception Completed signal sent from the system controller 8016 via the infrared communication interface 8051 of the infrared communication adaptor 8032 and the infrared communication interface 8018b. If the Reception Completed signal is not received from the system controller 8016, the control module 8045 generates an alarm sound twice at step S8113, and displays an error message like the one shown in FIG. 131 on the display section 8043 at step S8114. Control is then returned to step S8111. If the Reception Completed signal is received from the system controller 8016, the control module 8045 generates an alarm sound once at step S8115, and displays an error message like the one shown in FIG. 132 on the display section 8043 at step S8116. Control is then returned to step S8111.

During surgery, a doctor or nurse carrying the portable terminal 8031 to which the infrared communication adaptor 8032 is attached moves so that the infrared communication interface 8051 of the infrared communication adaptor 8032 will be opposed to the infrared communication interface 8018b connected to the system controller 8016.

(Advantages)

The present embodiment provides the same advantages as the thirty-second embodiment. In addition, a doctor or nurse carrying the portable terminal 8031 can create a data file smoothly by responding to instructions displayed on the remote controller.

### Thirty-Fourth Embodiment

Various attempts have been made in order to improve the maneuverability of an endoscopic surgery system in which an endoscope system and surgical equipment are controlled on a centralized basis. As one of the attempts, development of a remote control unit such as a remote controller for remotely controlling the endoscopic surgery system is under way.

For example, when a plurality of operators uses a plurality of remote control units, unintended set values or other information may be transferred to controlled equipment. This may hinder surgery.

In order to expand a remotely controllable range offered by a remote control unit, a plurality of signal transmitter receivers may be included. In this case, there is a possibility that a third person lying away from an operator in an operating room may remotely control controlled equipment unexpectedly to the operator.

The present embodiment provides a control system that even when controlled equipment receives output signals of a plurality of remote control units, can reliably set up the controlled equipment and transmit or receive data, and can prevent unintended remote control.

(Features)

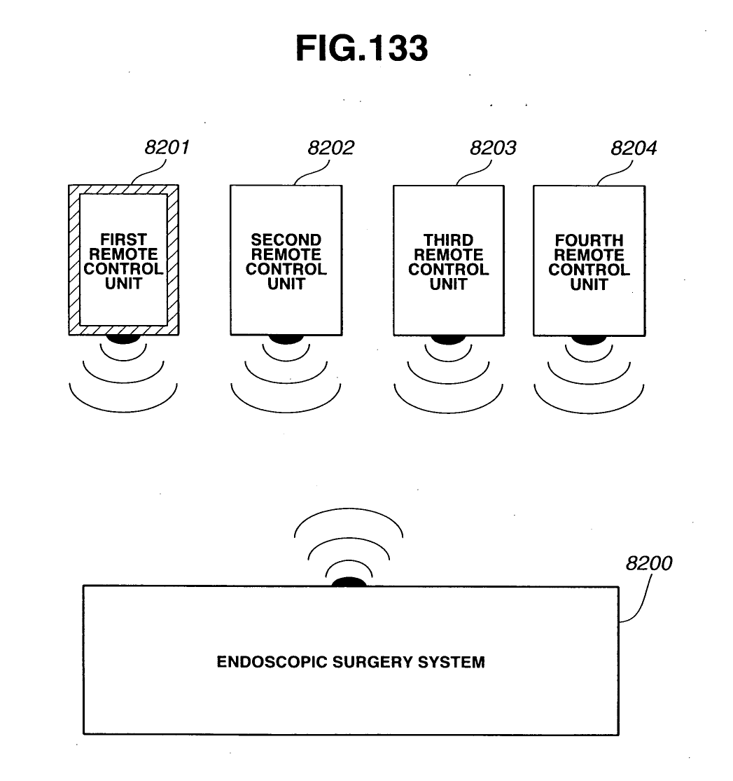

As shown in FIG. 133, an endoscopic surgery system 8200 includes a plurality of pieces of equipment. A first remote control unit 8201 has the user ID thereof registered in the endoscopic surgery system 8200. A plurality of remote control units, for example, second to fourth remote control units 8202, 8203, and 8204 do not have the user IDs thereof registered therein.

(Operations)

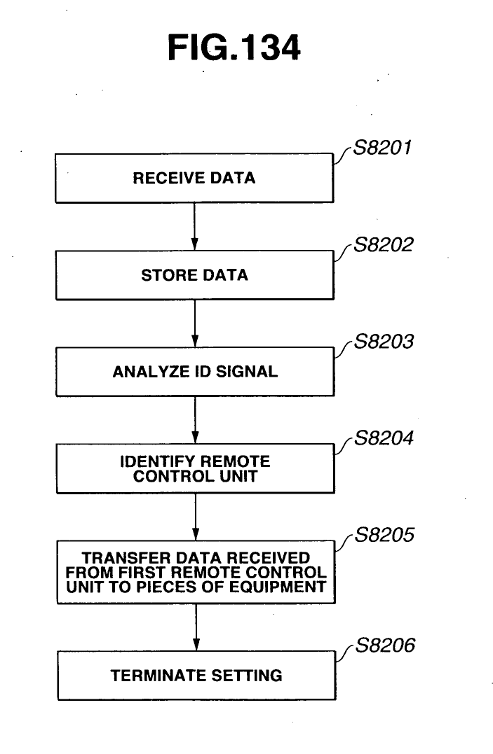

At step S8201 described in FIG. 134, the endoscopic surgery system 8200 receives data items sent from the first to fourth remote control units 8201 to 8204.

At step S8202, the data items received from the remote control units are stored. At step S8203, an ID signal is analyzed in order to judge whether received data is transmitted from the remote control unit whose user ID has been registered.

Thereafter, at step S8204, the first remote control unit 8201 whose user ID has been registered is identified. At step S8205, data received from the first remote control unit 8201 is transmitted to the pieces of equipment constituting the endoscopic surgery system 8200. At step S8206, setting up the endoscopic surgery system 8200 is completed.

(Advantages)

Data items other than data received from a remote control unit whose user ID has been registered in advance are not transferred to controlled equipment. Unintended set values or information received from any other remote control unit whose ID has not been registered will not be transferred to the controlled equipment. Surgery can be performed efficiently with security guaranteed.

### Thirty-Fifth Embodiment

A thirty-fifth embodiment is nearly identical to the thirty-fourth embodiment. A difference alone will be described below.

(Features)

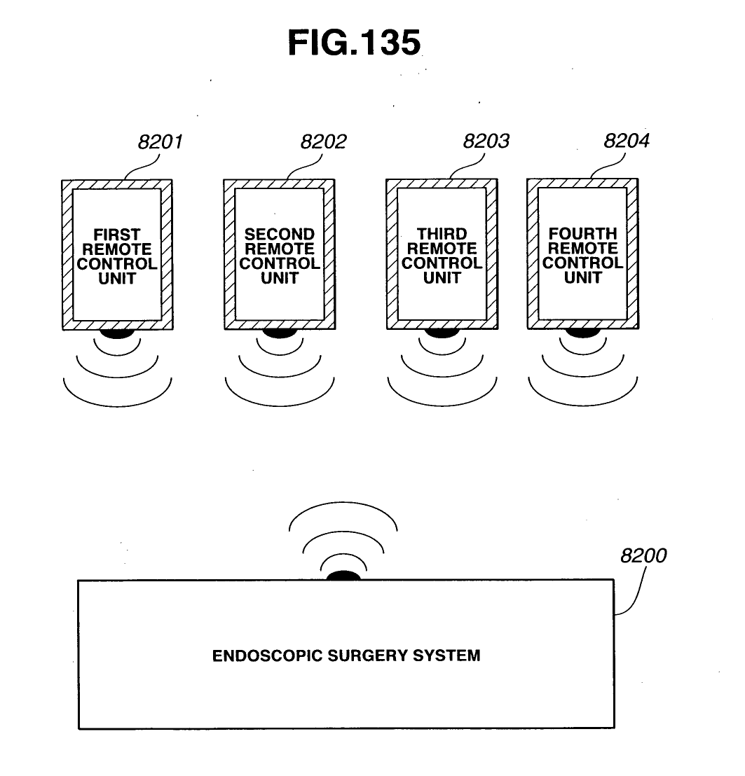

FIG. 135 shows the endoscopic surgery system 8200, and the plurality of remote control units whose user IDs have been registered in the endoscopic surgery system 8200, for example, the first to fourth remote control units 8201, 8202, 8203, and 8204.

(Operations)

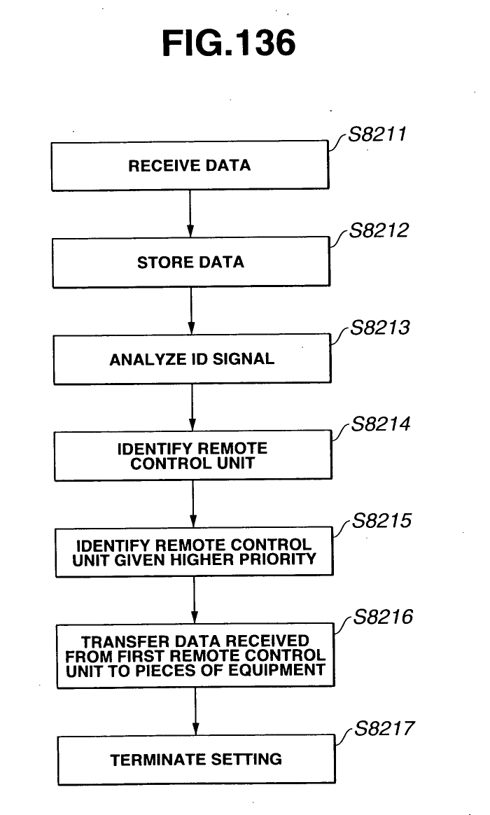

At step S8211 described in FIG. 136, the endoscopic surgery system 8200 receives data items from the first to fourth remote control units 8201, 8202, 8203, and 8204.

At step S8212, the data items received from the remote control units are stored. At step S8213, an ID signal is analyzed in order to judge whether received data is transmitted from a remote control unit whose user ID has been registered.

Thereafter, at step S8214, the data items received from the first to fourth remote control units 8201, 8202, 8203, and 8204 whose user IDs have been registered are identified. At step S8215, data received from a remote control unit whose registered ID is given higher priority is identified. In FIG. 136, the ID of the first remote control unit 8201 is given higher priority.

Thereafter, at step S8216, data received from the first remote control unit 8201 is transferred to pieces of equipment constituting the endoscopic surgery system 8200. At step S8217, setting up the endoscopic surgery system 8200 is completed.

(Advantages)

Remote control units have the user IDs thereof registered in advance and given priorities. Consequently, a remote control unit whose data can be accepted is identified distinctly. This prevents a user from getting confused during setup.

### Thirty-Sixth Embodiment

(Features)

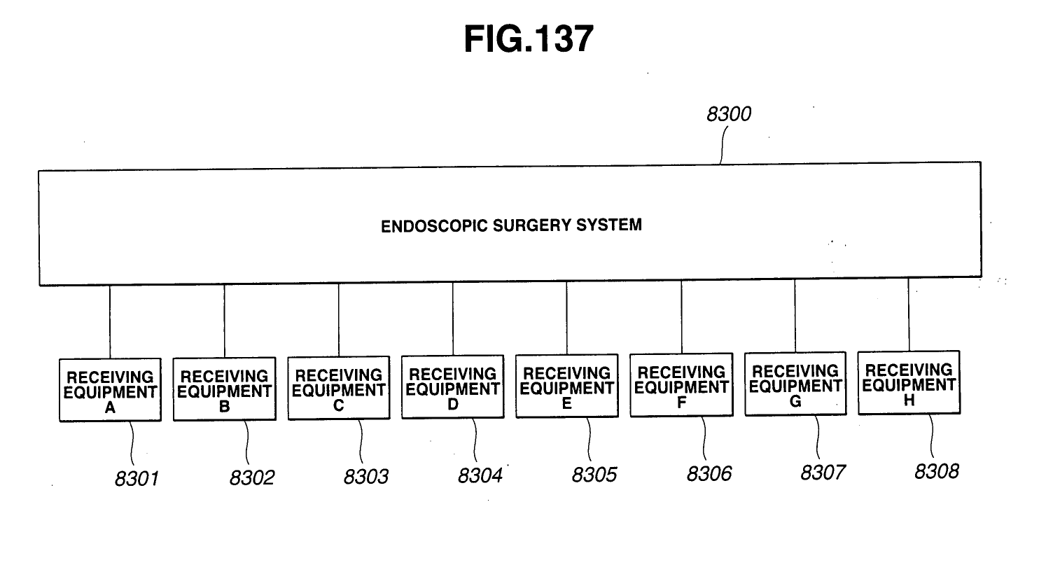

As shown in FIG. 137, an endoscopic surgery system 8300 and a plurality of pieces of signal receiving equipment A (8301) to H (8308) connected to the endoscopic surgery system 8300 are placed in an operating room.

(Operations)

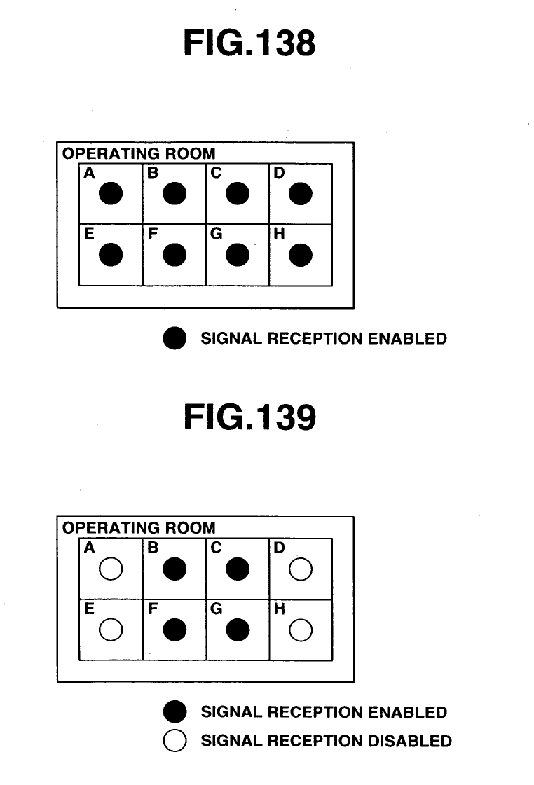

A signal reception enabling/disabling circuit included in the endoscopic surgery system 8300 designates, as shown in FIG. 138, all of the pieces of signal receiving equipment A (8301) to H (8308). A remote control unit is used to transfer data to or from all the pieces of equipment within the operating room.

Otherwise, as shown in FIG. 139, the signal receiving equipment B (8302), signal receiving equipment C (8303), signal receiving equipment F (8306), and signal receiving element G (8307) are selected. The remote control unit is used to transfer data to or from the pieces of equipment B, C, F, and G within the operating room.

(Advantages)

Since pieces of communication-enabled equipment located in different places are determined, invasion of unexpected signals from a large number of pieces of signal receiving equipment distributed over a wide area can be prevented.

### Thirty-Seventh Embodiment

(Features)

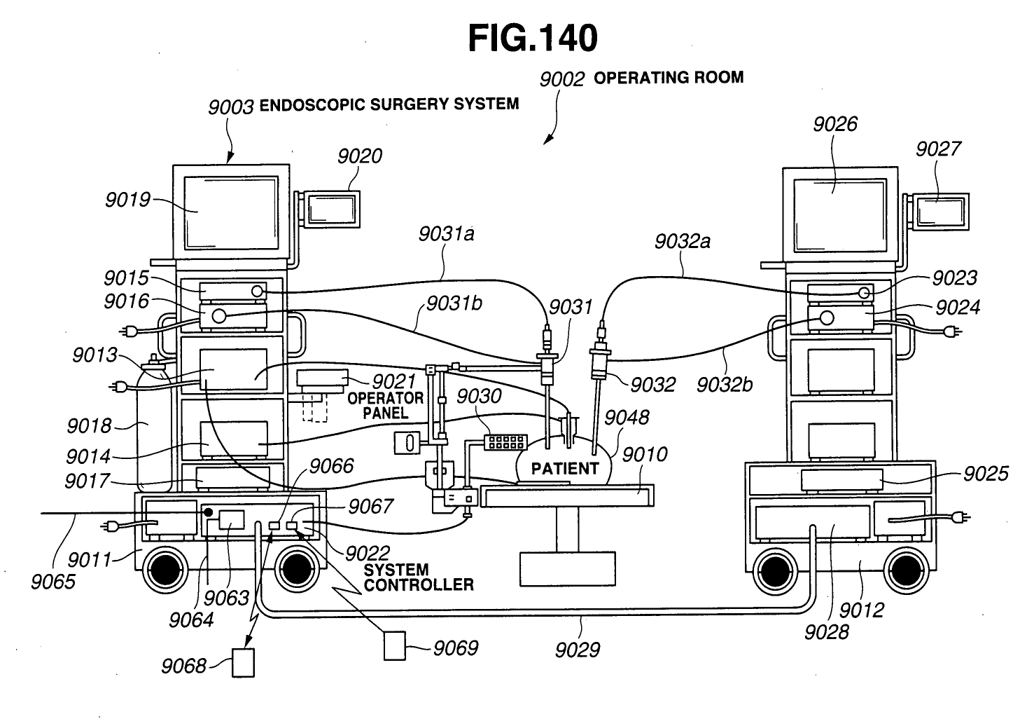

Referring to FIG. 140, the overall configuration of an endoscopic surgery system 9003 installed in an operating room 9002 will be described below.

As shown in FIG. 140, a patient couch 9010 on which a patient 9048 lies down and the endoscopic surgery system 9003 are placed in the operating room 9002. The endoscopic surgery system 9003 includes a first cart 9011 and a second cart 9012.

Medical equipment, for example, an electrocautery unit 9013, an insufflator unit 9014, an endoscopic camera unit 9015, a light source unit 9016, a VTR 9017, and a chemical cylinder 9018 filled with carbon dioxide are integrated into the first cart 9011. The endoscopic camera unit 9015 is connected to a first endoscope 9031 over a camera cable 9031a. The light source unit 9016 is connected to the first endoscope 9031 over a light guide cable 9031b.

Moreover, a display device 9019, a centralized display panel 9020, and an operator panel 9021 are mounted on the first cart 9011. The display device 9019 is, for example, a TV monitor on which an endoscopic image is displayed.

The centralized display panel 9020 is a display means on which every information acquired during surgery can be selectively displayed. The operator panel 9021 includes a display composed of, for example, a seven-segment display and LEDs, and switches presented through screen images to be displayed on the display, and serves as a centralized operating unit to be handled by a nurse or the like in a non-sterilized zone.

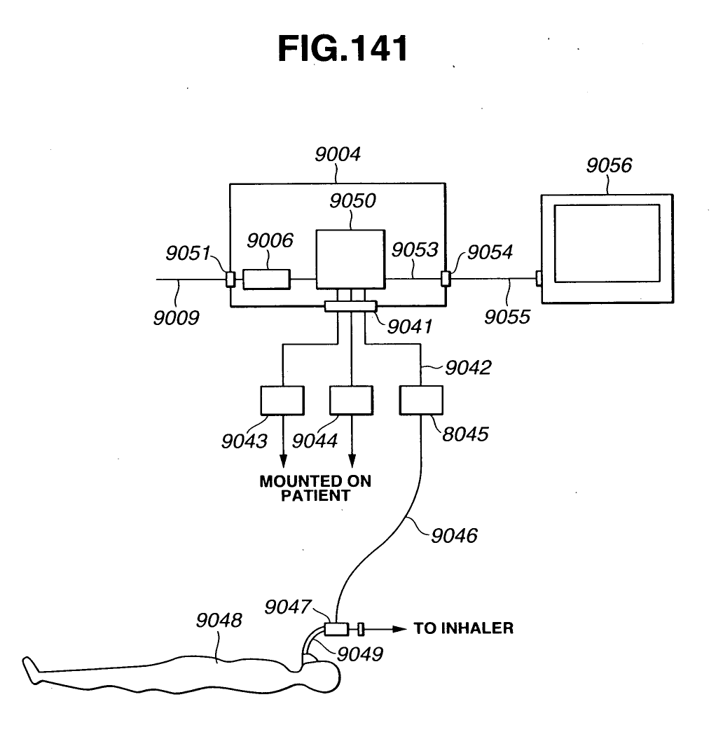

Furthermore, a system controller 9022 is mounted in the first cart 9011. The electrocautery unit 9013, insufflator unit 9014, endoscopic camera unit 9015, light source unit 9016, and VTR 9017 are connected to the system controller 9022 over transmission lines, which are not shown, according to a serial communication standard such as the RS-232C standard. A communication control module 9063 is incorporated in the system controller 9022, and connected to a communication circuit 9, which is shown in FIG. 141, over a communication cable 9064. The system controller 9022 is connected on an intra-hospital LAN over a communication cable 9065. Furthermore, the system controller 9022 has a bi-directional communication interface 9066 and a unidirectional infrared communication interface 9067. The system controller 9022 can transfer a signal to or from a PDA 9068 via the bi-directional infrared communication interface 9066 according to the IrDA communication standard. Moreover, the system controller 9022 can receive a command or control data from an infrared remote controller 9069 via the unidirectional infrared communication interface 9067 through infrared communication. The PDA 9068 can communicate with the system controller 9066 through serial communication.

According to the present embodiment, wireless communication is performed using infrared light waves (unidirectional infrared communication and bi-directional infrared communication conformable to, for example, the IrDA standard). Even if radiocommunication were adopted in order to transfer peripheral equipment parameters bi-directionally, no problem would occur. For example, a wireless LAN or a Bluetooth port may be adopted. In this case, since electromagnetic waves are employed, communication can be performed uninterruptedly and data can be transferred without an obstacle.

On the other hand, an endoscopic camera unit 9023, a light source unit 9024, an image processing unit 9025, a display device 9026, and a second centralized display panel 9027 are integrated into the second cart 9012.

The endoscopic camera unit 9023 is connected to a second endoscope 9032 over a camera cable 9032a, while the light source unit 9024 is connected to the second endoscope 9032 over a light guide cable 9032b.

An endoscopic image or the like produced by the endoscopic camera unit 9023 is displayed on the display device 9026. Every information acquired during surgery is selectively displayed on the second centralized display panel 9027.

The endoscopic camera unit 9023, light source unit 9024, and image processing unit 9025 are connected to a relay unit 9028 mounted in the second cart 9012 over a transmission line that is not shown. The relay unit 9028 is connected to the system controller 9022 mounted in the first cart 9011 over a relay cable 9029.

The system controller 9022 controls on a centralized basis the camera unit 9023, light source unit 9024, and image processing unit 9025 which are integrated into the second cart 9012, and the electrocautery unit 9013, insufflator unit 9014, camera unit 9015, light source unit 9016, and VTR 9017 which are integrated into the first cart 9011. When communication links are established between the system controller 9022 and these pieces of equipment, the system controller 9022 displays a setting screen image, which presents the set state of each connected equipment and operating switches, on the liquid crystal display of the operating panel 9021. Moreover, a user can modify or enter set values by touching a predetermined area on the liquid crystal display that corresponds to a desired operating switch.

A remote controller 9030 serves as a second centralized operating unit to be handled by an operator in a sterilized zone. Using the remote controller 9030, other pieces of equipment with which a communication link is established can be controlled under the control of the system controller 9022.

Referring to FIG. 141, a patient monitor system 9004 will be described below.

As shown in FIG. 141, the patient monitor system 9004 employed together with the present embodiment includes a signal connector 9041. The signal connector 9041 is connected to vital sign measuring instruments such as an electrocardiograph 9042, a pulse oximeter 9044, and a capnograph 9045 over cables 9042.

The capnograph 9045 is connected to a breath sensor 9047 over a cable 9046. The breath sensor 9047 is fixed to a hose extending from an inhaler mounted on the patient 9048. Consequently, an electrocardiogram, a blood oxygen saturation, a breath carbon dioxide concentration, and other biomedical information concerning the patient 9048 can be measured.

The signal connector 9041 is electrically connected to a control module 9050 within the patient monitor system 9004. Moreover, the control module 9050 is connected to a display device 9056 by way of a video signal line 9053, a video connector 9054, and a cable 9055. Furthermore, the control module 9050 is electrically connected to a communication controller 9006. The communication controller 9006 is connected to the communication circuit 9009 through a communication connector 9051.

The communication circuit 9009 is connected to the communication controller that is not shown and that is included in the endoscopic surgery system 9003.

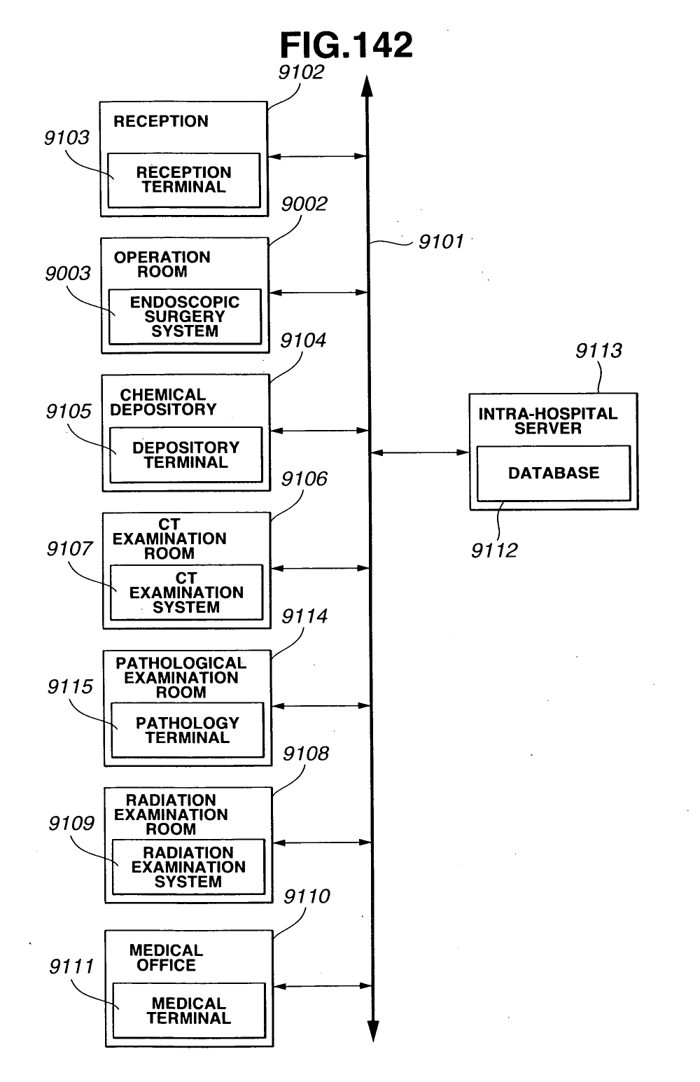

As shown in FIG. 142, the endoscopic surgery system 9003 installed in the operating room 9002 is connected on an intra-hospital LAN 9101, which is constructed within a hospital, by means of the system controller 9022.

Equipment installed in other facilities on the premises of the hospital, for example, a reception terminal 9103 installed at a reception 9102, a depository terminal 9105 installed in a chemical depository 9104, a CT examination system (system controller included therein) 9107 installed in a CT examination room 9106, a radiation examination system (system controller included therein) 9109 installed in a radiation examination room 9108, a medical office terminal 9111 installed in a medical office 9110, and a pathology terminal 9115 installed in a pathological examination room 9114 are connected on the intra-hospital LAN 9101. The intra-hospital LAN 9101 is managed by an intra-hospital server 9113 in which a database 9112 is constructed.

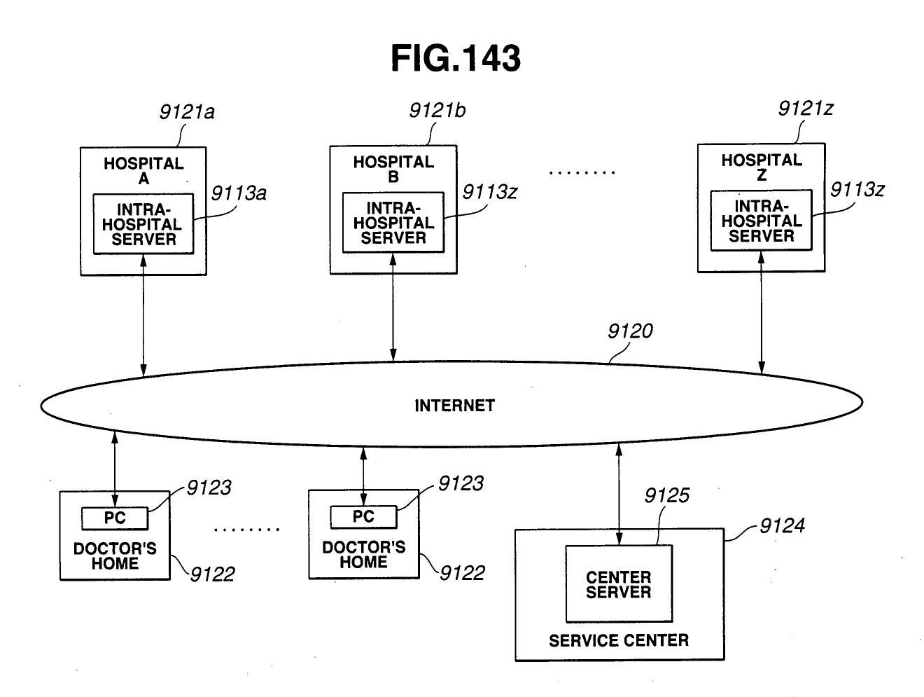

The intra-hospital server 9113 can be, as shown in FIG. 143, connected onto the Internet 9120. In addition to intra-hospital servers 9113a to 9113z installed at a plurality of hospitals 9121a to 9121z, personal computers 9123 at doctors' homes 9122 are connected onto the Internet 9120. Consequently, a center server 9125 installed at, for example, a service center 9124 can provide services including a service of distributing medical information to hospitals and doctors' homes.

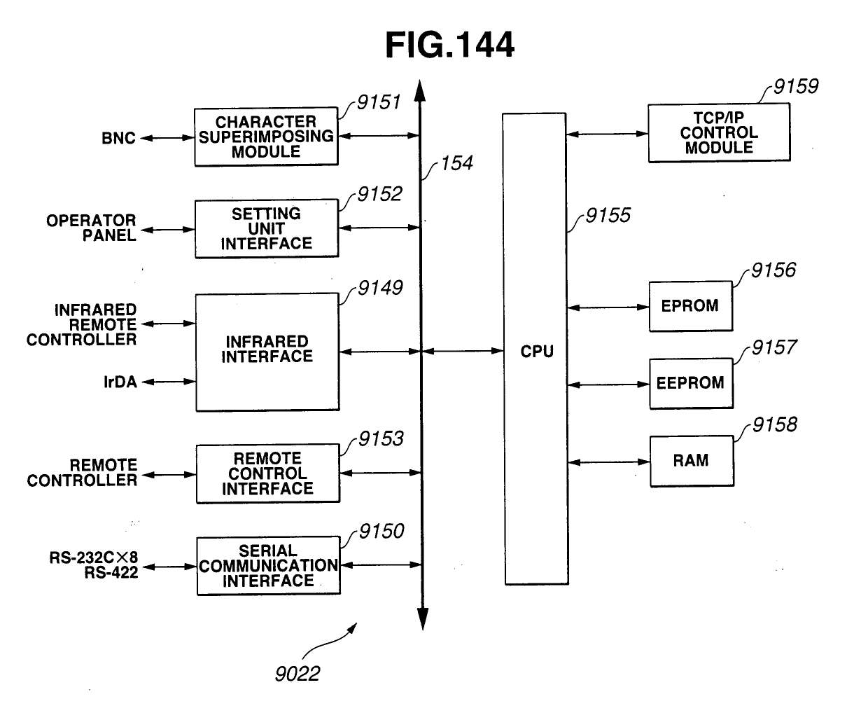

The system controller 9022 includes, as shown in FIG. 144: a character superimposition module 9151 that superimposes desired characters on an endoscopic image and transmits the resultant signal through a BNC connector 9138; a setting unit interface 9152 via which data is transferred to or from the operator panel 9021; an infrared interface 9149 via which the infrared remote controller 9069 and PDA 9068 communicates with each other by infrared light waves; a remote control interface 9153 via which data is transferred to or from the remote controller 9030; RS-232C communication connectors 9135(1) to 9135(8), and a serial communication interface 9150 via which serial communication is performed through a RS-422 communication connector 9136. The module, interfaces, and connectors are interconnected over an internal bus 9154.

A CPU 9151 that controls the components of the system controller 9022 is connected on the internal bus 9154. The CPU 9155 uses an EPROM 9156, an EEPROM 9157, and a RAM 9158 to control the components of the system controller 9022. A TCP/IP control module 9159 is connected to the CPU 9155. The TCP/IP control module 9159 enables connection of the CPU 9155 on the intra-hospital LAN 9101.

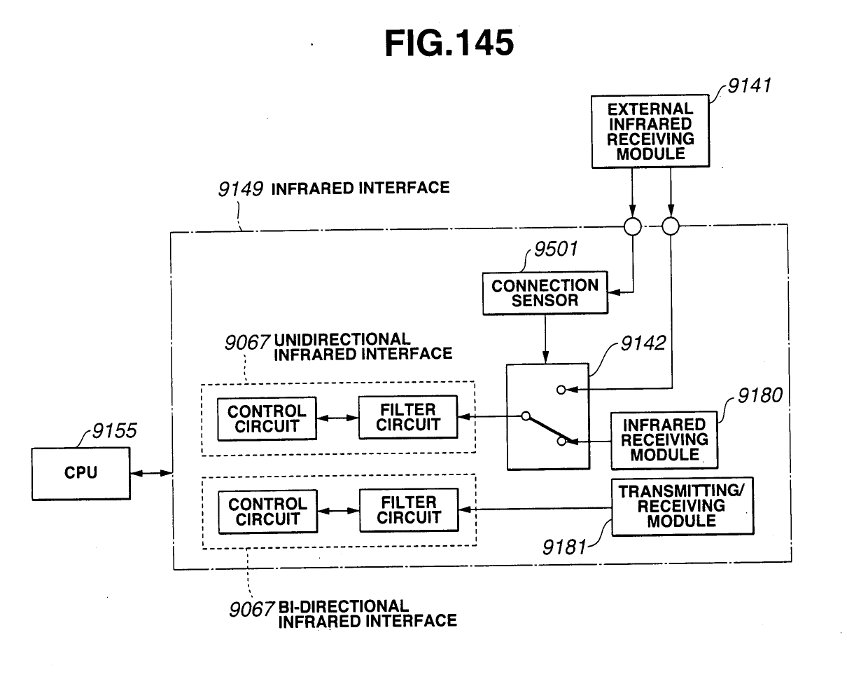

The infrared interface 9149 includes, as shown in FIG. 145: a unidirectional infrared receiving module 9180; a bi-directional IrDA communication infrared receiving module 9181; a bi-directional infrared interface 9066 via which data representing numerical values or equipment parameters sent from the PDA 9068 is transmitted or received; a unidirectional infrared interface 9067 via which a key code sent from the infrared remote controller 9069 is received; and an external infrared input module 9141 that receives data from an external infrared receiving module. A filter circuit included in each of the bi-directional infrared interface 9066 and unidirectional infrared interface 9067 filters an input signal received from the external infrared input module 9141 via a switch 9142.

During filtering, a high-frequency noise component is removed from a pulsating signal received from, for example, the unidirectional infrared communication remote controller 9069.

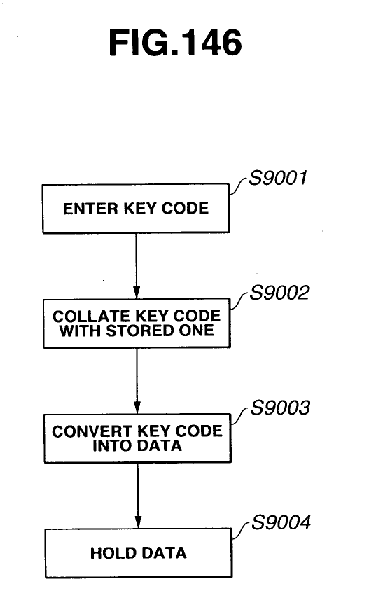

Referring to FIG. 146, how to analyze a key command received through unidirectional infrared communication will be described below. At step S9001, a key code having sent from the unidirectional infrared remote controller 9069 by infrared light waves and having a noise component thereof removed is received. At step S9002, the key code is collated with a key code stored in advance in the EEPROM 9157. At step S9003, the key code is converted into data. At step S9004, the data is stored in the RAM 9158.

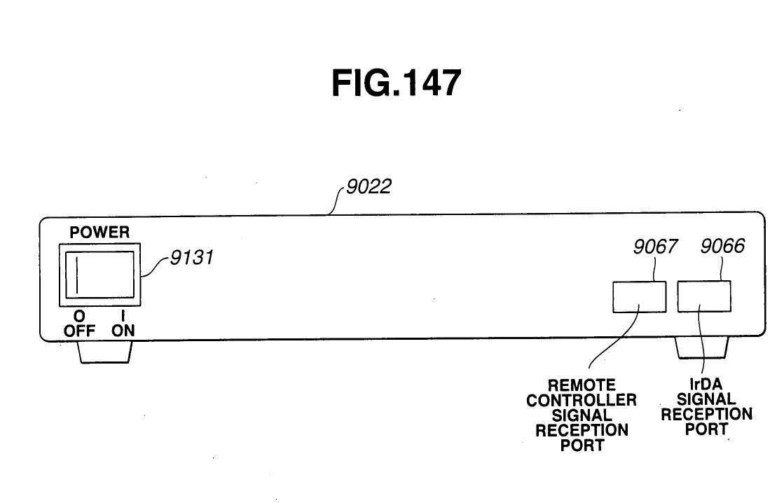

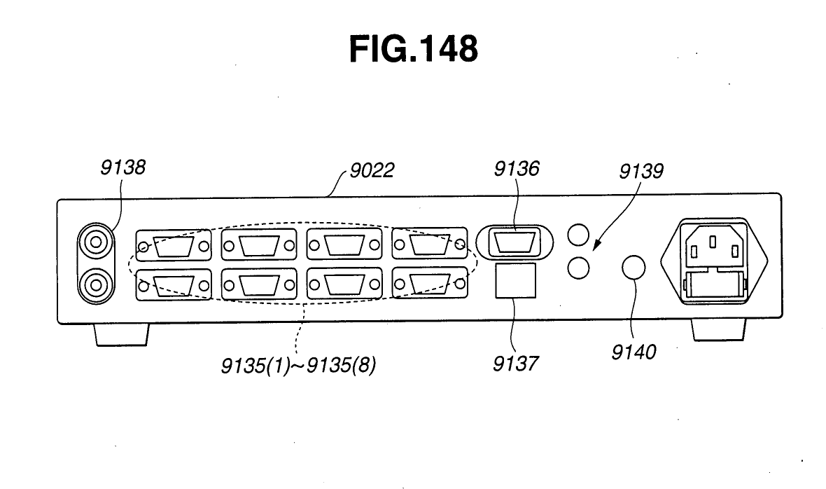

As shown in FIG. 147, a power switch 9131, the bi-directional infrared interface 9066 for bi-directional communication with the PDA 9068, and the unidirectional infrared interface 9067 for unidirectional communication with the infrared remote controller 9069 are exposed on the face of the system controller 9022. Exposed on the back thereof are, as shown in FIG. 148: the eight RS-232C communication connectors 9135(1) to 9135(8) through which the electrocautery unit 9013, insufflator unit 9014, endoscopic camera unit 9015, light source unit 9016, VTR 9017, and centralized display panel 9020 are controlled; the RS-422 communication connector 9136 through which the remote controller 9030 is controlled; a connector 9137 through which the system controller is connected on the intra-hospital LAN 9101 and which is conformable to, for example, the 10BaSe/T standard; the BNC connector 9138 through which the display device 9019 is connected; a pin jack 9139 through which a video signal is transferred to or from the VTR 9017; and a communication connector 9140 through which setup to be performed using the operator panel 9021 is controlled.

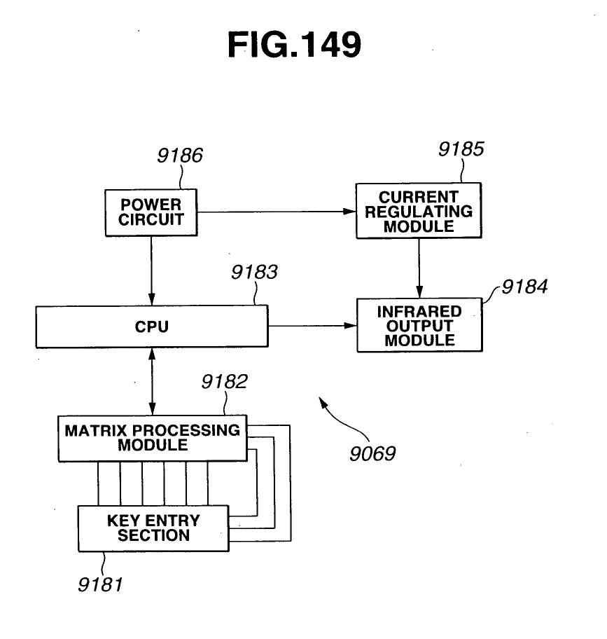

The infrared remote controller 9069 includes, as shown in FIG. 149: a key entry section 9181 composed of a plurality of keys; a matrix processing module 9182 that scans the key entry section 9181; a CPU 9183 that produces a key code associated with a key entry made at the key entry section 9181; an infrared output module 9184 that transmits an infrared pulse representing the key code to the system controller 9022 so as to perform unidirectional communication; a current regulating module 9185 that regulates a driving current to be fed to the infrared output module 9184; and a power circuit 9186 that supplies power to the CPU 9183 and current regulating module 9185.

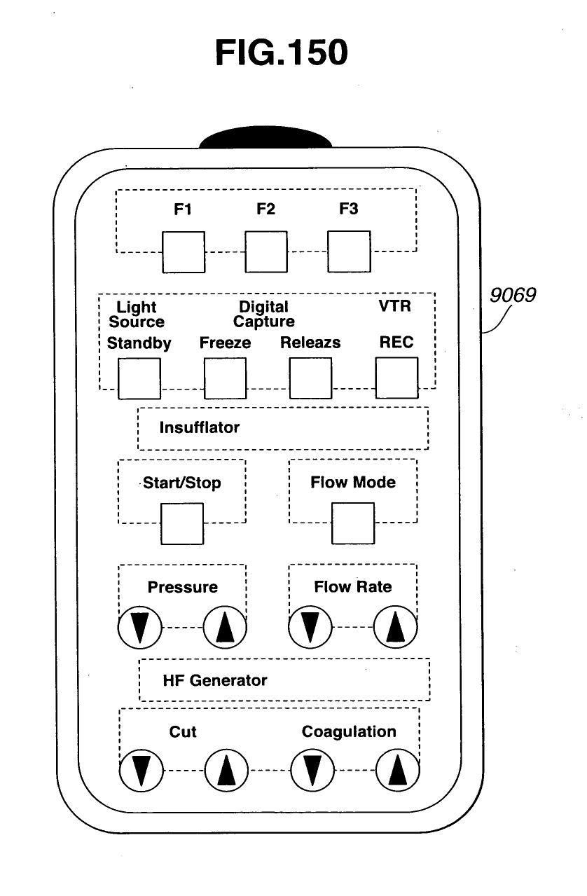

FIG. 150 shows the layout of keys on the key entry section 9181 of the infrared remote controller 9069.

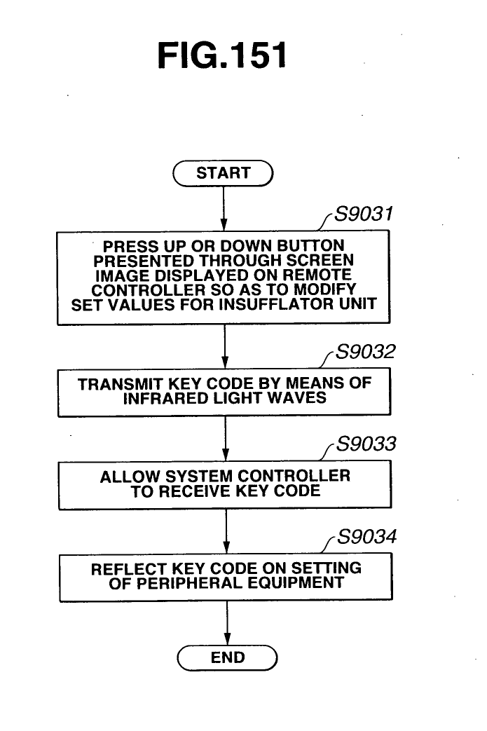

FIG. 151 is a flowchart describing how to operate peripheral equipment using a TV remote controller capable of performing unidirectional infrared communication. A detailed processing flow will be described later.

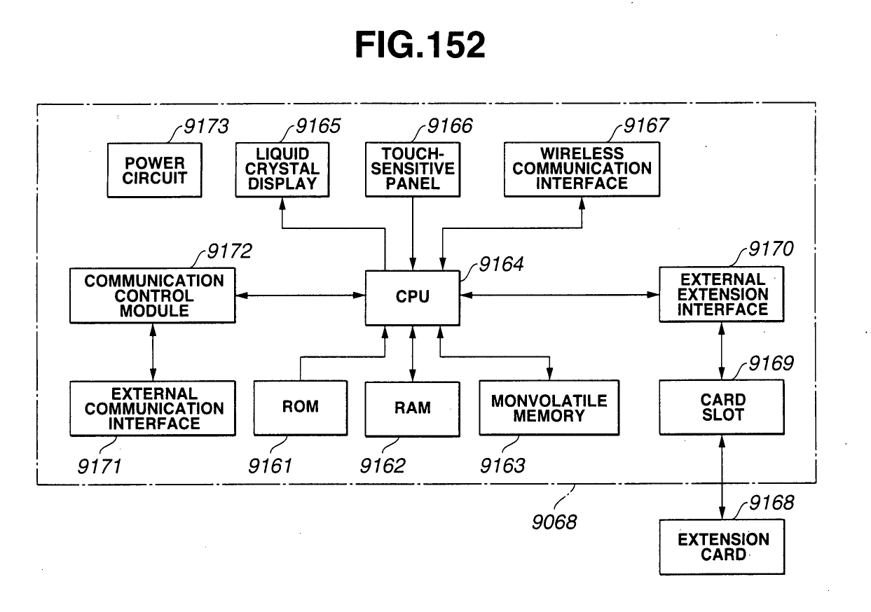

The PDA 9068 includes, as shown in FIG. 152: a CPU 9164 that uses a ROM 9161, a nonvolatile memory 9163, and a RAM 9162 to control the components of the PDA 9068; a liquid crystal display 9165 on which information provided by the CPU 9164 is displayed; a touch-sensitive panel 166 included in the liquid crystal display 9165 in order to permit entry of information; a wireless communication interface 9167 enabling bi-directional infrared communication conformable to the IrDA standard; an external extension interface 9170 via which an extension card 9168 inserted into a cart slot 9169 is connected to the CPU 9164 in order to realize an expansive feature; a communication control module 9172 that controls communication with external equipment connected via an external communication interface 9171; and a power circuit 9173 that supplies power to these circuits.

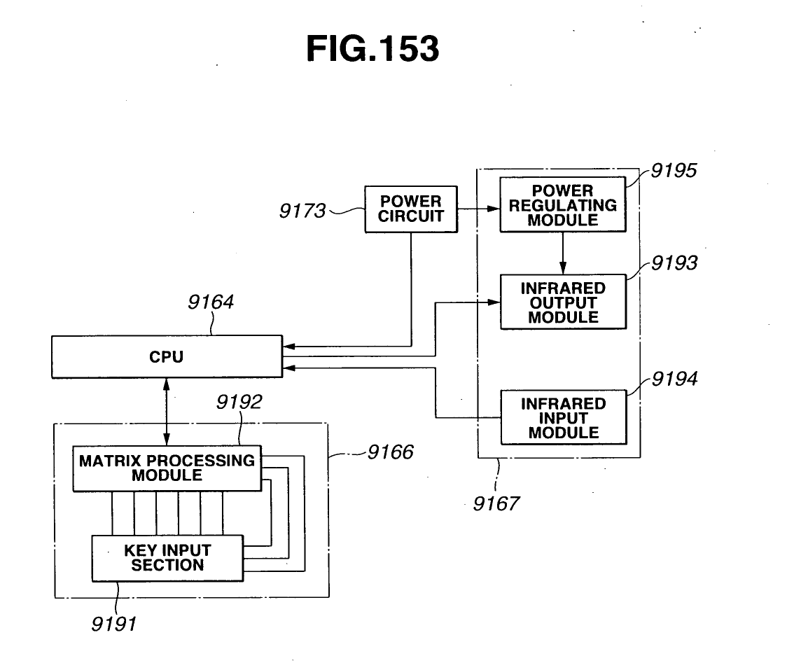

The touch-sensitive panel 9166 included in the PDA 9068 includes, as shown in FIG. 153, a key entry section 9191 composed of touch sensors arranged in the form of a matrix, and a matrix processing module 9192 that scans the key entry section 9191. The wireless communication interface 9167 includes: an infrared output module 9193 that transmits an infrared pulse, which represents a command that is produced by the CPU 9164 responsively to a key entry made at the key entry section 9191, to the system controller 9022; an infrared input module 9194 that receives an infrared pulse from the system controller 9022 and transfers it to the CPU 9164; and a current regulating module 9195 that regulates a driving current to be applied to the infrared output module 9193.

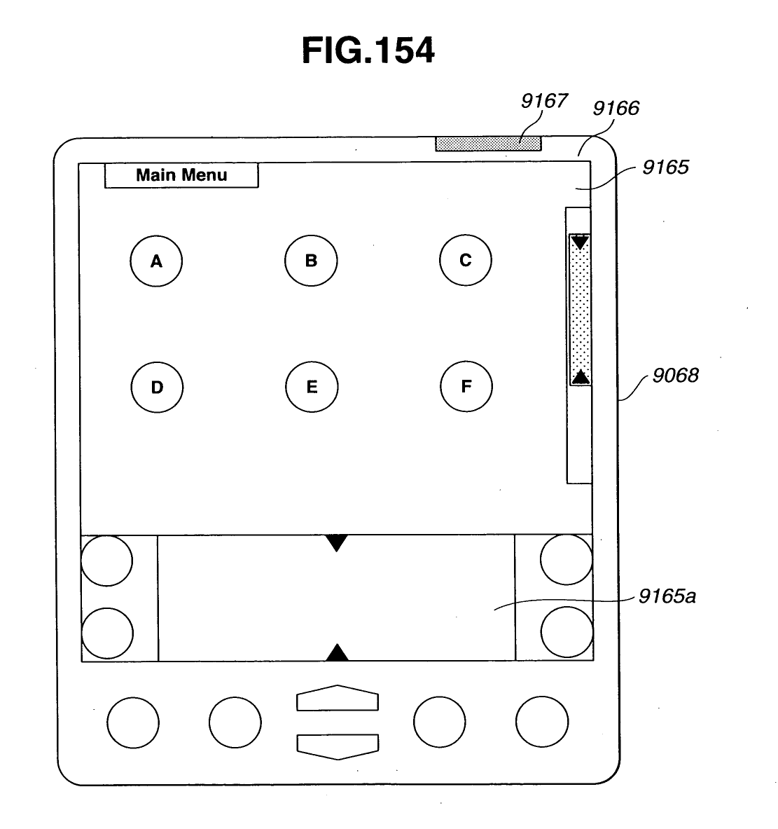

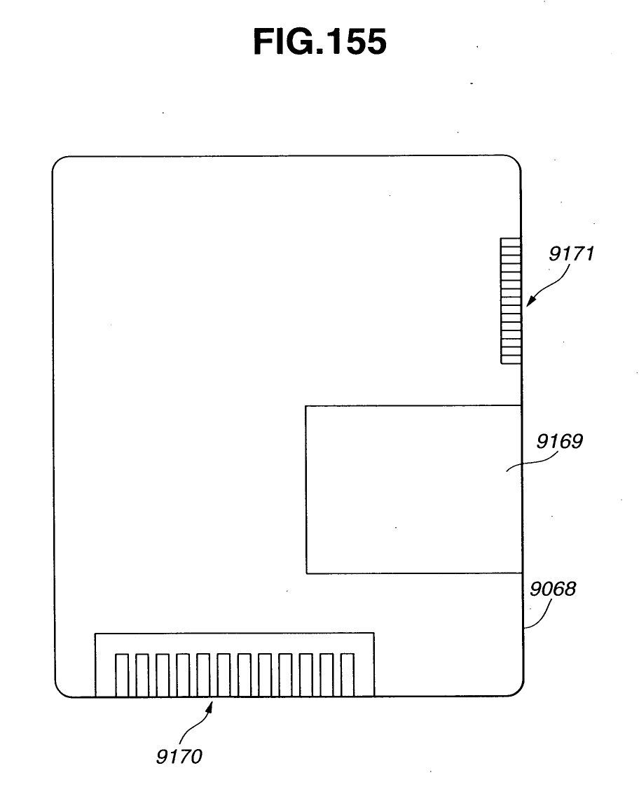

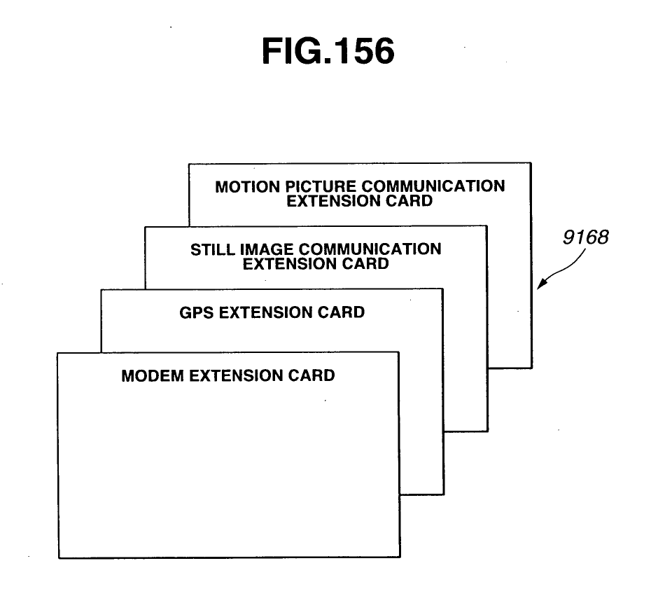

The liquid crystal display 9165 having the touch-sensitive panel 9166 is, as shown in FIG. 154, contained on the face of the PDA 9068. Part of the liquid crystal display 9165 serves as a handwriting entry section 9165a. A card slot 9169 and an external communication interface 9171 are, as shown in FIG. 155, contained in the back of the PDA 9068. The extension card 9168 to be inserted in the card slot 9169 is, for example, as shown in FIG. 156, a motion picture communication extension card, a still image communication extension card, a GPS extension card, or a modem extension card.

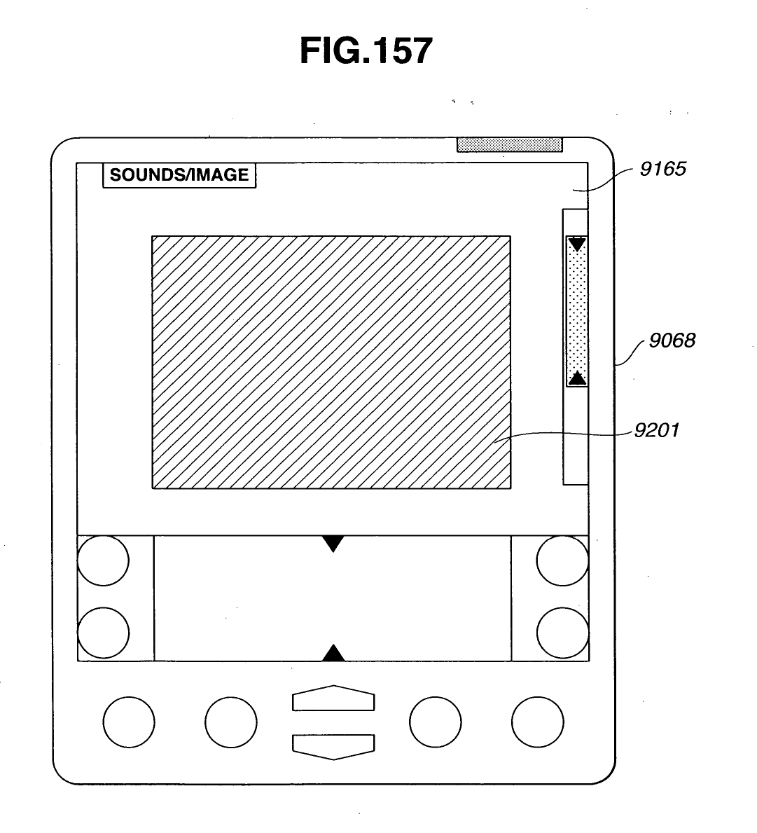

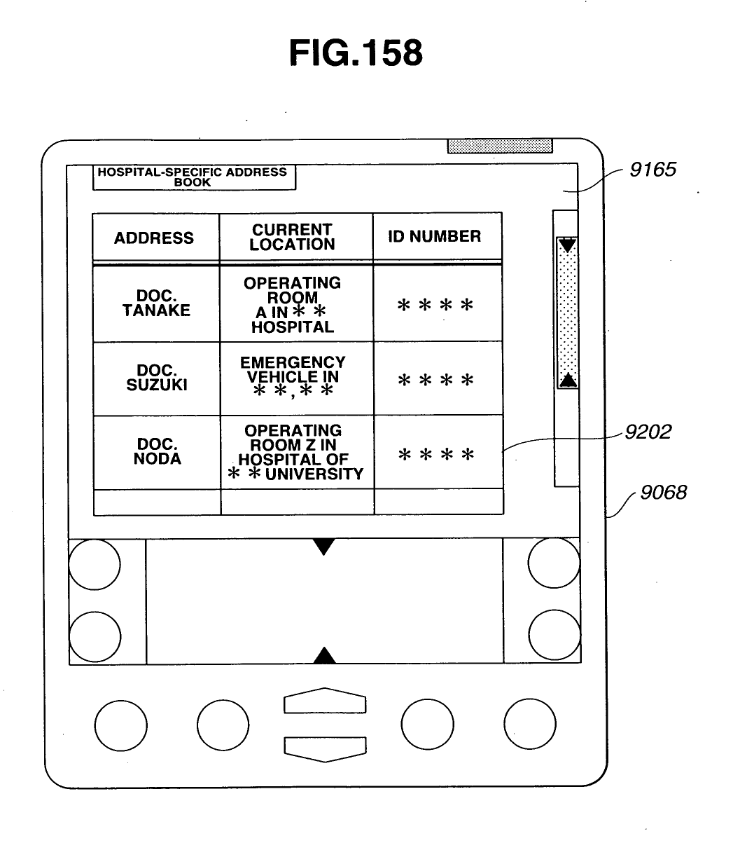

The touch-sensitive panel 9166 of the liquid crystal display 9165 shown in FIG. 154 is touched with a finger or a stylus pen with a menu screen image displayed, whereby data can be communicated to the system controller 9022 according to the IrDA standard. For example, an endoscopic image 9201 shown in FIG. 157 can be displayed on the liquid crystal display 9165. Moreover, assume that users who are doctors or the like each carry the PDA 9068 that has a GPS extension card, which is the extension card 9168, inserted into the card slot 9169 thereof, and can access the Internet. In this case, the locations of the accessible users can be, as shown in FIG. 158, displayed in the form of an address book 9202 on the liquid crystal display 9165.

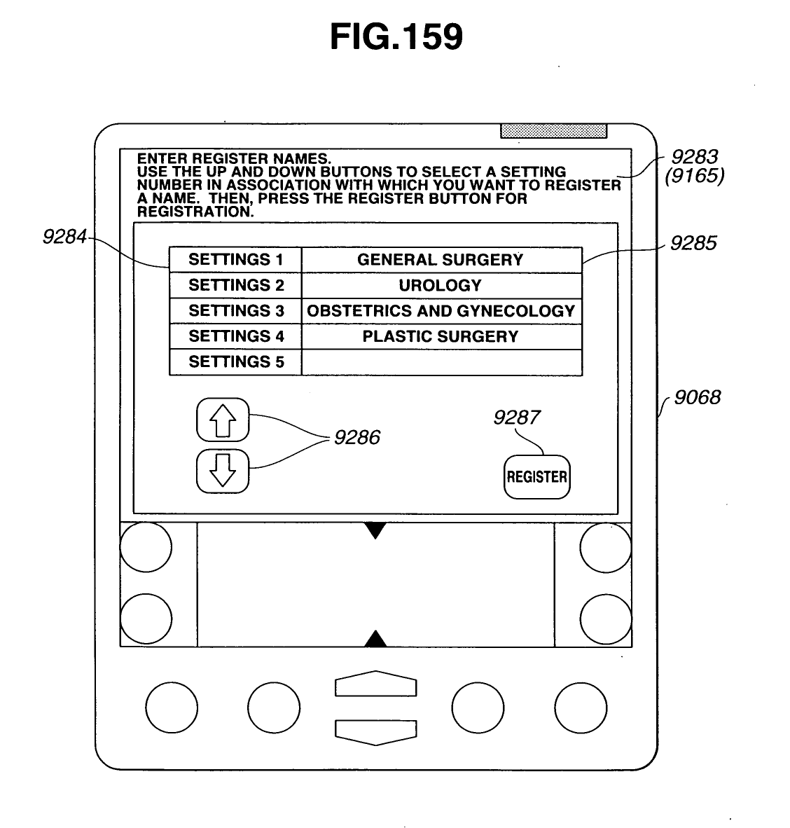

Moreover, the menu screen image displayed on the liquid crystal display 9165 shown in FIG. 154 presents a Register button (not shown) that is used to register set values. When a user touches the touch-sensitive panel 9166 so as to manipulate the Register button, the menu screen image displayed on the liquid crystal display 9165 is switched to a register name entry image 283 shown in FIG. 159.

The register name entry image 9283 shown in FIG. 159 is an entry image permitting a user to enter a register name suggesting a kind of surgery to be performed in each operating room 9002 whose interior has been described in conjunction with FIG. 140. A register name entry field 9285 in which a register name is entered is defined by the right-hand side of a setting number field 9284. Up and Down buttons 9286 used to move a cursor among the register name entry fields 9285 are located below the setting number fields 9284. Moreover, a Register button 9287 is located at the right lower corner of the entry image 9283.

A user touches the touch-sensitive panel 9166 so as to thus enter register names at the PDA 9068. Referring to FIG. 159, the register name entry image 9283 has register names entered in the register name entry fields 9285 associated with Setting 1 to Setting 4. The cursor is pointing out Setting 5 so as to indicate that a register name can be entered in the register name entry field 9285 associated with Setting 5.

Talking of a register name to be entered in the register name entry field 9285, for example, General Surgery is entered for Setting 1, Urology is entered for Setting 2, Obstetrics and Gynecology is entered for Setting 3, and Plastic Surgery is entered for Setting 4. In FIG. 159, the register name entry image 9283 contains the setting number fields of Setting 1 to Setting 5. Other setting number fields of Setting 6 and thereafter and associated register name entry fields will be scrolled up to appear with movement of the cursor.

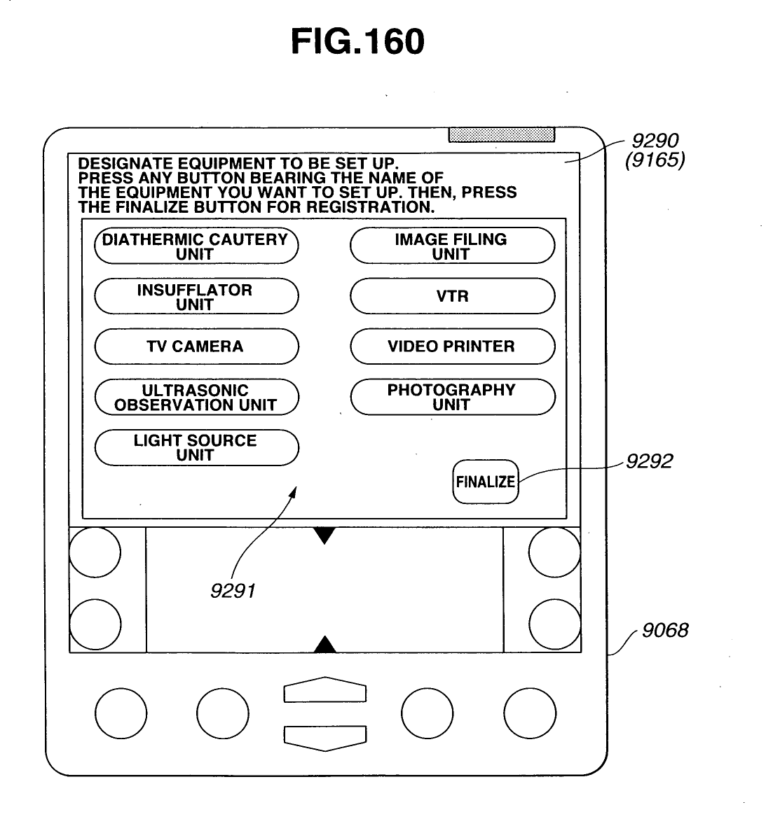

After a user enters register names, the user touches the touch-sensitive panel 9166 to manipulate the Register button 9287. Consequently, the register names are registered. The register names are preserved in the PDA 9068. When the PDA 9068 communicates data to the system controller 9022 according to the IrDA standard, the register name suggesting any kind of surgery or the like can be associated with settings. The user selects any of the registered register names so as to designate desired settings as the settings of each piece of medical equipment installed in the operating room 9002. When the Register button 9287 is manipulated, the screen image on the liquid crystal display 9165 is switched to an equipment selection image 9290 shown in FIG. 160.

The equipment selection image 9290 shown in FIG. 160 is an image permitting a user to select medical equipment whose settings the user wants to register. The equipment selection image 9290 presents the names of pieces of medical equipment including Diathermic Cautery Unit through a medical equipment presentation field 9291. Moreover, a Finalize button 9292 is located at the right lower corner of the image.

A user touches the touch-sensitive panel 9166 to designate medical equipment whose settings he/she wants to register, and then presses the Finalize button 9292.

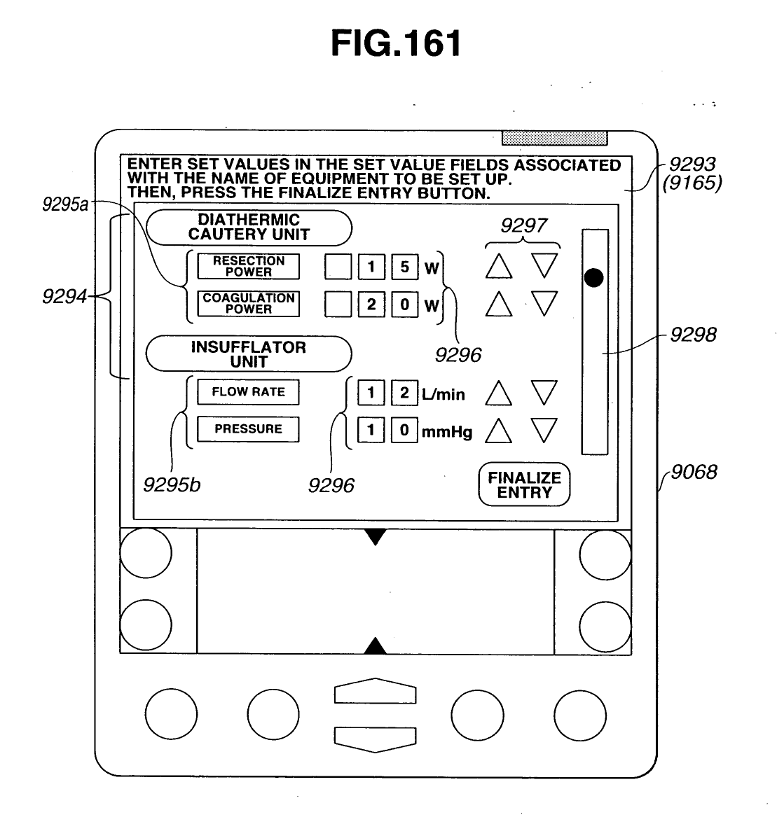

In the example shown in FIG. 160, the diathermic cautery unit and insufflator unit are designated as medical equipment. When the Finalize button 9292 is pressed, the screen image displayed on the liquid crystal display 9165 is switched to a setting entry image 9293 shown in FIG. 161.

The setting entry image 9293 shown in FIG. 161 is an image permitting a user to enter settings of medical equipment designated through the equipment selection image 9290 described in conjunction with FIG. 160. The setting entry screen 9293 prompts a user to enter desired set values for the medical equipment the user has designated. The setting entry image 9293 contains treatment mode name fields 295a and setting name fields 9295b that are located below each of medical equipment name presentation fields 9294. Moreover, set value entry fields 9296 are located by the right-hand side of each of the treatment mode name fields 9295a and setting name fields 9295b.

Up and Down buttons 9297 used to increase or decrease a set value entered in the set value entry field 9296 are located by the right-hand side of each of the set value entry fields 9296.

Moreover, a list indicator field 9298 that indicates a selected one of the set value entry fields 9296 is located by the right-hand side of the Up and Down buttons 9297. A Finalize Entry button 9299 to be used to finalize entries made in the set value entry fields 9296 is located below the Up and Down buttons 9297.

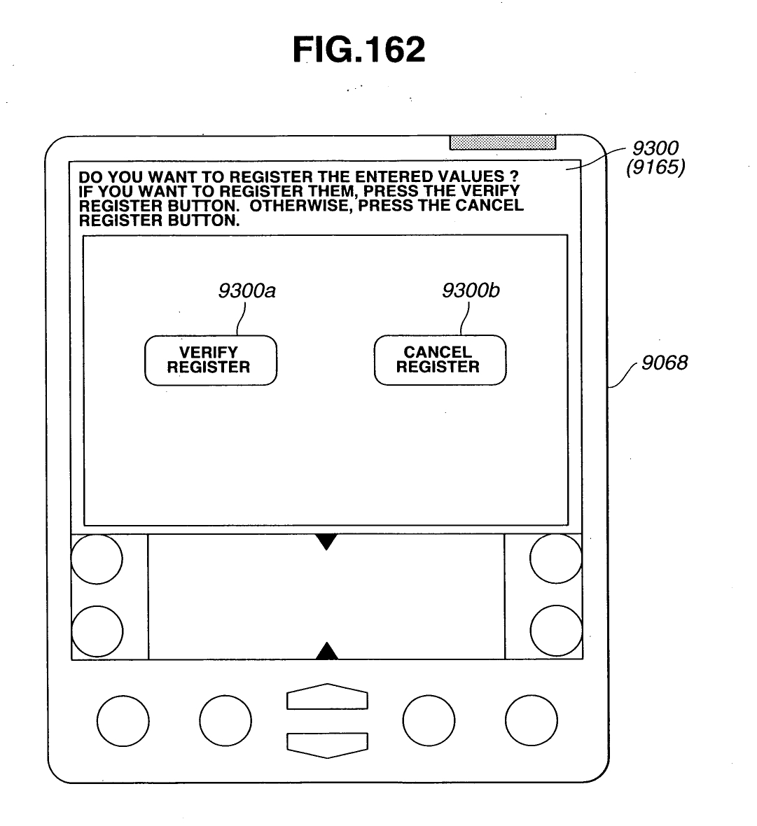

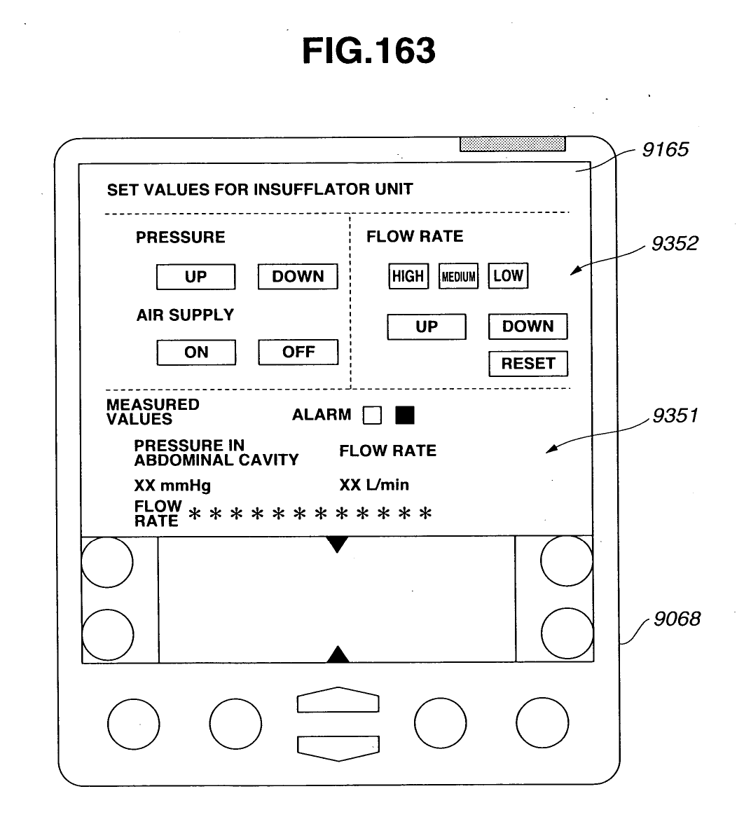

A user touches the touch-sensitive panel 9166 to enter desired set values for designated medical equipment in the set value entry fields 9296. When entry is completed, the user presses the Finalize Entry button 9299 for finalization. When the Finalize Entry button 9299 is pressed, the screen image on the liquid crystal display 9165 is switched to a register verification image 9300 shown in FIG. 162.

The register verification image 9300 shown in FIG. 162 is an image permitting a user to verify the contents of register made through the setting entry image 9293 and others described in conjunction with FIG. 161. The register verification image 9300 presents a Verify Register button 9300a to be used to verify the contents of register, and a Cancel Register button 9300b to be used to cancel the contents of register which are juxtaposed in the center of the screen image.

A user touches the touch-sensitive panel 9166 so as to manipulate the Verify Register button 9300a as long as the user is satisfied with the contents of register. Registration is thus completed. When the Verify Register button 9300a is pressed, the screen image on the liquid crystal display 9165 is switched to the menu screen image shown in FIG. 154.

If a user is dissatisfied with the contents of register, the user touches the touch-sensitive panel 9166 so as to manipulate a Cancel Register button 9300b. The user repeats registration until he/she is satisfied with the contents of register. If the Cancel Register button 9300b is pressed, the screen image on the liquid crystal display 9165 is switched to the register name entry image 9283 described in conjunction with FIG. 159.

When the PDA 9068 communicates data to the system controller 9022 according to the IrDA standard, the states of the pieces of medical equipment installed in the operating room 9002 can be downloaded and displayed on the liquid crystal display 9165. For example, a measured value screen image 9351 presenting the set values of a pressure in the abdominal cavity and a flow rate for the insufflator unit 9014 can be displayed on the liquid crystal display 9165. When a setting screen image 9352 permitting a user to enter set values is displayed on the liquid crystal display 9165, the set values can be modified.

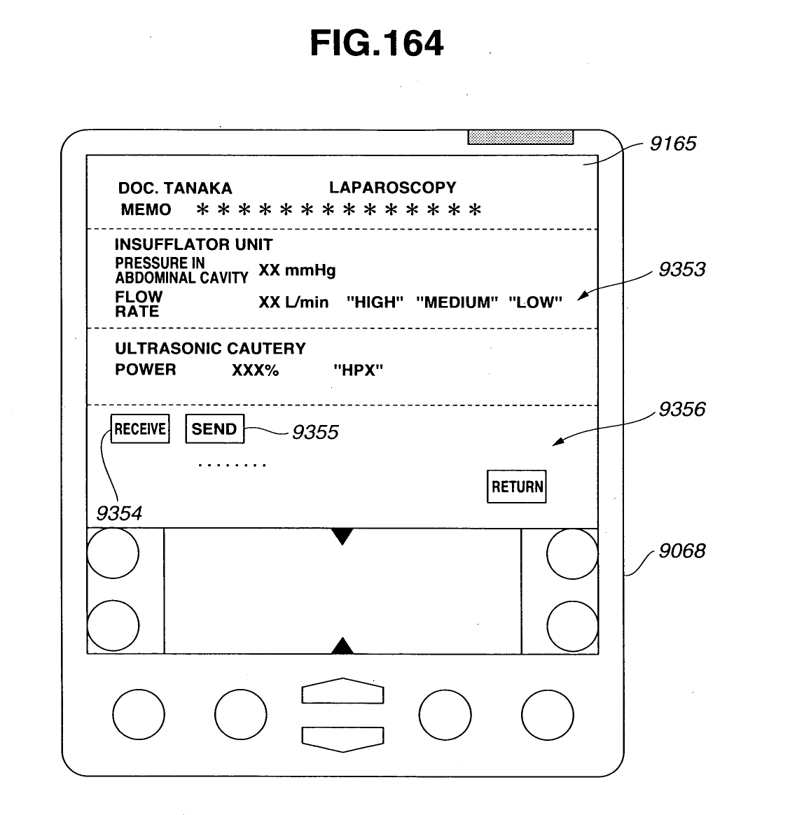

When the touch-sensitive panel 9166 is touched with the setting screen image 9352 displayed, a data transmission screen image 9353 shown in FIG. 164 appears. When a Send button 9354 is pressed, the settings of each piece of medical equipment determined using the PDA 9068 can be transmitted to the system controller 9022 through IrDA-conformable communication. When a Receive button 9355 is pressed, the set state of each piece of medical equipment installed in the operating room 9002 can be received from the system controller 9022 through IrDA-conformable communication.

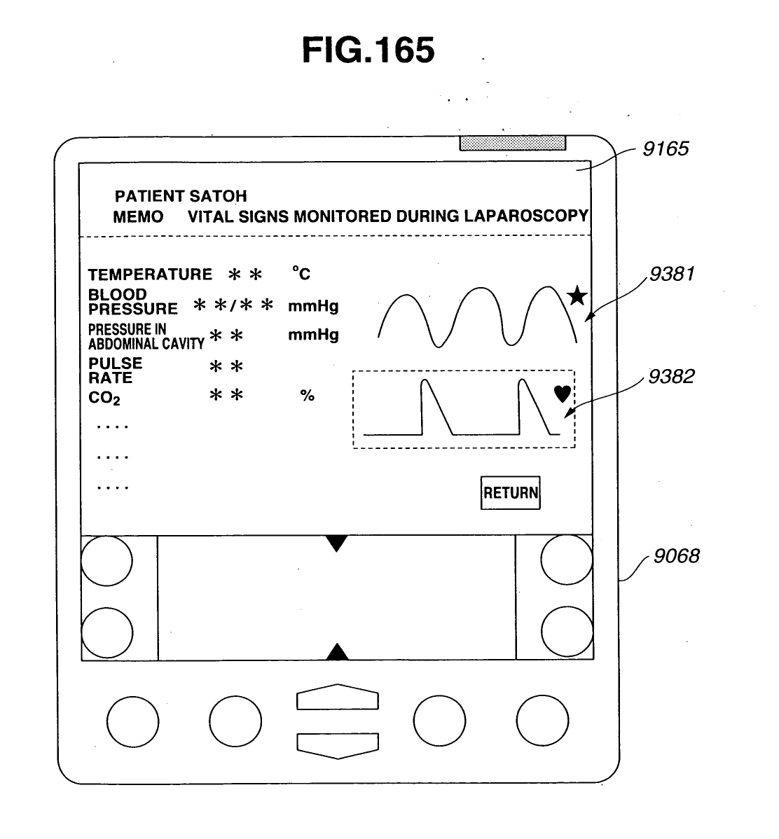

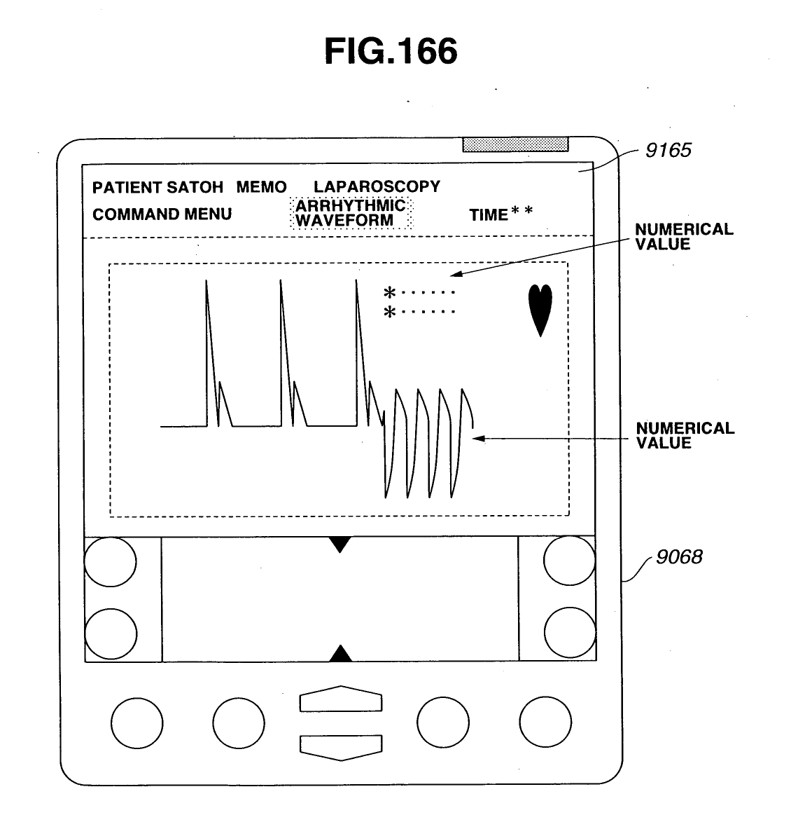

For example, assume that vital signs monitored using the patient monitor system 9004 during laparoscopy are received from the system controller 9022 according to the IrDA standard. In this case, as shown in FIG. 165, the PDA 9068 can display a blood pressure waveform 9381 and an electrocardiogram 9382 on the liquid crystal display 9165 together with a patient's temperature, blood pressure, and pulse rate. Moreover, for example, when the electrocardiogram 9382 is designated by pressing a corresponding portion of the touch-sensitive panel 9166, the electrocardiogram 9382 is, as shown in FIG. 166, displayed in enlargement. Furthermore, assuming that an abnormal waveform or any other waveform that attracts attention is found in the enlarged electrocardiogram 8392, when the portion of the touch-sensitive panel corresponding to the waveform that attracts attention is pressed, data representing the waveform that attracts attention is presented as numerical values.

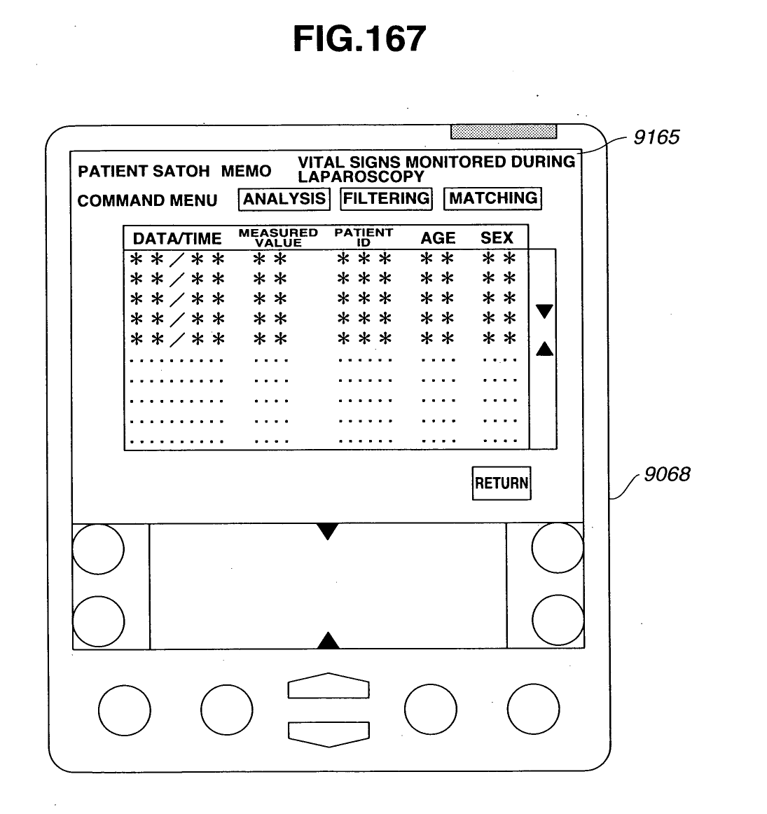

Incidentally, when the electrocardiogram 9382 is designated by pressing the corresponding portion of the touch-sensitive panel 9166, the electrocardiogram 9382 is displayed in enlargement. The present invention is not limited to this form. As shown in FIG. 167, a listing of numerical values expressing, for example, pulse rates may be displayed on the liquid crystal display 9165.

As mentioned above, equipment such as a TV remote controller that employs infrared light waves is adopted as the infrared remote controller 9069. The infrared remote controller 9069 is used to associate key codes or commands or control data items with a plurality of key entries, and transmit a key code through unidirectional infrared communication. The system controller 9022 receives the key code and updates data preserved in each piece of equipment according to the key code. The system controller 9022 requires a short response time to complete the reception and updating. Moreover, a portable terminal enabling bi-directional communication, such as, the PDA 9068 is used to transfer numerical values including values measured by equipment and patient information.

(Operations)

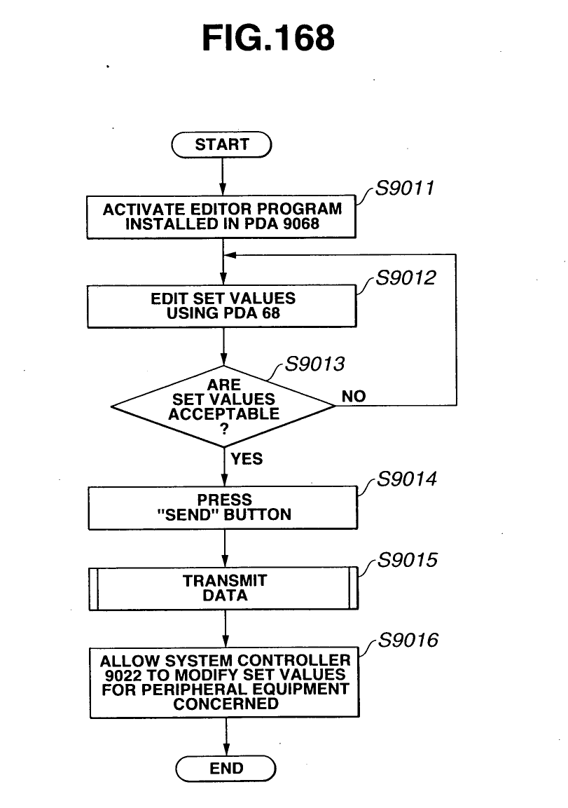

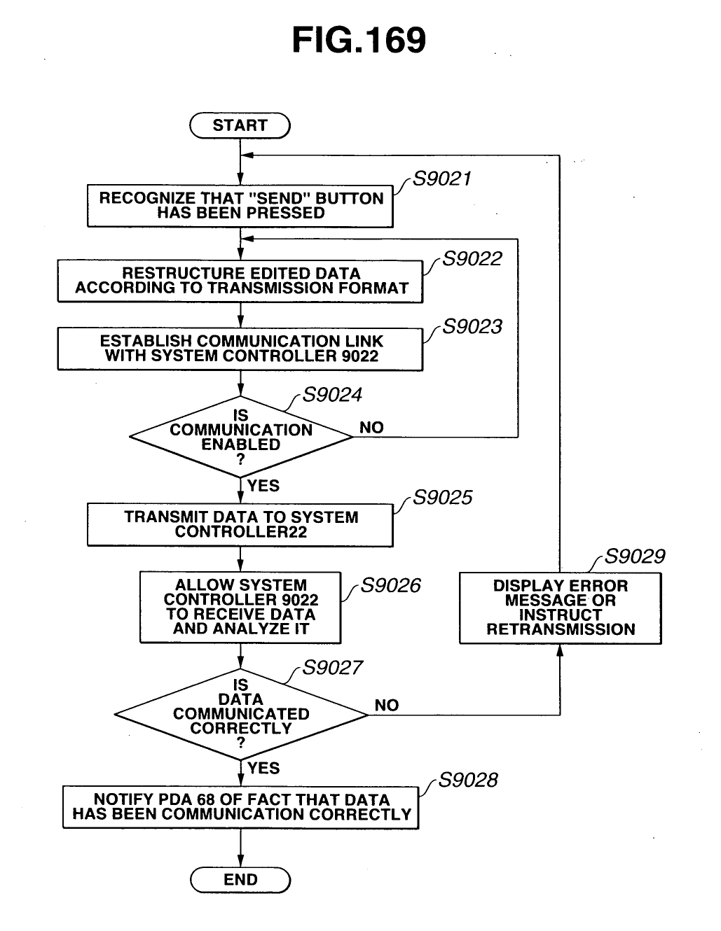

An operation to be exerted by the PDA 9068 will be described in conjunction with FIG. 168 and FIG. 169. An operation to be exerted by the unidirectional infrared remote controller 9069 will be described in conjunction with FIG. 151.

At step S901-1 described in the flowchart of FIG. 168, a parameter editor program is activated by clicking an icon contained in a main menu displayed on the PDA 9068 as shown in FIG. 154. At step S9012, the parameters or settings of peripheral equipment which an operator wants to remotely control are modified. This means that the operator has edited set values and stored the data representing the resultant set values in a predetermined register in the memory included in the PDA 9068. If it is found at step S9013 that the edited set values are acceptable, the Send button is pressed at step S9014. At step S9015, the system controller 9022 and PDA 9068 communicate with each other bi-directionally.

Referring to the flowchart of FIG. 169, a processing flow of transmission through bi-directional communication will be described below.

At step S9021, it is recognized that the Send button presented through an image displayed on the PDA 9068 has been pressed. At step S9022, the edited data is read from the memory and restructured in a transmissible format. For example, the data is converted into a packet communication form (structured as packets each specifying an inherent ID and port number). According to the present embodiment, data to be transmitted, a data type, a protocol version number, and a Read or Write instruction are transferred as one data structure. What is referred to as a data type is information concerning peripheral equipment whose settings must be updated, or in other words, an ID. Moreover, data to be transmitted may be the numerical values of parameters or settings of peripheral equipment, an on or off state, or the like.

At step S9023, the PDA 9068 issues a communication request to the system controller 9022 so as to establish a communication link with the system controller 9022. At step S9024, a communication link is established. At step S9025, the PDA 9068 transmits data to the system controller 9022. At step S9026, the system controller 9022 analyzes the contents of communication on the basis of the data type and protocol version. At step S9027, it is judged from the results of analysis performed at step S9026 if communication has succeeded. At step S9028, a reply saying that communication has succeeded is returned to the PDA 9068. If it is found at step S9027 that a key code has been communicated incorrectly, an error message is displayed at step S9029. Otherwise, a retransmission request is transmitted for retransmission.

At step S9028, communication is terminated. Control is then passed to step S9016 described in FIG. 168. The system controller 9022 modifies the stored set values for the peripheral equipment and terminates processing. The operator verifies the results of modification through the centralized display panel 9020 or the like.

If a protocol stipulating that a request should be issued in order to update data, such as, a Bluetooth protocol or a protocol dedicated to a wireless LAN is adopted, a data updating request may be transmitted from the PDA 9068 at step S9023 in FIG. 169. At step S9024, it may be judged whether data can be transferred to or from the system controller 9022.

Moreover, the PDA 9068 may have the ability to receive the vital signs of the patient 9048 monitored by the patient monitor system 9004 or fetch an endoscopic image.

Referring back to FIG. 151, a processing flow to be followed by the unidirectional infrared remote controller 9069 will be described below.

At step S9031, an operator presses the Insufflator field (to designate the insufflator unit 9014) and the Up and Down buttons, and then presses a command button. At step S9032, the infrared output module 9184 included in the unidirectional infrared remote controller 9069 irradiates infrared light waves. At step S9033, the system controller 9022 receives control data carried by the infrared light waves, filters it, and collates it with stored data so as to thus analyze the received data. At step S9034, the set values for the insufflator unit 9014 are modified.

(Advantages)

Since the PDA 9068 capable of performing bi-directional infrared communication is employed, all required parameters or settings can be determined with minimal handling. This helps a nurse set up equipment prior to surgery.

Moreover, since the unidirectional infrared remote controller 9069 is included, the parameters or settings of peripheral equipment can be determined one by one. This helps a doctor modify settings during surgery.

As mentioned above, since remote controllers optimal for determination or modification of settings to be performed prior to or during surgery are included, a user-friendly control system is realized.

### Thirty-Eighth Embodiment

A thirty-eighth embodiment of the present invention will be described below. The description of components identical to those of the thirty-seventh embodiment will be omitted.

(Features)

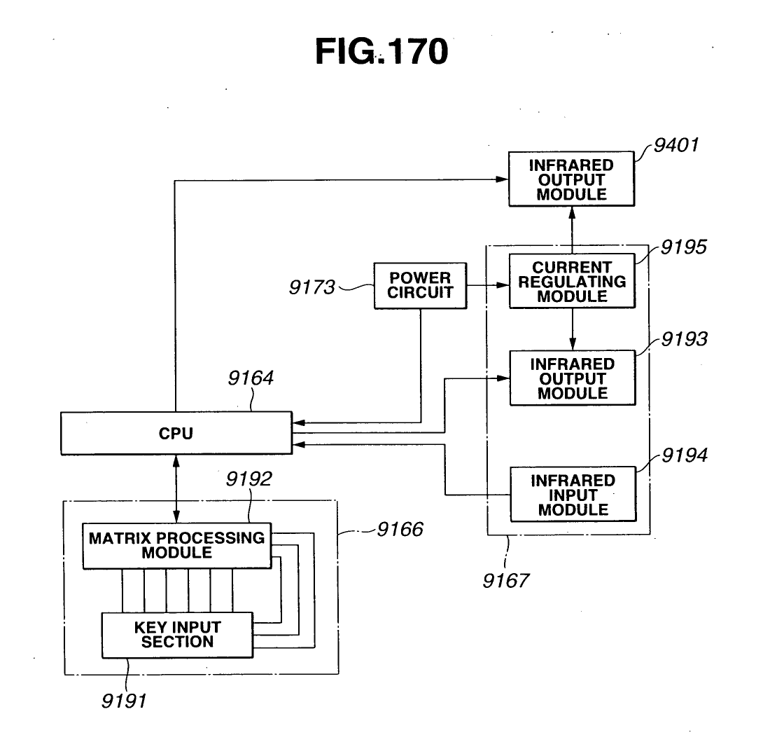

As shown in FIG. 170, when set values are all determined through the screen image, which is shown in FIG. 164, displayed on the display 9165 of the PDA 9068, if the Send button 9355 is pressed, the set values for the insufflator unit 9014 are all transmitted to the system controller 9022. The communicating state is then presented through a communicating state display field 9356.

(Operations)

According to the transfer procedure described in FIG. 169 in relation to the thirty-seventh embodiment, step S9023 of establishing a communication link, step S9025 of transferring data to or from the system controller 9022, step S9026 of analyzing data, and step S9028 of completing communication must be followed in order to transfer data. A current step within data communication or data transfer is presented through the communicating state display field 9365.

The communicating state to be displayed may be “Establishment of a communication link is under way.,” “Data reception (transmission) is under way.,” “Normal termination,” “Communication error,” “The insufflator unit is no good.”, or “The insufflator unit is in operation.”

Moreover, when communication is performed at a high speed, data updating may fail. In this case, at what step an error takes place or a progress resulting in occurrence of an error may be presented in the form of an error log. The error log may have such a style that “Establishment of a communication link: success→ID acquisition: success→Data transmission: failure.” An operator can retransmit data in consideration of the contents of the error log.

If set values transmitted from the system controller 9022 exceed limits within which peripheral equipment concerned can be set up, a set value limit error message may be displayed on the PDA 9068.

(Advantages)

According to the present embodiment, an operator can swiftly cope with a trouble such as a failure. This contributes to improved user-friendliness of a remote controller. The progress of surgery will not be hindered.

### Thirty-Ninth Embodiment

A thirty-ninth embodiment of the present invention will be described below. The description of components identical to those of the thirty-seventh and thirty-eighth embodiments will be omitted.

(Features)

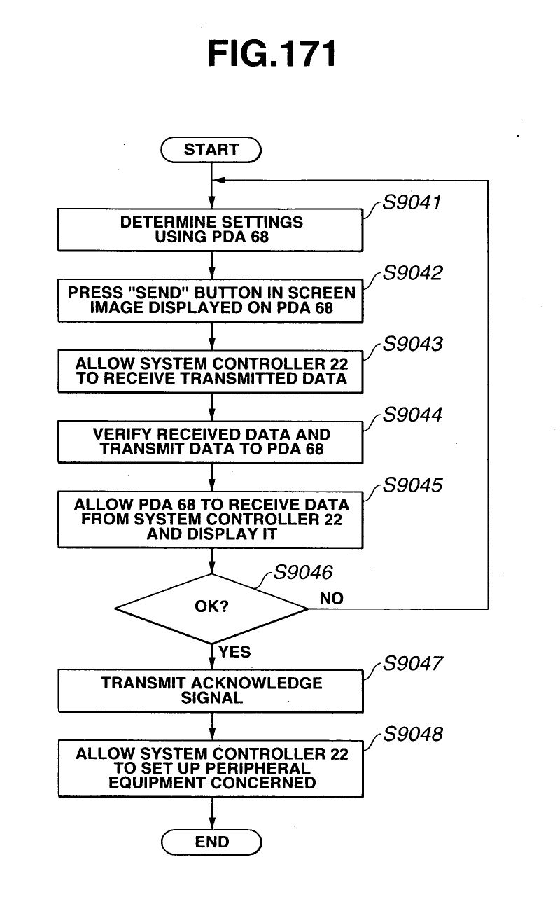

FIG. 171 is a flowchart describing a procedure to be followed in order to operate the PDA 9068.

(Operations)

Next, the flowchart of FIG. 171 will be described. At step S9041, the Insufflator Unit field contained in the screen image displayed on the PDA 9068 is selected in order to designate the insufflator unit 9014 (see FIG. 24). At step S9042, a desired command button is pressed in order to irradiate infrared light waves. At step S9043, the system controller 9022 receives transmitted data. At step S9044, the received data is checked and retransmitted to the PDA 9068. At step S9045, the PDA 9068 receives the data and displays it on the liquid crystal display 9165. At step S9046, an operator checks the data. If the operator verifies that the data is exactly the data he/she has transmitted, the operator presses a command button at step S9047 so as to transmit the data to the system controller 9022. At step S9048, if the system controller 9022 identifies an acknowledge signal, the system controller 9022 updates the set values for the insufflator unit 9014, and terminates processing.

(Advantages)

Owing to the above features and operation, for example, when the conventional unidirectional infrared remote controller 9069 is employed, an operator uses the Up and Down buttons to determine the settings of peripheral equipment, and verifies the updated set values through the display device 9019. Thus, security is guaranteed. In contrast, when an operator uses the PDA 9068 to determine settings, the system controller 9022 returns received values to prompt the operator to verify the values again. Consequently, security is guaranteed more successfully.

### Fortieth Embodiment

(Structure)

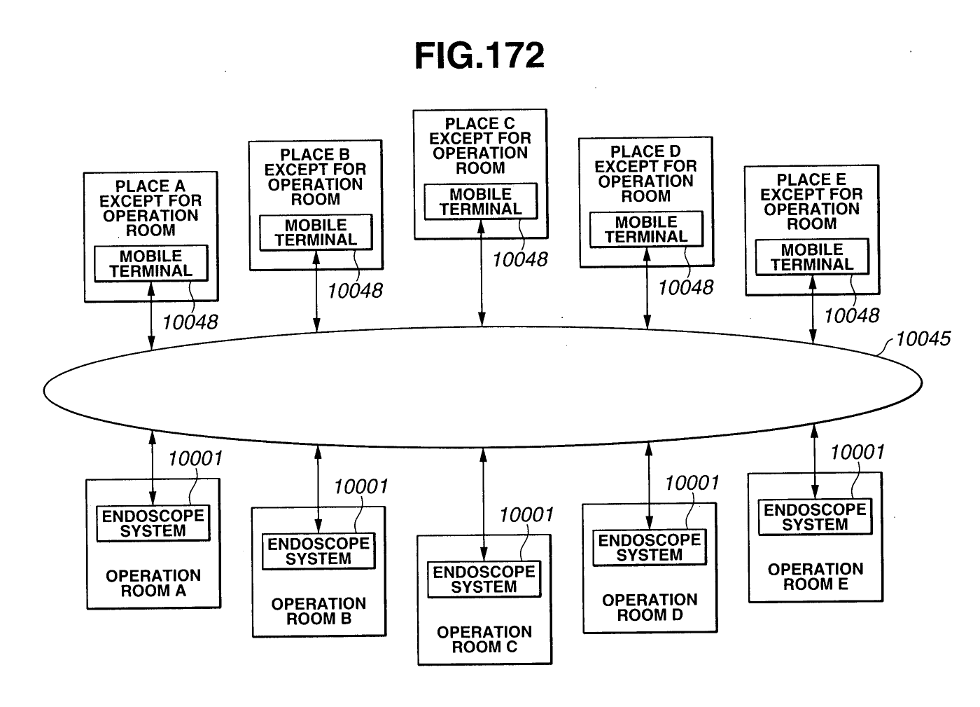

Referring to FIG. 172, an operation supporting system according to the fortieth embodiment has a plurality of operation rooms having endoscope systems 10001 in a hospital. The endoscope systems 10001 is connected to a communication line 10045 via a cable (not shown).

At the place except for the plurality of operation rooms, a mobile terminal 10048 is installed to be communicated to the operation rooms via the communication line 10045.

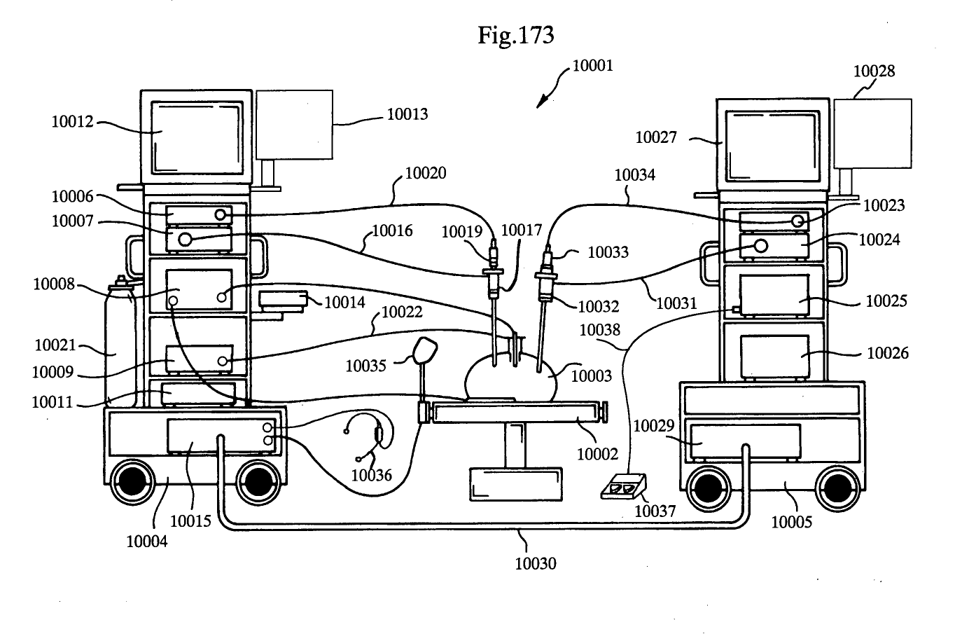

Referring to FIG. 173, the endoscope system 10001 has a first trolley 10004 and a second trolley 10005 on both sides of an operation bed 10002 on which a patient 10003 is laid. A plurality of endoscope peripheral devices are mounted on both the first and second trolleys 10004 and 10005 for observation, examination, treatment, and recording.

The first trolley 10004 comprises: a first TV camera device 10006; a first light source device 10007; a high-frequency cautery device (hereinafter, referred to as an electric knife) 10008; an aeroperitoneum device 10009; a video printer (not shown); a first display 10012; an intensive operating panel 10014 having a mouse or a pointing device such as a touch panel (not shown), which is arranged in a non-sterilized area and on which a nurse intensively operates medical devices; a system controller 10015; and the like. The devices are connected to the system controller 10015 via a cable (which will be described later) for interactive communication.

The first light source device 10007 is connected to the first endoscope 10017 via a light guide cable 10016 for transmitting illuminating light. The illuminating light from the first light source device 10007 is supplied to a light guide of the first endoscope 10017, thereby illuminating the affected part in the abdominal region of the patient 10003 in which an inserting portion of the first endoscope 10017 is inserted.

A first camera head 10019 having an image pick-up device is attached to an eyepiece portion of the first endoscope 10017. The image pick-up device in the first camera head 10019 picks-up an optical image of the affected part through an observation optical system of the first endoscope 10017, and the image is transmitted to the first TV camera device 10006 via a camera cable 10020. The transmitted image is subjected to signal processing by a signal processing circuit in the first TV camera device 10006, and a video signal is generated. Further, the signal is outputted to the first display 10012 via the system controller 10015, and an endoscope image of the affected part is displayed.

The system controller 10015 includes an external medium recording device (DVD or MO, not shown), and an image recorded to the external recording medium is outputted and displayed onto a first display 10012.

Further, the system controller 10015 is communicated with a communication line 10045 arranged in a hospital (not shown) via a cable (not shown), thereby outputting and displaying the image data on the communication line 10045 on the first display 10012.

The aeroperitoneum device 10009 is connected to a CO₂ cylinder 10021, thereby feeding CO₂ gas in the abdominal region of the patient 10003 via an aeroperitoneum tube 10022 extended to the patient 10003 from the aeroperitoneum device 10009.

The second trolley 10005 comprises: a second camera device 10023; a second light source device 10024; an ultrasonic treating device 10025; a VTR 10026; a second display 10027; an intensive display device 10028; and a relay unit 10029 and the like. The devices are connected to the relay unit 10029 via a cable (not shown) for interactive communication.

The second light source device 10024 is connected to a second endoscope 10032 via a light guide cable 10031 for transmitting illuminating light, the illuminating light from the second light source device 10024 is supplied to a light guide of the second endoscope 10032, and the affected part in the abdominal region of the patient 10003 in which an inserting portion of the second endoscope 10032 is inserted is illuminated.

A second camera head 10033 having an image pick-up device is attached to an eyepiece portion of the second endoscope 10032, and the image pick-up device in the second camera head 10033 picks-up an optical image of the affected part through an observing optical system of the second endoscope 10032. The image is transmitted to the second TV camera device 10023 and is subjected to signal processing by a signal processing circuit in the second TV camera device 10023, thereby generating a video signal. The video signal is outputted and displayed onto the second display 10027 as an endoscope image of the affected part.

The system controller 10015 is connected to the relay unit 10029 via a system cable 10030.

Further, a Dr remote controller 10035 is connected to the system controller 10015 operate the devices from a sterilized area by an operator.

A head set 10036 is connected to the system controller 10015. In the system controller 10015, input voice from the head set 10036 is recognized and the devices are controlled by the operator's voice. Further, a foot switch 10037 is connected to the ultrasonic treating device 10025 via a cable 10038.

Referring to FIG. 174, connected to the system controller 10015 via a communication cable 10040 are the intensive operating panel 10014, the first TV camera device 10006, the first light source device 10007, the electric knife 10008, the aeroperitoneum device 10009, the video printer 10010, and the first display 10012, so as to receive and transmit data and a video signal.

Further, connected to the relay unit 10029 via a communication cable 10041 are the second TV camera device 10023, the second light source device 10024, the ultrasonic treating device 10025, the VTR 10026, and the second display 10027, so as to receive and transmit data and a video signal.

The relay unit 10029 is connected to the system controller 10015 via a the cable 10030 (refer to FIG. 173). Further, the intensive operating panel 10014 is connected to the system controller 10015 via an intensive operating panel cable 10042. The head set 10036 is connected to the system controller 10015 via a head set cable 10047. The Dr remote controller 10035 is connected to the system controller 10015 via a remote controller cable 10044. The intensive display panels 10013 and 10028 are connected to the system controller 10015 via system cables 10046a and 10046b.

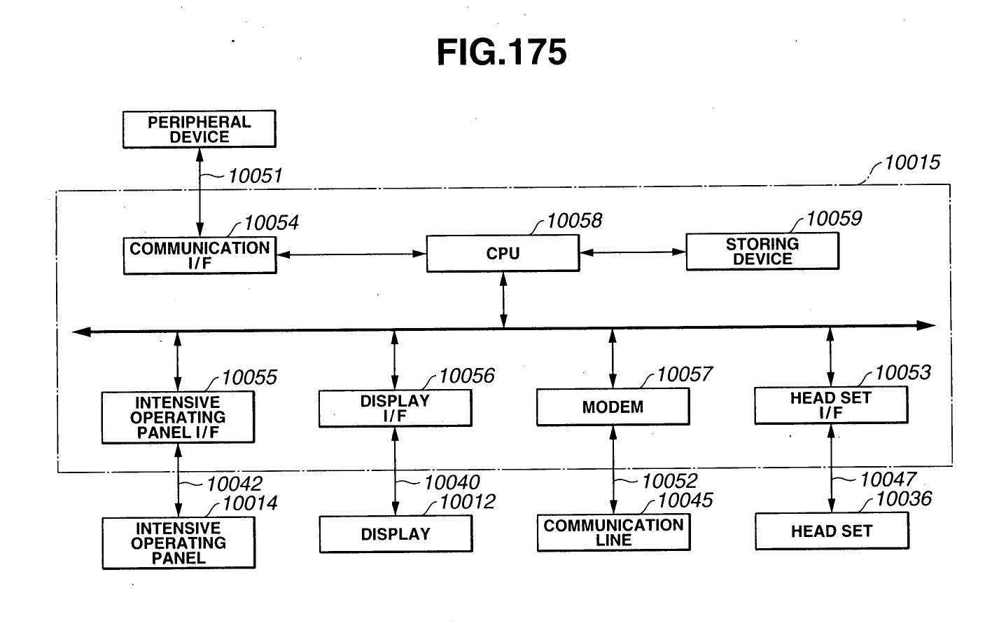

FIG. 175 shows the internal structure of the system controller 10015.

The system controller 10015 installed in the operation room comprises: a CPU 10058; a communication interface (hereinafter, abbreviated to an I/F) 10054; an intensive operating panel I/F 10055; a display I/F 10056; a modem 10057; a storing device 10059; and a head set I/F 10053.

The devices are connected by the communication I/F 10054 via a communication cable 10051, are connected to the intensive operating panel 10014 by the intensive operating panel I/F 10055 via the intensive operating panel cable 10042, are connected to the display 10012 by the display I/F 10056 via the communication cable 10040, are connected to the communication line 10045 by the modem 10057 via a LAN cable 10052, and are connected to the head set 10036 by the head set I/F 10053 via a head set cable 10047. The I/Fs, the modem 10057, and the storing device 10059 are connected to the CPU 10058 for intensively controlling the devices.

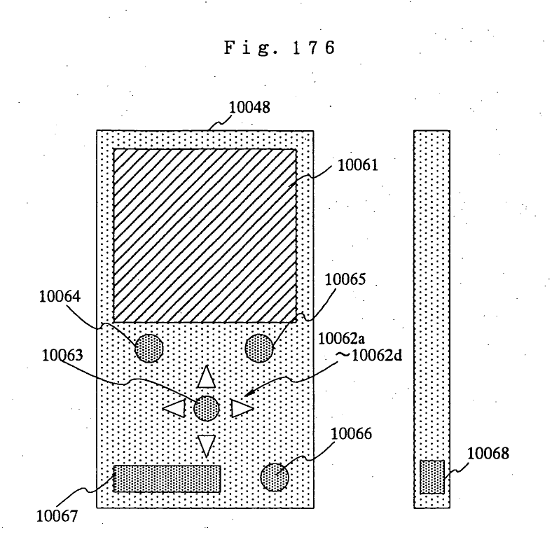

FIG. 176 shows an appearance diagram of the mobile terminal 10048.

The mobile terminal 10048 is portable in size, and has a display 10061 having a touch panel. Further, the mobile terminal 10048 comprises key switches 10062a to 10062d for selecting switches displayed on the display 10016, and an execution switch 10063.

Furthermore, the mobile terminal 10048 comprises a receiving switch 10064 for receiving the external access; a disconnecting switch 10065 for disconnecting the external access; a microphone 10066 for externally speaking via the communication line 10045; and a speaker 10067. In addition, the mobile terminal 10048 comprises: a connector 10068 detachable to a mobile terminal cable, which will be described later.

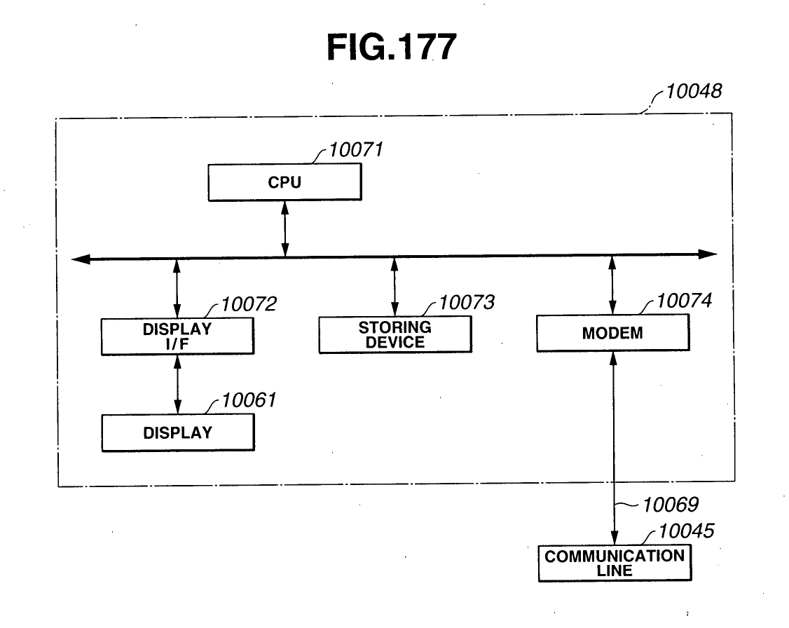

FIG. 177 shows the internal structure of the mobile terminal 10048.

The mobile terminal 10048 comprises: a CPU 10071; a display I/F 10072; a storing device 10073; a modem 10074; and the display 10061. The display I/F 10072, the storing device 10073, the modem 10074 are connected to the CPU 10071 for intensively controlling the devices. The display I/F 10072 is connected to the display 10061.

The display I/F 10072 receives an input upon selecting and executing switches displayed on the display 10061 of the mobile terminal 10048 by using key switches 10062a to 10062d and execution switch 10063. The CPU 10071 of the mobile terminal 10048 controls the operation in accordance with the input.

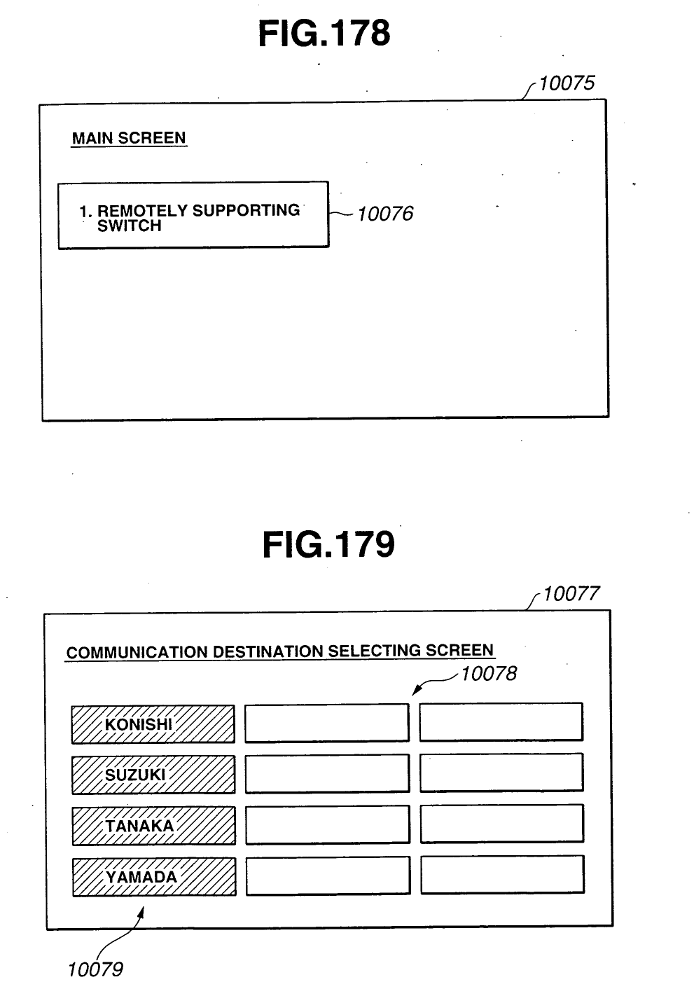

FIGS. 178 to 184 show operating screens of the intensive operating panel 10014.

Referring to FIG. 178, a main screen 10075 is shown and a remotely supporting switch 10076 is provided to start a remotely supporting system. When the remotely supporting switch 10076 is selected, a communication destination selecting screen 10077 is displayed as shown in FIG. 179.

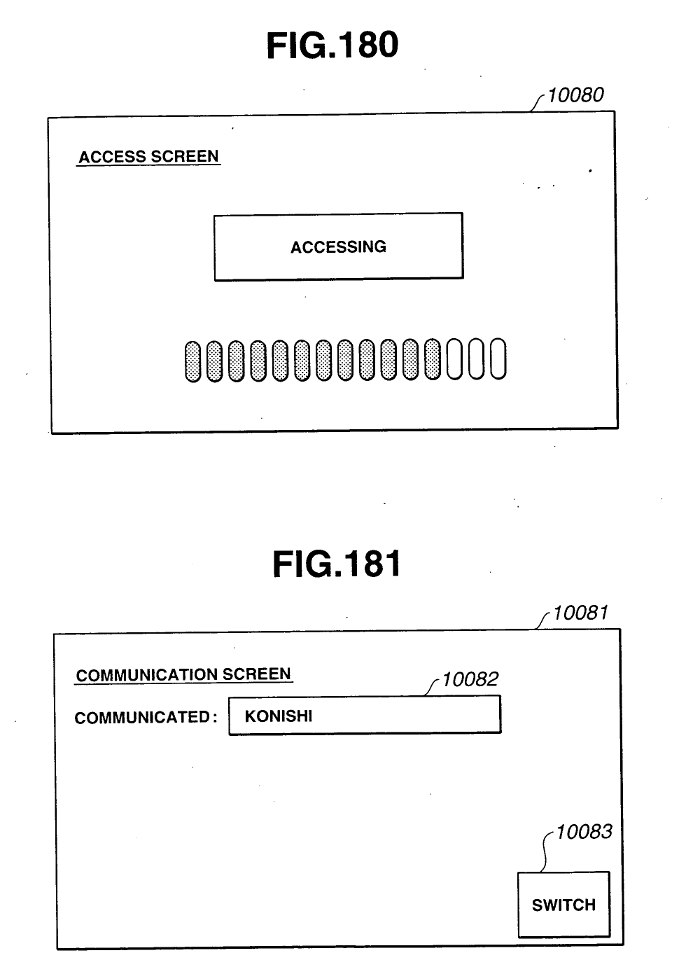

Referring to FIG. 179, a communication destination selecting screen 10077 has a newly registering switch 10078 for registering a new destination and a communication destination registered switch 10079 indicating that the communication destination is registered. The communication destination registered switch 10079 is selected, thereby displaying an access screen 10081 shown in FIG. 180. When the newly registering switch 10070 is selected, thereby displaying a newly registering screen shown in FIG. 183.

Referring to FIG. 180, an access screen 10080 indicates that data is accessed to the communication destination. After completing the communication, a communication screen 10081 shown in FIG. 181 is displayed. The communication is disconnected, thereby returning to a communication destination selecting screen 10077 shown in FIG. 179.

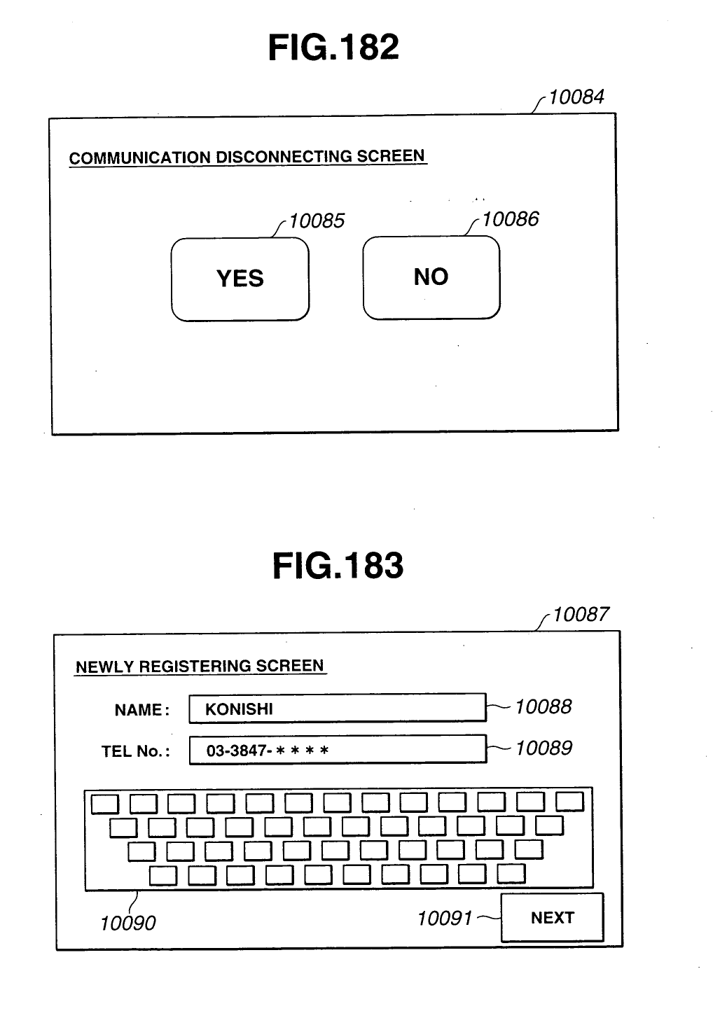

Referring to FIG. 181, a communication screen 10081 has a communication destination display column 10082 for displaying the name at the communication destination and a disconnecting switch 10083 for disconnecting the communication. By selecting the disconnecting switch 10083, a communication disconnecting screen 10084 shown in FIG. 182 is displayed.

Referring to FIG. 182, a communication disconnecting screen 10084 has a YES switch 10085 and a NO switch 10086.

By selecting the YES switch 10085, the communication is disconnected, and the screen is returned to the main screen 10075 shown in FIG. 178. Further, by selecting the NO switch 10086, the screen is returned to the communication screen 10081.

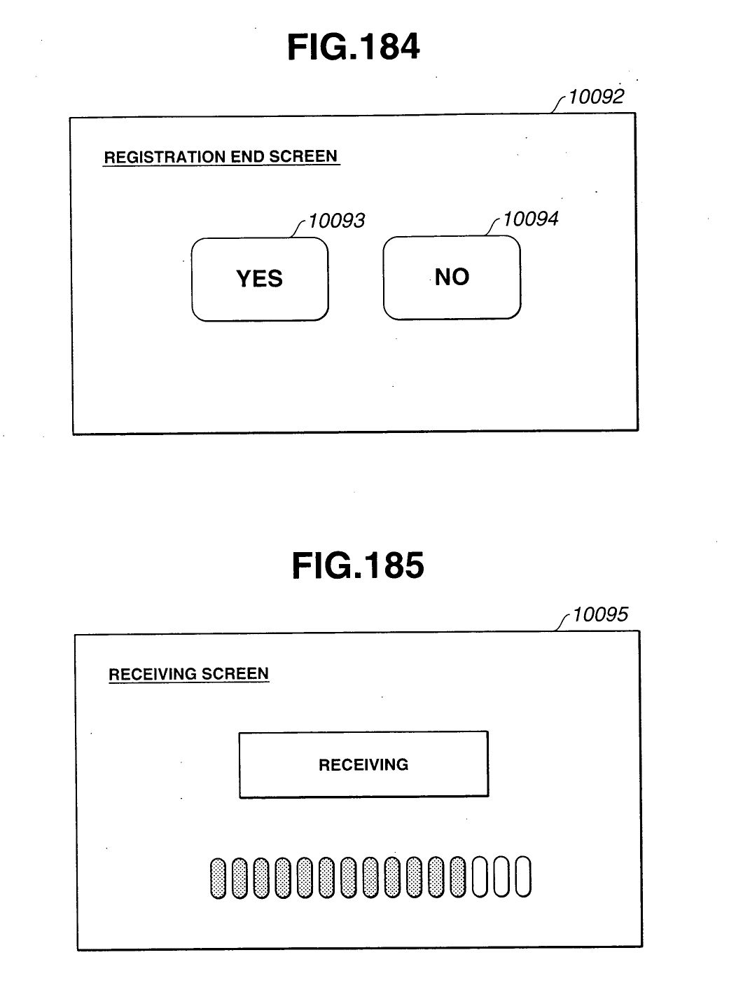

Referring to FIG. 183, a newly registering screen 10087 comprises a name input column 10088 for newly registering the name, a telephone number input column 10089, a keyboard switch 10090, and a registering switch 10091. The name and the telephone number which are inputted by the keyboard switch 10090 are displayed on a name input column 10088 and a telephone number input column 10089. After completing the input operation, a registering switch (NEXT) 10091 is selected and then a registration end screen 10092 shown in FIG. 184 is displayed.

Referring to FIG. 184, a registration end screen 10092 comprises a YES switch 10093 and a NO switch 10094. In the case of registering the new input communication destination, the YES switch 10093 is selected. In the case of inputting it again, the NO switch 10094 is selected and then the screen is returned to the newly registering screen 10087 shown in FIG. 183.

FIGS. 185 to 187 show operating screens of the mobile terminal 10048.

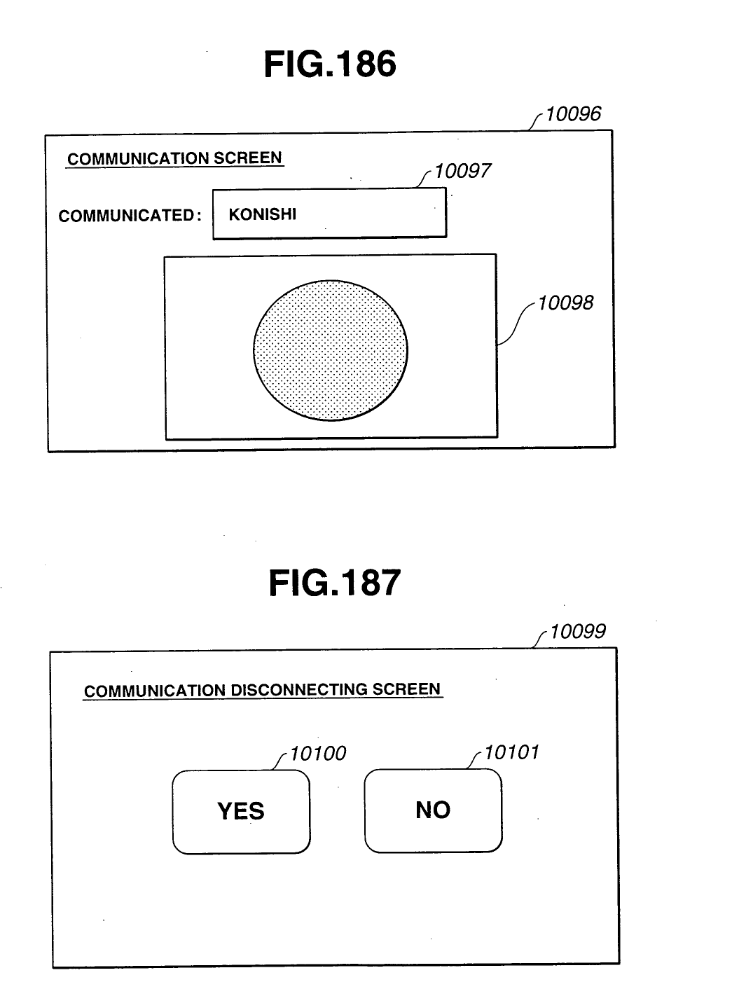

Referring to FIG. 185, a receiving screen 10095 is displayed by receiving the access from the operation room. By selecting the receiving switch 10064 (refer to FIG. 176) of the mobile terminal 10048, an operation room information screen 10096 shown in FIG. 186 is displayed.

Referring to FIG. 186, the operation room information screen 10096 comprises a communication destination display column 10097 for displaying the communication destination and an operation image display area 10098 for displaying an operation image displayed on the display 10012 of the operation room. By selecting the receiving switch 10065 (refer to FIG. 176) of the mobile terminal 10048, a communication disconnecting screen 10099 shown in FIG. 187 is displayed.

Referring to FIG. 187, the communication disconnecting screen 10099 comprises a YES switch 10100 and a NO switch 10101. By selecting the YES switch 10100, the communication is disconnected. By selecting the NO switch 10101, the screen is returned to the operation room information screen 10096 shown in FIG. 186.

(Operation)

FIGS. 178 to 180 show accessing methods from the operation room to a remote position. First, a power switch (not shown) of the system controller 10015 is turned on and then the main screen 10075 is displayed as shown in FIG. 178.

Next, by selecting the remotely supporting switch 10076 of the main screen 10075, a communication destination selecting screen 10077 shown in FIG. 179 is displayed. By selecting the communication destination registered switch 10079, according to the forty-first embodiment, e.g., a switch displayed as “KONISHI” is selected and then an access screen 10080 shown in FIG. 180 is displayed.

The access screen 10080 is displayed and then the display 61 of the mobile terminal 10048 as the access destination displays a receiving screen 10095 shown in FIG. 185.

Referring to FIGS. 185 to 187, a description is given of a method for receiving the access from the operation room by the mobile terminal 10048. The operation is possible if the mobile terminal 10048 is provided irrespective of the place and the time.

The mobile terminal 10048 is accessed from the operation room and then the display 10061 of the mobile terminal 10048 displays the receiving screen 10095 shown in FIG. 185. By selecting the receiving switch 10064 of the mobile terminal 10048, the communication is ensured. Then, the intensive operating panel 10014 displays the communication screen 10081 shown in FIG. 181, the mobile terminal 10048 displays the operation room information screen 10096 shown in FIG. 186, and the display 10061 of the mobile terminal 10048 displays the same image as that displayed on the display 10012 in the operation room. The operation room and the mobile terminal 10048 enables the information exchange by using the voice.

A description is given of a method for registering the communication destination with reference to FIGS. 178, 179, 183, and 184.

A power switch (not shown) of the system controller 10015 is turned on and then the main screen 10075 is displayed as shown in FIG. 178. Next, by selecting the remotely supporting switch 10076 of the main screen 10075, the communication destination selecting screen 10077 shown in FIG. 179 is displayed. By selecting the newly registering switch 10070, the newly registering screen 10087 is displayed as shown in FIG. 183.

On the newly registering screen 10087, the name and the telephone number are inputted to the name input column 10088 and the telephone number input column 10089 by the keyboard switch 10090. After ending the input operation, the registering switch (NEXT) 10091 is selected, thereby displaying the registration end screen 10092 as shown in FIG. 184. By selecting the YES switch 10093, the newly input communication destination is registered to the storing device 10059.

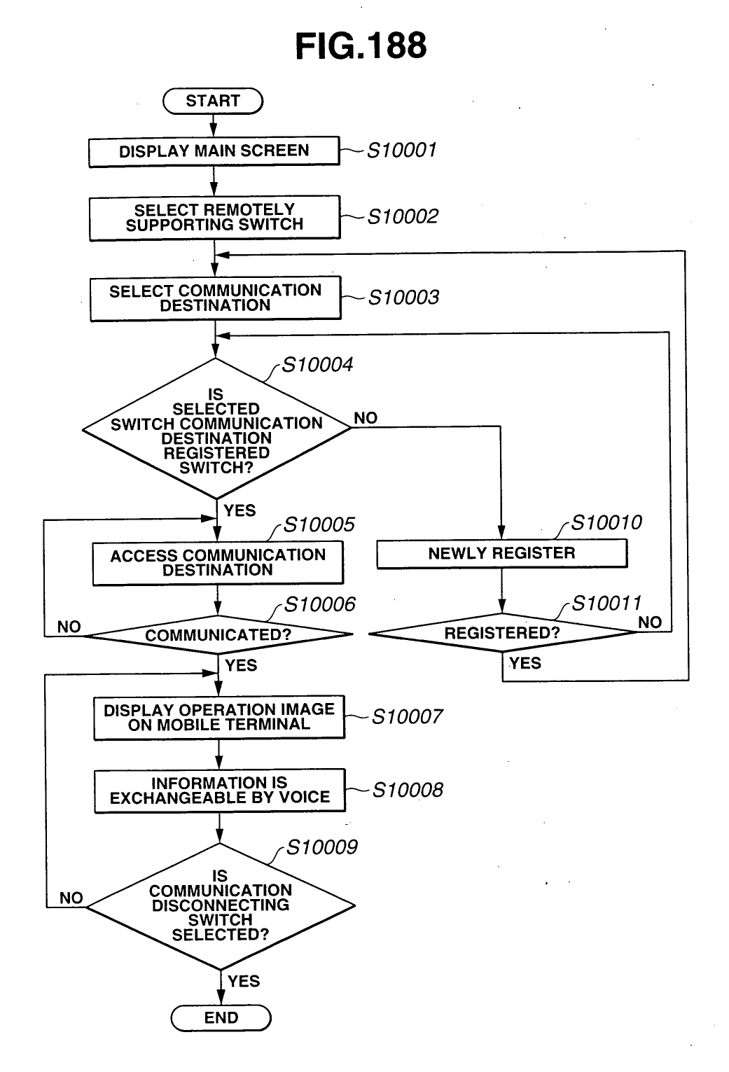

FIG. 188 is a flowchart showing a remotely supporting method using the mobile terminal 10048. A description is given of a method for accessing the mobile terminal at the remote position from the operation room and for observing the same image at both the operation room and the remote position with reference to FIG. 188.

In step S10001, the power of the system controller 10015 is turned on, thereby displaying the main screen 10075 in FIG. 178 on the intensive operating panel 10014. Then, the processing sequence advances to step S10002.

In step S10002, the remotely supporting switch 10076 of the main screen 10075 is selected, thereby displaying the communication destination selecting screen 10078 shown in FIG. 179. Then, the processing sequence advances to step S10003. In step S10003, the communication destination is selected and then the processing sequence advances to step S10004.

In step S10004, the CPU 10058 determines whether or not the switch selected on the communication destination selecting screen 10078 is the communication destination registered switch 10079. If the CPU 10058 determines that the switch is the communication destination registered switch 10079, the processing sequence advances to step S10005. If the CPU 10058 determines that the switch is the newly registering switch, the processing sequence advances to step S10010.

In step S10005, the telephone number registered in the selected switch is accessed and then the processing sequence advances to step S10006.

In step S10006, the CPU 10058 determines whether or not the access is received. If the CPU 10058 determines that the access is received, the processing sequence advances to step S1007. If the CPU 10058 determines that the access is not received, the processing sequence returns to step S10005.

In step S10007, the communication is established, then, the same image as that of the display 10012 of the operation room is displayed on the mobile terminal 10048, and the processing sequence advances to step S10008.

In step S10008, the communication is established between the operation room and the mobile terminal 10048, enabling the communication by using the voice. Then, the processing sequence advances to step S10009.

In step S10009, the CPU 10058 determines whether or not the communication is disconnected. If the communication is disconnected, the communication ends. If the communication is not disconnected, the processing sequence returns to step S10007.

In step S10010, a new telephone-number is registered on the newly registering screen 10087 shown in FIG. 183. The name and the telephone number are inputted to the name input column 10088 and the telephone number input column 10089 by the keyboard switch 10090. After ending the input operation, the registering switch (NEXT) 10091 is selected, thereby displaying the registration end screen 10092 shown in FIG. 184. Then, the processing sequence advances to step S10011.

In step S10011, it is determined whether or not the telephone number inputted on the registration end screen 10092 is registered in the storing device 10059. If the YES switch 10093 is selected, the new input communication destination is registered in the storing device 10059. Then, the processing sequence shifts to step S10003. If the NO switch 10094 is selected, the processing sequence shifts to step S10004.

(Advantages)

According to the fortieth embodiment, as mentioned above, the access from the operation room is received anywhere, irrespective of places by providing the mobile terminal. The same image in the operation room and at the remote position is observed in real time and therefore it is convenient that the operation is easily supported.

### Forty-First Embodiment

The forty-first embodiment is substantially the same as the fortieth embodiment. Therefore, only different points are described, the same reference numerals denote the same components, and a description thereof is omitted.

(Structure)

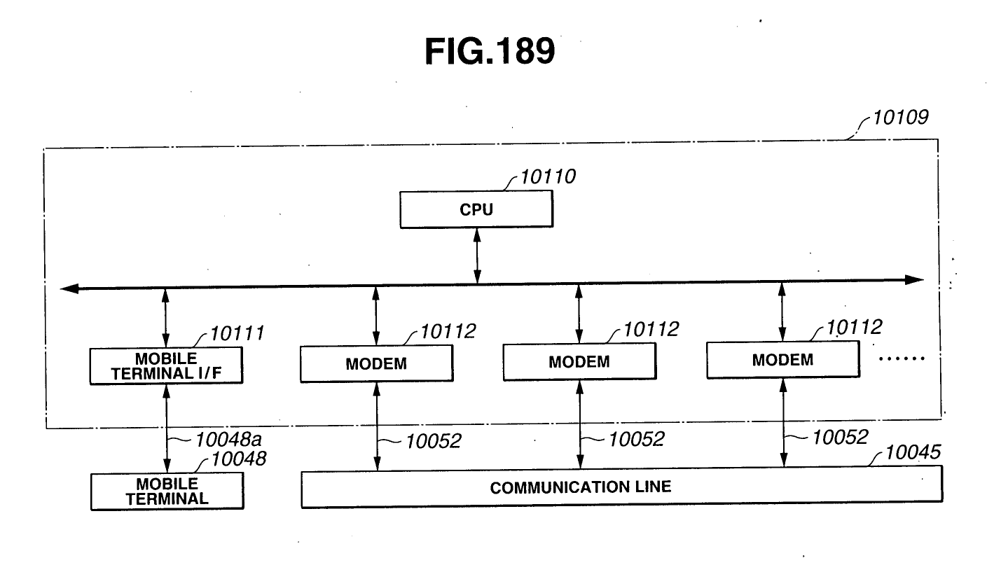

FIG. 189 shows the internal structure of a switching device 10109. The switching device 10109 comprises a CPU 10110, a mobile terminal I/F 10111, and a plurality of modems 10112. The mobile terminal I/F 10111 is connected to the mobile terminal 48 via a mobile terminal cable 10048a. The modems 10112 are respectively connected to the communication line 10045 via the LAN cable 10052.

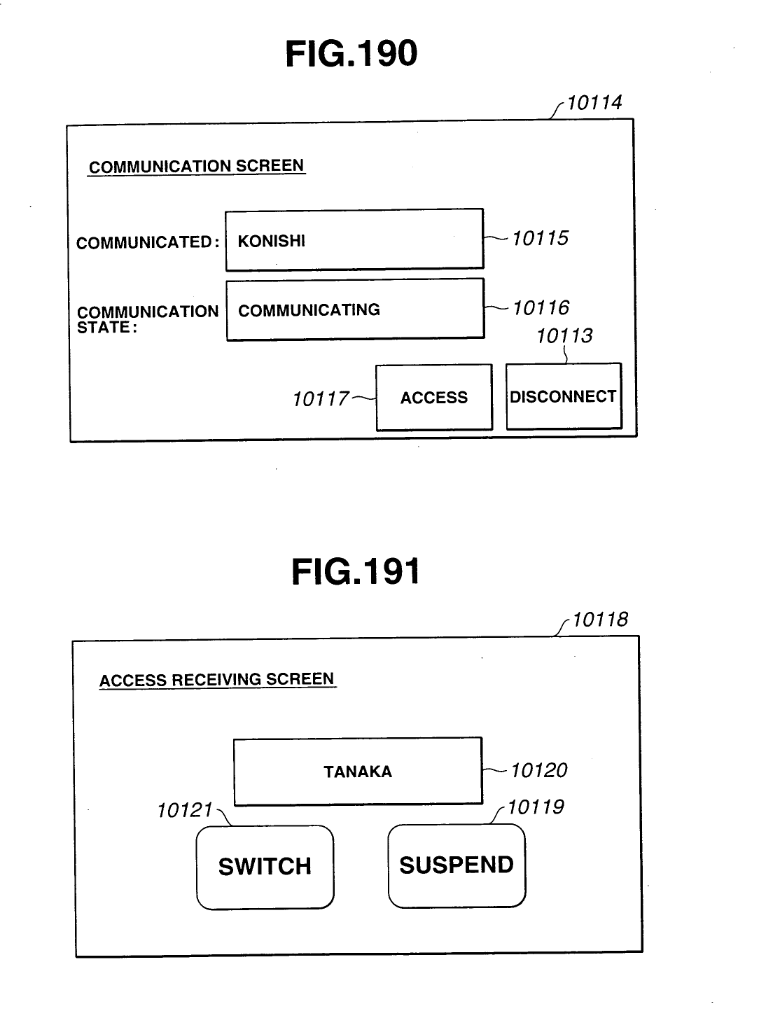

Referring to FIG. 190, a communication screen 10114 of the intensive operating panel 10014 is displayed upon ending the communication with the access destination. Further, the communication screen 10114 comprises a communication destination display column 10115 for displaying the communication destination, a communication state display column 10116 for displaying the communication state, an access switch 10117, and a disconnecting switch 10113.

By selecting the access switch 10117, the mobile terminal 10048 displays an access receiving screen 10118 shown in FIG. 191. By selecting the disconnecting switch 10113, the main screen 10075 shown in FIG. 7 is displayed.

FIGS. 191 to 193 show operating screens of the mobile terminal 10048.

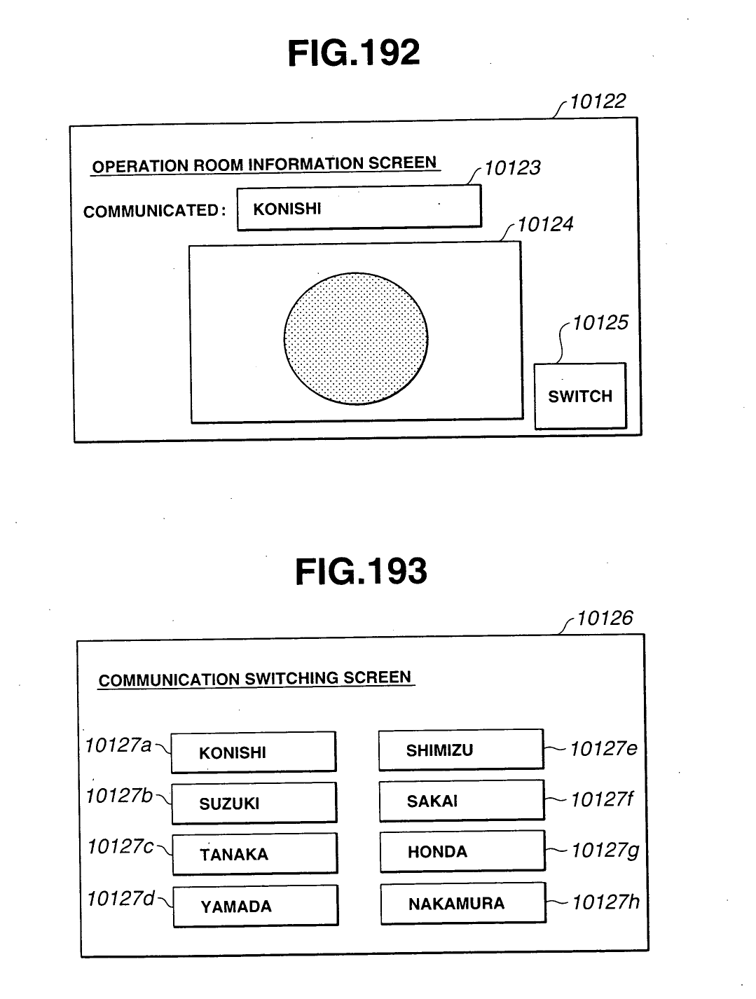

Referring to FIG. 191, an access receiving screen 10118 is displayed when the operation room accesses. The access receiving screen 10118 comprises a communication destination access display column 10120 indicating the access is being executed, a communication destination change-over switch 10121, and a suspending switch 10119. By selecting the communication destination change-over switch 10121, an operation room information screen 10122 shown in FIG. 192 is displayed.

Referring to FIG. 192, an operation room information screen 10122 comprises a communication destination display column 10123 for displaying the communication destination, an operation image display area 10124 for displaying the image displayed on the display 10012 in the operation room, and a communication destination change-over switch 10125. By selecting the communication destination change-over switch 10125, the current communication is suspended and a communication destination switching screen 10126 shown in FIG. 193 is displayed.

Referring to FIG. 193, the communication destination switching screen 10126 displays the communication destination which is communicable now. The communication destination switching screen 10126 comprises communication destination selecting switches 10127a to 10127h for ending the communication with the selected communication destination and for displaying the operation room information screen 10122 shown in FIG. 192.

(Operation)

A description is given of a method for ensuring the communication between the operation room and the remote position with reference to FIGS. 191 and 192.

Similarly to the fortieth embodiment, the remote position is accessed. The CPU 10110 of the switching device 10109 receives the access from the operation room and then the communication with the operation room is kept to the suspending state by using the unused modem 10112.

Further, a description is given of a method for switching the operation room which is accessed, as the communication destination, with reference to FIGS. 191 and 192.

The mobile terminal 10048 during the communication with an operation room A is accessed from another operation room B. Then, the mobile terminal 10048 displays the access receiving screen 10118 shown in FIG. 191. The communication destination switch 10121 is selected on the access receiving screen 10118, then, the communication with the operation room B which is accessed is prior, and an operation room information screen 10122 shown in FIG. 192 as the access destination is displayed. When the access from another operation room is not received, the suspending switch 10119 is selected and the access destination during the communication is prior.

A description is given of a method for changing the communication destination from the mobile terminal 10048 with reference to FIGS. 192 and 193.

Referring to FIG. 192, a communication destination switching switch 10125 is selected on the operation room information screen 10122, thereby displaying a communication destination switching screen 10126 shown in FIG. 193. According to the forty-first embodiment, the communication destination “KONISHI” shown by a communication destination selecting switch 10127a is switched to a communication destination “TANAKA” shown by a communication destination selecting switch 10127b. By selecting the communication destination selecting switch 10127b, the communication with “KONISHI” registered in the communication destination selecting switch 10127a is suspended, and the communication with “TANAKA” registered in the communication destination selecting switch 10127b is completed. Further, the operation room information screen 10122 shown in FIG. 192 is displayed as the communication destination registered as “TANAKA”.

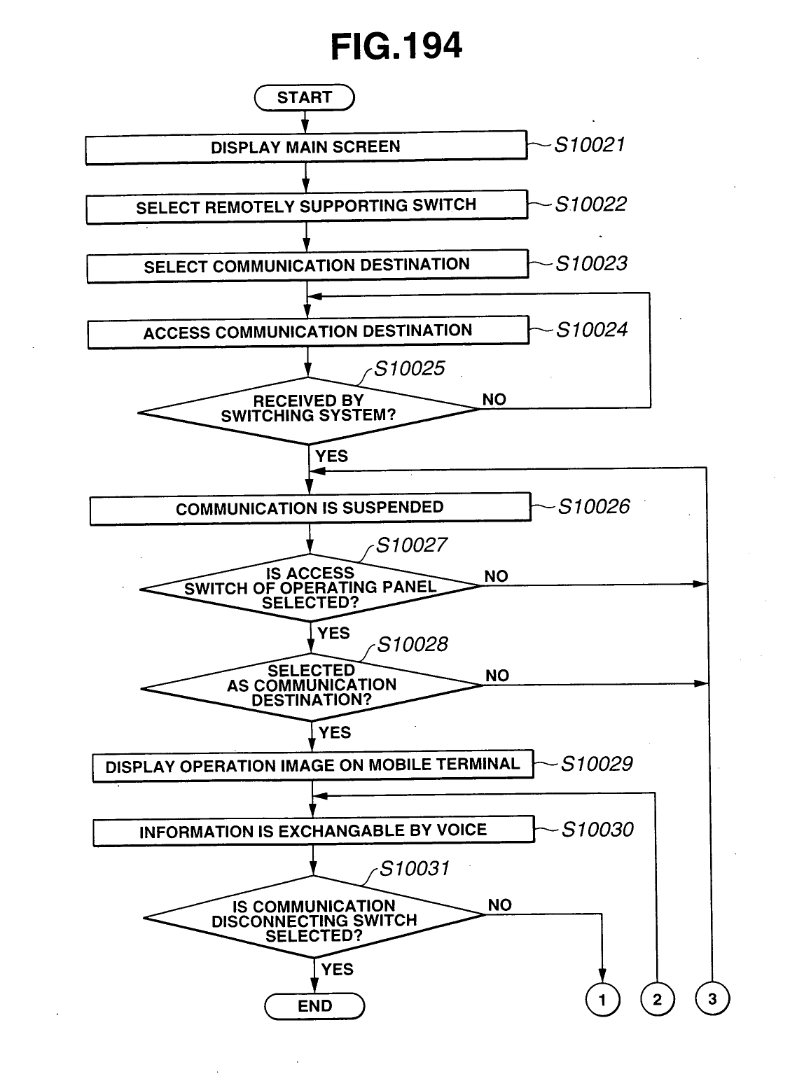

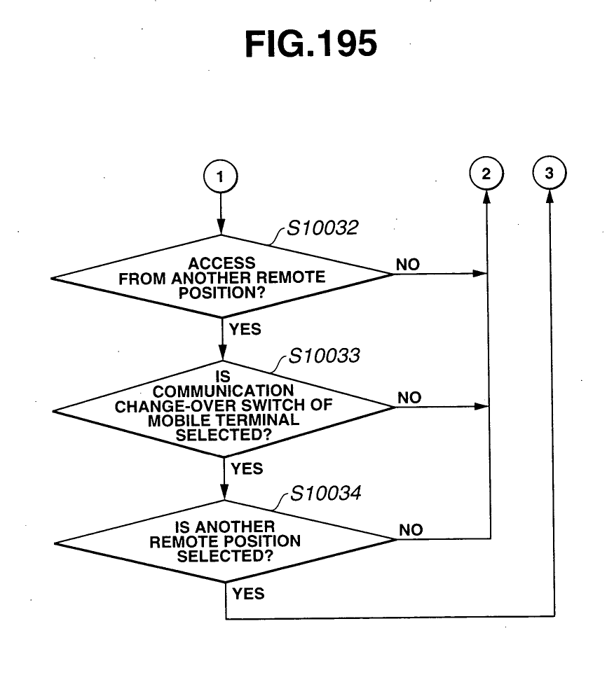

FIGS. 194 and 195 are flowcharts showing a method for remotely supporting a plurality of operation rooms by using the single mobile terminal 10048. A description is given of a method for remotely supporting a plurality of operation rooms by using the single mobile terminal 10048 with reference to FIGS. 194 and 195.

In step S10021, the power of the system controller 10015 is turned on, thereby displaying the main screen 10075 in FIG. 7 on the intensive operating panel 10014. Then, the processing sequence advances to step S10022.

In step S10022, the remotely supporting switch 10066 is selected, thereby displaying the communication destination selecting screen 10077 shown in FIG. 179. Then, the processing sequence advances to step S10023.

In step S10023, the communication destination registered switch 10079 is selected, thereby selecting the communication destination. Then, the processing sequence advances to step S10024.

In step S10024, the telephone number registered in the selected switch is accessed. Then, the processing sequence advances to step S10025.

In step S10025, the CPU 10058 of the system controller 10015 determines whether or not the communication with the switching system is established by the switching device 10109. If the communication is established, the processing sequence advances to step S10026. If the communication is not established, the processing sequence returns to step S10024.

In step S10026, the communication between operation room and the switching system is suspended by the switching device 10109.

In step S10027, the CPU 10058 of the system controller 10015 determines whether or not the access switch 10117 of the communication screen 10114 of the intensive operating panel 10014 is selected. If the access switch 10117 is selected, the system controller 10015 transmits an access requesting signal to the switching device 10109 via the communication line 10045, and the CPU 10110 of the switching device 10109 transmits the signal to the mobile terminal 10048.

In step S10028, the CPU 10110 of the switching device 10109 determines whether or not the mobile terminal 10048 selects, as the communication destination, the operation room to which the access is requested. If the operation room is selected as the communication destination, the processing sequence advances to step S10029. If he operation room is not selected as the communication destination, the processing sequence returns to step S10026.

In step S10029, the communication is established and the same image as that on the display 10012 of the operation room is displayed on the mobile terminal 10048 (refer to FIG. 192). Then, the processing sequence advances to step S10030.

In step S10030, the communication is possible between the operation room and the mobile terminal 10048 by the voice. Then, the processing sequence advances to step S10031.

In step S10031, the CPU 10058 of the system controller 10015 determines whether or not the communication is disconnected. If the communication is disconnected, the communication ends. If the communication is not disconnected, the processing sequence advances to step S10032.

In step S10032, the CPU 10110 of the switching device 10109 determines whether or not another remote position accesses. If another remote position accesses, the CPU 10110 of the switching device 10109 transmits an access requesting signal from another operation room to the mobile terminal 10048, and the processing sequence advances to step S10033. If another remote position does not access, the processing sequence returns to step S10029.

In step S10033, the CPU 10071 of the mobile terminal 10048 determines whether or not the communication destination change-over switch 10125 of the mobile terminal 10048 is selected. If the communication destination change-over switch 10125 is selected, the processing sequence advances to step S10034. If the communication destination change-over switch 10125 is not selected, the processing sequence returns to step S10029.

In step S10034, the CPU 10071 of the mobile terminal 10048 determines whether or not another operation room is selected as the communication destination. If another operation room is selected, the processing sequence returns to step S10026. If the other operation room is not selected, the processing sequence returns to step S10029.

(Advantages)

In addition to the advantages according to the fortieth embodiment, the communication is established with a plurality of operation rooms at once and only the operation room which receives the access is remotely supported. Therefore, conveniently, the operation does not need to be always observed and a plurality of operations are supported at once.

Having described the preferred embodiments of the invention referring to the accompanying drawings. It should be understood that the present invention is not limited to those precise embodiments and various changes and modifications thereof could be made by one skilled in the art without departing from the spirit or scope of the invention as defined in the appended claims. The present invention will be limited to the appended claims but not restricted to any specific embodiments.

1. A control system for controlling medical equipment comprising:
a mobile device including: an operator panel that has an operating section used to determine the settings of a plurality of pieces of medical equipment; a first information processing circuit that produces data, which represents the settings of medical equipment, on the basis of the determination made through said operator panel; and a first communication interface that enables bi-directional communication so as to permit transmission of the setting data produced by said information processing circuit; and
a controller including: a second communication interface via which said controller is connected to a plurality of pieces of medical equipment; a third communication interface that enables communication via said first communication interface; and a second information processing circuit that applies the setting data received via said third communication interface to said second communication interface.

2. A control system according to claim 1, wherein said mobile device further includes a memory in which the setting data produced by said first information processing circuit is stored, reads the setting data from said memory, and transmits the setting data to said controller via said first communication interface.

3. A control system according to claim 2, wherein said memory is freely detachable from said mobile device.

4. A control system according to claim 3, wherein said controller has a loading portion in which said memory is loaded, reads the setting data from said memory loaded in the loading portion, and transmits the data to said plurality of pieces of medical equipment.

5. A control system according to claim 2, wherein: said controller uses said second information processing circuit to produce data representing the settings of medical equipment, and transmits the setting data to said mobile device via said third communication interface; and said mobile device receives the setting data via said first communication interface and stores it in said memory.

6. A control system according to claim 5, further comprising a remote control unit that transmits control data, based on which the data representing the settings of medical equipment is modified, to said controller, wherein said controller modifies the setting data on the basis of the received control data.

7. A control system according to claim 6, wherein said remote control unit transmits control data by means of infrared light waves.

8. A control system according to claim 5, wherein said first information processing circuit reads and edits the setting data stored in said memory.

9. A control system according to claim 1, wherein said first communication interface is coupled to said third communication interface with a connector, which is freely detachably attached to said third communication interface, between them.

10. A control system according to claim 1, wherein said first communication interface enables wireless communication via said third communication interface.

11. A control system according to claim 10, wherein said first communication interface enables wireless communication by means of infrared light waves.

12. A control system according to claim 10, wherein: said mobile device further includes a fourth communication interface conformable to a protocol different from said first communication interface is; and said controller further includes a fifth communication interface that enables communication via said fourth communication interface.

13. A control system according to claim 10, further comprising a communication adaptor that is freely detachably attached to said mobile device, wherein said communication adaptor amplifies a wireless communication signal sent via said first communication interface, and applies the resultant signal to said third communication interface.

14. A control system according to claim 1, wherein: said controller receives information of medical equipment via said second communication interface, transmits the equipment information to said mobile device via said third communication interface; and said mobile device displays the settings on a display on the basis of the setting data received via said first communication interface.

15. A controller for controlling medical equipment, comprising:
an information processing circuit for producing data that represents the settings of medical equipment;
a first communication interface via which the setting data produced by said information processing circuit is transmitted to said medical equipment, and equipment information is received from said medical equipment;
a memory in which the setting data produced by said information processing circuit or the equipment information received via said first communication interface is stored; and
a second communication interface that enables communication with a mobile device having a storage device so as to permit transmission of the setting data or equipment information, which is stored in said memory, to said mobile device.

16. A controller according to claim 15, wherein said mobile device further includes a display device, and displays the information of medical equipment, which is transmitted from said controller, on said display device.

17. A controller according to claim 15, wherein: said information processing circuit judges whether data is transmitted via said second communication interface; and if said information processing circuit judges that data is transmitted, said information processing circuit terminates the action of said control system.

18. A controller according to claim 15, wherein said second communication interface enables communication with a plurality of mobile devices.

19. A controller according to claim 18, wherein said information processing circuit identifies a mobile device on the basis of identification information received from the mobile device via said second communication interface.

20. A controller according to claim 19, wherein said information processing circuit controls a storage area in said memory on the basis of the identification information.

21. A controller according to claim 19, wherein said second communication interface permits transmission of a program executable by said mobile device on the basis of the identification information.

22. A controller according to claim 18, wherein: said information processing circuit judges whether data is transmitted to a plurality of mobile devices via said second communication interface; and if said information processing circuit judges that data is transmitted, said information processing circuit controls updating of said memory.

23. A controller according to claim 15, further comprising a third communication interface connected on a network, wherein said information processing circuit controls said third communication interface on the basis of the equipment information received via said first communication interface.

24. A controller according to claim 18, wherein said information processing circuit judges the priorities given to said plurality of mobile devices, and controls said third communication interface on the basis of the results of the judgment.

25. A control system, comprising:
one or a plurality of medical devices;
a medical device control portion which controls the medical device via a communication portion;
a medical image display control portion for displaying at least a medical image from the medical device on a medical image display portion connected to the medical device control portion; and
a mobile terminal which can be communicated via the medical device control portion and a communication line,
wherein the mobile terminal has an image display portion for displaying an image at the terminal side and displays the medical image on the image display portion for displaying an image at the terminal side via the communication line.

26. A control system according to claim 25, further comprising:
a switching system which can be connected to the communication line and the mobile terminal.

27. A control system according to claim 26, further comprising a first voice input portion to input voice and a first voice output portion to output voice, connected to the medical device control portion,
wherein the mobile terminal further comprises a second voice input portion to input voice and a second voice output portion to output voice, thereby to send/receive voice information between the first voice input portion/the first voice output portion and the second voice input portion/the second voice output portion via the communication line.

28. A control system according to claim 26, further comprising:
a switching state setting portion which sets a switching state of the switching system.

29. A control system according to claim 27, further comprising:
a switching state setting portion which sets a switching state of the switching system.

30. A control system according to claim 28,
wherein the medical device control portion comprises a control image generating portion which generates a control image for controlling the medical device, and
the control system further comprises a control image transmitting portion which transmits the control image to the mobile terminal via the communication line when the switching state setting portion controls the switching system and sets a switching state for connecting the communication line to the mobile terminal.

31. A control system according to claim 29,
wherein the medical device control portion comprises a control image generating portion which generates a control image for controlling the medical device, and
the control system further comprises a control image transmitting portion which transmits the control image to the mobile terminal via the communication line when the switching state setting portion controls the switching system and sets a switching state for connecting the communication line to the mobile terminal.

32. A control system according to claim 25,
wherein the medical device control portion comprises a control image generating portion which generates a control image for controlling the medical device, and
the control system further comprises a control image transmitting portion which transmits the control image to the mobile terminal via the communication line when the communication line can be communicated with the mobile terminal.

33. A control system according to claim 26,
wherein the medical device control portion comprises a control image generating portion which generates a control image for controlling the medical device, and
the control system further comprises a control image transmitting portion which transmits the control image to the mobile terminal via the communication line when the communication line can be communicated with the mobile terminal.

34. A control system according to claim 27,
wherein the medical device control portion comprises a control image generating portion which generates a control image for controlling the medical device, and
the control system further comprises a control image transmitting portion which transmits the control image to the mobile terminal via the communication line when the communication line can be communicated with the mobile terminal.

35. A control method for supporting an operation, comprising:
information sending/receiving step for sending/receiving information between a medical device control portion which controls one or a plurality of medical devices via a communication portion and a mobile terminal connected to the medical device control portion via a communication line; and
medical device controlling step for controlling the one or the plurality of medical devices by the medical device control portion,
wherein the medical device controlling step comprises control image generating step for generating a control image for controlling the medical device and control image transmitting step for transmitting the control image to the mobile terminal connected via the communication line.

36. A control method for supporting an operation according to claim 35,
wherein the control image includes a medical image from the medical device.

37. A control system, comprising:
one or a plurality of medical devices;
a medical device control means which controls the medical device via a communication means;
a medical image display control means for displaying at least a medical image from the medical device on a medical image display means connected to the medical device control means; and
a mobile terminal which can be communicated via the medical device control means and a communication line,
wherein the mobile terminal has an image display means for displaying an image at the terminal side and displays the medical image on the image display means for displaying an image at the terminal side via the communication line.

38. A control system according to claim 37, further comprising a first voice input means to input voice and a first voice output means to output voice, connected to the medical device control means,
wherein the mobile terminal further comprises a second voice input means to input voice and a second voice output means to output voice, thereby to send/receive voice information between the first voice input means/the first voice output means and the second voice input means/the second voice output means via the communication line.
